(19) United States
(12) Patent Application Publication
(10) Pub. No.: US 2026/0118857 A1
(43) Pub. Date: Apr. 30, 2026

(54) APPARATUS FOR PROVIDING DIGITAL PRODUCTION PLAN INFORMATION, METHOD THEREOF, AND COMPUTATIONALLY IMPLEMENTABLE STORAGE MEDIUM FOR STORING A SOFTWARE FOR PROVIDING DIGITAL PRODUCTION PLAN INFORMATION

(71) Applicant: VMS SOLUTIONS CO., LTD., Yongin-si (KR)

(72) Inventors: Taeryong KIM, Yongin-si (KR); Seungjin RYU, Yongin-si (KR); Wonseok LEE, Yongin-si (KR); Wonjun LEE, Yongin-si (KR); Goohwan CHUNG, Yongin-si (KR); Byunghee KIM, Yongin-si (KR)

(21) Appl. No.: 19/371,112

(22) Filed: Oct. 28, 2025

Related U.S. Application Data
(63) Continuation of application No. PCT/KR2025/005993, filed on May 2, 2025.

(30) Foreign Application Priority Data
Oct. 22, 2024 (KR) 10-2024-0144693
Feb. 18, 2025 (KR) 10-2025-0020980
Feb. 18, 2025 (KR) 10-2025-0020997
Apr. 30, 2025 (KR) 10-2025-0057323

(51) Int. Cl. G05B 19/418

(52) U.S. Cl. CPC G05B 19/41865

(57) ABSTRACT

An embodiment for providing digital production plan information comprises that providing, to a client, an extensible software model and logic set to generate production plan data, receiving first input data comprising reference information for a manufacturing production system, and second input data for setting at least one parameter, and based on the first and second input data, performing at least one of learning, evaluating, operating, deploying, and managing at least one policy to provide the production plan data to the client.

### CROSS-REFERENCE TO RELATED APPLICATION

This application is the National Stage filing under 35 U.S.C. 371 of International Application No. PCT/KR2025/005993 filed on May 2, 2025, which claims the benefit of Korean Patent Application No. 10-2024-0144693, filed on Oct. 22, 2024, Korean Patent Application No. 10-2025-0020980, filed on Feb. 18, 2025, Korean Patent Application No. 10-2025-0020997, filed on Feb. 18, 2025, Korean Patent Application No. 10-2025-0057323, filed on Apr. 30, 2025, the contents of which are all hereby incorporated by reference herein in their entirety.

### BACKGROUND OF THE INVENTION

### Field of the Invention

The following disclosure provides a device for providing digital production plan information, a method for providing digital production plan information, and a storage medium storing computer-executable software for providing a digital production plan.

### Description of the Related Art

A manufacturing system that produces a product involves several work steps and involves several resources. Depending on the product, it may involve a number of complex steps, may require expensive resources depending on the product, and each step requires optimal operations.

For example, in cutting-edge fields such as semiconductors, displays, secondary batteries, automobiles, steel, home appliances, and biotechnology, extremely expensive resources are invested, therefore, reducing process failures and increasing efficiency are key factors for enhancing product competitiveness. In many cases, the cost of the equipment responsible for executing a manufacturing process was associated with significant capital cost, or the integration of additional equipment may be impractical due to physical space constraints within the manufacturing system. Making good decisions in complex manufacturing processes may increase production efficiency without adding equipment.

Several approaches are being developed to optimize these work steps, increase resource efficiency, and increase productivity.

Among such approaches, the use of digital modeling to implement manufacturing systems and to identify and resolve issues therein is becoming increasingly prevalent. Since decision-making in the real world is irreversible, solutions are being proposed to solve the problem of improving decision-making and production efficiency through digital modeling.

Recently, with the advancement of artificial intelligence technology, methodologies are being developed to make better decisions through learning in various decision-making problems.

### SUMMARY OF THE INVENTION

The present disclosure is to provide a device for providing digital production plan information, a method for providing digital production plan information, and a storage medium storing computer-executable software for providing a digital production plan, which may provide reusability and expandability for manufacturing or production system.

Another aspect of the present disclosure is to provide a device for providing digital production plan information, a method for providing digital production plan information, and a storage medium storing computer-executable software for providing a digital production plan, which is capable of predicting real-time changes in a manufacturing or production system or providing an efficient production plan.

Another aspect of the present disclosure is to provide a device for providing digital production plan information, a method for providing digital production plan information, and a storage medium storing computer-executable software for providing a digital production plan, which may significantly reduce time and cost by reproducing decision-making in a virtual environment through digital modeling.

Another object of the present disclosure is to provide a device for providing digital production plan information, a method for providing digital production plan information, and a storage medium storing computer-executable software for providing a digital production plan, which is capable of solving various decision-making problems through artificial intelligence learning.

According to the embodiments of the disclosure provides a method of providing digital production plan information comprising: obtaining rule information for each decision-making point of at least one of pre-stored backward planning logic or forward planning logic for a manufacturing production system of a client; receiving input data including reference information about the manufacturing production system from the client; and providing production plan data to the client by executing a software model and logic set including at least one of backward planning logic or forward planning logic according to the rule information based on the input data.

According to one embodiment of the present disclosure, further comprising: after the receiving step, applying the input data based on a pre-stored standard model to determine at least one of the backward planning logic or the forward planning logic; and applying the rule information for each decision-making point to a decision-making point in at least one of the determined backward planning logic or the determined forward planning logic.

According to one embodiment of the present disclosure, the backward planning logic comprises: an align step, determining a pegging group including at least one work object of a plurality of work objects based on the input data according to the rule information; an item/site/buffer (ISB) pegging step, executing a work-in-process (WIP) pegging on a target work object of the at least one work object for current ISB information according to the rule information; an ISB routing step, determining a target bill of material (BOM) of the at least one BOM for the target work object for which the WIP pegging is performed according to the rule information; an operation pegging step, performing the WIP pegging on the target work object for an operation on the target BOM according to the rule information; and an operation routing step, applying time information for the operation to the target work object for which the WIP pegging is performed according to the rule information.

According to one embodiment of the present disclosure, the backward planning logic comprises: calculating at least one of an operation target, factory input plan information, or a pegging history for the operation based on a target work object having time information for the operation according to the rule information.

According to one embodiment of the present disclosure, the forward planning logic comprises: selecting, based on the rule information, a resource group including at least one resource for an operation of the manufacturing production system of the client; selecting a work item group including at least one work item for the resource group; selecting a resource for the selected work item group from at least one resource included in the resource group; and selecting a work item for the resource from among at least one work item included in the work item group.

According to one embodiment of the present disclosure, the forward planning logic comprises: selecting, based on the rule information, a resource for an operation of the manufacturing production system of the client; selecting a work item group including at least one work item for the resource; and selecting a work item for the resource from the at least one work item included in the work item group.

According to one embodiment of the present disclosure, the forward planning logic comprises: executing operation processing on the selected work item and resource; placing the work item into the ISB information based on the pegging history included in the input data; moving work item based on an operational target included in the input data to an operation for the ISB information; if the operation is not a dummy operation, placing the moved work item into a buffer; and if the operation is a dummy operation, executing dummy operation processing on the moved work item.

According to one embodiment of the present disclosure provides a device providing digital production plan information, comprising: storage storing data; an in-memory storing a library engine set associated with a software; and a processor executing the software, wherein the processor is configured to: obtain rule information for each decision-making point of at least one of pre-stored backward planning logic or forward planning logic for a manufacturing production system of a client; and receive, from the client, input data including reference information about the manufacturing production system; and execute, based on the input data, a software model and logic set including at least one of backward planning logic or forward planning logic according to the rule information to provide production plan data to the client.

According to one embodiment of the present disclosure, the processor is further configured to: apply the input data based on a pre-stored standard model and determine at least one of the backward planning logic or the forward planning logic; and apply the rule information for each decision-making point to a decision-making point of at least one of the determined backward planning logic or the determined forward planning logic.

According to one embodiment of the present disclosure, the backward planning logic comprises: determining a pegging group including at least one work object of a plurality of work objects based on the input data according to the rule information; executing a work-in-process (WIP) pegging on a target work object of the at least one work object for current ISB information according to the rule information; determining a target bill of material (BOM) of the at least one BOM for the target work object for which the WIP pegging is performed according to the rule information; performing the WIP pegging on the target work object for an operation on the target BOM according to the rule information; and applying time information for the operation to the target work object for which the WIP pegging is performed according to the rule information.

According to one embodiment of the present disclosure, the backward planning logic includes calculating at least one of an operation target, factory input plan information, or a pegging history for the operation based on a target work object having time information for the operation according to the rule information.

According to one embodiment of the present disclosure, the forward planning logic comprises: selecting, based on the rule information, a resource group including at least one resource for an operation of the manufacturing production system of the client; selecting a work item group including at least one work item for the resource group; selecting a resource for the selected work item group from at least one resource included in the resource group; and selecting a work item for the resource from among at least one work item included in the work item group.

According to one embodiment of the present disclosure, the forward planning logic comprises: selecting, based on the rule information, a resource for an operation of the manufacturing production system of the client; selecting a work item group including at least one work item for the resource; and selecting a work item for the resource from the at least one work item included in the work item group.

According to embodiments of the present disclosure, the forward planning logic comprises: executing operation processing on the selected work item and resource; placing the work item into the ISB information based on the pegging history included in the input data; moving work item based on an operational target included in the input data to an operation for the ISB information; if the operation is not a dummy operation, placing the moved work item into a buffer; and if the operation is a dummy operation, executing dummy operation processing on the moved work item.

According to one embodiment of the present disclosure provides a non-transitory computer-readable storage medium for storing a program for providing digital production plan information executable by a computer, the program comprising instructions configured to: obtain, rule information for each decision-making point of at least one of pre-stored backward planning logic or forward planning logic for a manufacturing production system of a client; receive, from the client, input data including reference information about the manufacturing production system; and execute, based on the input data, a software model and logic set including at least one of backward planning logic or forward planning logic according to the rule information to provide production plan data to the client.

According to the embodiments, it is possible provide reusability and extensibility of digital models for manufacturing or production systems.

According to the embodiments, it is possible to predict real-time changes in a manufacturing or production system or to provide efficient production planning.

According to the embodiments, digital modeling of a manufacturing or production system may significantly reduce time and cost by reproducing decision-making in a virtual environment, and various decision-making problems in a manufacturing or production system may be solved through artificial intelligence learning.

According to the embodiments, a series of processes may be automatically performed in a manufacturing production system requiring production plans of various levels of detail.

### BRIEF DESCRIPTION OF THE DRAWINGS

FIG. 1 is a diagram illustrating an embodiment of a method for providing a digital production plan.

FIG. 2 is a diagram illustrating an embodiment of a computing system that provides digital production plan data.

FIG. 3 is a diagram illustrating another embodiment of a computing system providing digital production plan data.

FIG. 4 is a diagram illustrating an embodiment of procedures executed by backward planning logic.

FIG. 5 is a diagram illustrating an embodiment of execution steps of backward planning logic within a library engine set.

FIG. 6 is a diagram illustrating an embodiment of executing backward planning.

FIG. 7 is a flowchart illustrating an embodiment of generating a production plan using a software model and logic set including backward planning logic.

FIG. 8 is a diagram illustrating an embodiment of a device providing digital production plan information.

FIG. 9 is a diagram illustrating procedures executed by forward planning logic according to an embodiment.

FIG. 10 is a diagram illustrating execution steps of forward planning logic within a library engine set according to an embodiment.

FIG. 11 is a diagram illustrating an example of state variables of forward planning according to an embodiment.

FIG. 12 is a diagram illustrating an example of an event in an event queue executing forward planning according to an embodiment.

FIG. 13 is a flowchart for generating a production plan using forward planning logic according to an embodiment.

FIG. 14 is a diagram illustrating another example of an event in an event queue executed by forward planning logic according to an embodiment.

FIG. 15 is a diagram illustrating steps of an input decision-making execution executed by forward planning logic according to an embodiment.

FIG. 16 is a diagram illustrating an example of dispatching executed by forward planning logic according to an embodiment.

FIG. 17 is a diagram illustrating another example of dispatching executed by forward planning logic according to an embodiment.

FIG. 18 is a flowchart for generating a production plan using forward planning logic according to an embodiment.

FIG. 19 is a diagram illustrating an example of generating a software model and a logic set based on a data schema and library engine set according to an embodiment.

FIG. 20 is a diagram illustrating an example of generating a logic set including pegging logic and simulation logic according to an embodiment.

FIG. 21 is a diagram illustrating an example of a method for providing digital production plan information according to an embodiment of the present invention, which generates a software model and logic set.

FIG. 22 is a diagram illustrating an example of a method for providing digital production plan information according to an embodiment to generate a production plan.

FIG. 23 is a diagram illustrating an example of generating an operational task based on a software model and logic set according to an embodiment.

FIG. 24 is a diagram illustrating an example of executing an operational task based on a software model and logic set according to an embodiment.

FIG. 25 is a diagram illustrating an example of configuring an operational task in a system operation unit according to an embodiment.

FIG. 26 is a diagram illustrating an example of generating and executing an operational task in an on-premise computing system according to an embodiment.

FIG. 27 is a diagram illustrating an example of generating and performing an operational task in a cloud computing system according to an embodiment.

FIG. 28 is a diagram illustrating a method for providing digital production plan information according to an embodiment.

FIG. 29 is a diagram illustrating an embodiment of a device providing digital production plan information.

FIG. 30 is a diagram illustrating an example of analyzing a production plan based on a software model and logic set according to an embodiment.

FIG. 31 is a diagram illustrating an example of a data retrieval screen according to an embodiment.

FIG. 32 is a diagram illustrating an example of a pivot grid retrieval screen according to an embodiment.

FIG. 33 is a diagram illustrating an example of a data editing screen according to an embodiment.

FIG. 34 is a diagram illustrating an example of an experimental configuration and execution screen according to an embodiment.

FIG. 35 is a flow chart illustrating an example of analyzing a production plan based on a software model and logic set according to an embodiment.

FIG. 36 is a diagram illustrating an example of a computing system that provides digital production plan data according to an embodiment.

FIG. 37 is a diagram illustrating an example of the basic structure of an experimental hub based on a software model and logic set according to an embodiment.

FIG. 38 is a diagram illustrating an example of generating an experimental hub file based on a software model and logic set according to an embodiment.

FIG. 39 is a diagram illustrating an example of generating an experimental hub file based on a software model and logic set according to an embodiment.

FIG. 40 is a diagram illustrating an example of generating refinement logic from an experimental hub file based on a software model and logic set according to an embodiment.

FIG. 41 is a diagram illustrating an example of generating an experimental hub file based on a software model and logic set according to an embodiment.

FIG. 42 is a diagram illustrating an example of generating an experimental hub file based on a software model and logic set according to an embodiment.

FIG. 43 is a diagram illustrating an example of executing an experiment based on a software model and logic set according to an embodiment.

FIG. 44 is a diagram illustrating an example of outputting information about an experimental hub file based on a software model and logic set according to an embodiment.

FIG. 45 is a diagram illustrating an example of performing and executing an experiment in an experimental hub based on a software model and logic set according to an embodiment.

FIG. 46 is a flowchart illustrating an example of generating and performing an experimental hub according to an embodiment.

FIG. 47 is a flowchart illustrating a method for providing digital production plan information according to an embodiment.

FIG. 48 is a diagram illustrating the configuration of an iterative experiment design based on a software model and logic set according to an embodiment.

FIG. 49 is a diagram illustrating an example of performing an iterative experiment design based on a software model and logic set according to an embodiment.

FIG. 50 is a flowchart illustrating a method for providing digital production plan information according to an embodiment.

FIG. 51 is a diagram illustrating an example of setting up an operational task in a system operation unit according to an embodiment.

FIG. 52 is a diagram illustrating an example of an operational task performed using a fixed-size experiment design in an operating environment according to an embodiment.

FIG. 53 is a flowchart illustrating an example of setting up and performing operational tasks of an experimental hub according to an embodiment.

FIG. 54 is a flowchart illustrating a method for providing digital production plan information according to an embodiment

FIG. 55 is a diagram illustrating an example of an experimental hub screen according to an embodiment.

FIG. 56 is a diagram illustrating an example of file generation and factor registration on an experimental hub screen according to an embodiment.

FIG. 57 is a diagram illustrating an example of generating data type factors and key performance indicators on a data table of an experimental hub file according to an embodiment.

FIG. 58 is a diagram illustrating an example of generating model data factors of an experimental hub file according to an embodiment.

FIG. 59 is a diagram illustrating an example of generating a data type factor of an experimental hub file according to an embodiment.

FIG. 60 is a diagram illustrating an example of generating a data type factor of an experimental hub file according to an embodiment.

FIG. 61 is a diagram illustrating an example of generating a data type factor of an experimental hub file according to an embodiment.

FIG. 62 is a diagram illustrating an example of registering a model type factor of an experimental hub file according to an embodiment.

FIG. 63 is a diagram illustrating an example of registering a logic type factor of an experimental hub file according to an embodiment.

FIG. 64 is a diagram illustrating an example of registering key performance indicators of an experimental hub file according to an embodiment.

FIG. 65 is a diagram illustrating another example of a method for editing an experimental hub according to an embodiment.

FIG. 66 is a flowchart illustrating an example of providing digital production plan information according to an embodiment.

FIG. 67 is a diagram illustrating an example of a scenario refinement included in an experimental hub according to an embodiment.

FIG. 68 is a diagram illustrating an example of a scenario refinement included in an experimental hub according to an embodiment.

FIG. 69 is a diagram illustrating an example of an experimental refinement included in an experimental hub according to an embodiment.

FIG. 70 is a diagram illustrating an example of an experimental refinement included in an experimental hub according to an embodiment.

FIG. 71 is a diagram illustrating an example of editing an experiment design of an experimental hub file according to an embodiment.

FIG. 72 is a diagram illustrating an example of editing an experiment design of an experimental hub file according to an embodiment.

FIG. 73 is a diagram illustrating an example of editing an experiment design of an experimental hub file according to an embodiment.

FIG. 74 is a diagram illustrating an example of editing an experimental performance of an experimental hub file according to an embodiment.

FIG. 75 is a diagram illustrating an example of experiment execution editing of an experiment hub file according to an embodiment.

FIG. 76 is a diagram illustrating an example of editing an experimental performance of an experimental hub file according to an embodiment.

FIG. 77 is a diagram illustrating an example of editing an experiment performance of an experiment hub file according to an embodiment.

FIG. 78 is a diagram illustrating an example of confirmation of experimental performance results of an experimental hub file according to an embodiment.

FIG. 79 is a flowchart illustrating an example of providing digital production plan information according to an embodiment.

FIG. 80 is a diagram illustrating an example of providing digital production plan information based on a model based on a repair optimization model according to an embodiment.

FIG. 81 is a diagram illustrating an example of using variable time buckets according to an embodiment.

FIG. 82 is a flowchart illustrating an example of model execution based on a mathematical optimization formulation according to an embodiment.

FIG. 83 is a diagram illustrating an example of model execution based on a mathematical optimization formulation according to an embodiment.

FIG. 84 is a flowchart illustrating an example of providing digital production plan information according to an embodiment.

FIG. 85 is a diagram illustrating an example of setting up an operational task for dynamic policy operation in a system operation unit according to an embodiment

FIG. 86 is a diagram illustrating an example of an operational task performed for dynamic policy operation in an operational environment according to an embodiment.

FIG. 87 is a diagram illustrating an example of setting up an operational task for dynamic policy operation in a system operation unit according to an embodiment.

FIG. 88 is a diagram illustrating an example of an operational task performed for dynamic policy operation in an operational environment according to an embodiment.

FIG. 89 is a flowchart illustrating an example of setting up and performing operational tasks for dynamic policy operation in an operating environment according to an embodiment.

FIG. 90 is a flowchart illustrating a method for providing digital production plan information according to an embodiment.

FIG. 91 is a diagram illustrating an example of providing digital production plan information using a domain-specific engine according to an embodiment.

FIG. 92 is a diagram illustrating an example of balanced production logic according to an embodiment.

FIG. 93 is a diagram illustrating an example of a process of balanced production logic according to an embodiment.

FIG. 94 is a flowchart illustrating an example of balanced production logic according to an embodiment.

FIG. 95 is a diagram illustrating an example of wait time control logic according to an embodiment.

FIG. 96 is a diagram illustrating an example of a process of queue waiting time control logic according to an embodiment.

FIG. 97 is a flowchart illustrating an example of queue waiting time control logic according to an embodiment.

FIG. 98 is a diagram illustrating an example of batch control logic according to an embodiment.

FIG. 99 is a diagram illustrating an example of a process of batch control logic according to an embodiment.

FIG. 100 is a flowchart illustrating an example of batch control logic according to an embodiment.

FIG. 101 is a flowchart illustrating an example of providing digital production plan information according to an embodiment.

FIG. 102 is a diagram illustrating an embodiment of a method for providing a digital production plan.

FIG. 103 is a diagram illustrating an embodiment of a computing system that provides digital production plan data.

FIG. 104 is a diagram illustrating an example of a device providing digital production plan data.

FIG. 105 is a diagram illustrating an embodiment of a computing system that provides digital production plan data.

FIG. 106 is a diagram showing an item in a cloud system that provides digital production plan data.

FIG. 107 is a diagram illustrating a site of a cloud system that provides digital production plan data.

FIG. 108 is a diagram illustrating a buffer of a cloud system that provides digital production plan data.

FIG. 109 is a diagram illustrating BOM information of a cloud system that provides digital production plan data.

FIG. 110 is a diagram illustrating alternative BOM information of a cloud system that provides digital production plan data.

FIG. 111 is a diagram illustrating the routing of a cloud system that provides digital production plan data.

FIG. 112 is a diagram illustrating the operation of a cloud system that provides digital production plan data.

FIG. 113 is a diagram illustrating the resources of a cloud system that provides digital production plan data.

FIG. 114 is a diagram illustrating work in process (WIP) of a cloud system that provides digital production plan data.

FIG. 115 is a diagram illustrating a work item (Lot) of a cloud system that provides digital production plan data.

FIG. 116 is a flowchart illustrating an example of providing digital production plan information in a standard model of a cloud system providing digital production plan data.

FIG. 117 is a diagram illustrating an example of providing digital production plan information based on backward planning logic according to an embodiment.

FIG. 118 is a diagram illustrating an example of an alignment process based on backward planning logic according to an embodiment

FIG. 119 is a diagram illustrating an example of an ISB pegging process based on backward planning logic according to an embodiment.

FIG. 120 is a diagram illustrating an example of an ISB routing process based on backward planning logic according to an embodiment.

FIG. 121 is a diagram illustrating an example of an operation pegging and operation routing process based on backward planning logic according to an embodiment.

FIG. 122 is a flowchart illustrating an example of providing digital production plan information based on backward planning logic according to an embodiment.

FIG. 123 is another flowchart illustrating an example of providing digital production plan information based on backward planning logic according to an embodiment.

FIG. 124 is a diagram illustrating an example of providing digital production plan information based on forward planning logic according to an embodiment.

FIG. 125 is a diagram illustrating an example of a work item group selection process in the LFS method based on forward planning logic according to an embodiment.

FIG. 126 is a diagram illustrating an example of a work item selection process in the LFS method based on forward planning logic according to an embodiment.

FIG. 127 is a diagram illustrating an example of an input decision-making in the LFS method based on forward planning logic according to an embodiment.

FIG. 128 is a diagram illustrating an example of a bucket selection process of RFS method based on forward planning logic according to an embodiment.

FIG. 129 is a diagram illustrating an example of a work item group selection process in the RFS method based on forward planning logic according to an embodiment.

FIG. 130 is a diagram illustrating an example of a work item selection process in the RFS method based on forward planning logic according to an embodiment.

FIG. 131 is a diagram illustrating an example of a processing process based on forward planning logic according to an embodiment.

FIG. 132 is a flowchart illustrating an example of providing digital production plan information based on forward planning logic according to an embodiment.

FIG. 133 is another flowchart illustrating an example of providing digital production plan information based on forward planning logic according to an embodiment.

FIG. 134 is a diagram illustrating an example of providing digital production plan information based on a compare agent for decision-making according to an embodiment.

FIG. 135 is a flowchart illustrating an example of a decision-making execution process based on a decision-making method according to an embodiment

FIG. 136 is a flowchart illustrating an example of a decision-making process based on a weight sum method according to an embodiment.

FIG. 137 is a flowchart illustrating an example of a decision-making process based on a weight sorting method according to an embodiment.

FIG. 138 is another flowchart illustrating an example of providing digital production plan information based on a compare decision-making agent according to an embodiment.

FIG. 139 is a diagram illustrating a tool of a system for a policy according to an embodiment.

FIG. 140 is a diagram illustrating the configuration of an action selector according to an embodiment.

FIG. 141 is a diagram illustrating the configuration of a feature extractor according to an embodiment.

FIG. 142 is a diagram illustrating the configuration of an evaluator according to an embodiment.

FIG. 143 is a diagram illustrating the configuration of a policy manager according to an embodiment.

FIG. 144 is a diagram illustrating the configuration of a reinforcement learning operation manager according to an embodiment.

FIG. 145 is a flow chart for generating a production plan using a dynamic tool according to an embodiment.

FIG. 146 is a diagram illustrating a tool of a policy operation system according to an embodiment.

FIG. 147 is a diagram illustrating the executing entity of the policy operation system according to an embodiment.

FIG. 148 is a diagram illustrating an example of generating a production plan through a policy operation system according to an embodiment

FIG. 149 is a diagram illustrating another example of generating a production plan through a policy operation system according to an embodiment.

FIG. 150 is a flowchart describing an example of performing a simulation and calculating a performance index through a policy operation system according to an embodiment

FIG. 151 is a flowchart describing steps for initializing a policy operation system according to an embodiment.

FIG. 152 is a flowchart of generating production plan data through a policy operation system according to an embodiment.

FIG. 153 is a diagram illustrating a tool of a policy learning system according to an embodiment.

FIG. 154 is a diagram illustrating the executing entity of a policy learning system according to an embodiment.

FIG. 155 is a diagram illustrating an example of performing policy learning through a policy learning system according to an embodiment.

FIG. 156 is a diagram illustrating another example of performing policy learning through a policy learning system according to an embodiment.

FIG. 157 is a flowchart illustrating an example of performing learning through a policy learning system according to an embodiment.

FIG. 158 is a flowchart illustrating steps for initializing a policy learning system according to an embodiment.

FIG. 159 is a flowchart illustrating obtaining a reward or performance indicator when performing policy learning according to an embodiment.

FIG. 160 is a flowchart of generating a policy through a policy learning system according to an embodiment.

FIG. 161 is a diagram illustrating a tool of a dynamic policy operation and learning system according to an embodiment.

FIG. 162 is a diagram illustrating the execution entity of a dynamic policy operation and learning system according to an embodiment.

FIG. 163 is a diagram illustrating an example of executing a simulation through a dynamic policy operation and policy learning system according to an embodiment.

FIG. 164 is a flowchart illustrating a dynamic policy operation performed through a dynamic policy operation and learning system according to an embodiment.

FIG. 165 is a flowchart of generating a production plan through dynamic policy operation and learning according to an embodiment.

### DETAILED DESCRIPTION

Hereinafter, embodiments are disclosed that may solve the above problems and resolve technical inconveniences for transactions. In the embodiments, components such as a framework, a module, an application program interface, etc. may be implemented as a device coupled with a physical device or may be implemented as software. Hereinafter, embodiments will be described in detail with reference to the accompanying drawings.

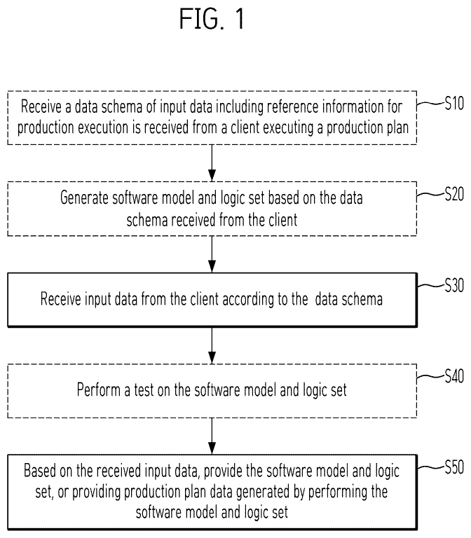

FIG. 1 is a diagram illustrating an embodiment of a method for providing a digital production plan.

A data schema of input data including reference information for production execution is received from a client executing a production plan S10.

The reference information for production execution refers to various reference information within a place where production is executed, for example, a manufacturing production system. Various reference information within the manufacturing production system is described in detail below.

A data schema containing reference information for production execution may include customized data schema that are specific to a particular product or process, in addition to general data schema for widely used processes required to generate digital production plan.

If the structure or type of data related to the reference information provided by the client is known in advance, or if the client has prepared production operation data according to a pre-determined data schema, this step may be omitted.

Input data containing reference information for production execution may include data at a specific point in time, for example, the current point in time, with a certain format and content, and include data indicating the status of the manufacturing production system.

A software model and logic set are generated based on the data schema received from the client S20.

At this stage, at least one of a software (SW) model or a set of logic may be generated that may generate relevant production plan information based on the data schema received from the client.

Here, a software model refers to a program designed to be executed on a computer as a part of computing software that uses received data to produce results, which is the real-world system that is to be implemented.

Here, logic refers to a data set that includes the procedure for determining how the SW model should operate when the SW model is executed, as a file that includes rules for performing data generation, storage, modification, etc. of a computing model or program, and refers to the data required to implement the core functions of the computing SW model. Therefore, logic set may be provided in the form of a file as a structured set of rules that define what action to take on the input data.

At least one of these software (SW) models or model logics may be prepared in advance, at least in part, within the system. Additionally, some of the software (SW) models and some of the logic required to generate the relevant production plan information may also be generated at this stage.

For example, if it is a cloud system that provides a production plan based on input data containing reference information from a client, this step may generate some customized logic set for the user, or it may be omitted at this step.

Input data is received from the client according to the data schema S30.

If input data is prepared in advance according to a data schema received from the client's system, or, if a data schema is obtained from the client, input data for generating production plan information may be received from the client according to the data schema.

If the input data is stored in the client's database, it may be set to query the input data from this database or to retrieve it in a set manner or automatically.

Testing may be performed on the generated software model and logic set S40.

When data according to the data schema is received from the client, the generated software model or logic may be tested based on the received data.

A simulation, which is a type of production planning system modeling based on a software model or logic, may be executed, and the result of the simulation may be retrieved. Here, various setting variables that affect the production plan may be modified, and various options required for executing the model may be set.

It may be tested whether the SW model generates production plan data optimized for various environments by changing variables or settings.

For example, an experiment may be performed that design combinations of variables and performance indicators that affect production planning using some kind of software (SW) model or logic. For example, an experiment may be performed using some kind of software (SW) model or logic to design combinations of variables and performance indicators that affect the production plan. An experiment may contain one or more execution scenarios that are performed by selecting specific variables or specific performance metrics.

When the plurality of software models or logics are used, it is also possible to generate an Experiment Hub containing the plurality of experiments.

In addition, the received input data may be used to generate output data including production plan information by utilizing an engine, which is a core part of a software (SW) model or logic. This step allows testing computer-implemented models in a variety of scenarios that change components such as input data, engines, and output data. If such testing is not necessary and preconfigured variables are used, for example, when a type of production plan applicable to a specific industry is preconfigured, this step may be omitted.

Based on the received input data, the software model and logic set are provided, or production plan data generated by executing the software model and logic set are provided S50.

This step of the embodiment may provide software model and model logic to the client based on the generated production plan data. Alternatively, the software model and model logic may be performed based on the generated production plan data, and production plan data based on the performed results may be provided to the client.

The generated production plan data may be uploaded to a database or the like of the client system.

One embodiment of a method for providing such digital production plan data may be implemented via a platform such as an on-premise computing system or a cloud computing system. When the embodiment is implemented as a cloud computing system, the client may obtain the production plan through a software package that implements the embodiment in a Saas (Software-as-a-Service) manner.

Additionally, when executing the above generated software model and model logic, several extension functions for decision making may be used. In this case, the extension function may be used to modify parameters required for scenarios or simulations or to generate production plan data by performing machine learning. Detailed examples of this are described below.

Hereinafter, embodiments of a computing system implementing an embodiment of a method for providing digital production plan data are disclosed.

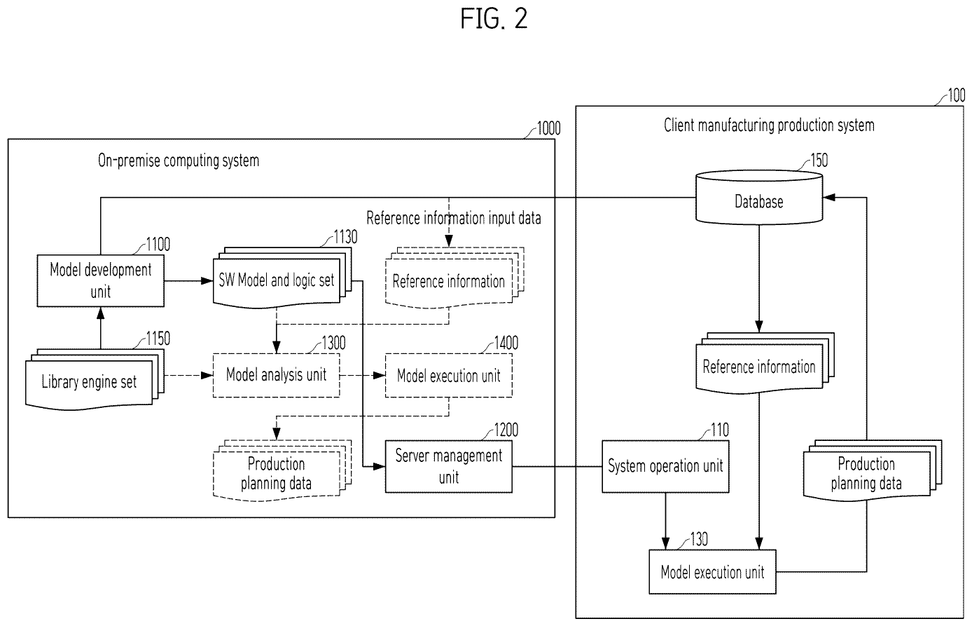

FIG. 2 discloses an embodiment of a computing system that provides digital production plan data.

This drawing discloses an embodiment of an on-premise computing system that provides digital production operations data.

In one embodiment, a client manufacturing production system 100 that executes a production plan in a manufacturing production system, etc., provides input data including reference information for production execution to an on-premise computing system 1000, and receives digital production plan data generated accordingly from the on-premise computing system 1000.

In this embodiment, the manufacturing production system 100 includes a system operation unit 110 that operates and manages the manufacturing process overall, a model execution unit 130 that generates production plan data according to an execution request of the system operation unit 110, and a database 150 that stores the production plan data that is the execution result of the model execution unit 130.

In this embodiment, the on-premise computing system 1000 may be located on the client side or may be provided by a service provider external to the client.

According to one embodiment, an on-premise computing system 1000 includes a model development unit 1100 that develops a model related to a production plan based on input data or a schema of input data received from a client's manufacturing production system 100, and a server management unit 1200 that manages a client operation server to provide and execute the developed model to the client.

according to the embodiment the on-premise computing system 1000 may further include a model analysis unit 1300 that changes and analyzes settings of a software (SW) model or logic set developed by a model development unit 1100.

According to the embodiment, the on-premise computing system 1000 may further include a model execution unit 1400 that may obtain results by executing a software (SW) model or logic analyzed by the model analysis unit 1300 in advance. When one embodiment of an on-premise computing system 1000 includes a model analysis unit 1300 and a model execution unit 1400, the results of a model to be executed in the client's manufacturing production system 100 may be analyzed and changed in advance, thereby generating an optimal production operation plan.

The on-premise computing system 1000 receives a data schema related to a production plan from the manufacturing production system 100. The data schema of input data containing reference information for production execution contains the basic format of data required to perform software (SW) models or logic. This data schema may enable data having various information and types to be received in a certain format and content according to the manufacturing production system 100.

The model development unit 1100 of the on-premise computing system 1000 may generate a software model or logic set that generate production plan data based on the received data schema and library engine set 1150. The library engine set 1150 may include a core library, a production planning engine, a production domain-specific engine, etc.

Hereinafter, the term “engine” or “engine set” refers to a software engine and means a software configuration module including a library or object that contains various encapsulated function blocks. When executing software, the engine enables software models or logics associated with the software to perform common and essential functions.

The core library of the library engine set 1150 is a set that includes data structures that implement production plans together with the production planning engine.

And the production domain-specialized engine of the library engine set 1150 inherits some functions of the production planning engine and is a data set that implements logic used in a specific production domain and may be defined differently depending on the industry or manufacturing production system.

The production planning engine of the library engine set 1150 is defined as a set of several encapsulated function blocks that generate production plans.

The core library of the library engine set 1150 includes an overall library for generating software SW models and model logic according to an embodiment.

That is, the model development unit 1100 receives the data schema of the input data from the client according to a predefined definition. The model development unit 1100 may define a data schema in advance so that the data schema received from the client is in a data format required for executing the software (SW) model and model logic.

The model development unit 1100 may also set the order for collecting reference information of the manufacturing production system in the data schema or set the information required for executing the software (SW) model and model logic. For example, the model development unit 1100 may set the method of retrieving data from the database 150, the format of the data, etc. For example, the size of the data, the download order, and the reception conditions may be set.

The model development unit 1100 may provide various development tools to generate appropriate software (SW) models and model logic based on the received data schema and library engine set 1150.

The software (SW) model and model logic generated by the model development unit 1100 may include various modules, such as the pegging step to be disclosed later or various simulations. The model development unit 1100 may define a software model, define data to be used, and store the generated data.

It is also possible to set various variables or logics of modules related to scenarios or simulations, as well as software (SW) models and model logic developed by the model development unit 1100. Software (SW) models and model logic may be used, for example, for optimizing decision making for production planning, machine learning, and experiment design in a variety of fields.

The model development unit 1100 may define software (SW) models and model logic by combining various modules according to the form of production plan desired by the client. For example, if only a plan for inputting products into a factory is desired, the input plan may be obtained by using the pegging module of backward planning, which will be described later.

In another example, if it is desired to obtain a production plan that takes into account a monthly product input plan when establishing a weekly production plan, a model may be generated that sequentially generates the production plan by using the input plan obtained from a first module, the pegging module, as an input value for a second module, the simulation module.

The model development unit 1100 may define components of individual modules included in the software model. For example, the logic of the simulation, such as the factory, workpiece, input allocation, and constraints, may be modified to reproduce it in the client's manufacturing production system.

In addition, the model development unit 1100 may manage the settings and execution of various modules added to the software model and logic.

The server management unit 1200 may transmit the software (SW) model and model logic generated by the model development unit 1100 to the client and cause the client's manufacturing production system 100 to generate production plan data so that production operation may proceed.

The server management unit 1200 may transmit a software (SW) model and model logic to the client's system operation unit 110 and define, schedule, and register tasks related to the execution of the software (SW) model. The client's system operation unit 110 may perform model execution tasks according to the instructions from the server management unit 1200 or the user thereof.

The server management unit 1200 may manage not only the system operation unit 110 of the client's manufacturing production system 100, but also modify and set projects or tasks management, trigger management for operating projects or tasks according to plans, and the monitoring and performance thereof.

Meanwhile, in the embodiment, the model analysis unit 1300 may change various setting information of the software (SW) model and model logic, and generate production plan data in the model execution unit 1400 to test and analyze it.

The model analysis unit 1300 may provide a tool for transferring the software (SW) model and model logic generated by the model development unit 1100 and the received data schema for the input data to the model execution unit 1400 for execution and analyzing the results thereof.

In the model analysis unit 1300, if a change in the software (SW) model and model logic is required based on the results, the library engine set 1150 may be changed.

For example, the model analysis unit 1300 may receive input data including a reference information data set of the manufacturing production system from the client's database 150 in the form of a file, etc., through a query, etc.

The model analysis unit 1300 provides a tool for experimental analysis of the software (SW) model and model logic developed by the model development unit 1100 while changing the library engine set 1150 and the reference information of input data.

For example, the model analysis unit 1300 may generate production plan data through the model execution unit 1400 using a data set including reference information in the received input data.

The model analysis unit 1300 may provide a user interface that may retrieve information on software (SW) models and model logic, as well as execution results thereof.

The model analysis unit 1300 may provide users with input data of software (SW) models and model logic, various setting information, and result analysis according to modeling results.

The model analysis unit 1300 may set various scenario information when a software (SW) model and model logic are performed.

For example, the manufacturing system reference information input values, the version of the library engine set 1150, etc. may be modified with various scenario information.

The model execution unit 1400 may execute a software (SW) model and model logic and generate production plan data to provide production plan data that may be analyzed by the model analysis unit 1300.

When the system operation unit 110 of the client's manufacturing production system 100 receives a software (SW) model and model logic developed by the model development unit 1100 through the server management unit 1200, it receives input data including reference information data from the database 150 and may use this to execute the received software model and logic set to generate production plan data.

The generated production plan data may be uploaded back to the database 150 and stored.

According to an embodiment, an on-premise computing system 1000 may receive input data including reference information of a manufacturing production system from a client and execute a developed software (SW) model and model logic to generate production plan data. Alternatively, the client's manufacturing production system 100 may generate production plan data using a software model and logic set provided by the on-premise computing system 1000.

Detailed embodiments of each component of the on-premise computing system 1000 are described below.

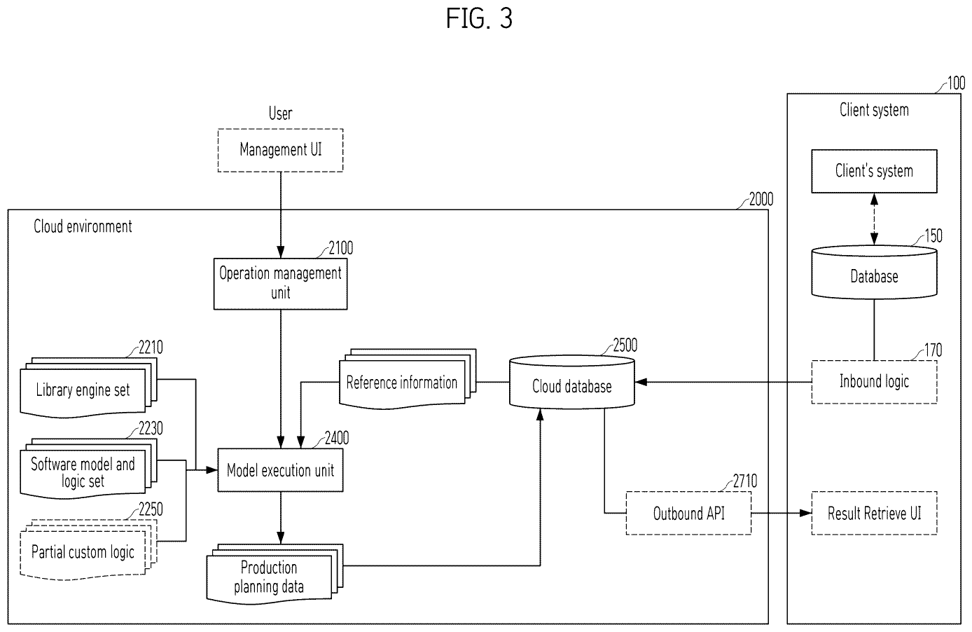

FIG. 3 discloses another embodiment of a computing system providing digital production plan data.

This diagram discloses one embodiment of a cloud computing system that provides digital production operation data. A cloud computing system according to an embodiment may provide digital production plan data as a Software-as-a-Service (SaaS).

In the disclosed embodiment, a client manufacturing production system 100 including a database 150 may provide input data including reference information of the manufacturing production system to a cloud computing system 2000 and receive production plan data as a result.

A cloud computing system 2000 that provides production plan data optimized for the situation of a client system may include an operation management unit 2100, a model execution unit 2400 that executes a defined software model and logic set, and a cloud database 2500.

A library engine set 2210 of a cloud computing system 2000 includes a core library containing key data for generating a software model and a production planning engine which is a set of encapsulated function blocks for generating a production plan.

Cloud computing systems 2000 include the software model and logic set 2230 that are already defined and generalized to products or scenarios, unlike those developed separately in on-premise computing systems. However, it may further include a custom library engine set 2250 for generating the client's customized production operation plan.

The client manufacturing production system 100 includes a database 150 that stores input data related to production operations including reference information of the manufacturing production system.

The client manufacturing production system 100 may execute inbound logic 170 that converts the schema of input data stored in the database 150 and upload the converted input data to the cloud database 2500.

Input data including the client's reference information data may be stored in a cloud database 2500 according to the execution of the inbound logic 170 of the client manufacturing production system 100.

The operation management unit 2100 generates production plan data using input data stored in the cloud database 2500 based on the library engine set 2210, software model and logic set 2230, and custom library engine set 2250 according to the settings of the client or cloud system manager.

The generated production plan data may be stored again in the cloud database 2500.

The cloud computing system 2000 provides production plan data stored in a cloud database 2500 to a client through an outbound API 2710 that provides a consistent user interface.

A client may have an interface to set up a model for execution on a cloud computing system 2000, modify a custom library engine set 2250, or obtain final production plan data.

Detailed embodiments of each component of a cloud computing system 2000 having different functions from the on-premise computing system 1000 are described below.

The following examples detail an example of providing production plan data using a software model and logic set generated based on an installed library engine set.

As described, the model development unit 110 of the on-premise computing system 1000 provides a frame for developing a software model and logic set capable of generating a production plan based on a library engine set 1150.

As another example, the cloud computing system 2000 may provide a number of formalized software model and logic set that may generate production plans based on a library engine set.

In the disclosed embodiment, a software model and logic set capable of generating a production plan may schedule the production plan in a time-reverse manner to derive an operation target (Step Target). The operation target (Step Target) may include information on the target production quantity (Quantity) and time (Date) of the process. The method of scheduling production plans in this case using a time-reversal method may be called backward planning.

The library engine set 1150 may provide a core library capable of generating backward planning logic in a time-reversal manner.

The model development unit 110 may generate a software model and logic set including backward planning logic based on a library engine set 1150. Here, the backward planning method is a method of allocating work by calculating the time and quantity backwards from the due date of the demand information and the target production quantity information.

That is, based on input waiting time (Wait TAT) for each process, operation time (Run TAT) for each process, and yield (Yield) for each process to produce the finished product included in the demand information by the due date, the quantity (Quantity) and time (Date) of the input target (In Target) of the production process, and the quantity (Quantity) and time (Date) of the completion target (Out Target) of each process may be calculated.

For example, demand information, that is, the delivery time and quantity information of the finished product, is calculated based on the quantity (Quantity) and time information (Date) of the completion target (Out Target) of the Nth process to meet the delivery time of the finished product, and the work time (RUN TAT) and yield information (Yield) are used to produce the quantity (Quantity) and time (Date) information of the input target (In Target) of the Nth process.

And, based on the quantity (Quantity) and time (Date) information of the input target (In Target) of the Nth process to meet the delivery time of the finished product, the quantity (Quantity) and time (Date) information of the completion target (Out Target) of the (N−1) process may be reverse-calculated by considering the input waiting time (Wait TAT).

In this way, by calculating the operation time (Run TAT) and yield information (Yield) for each process (1, 2, 3, . . . . N) and the input waiting time (Wait TAT) for that process in reverse, a production plan may be derived.

As a result, the backward planning method may produce operation target information to satisfy the delivery date and quantity based on demand information.

Here, the operation target (Step Target) information may include process input plan time information (Inplan Date), input plan quantity information (Inplan Quantity), process completion information (Outplan Date), and completion time quantity information (Outplan Quantity).

As another example, the operation target (Step Target) information may include process input target date information (In Target Date), input target date quantity information (In Target Quantity), process completion target date information (Out Target Date), and completion target date quantity information (Out Target Quantity).

As above, in some cases, the operation target (Step Target) information may use the process's input plan (Inplan) information and completion information (Outplan), or it may use the input target (In Target) information and completion target (Out Target) information.

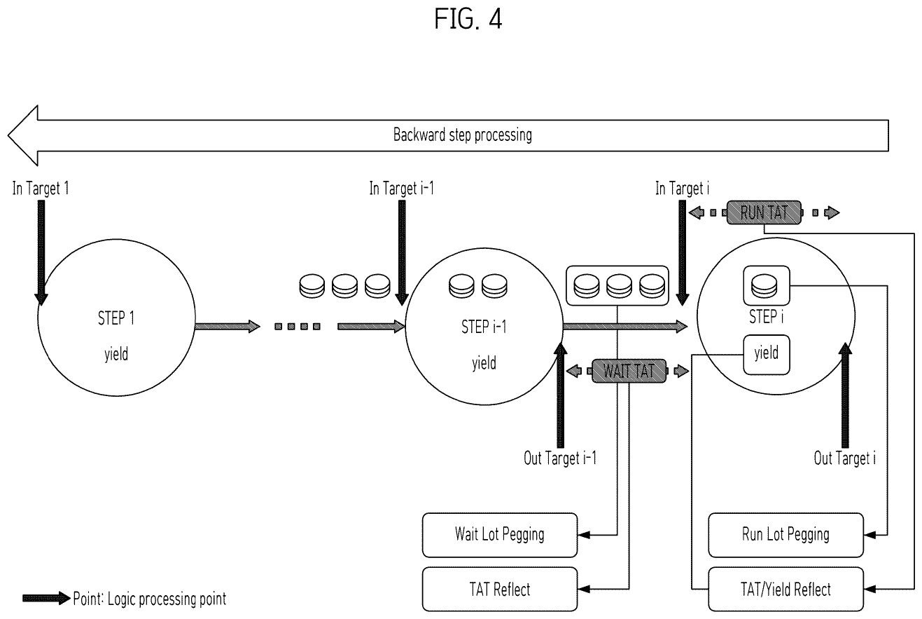

FIG. 4 is a diagram illustrating procedures executed by backward planning logic according to an embodiment. With reference to this diagram, the following is a conceptual explanation of an embodiment of the procedures executed by the backward planning logic.

Backward planning logic may obtain information necessary for production planning by progressing backwards in time from the last process of the process at the start or completion point of the wait state (Wait) or work state (Run) of each process.

In this diagram, it is assumed that the work for production proceeds in the order of the first process (step 1), . . . the (i−1) process (step i−1), and the I process (step i).

When generating a production plan using backward planning, each process has input target information (In Target) (including time and quantity) and completion target information (Out Target) (including time and quantity) for inputting work materials to each task.

Here, the input target information (In target 1) of the first process (step 1), the input target information (In target i−1) of the (i−1) process, and the input target information (In target i) of the I process are each indicated by arrows. In addition, the completion target information (Out target i−1) of the (i−1) process and the timing information of the completion target information (Out target i) of the I process are described.

In backward planning logic, the input target time and completion target time of each process may become time processing points for generating a production plan.

Each process is performed during the work time (Run TAT), and the work piece may wait for the input waiting time (Wait TAT) from the completion target time (Out target i−1) of the (i−1) process to the input time (In target i) of the I process, and each process may have yield information (Yield).

In backward planning, the pegging (Run lot pegging), operation time (Run TAT), and yield information (Yield) for the work volume of the process are reflected in Process I. And, between the I process and the (i−1) process, the pegging for the waiting work volume (Wait lot pegging) and the waiting time for input (Wait TAT) are reflected.

In this way, backward planning logic may obtain information necessary for production planning by moving backwards in time from the last process of the process to the first process, which is the sequence of processes.

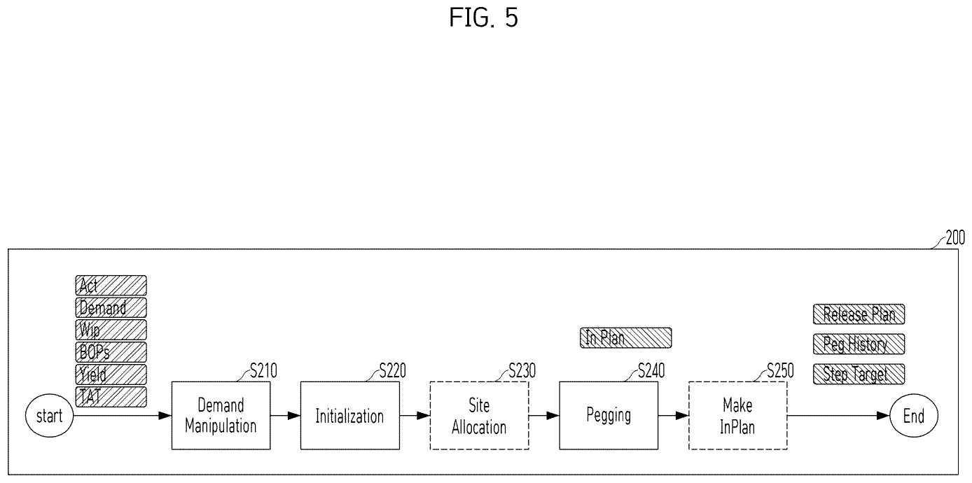

FIG. 5 is a diagram illustrating execution steps of backward planning logic within a library engine set according to an embodiment.

When a library engine set includes backward planning logic, a software model and logic set generated based on the client's data schema may generate a production plan according to the backward planning logic.

Hereinafter, to facilitate explanation of an embodiment of backward planning logic within the library engine set, an example is disclosed in which the generated software model and logic set generate production plan data according to a backward planning method.

The backward planning method may include a demand information preprocessing step (Demand Manipulation) 210, a pegging initialization step (Initialization) 220, a site allocation step (Site Allocation) 230, a pegging step (Pegging) 240, and an input plan calculation step (Make InPlan) 250.

The generated software model and logic set may obtain demand information (Demand), actual production record information (ACT), work in process quantity information (Wip), process flow information (BOP, Bill of Process), yield information (Yield), and time information (TAT) for each process, input waiting time (Wait TAT) for each process or running time (Run TAT) for each process from the manufacturing production system reference information to execute backward planning.

The demand information preprocessing step S210 may preprocess demand information (Demand) based on the demand information (Demand), among the data received by the manufacturing production system, actual production record information (Act) of the manufacturing production system, remaining demand quantity, and production schedule.

For example, the remaining demand quantity (Demand quality) may be calculated by subtracting the actual production record (Act) from the demand information (Demand) and then distributed according to the work schedule.

If the demand information (Demand) has a due date generated according to the weekly plan, a preprocessing task may be performed to modify it into a preprocessed daily plan that distributes the remaining demand quantity (Demand quality) and due date by day.

The pegging initialization step S220 is a step for initializing preprocessed demand information as data for backward planning. After initializing the data, it may be verified to ensure that there are no problems in subsequent steps. For example, among the preprocessed and initialized demand information, the work object information (PegPart) that becomes the target of backward planning may be initialized by grouping it into units such as the same product, product group, and process.

In the backward planning method, information such as working hours, processes, quantities, and due dates may change for each process, and work object information (PegPart) which changes depending on each process may be initialized and generated accordingly. This will be described later.

The site allocation step S230 receives initialized work object information (PegPart). The site allocation step S230 may be a step for distributing demand information to each production facility according to distribution rules when there are the plurality of production facilities (Sites) in one manufacturing production system. If facility distribution information is obtained in advance from a result derived from the client's manufacturing production system or a separate external solution, the performance of the site allocation step S230 may be omitted.

The pegging step S240 receives initialized work object information (PegPart) and distribution information from the previous step, the site allocation step S230.

The pegging step S240 calculates the completion target date information (Out Target Date), the quantity information at the completion target date (Out Target Quantity), the input target (In Target) information and the completion target (Out Target) information of each process based on the initialized demand information, and may finally output log record information including the pegging history (Peghistory) and operation target (Step Target) information.

And the pegging step S240 may produce various object information including input plan (InPlan) information (including quantity and timing) for the process of the next step.

The pegging step S240 may produce information included in the work-in-progress quantity information (Wip) of each process as output object information of each process. For example, work-in-progress information (Wip) as output object information may include such as priority sorting, process selection, work quantity of a process, due date information of a process, process time update, process yield application, process log record information according to processes.

The factory input plan calculation step S250 receives the information output from the previous step, the pegging step S240, and may calculate the factory input plan information (also referred to as “Release Plan”, “arrival plan” or “entry plan”) (including quantity and timing) of the first process from the demand information of the final process step.

By using the input plan (also referred to as “InPlan”) information (including quantity and timing), it is possible to obtain guide information for forward planning that generates a production plan in chronological order, and in the embodiment, the execution of the input plan calculation step 250 may be omitted.

Therefore, when the software module and module logic perform backward planning logic according to an embodiment, the operation target (Step Target) and process input plan (Inplan) information may be produced.

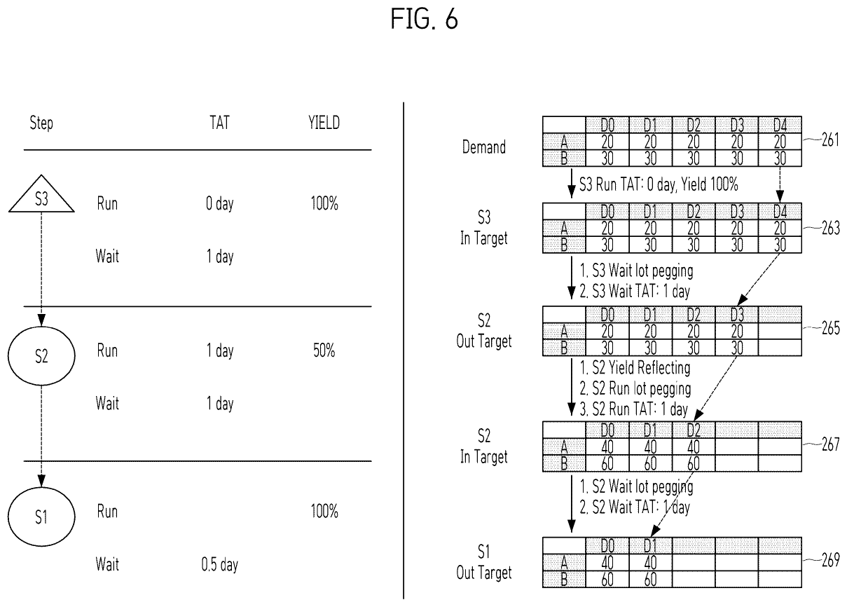

FIG. 6 is a diagram illustrating an example of executing backward planning according to an embodiment.

Backward planning may derive a production plan from the process input target (In Target) information and the process completion target information (Out Target) by calculating backwards from demand information.

In this example, it is assumed that the actual process proceeds in the order of the first process (operation S1), the second process (operation S2), and the third process (operation S3). The backward planning method considers the target demand information of the process including these three processes and produces a production plan by reversing the order of the processes in the order of the third process (operation S3), the second process (operation S2), and the first process (operation S1).

The demand information of the reference information is divided into schedules (D0, D1, D2, D3, D4) and assigned to equipment (A or B) based on the remaining demand quantity (Demand quality) obtained by deducting the actual production record (Act) from the demand information, as shown in Table 261.

Backward planning may produce an intermediate production plan, as shown in Table 263, at the time of arrival (In target) of the third process (operation S3) by reflecting the process operation time (Run TAT) and yield (Yield) of 100% of the third process (operation S3) in Table 261. Table 263 has the same value as Table 261 because the process operation time (Run TAT) is 0 day and the yield is 100%.

And backward planning may produce an intermediate production plan for the out target time of the second process (operation S2) as shown in table 265, by reflecting the input waiting time (Wait TAT) (1 day) of the third process (operation S3) and the pegging for the amount of work waiting (Wait lot pegging), in the intermediate production plan of table 263. Table 265 reflects the input waiting time (Wait TAT) (1 day) of the second process (operation S2), and the data in the schedules (D0, D1, D2, D3, D4) of table 263 have values shifted by 1 day.

Backward planning may produce an intermediate production plan (Table 267) at the time of the input target (In Target) of the second process (Operation S2) by reflecting the yield (50%) of the second process (Operation S2), pegging for the work amount (Run lot pegging), and process work time (Run TAT) for the intermediate production plan of Table 265. The values in each schedule of table 267 are calculated by reversely calculating the yield 50% and the process operation time (Run TAT) (1 day) of the second process (operation S2), so that each schedule of table 265 is shifted and may have a value twice that of table 265.

In this example, finally, backward planning may generate the production plan of Table 269 by calculating the Wait lot pegging and Wait TAT (1 day) for the work waiting amount of the second process (operation S2) at the time of the completion target (Out Target) of the first process (operation S1) for the intermediate production plan of Table 267. Table 269 may have each schedule of Table 267 shifted values by calculating the input waiting time (Wait TAT) (1 day) of the second process (operation S2).

In this way, backward planning may calculate production plan information by considering work volume, waiting volume, yield, etc. to calculate the timing and quantity of the input target (In Target) and the timing and quantity of the completion target (Out Target) for demand information.

Such backward planning may generate process input target (In Target) information and completion target (Out Target) information by calculating backward from the target due date and production quantity information in the same manner described above. And, by calculating the production plan in the forward planning method that schedules the production plan in the forward direction by utilizing the input target (In Target) information and the completion target (Out Target) information, the production plan may be derived.

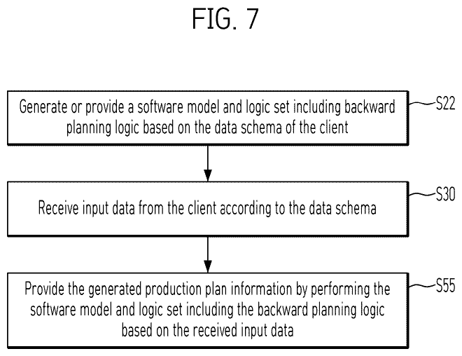

FIG. 7 is a flowchart of generating a production plan using a software model and logic set including backward planning logic according to an embodiment.

A software model and logic set including backward planning logic may be generated or provided based on the data schema of the client manufacturing production system (S22).

The data schema of a client executing a production plan may be prepared in advance if the structure or type of data related to the reference information provided by the client is known in advance. Alternatively, the data schema of input data containing reference information for production execution may be received from the client.

In on-premises computing systems, when a library engine set includes backward planning logic, a software model and logic set may be generated based on the client's data schema.

In case of cloud computing system, a software model and logic set that execute backward planning logic may be provided based on a library engine set that include backward planning logic.

The software model and logic set may include the backward planning logic disclosed above. Detailed embodiments of the backward planning logic are disclosed in FIGS. 4 to 6. Input data is received from the client according to the data schema S30.

When generating and providing a production plan using an on-premise computing system, various conditions may be additionally applied to the received software model and logic set including backward planning logic, and a test may be performed on the software model and logic set.

Input data may include reference information from the client's manufacturing production system. Here, the reference information may include demand information for each process (Demand), actual production record information or performance information (Act), work in process quantity information currently being worked on (Wip, work in process), process flow information (BOP, Bill of process), yield information (Yield), and process time information (TAT), which may include input waiting time (Wait TAT) or process operation time (Run TAT).

Based on the received input data, the software model and logic set including the above backward planning logic may be executed to provide the generated production plan information S55.

Backward planning logic may generate operation target (step target) information (quantity and target) in a time-reverse manner from reference information including demand information, which is the target production volume included in the input data.

In addition, the backward planning logic may generate history information (Peghistory) that includes information on demand back-calculation (Lot-Demand pegging) of each process for the exemplified reference information and information on tasks that were not finally processed after time back-calculation in each process.

If the above software model and logic set include forward planning logic, the production plan information may be generated in the forward time direction using the operation target information (Step Target) and factory input plan information (Release Plan) obtained from the backward planning logic.

A detailed procedure of the backward planning logic according to the embodiment is illustrated in FIG. 5.

The software model and logic set of the embodiments may include the backward planning logic or the forward planning logic that is executed according to the result after executing the backward planning logic.

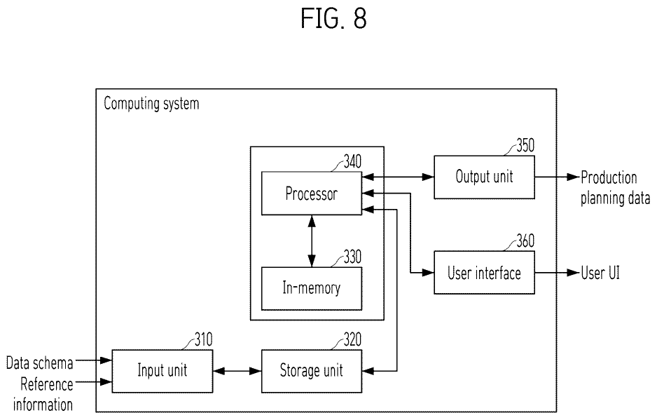

FIG. 8 is a diagram illustrating an embodiment of a device providing digital production plan information.

An embodiment of a device providing digital production plan information may include an input unit 310, a storage unit 320, an in-memory 330, a processor 340, an output unit 350, and a user interface 360.

Hereinafter, an embodiment of a device providing digital production plan information may be controlled by user control and management via a user interface 360.

The input unit 310 may receive the data schema of the manufacturing production system from the client manufacturing production system.

The storage device 320 may store the data schema received by the input unit 310 or, if a standardized data schema is prepared in advance, store the standardized data schema in the storage device 320. The storage device 320 may include volatile memory or non-volatile memory.

In-memory 330 may store the library engine set disclosed above.

A library engine set may contain a production planning engine, which is a number of encapsulated function block files that generate production plans. The production planning engine may include files for the backward planning logic disclosed above.

Additionally, the library engine set may further include a core library, which is a file containing data structures that implement a production plan together with a production planning engine, and a production domain-specific engine that inherits some of the functions of the production planning engine and implements logic used in a specific production domain.

The processor 340 of the embodiment may receive a data schema stored in the storage device 320. Additionally, the processor 340 may generate a software model and logic set based on the data schema and the engine or library stored in the in-memory 330. The generated software model and logic set may generate production plan data in a time-reversal manner according to backward planning logic. Embodiments of generating production plan data in a time-reversal manner according to backward planning logic are disclosed in FIGS. 4 to 6.

The processor 340 may obtain production plan data by testing or pre-executing the generated software model and logic set according to a user request of the user interface 360. And the processor 340 may analyze or test the software model and logic that generates production plan data according to the user's request and provide the results to the user through the user interface 360.

The processor 340 may receive input data including reference information of the manufacturing production system according to the data schema received from the input unit 310. The processor 340 may generate production plan data by executing a software model and logic set including a time inversion method according to backward planning logic. Detailed examples of generating production plan data according to backward planning logic are disclosed in FIGS. 4 to 6.

The output unit 350 may provide production plan data based on the execution results of a software model and logic set including backward planning logic to a client manufacturing production system so that the client system may manage production or processes.

According to an embodiment, production plan information may be obtained according to time-reverse scheduling based on reference information received from a client manufacturing production system. According to the time reverse calculation method, the operation target (Step Target) information and input plan information (Inplan) of each process may be obtained, and the factory input plan information (Release Plan) of the first process may be calculated based on the demand information of the last process according to the time reverse calculation. Using this time-reversal method, efficient production plan information may be generated and provided.

Clients may either perform production according to the production plan generated in a time-reverse manner, or link it to a time-sequenced production plan to obtain a more detailed and efficient production plan.

In the following embodiment, an example of providing production plan data using a software model and logic set generated based on an installed library engine set will be described in detail.

As described, the model development unit 1100 of the on-premise computing system 1000 provides a frame for developing a software model and logic set capable of generating a production plan based on a library engine set 1150.

As another example, the cloud computing system 2000 may provide a number of standardized software model and logic set that may generate production plans based on a library engine set 2210. In the disclosed embodiment, a software model and logic set capable of generating a production plan performs procedures to establish a production plan by virtually executing events occurring in a production system of an actual factory in a time-forward manner.

The method of scheduling production plans in a time-forward manner may be called forward planning.

The model development unit 1100 may generate a software model and logic set including forward planning logic based on a library engine set 1150. The forward planning method is a method of executing a simulation of an actual production plan by executing events that may occur in the factory in chronological order from the time of the first input of a workpiece based on at least one of the factory input plan (Release plan) information, input plan (Inplan) information (including quantity and timing), operation target (Step Target) information, or peg history (Peghistory) information output as a result of the backward planning.

For example, the forward planning method is a discrete event simulation method that may simulate the production plan by calculating in time order what work will be done through what path from the time an actual work item is put into the factory until production is finished (or completed).

That is, the forward planning method may produce a detailed production plan by executing events such as work lot placement (route), work lot filtering (filter), work lot transfer (transfer), input decision making (dispatching), work lot input (in), and work lot removal (out) in relation to work lots or equipment in an actual factory based on the process goals produced as a result of the backward planning.

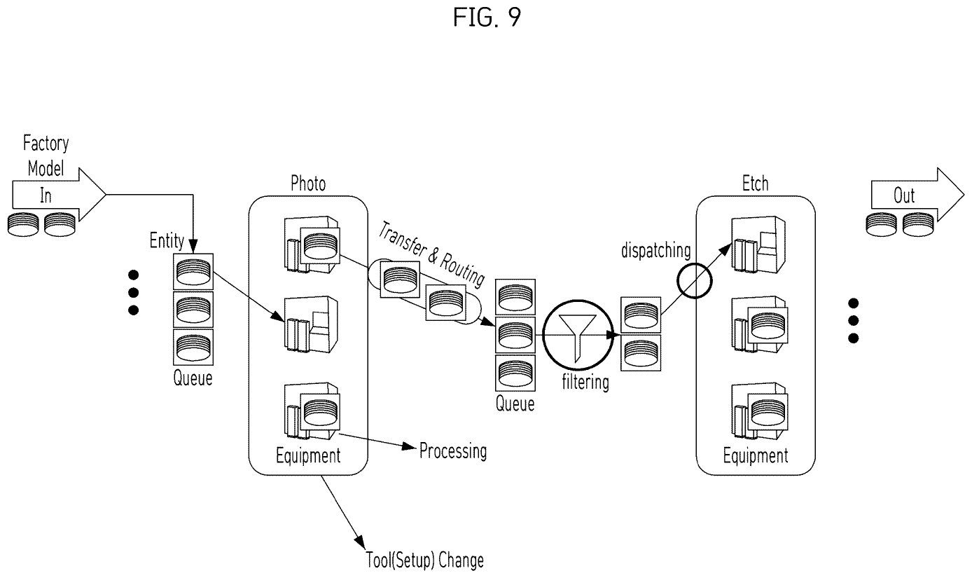

FIG. 9 is a diagram illustrating procedures executed by forward planning logic according to an embodiment. With reference to this diagram, the following is a conceptual explanation of an embodiment of the procedures executed by the forward planning logic.

Forward planning logic is a method of generating a production plan and production schedule by simulating an actual factory in chronological order of equipment or work items from the point in time when the work item is first introduced into the factory to the point in time when the work item is completed.

Through forward planning logic, a simulation model of an actual factory may be constructed and executed, and a production plan that reproduces the dynamics of an actual factory may be generated by executing events such as work item input (in), queue entry (Buffer), work item transfer, work item placement (route), process processing, equipment change (tool change), input decision making (dispatching), work item filtering, and work item removal (out).

The work item input (in) corresponds to an event that plans when and how many work item will be input into the factory, and work item removal (out) corresponds to an event that completes the work when the last process for the work item is completed. Work item transfer corresponds to an event in which a work item moves to the next process after the current process is completed, and work item placement (route) corresponds to an event that determines which process a work item will move to. In addition, process processing corresponds to an event in which work assigned to a work item input to equipment is processed for a certain period of time, and tool change corresponds to an event in which tool change is performed when tool change is necessary before a work item is input to equipment. Dispatching is an event that determines which of the waiting work items will be processed first, and filtering is an event that determines filtering related to work items or equipment before dispatching. For example, if a work item waiting for a process is selected by input decision making (dispatching) and put into equipment, the work item may be routed to a certain process after a certain amount of time.

Alternatively, the work item may be determined to be completed (out) through work item route after a certain work time. Alternatively, one could plan for filtering work item to occur before input decision making (dispatching) is made.

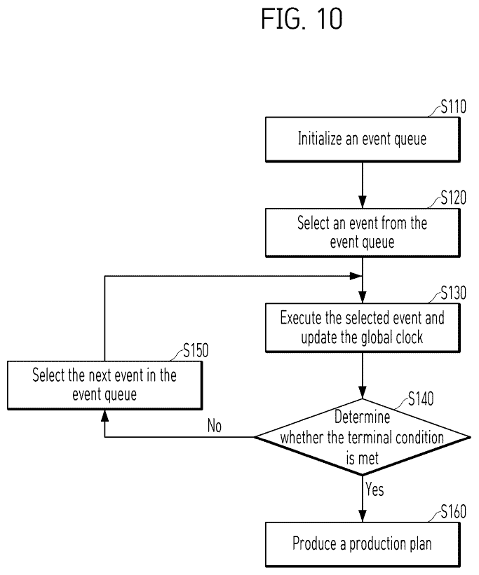

FIG. 10 is a diagram illustrating execution steps of forward planning logic within a library engine set according to an embodiment.

When a library engine set includes forward planning logic, a software model and logic set generated based on the client's data schema may generate a production plan according to the forward planning logic. As an example, a software model and logic set generated based on a client's data schema may use the output of the backward planning logic as input to generate a production plan according to the forward planning logic.

Hereinafter, to facilitate the explanation of an embodiment of forward planning logic within a library engine set, an example is disclosed in which a generated software model and logic set perform production plan modeling in a discrete event simulation manner according to a forward planning method.

To implement this forward planning logic, discrete event simulation modeling may be performed. Discrete event simulation, unlike continuous event simulation, models events in the order of the forward flow of time, but each event occurs at a specific point in time and changes the state of the system.

Modeling in the discrete event simulation method may be implemented through a global clock, state variables, and event queues related to events. An event is a unit that causes a transition of states in a manufacturing production system. Additionally, the present embodiment illustrates a case where forward planning is executed to generate a production plan in a model including at least one piece of equipment or work item. For example, a model refers to a model for planning in a manufacturing system, and may represent equipment, work items, or their dynamic relationships.

A global clock may represent the time of the simulation while events are being performed. A state variable may represent a variable related to a state of a simulation in a manufacturing production system within a factory such as processes, equipment, work items, or queues. For example, each state variable may have at least one corresponding event. An event queue may represent a set of events in which at least one event is arranged. For example, an event queue has at least one event sorted in fast order in simulation time, so that events may be performed in FIFO (first-in-first-out) order.

First, an event queue may be initialized S110. Additionally, when the event queue is initialized, state variables and the global clock may also be initialized. At this time, the time of the global clock may correspond to 0. That is, in the forwarding planning logic, simulation of the manufacturing production system may start with the event queue, state variables, and global clock initialized.

Next, one event from the event queue may be selected S120. As an example, the event that is chronologically closest to the first event in an event queue may be selected. As another example, when there are the plurality of events with the same time order, a priority may be given to which event should be performed first, and the event may be selected based on the priority.

For example, an event where a work item searches for the next route and an event where equipment searches for the next work item may occur simultaneously. In this case, a priority may be assigned such that the event that searches for the next path for the work item is performed first, and the event that searches for the next work item for the equipment is executed thereafter.

When an event is selected, the selected event is executed and the global clock may be updated S130. Additionally, when a selected event is executed, the state variable corresponding to the event may also be updated.

For example, when a work input (in) event occurs, the corresponding status variable, work in process (Wip), may be updated. Additionally, the global clock may be updated by the time difference between the last previously executed event and the currently executed event.

Next, after the event is executed, it may be determined whether the terminal condition is satisfied S140. For example, a terminal condition may be, but is not limited to, when all tasks assigned to a work item within a factory have been completed. In this case, the event may be completed for the work.

Meanwhile, if the task for which the event is executed does not correspond to the terminal condition, the next event in the event queue may be selected S150. In this case, operation S130 may proceed, causing the next event to be executed and the global clock to be updated.

When an event for a model including at least one piece of equipment or workpiece is completed, modeling of a production plan may be implemented including information about the executed event and the global clock and state variables associated with it S160.

Therefore, when the software and model logic execute forward planning according to an embodiment, a production plan may be produced according to the time sequence of work items input into the factory.

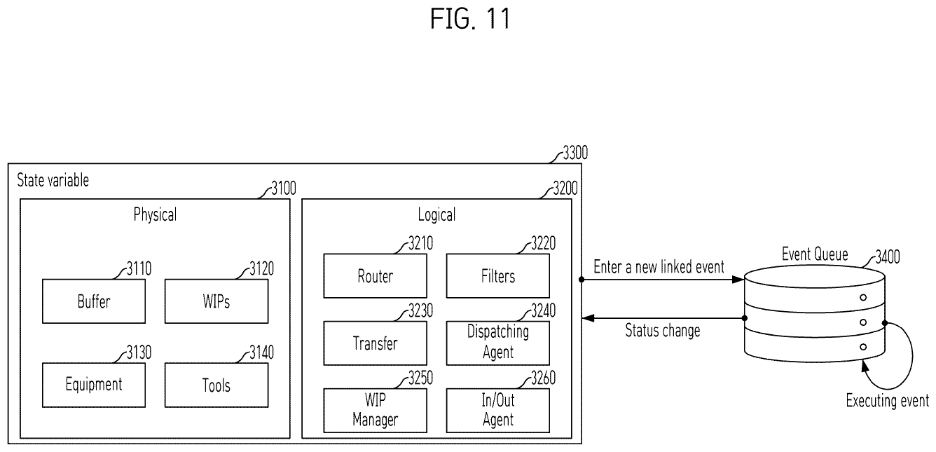

FIG. 11 is a diagram illustrating an example of state variables of forward planning according to an embodiment.

As described above, forward planning produces a production plan by executing events in time order from the point when work items are introduced into the factory. At this time, in accordance with the execution of the above-described event, a change occurs in the state variable 3300 corresponding to the event.

The state variable 3300 corresponds to a set of various variables used to simulate a manufacturing production system, and includes a physical variable 3100 and a logical variable 3200. The physical variables 3100 of the state variables represent physical elements such as products, processes, equipment, and tools among the components of the simulation, and the physical variables 3100 may be included in the plurality of elements according to type, and the logical variables 3200 represent elements related to the dynamic part or input decision-making in simulation modeling, and at least one logical variable 3200 may be included according to type.

For example, physical variables 3100 include, but are not limited to, a factory (not shown), a work item queue (buffer) 3110, work-in-process WIPs 3120, equipment 3130, and tools 3140. In addition, for example, the logical variable 3200 includes, but is not limited to, work item placement (route) 3210, filtering (filter) 3220, material movement (transfer) 3230, input decision-making (dispatching agent) 3240, work item management (WIP manager) 3250, work item input/output (in/out agent) 3260, etc.

The work item queue (buffer) 3110 represents work items that are waiting, work item information (WIPs, work in progress) 3120 represents information on work items within the factory, equipment 3130 represents a target for processing the work items, factory represents a location where the work item process is performed, and tool 3140 may represent a tool required for the process to proceed in the equipment.

In addition, the work item status management (WIP manager) 3250 may represent the location and information management of all work items within the factory, and the work item input/output agent (in/out agent) 3260 may represent the management of the input and output of work items within the factory.

As an example, in forward planning logic, as an event for at least one piece of equipment or work item in the model is selected and the simulation progresses, a change occurs in the state variable corresponding to the event. For example, the state of the equipment may include states such as idle (IDLE), running (RUN), tool replacement (Tool Change), preventive maintenance (PM), failure (DOWN), and available (UP), and the state of a work item may include states such as waiting (WAIT), in transfer (TRANSFER), and in process (PROCESSING), but is not limited thereto.

For example, when a process start event is executed, a change occurs in the corresponding state variable, such as equipment or work item (job or lot). In the case of equipment, the status changes from idle (IDLE) to running (RUN), and the status of the work item also changes from waiting (WAIT) to running or processing (RUN or Processing). Additionally, for example, when a tool change event is executed, changes occur in the corresponding state variables, tool and equipment. In the case of tools, the available quantity decreases, and in the case of equipment, the tool in use changes.

In this case, an event corresponding to or linked to the changed state variable may be newly entered into the event queue 3400. Additionally, linked events may be entered into an event queue 3400 and executed in a specified order or time. For example, when a work item transfer (Transfer) event is executed, a change occurs in the state variable corresponding to the work item transfer. When the movement of a work item (Transfer) begins, the status of the target work item changes to moving (TRANSFERING), and when the movement is finished, it changes to waiting status (WAIT) and generates a queue entry event (BUFFER). In this case, events other than work item transfer (Transfer) may be entered into the event queue based on changes in state variables corresponding to work transfer.

That is, depending on the execution of an event, a change occurs in a state variable 3300 corresponding to the event, and the physical variables and logical variables used within the factory are not limited to the variables illustrated in this figure, and may include other variables related to work items or equipment.

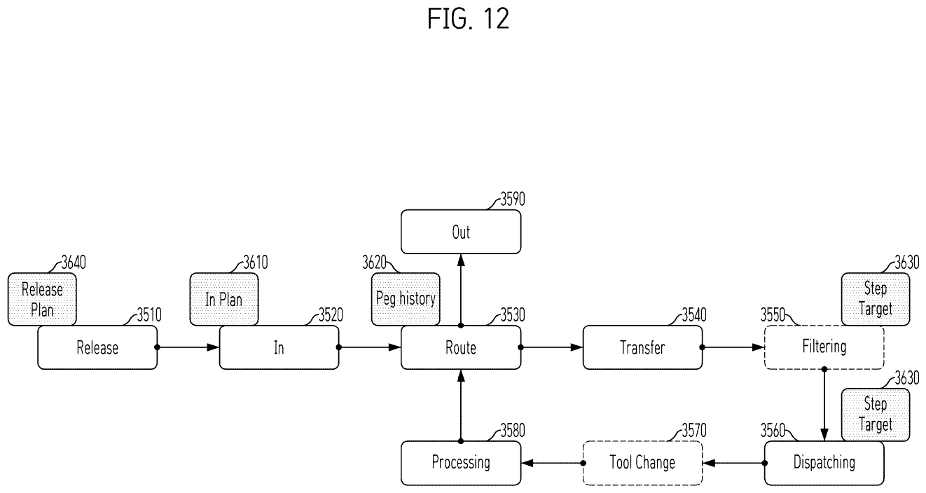

FIG. 12 is a diagram illustrating an example of an event in an event queue executing forward planning according to an embodiment.

Forward planning is a production plan that executes the logic in chronological order from the moment work is put into the first process in the factory until the process is completed.

Each event depicted may represent an event that is sorted according to criteria set in the event queue based on work items input into the factory. For example, the predefined criteria may be, but are not limited to, based on time order or priority. For this embodiment, it is assumed that each event depicted is arranged in chronological order.

Additionally, each event depicted in this diagram may represent system dynamics, including transitions in state associated with a work item, process, or equipment. Hereinafter, these will be collectively referred to as events. Additionally, each event depicted may correspond to an event occurring within a model that includes at least one piece of equipment or workpiece.

As an example, in the event queue, after work item generation (release) 3510, work item input (in) 3520 is performed first, followed by work item placement (routing) 3530, work item transfer (transfer) 3540, input decision (dispatching) 3560, operation processing 3580, work item placement (routing) 3530, and work item output (out) 3590 in this order.

Optionally, after the work item transfer (Transfer) 3540 event is executed, the work item filtering (Filtering) 3550 event may be executed, or after the input decision (Dispatching) 3560 event is executed, the tool change 3570 event may be executed. The events and event order arranged in the event queue are examples and are not limited thereto.

As described above, based on at least one of the factory release plan information 3640, the input plan (Inplan) information 3610, the operation target information 3630, and the peghistory information 3630 output as a result of backward planning, a simulation of an actual production plan may be performed in chronological order from the time of the first input of the work item.

For example, a work item generation (release) 3510 event may be executed based on factory input plan (release plan) information 3640 scheduled as a result of backward planning, a work item input (in) 3520 event may be executed based on input plan (Inplan) information 3610 scheduled as a result of the backward planning, a work item placement (route) 3530 event may be executed based on pegging history (peghistory) information 3620 scheduled as a result of the backward planning, and an input decision (dispatching) 3560 event may be executed based on operation target information 3630 scheduled as a result of the backward planning. Additionally, for example, a work item filtering 3550 event may be executed based on the operation target (Operation Target) information 3630.

Meanwhile, a state change may occur in the tool variable among the state variables. In this case, an event corresponding to the tool variable, tool replacement (Tool change) 3570, may be newly entered into the event queue. Therefore, a tool change 3570 may be added between dispatching 3560 and processing 3580 so that an event may be executed.

Additionally, if it is determined that the terminal condition that all operations of the work item have been completed has been satisfied in the work item routing 3530 while the events are being executed sequentially, the work item may be taken out (Out) 3590. For example, terminal condition may include, but are not limited to, such as when the predefined amount of time has elapsed on the global clock, or when an error occurs during event execution.

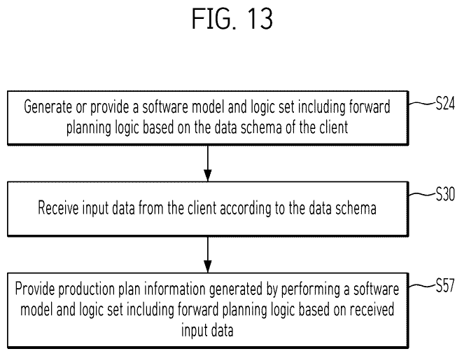

FIG. 13 is a flowchart for generating a production plan using forward planning logic according to an embodiment.

A software model and logic set including forward planning logic may be generated or provided based on the data schema of the client manufacturing production system S24.

Additionally, based on the software model and logic set including the above-described backward planning logic, a software model and logic set including forward planning logic may be generated or provided.

That is, the software model and logic set may include the forward planning logic disclosed above, and may use at least one of the factory input plan (release plan) information, the input plan (Inplan) information, the step target (Operation Target) information, and the pegging history (peghistory) information, which are outputs of the backward planning logic, as input data.

When a library engine set in an on-premise computing system includes forward planning logic, it is possible to generate a software model and logic set based on the client's data schema.

If the cloud system provides a production plan based on input data containing reference information from the client, this step may generate some customized logic set of the user, or this step may be omitted.

The generated software model and logic set may be used to generate production plan data in a time sequence according to forward planning logic. Detailed embodiments of the forward planning logic are disclosed in FIGS. 9 to 12.

Input data is received from the client according to the above data schema S30.

When production plan is generated and provided using an on-premise system, testing may be performed on software model and logic set by adding various conditions to the software model and logic set that contains the received forward planning logic.

It is possible to provide production plan information generated by executing a software model and logic set including forward planning logic based on received input data S57.

Forward planning logic is a method of generating a production plan and production schedule by simulating an actual factory in chronological order of equipment or work items from the time the work item is first introduced into the factory to the time it is completed.

The input data contains the results of the backward planning logic described above. Here, the input data may include at least one of factory input plan (release plan) information, input plan (Inplan) information, operation target (Operation Target) information, and pegging history (peghistory) information.

According to an embodiment, a production plan may be established in the forward flow of time based on reference information received from a client manufacturing production system. The actual production plan of work items or equipment within a factory may be simulated according to the time-forward method. Using this forward planning method, efficient production plan information may be generated and provided.

Clients may simulate the actual factory situation in a time-forward manner and obtain more efficient production plans based on the generated production plan.

Referring to FIG. 8, an embodiment of a device providing digital production plan information including forward planning logic is described as follows.

An embodiment of a device providing digital production plan information may include an input unit 310, a storage unit 320, an in-memory 330, a processor 340, an output unit 350, and a user interface 360.

An embodiment of a device providing digital production plan information below may be controlled by user control and management via a user interface 360.

The input unit 310 may receive the data schema of the manufacturing production system from the client manufacturing production system.

The storage device 320 may store the data schema received by the input unit 310 or, if a standardized data schema is prepared in advance, store the standardized data schema in the storage device 320. The storage device 320 may include volatile memory or non-volatile memory.

In-memory 330 may store the library engine set disclosed above.

A library engine set may contain a production planning engine, which is a number of encapsulated function block files that generate production plans. The production planning engine may include files for the forward planning logic described above.

Additionally, the library engine set may further include a core library, which is a file containing data structures that implement a production plan together with a production planning engine, and a production domain-specific engine that inherits some of the functions of the production planning engine and implements logic used in a specific production domain.

The processor 340 of the embodiment may receive a data schema stored in the storage device 320. Additionally, the processor 340 may generate a software model and logic set based on the data schema and the engine or library stored in the in-memory 330. The generated software model and logic set may generate production plan data in a time-forward manner according to the forward planning logic based on the software model and logic set including the backward planning logic. Embodiments of generating production plan data in a time-forward manner according to forward planning logic are disclosed in FIGS. 9 to 12.

The processor 340 may obtain production plan data by testing or pre-executing the generated software model and logic set according to a user request of the user interface 360. And the processor 340 may provide through the user interface 360, a result of analyzing or testing the software model and logic that generates production plan data according to the user's request to the user.

The processor 340 may receive input data including reference information of the manufacturing production system according to the data schema received from the input unit 310. The processor 340 may generate production plan data by executing a software model and logic set including a time-forward method according to forward planning logic. Detailed examples of generating production plan data according to forward planning logic are disclosed in FIGS. 9 to 12.

The output unit 350 may provide production plan data based on the execution results of a software model and logic set including forward planning logic to a client manufacturing production system so that the client system may manage production or processes.

The following examples detail an example of providing production plan data using a software model and logic set generated based on an installed library engine set.

As described, the model development unit 1100 of the on-premise computing system 1000 provides a frame for developing a software model and logic set capable of generating a production plan based on a library engine set 1150.

As another example, the cloud computing system 2000 may provide a number of standardized software model and logic set that may generate production plans based on a library engine set 2210.

In the disclosed embodiment, a software model and logic set capable of generating a production plan performs procedures to establish a production plan by virtually executing events occurring in a production system of an actual factory in a time-forward manner. The method of scheduling production plans in a time-forward manner may be called forward planning.

The model development unit 1100 may generate a software model and logic set including forward planning logic based on a library engine set 1150. The forward planning method is a method of executing a simulation of an actual production plan by executing events that may occur in the factory in chronological order from the time of the first input of a work item based on at least one of the factory input plan (Release Plan) information, input plan (In Plan) information (including quantity and timing), operation target (Step Target) information, and pegging history (Peg history) information output as a result of the above-described backward planning.

For example, the forward planning method is a discrete event simulation method that may simulate the production plan by calculating in time order what work will be done through what path and at what point in time from the time an actual work item is put into the factory until the work is completed.

That is, the forward planning method may produce a detailed production plan by executing events such as work lot placement (Route), work lot filtering (Filter), work lot transfer (Transfer), input decision (Dispatching), dummy processing, work lot input (In), and work lot output (Out) in relation to work lots or equipment in an actual factory based on the operation target produced through the backward planning method.

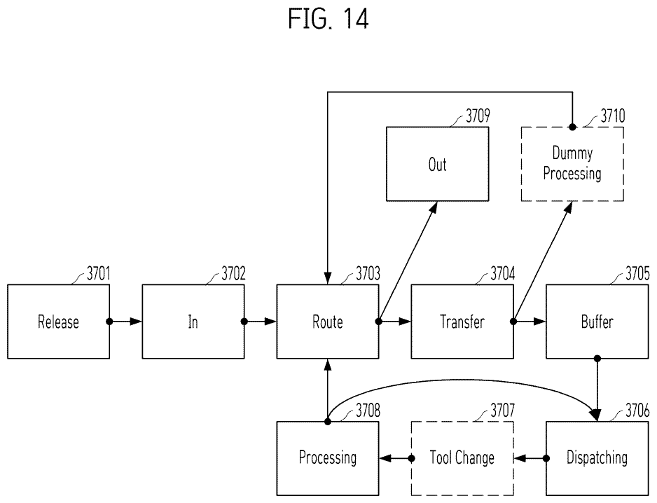

FIG. 14 is a diagram illustrating another example of an event in an event queue executed by forward planning logic according to an embodiment.

Forward planning is a production plan that executes the logic in chronological order from the time that work items are generated in the factory and put into the operation until the operation is completed.

As described above, through forward planning logic, a simulation model of an actual factory may be generated and run, and a production plan that reproduces the dynamics of an actual factory may be generated through events such as work item generation (Release), work item input (In), queue entry (Queue), work item transfer (Transfer), work item placement (Route), operation processing (Processing), equipment change (Tool Change), input decision-making (Dispatching), work item filtering (Filtering), and work item out (Out). As an example, an input decision-making (Dispatching) event may include a work item filter (Filtering) event.

In addition, as described above, a forward planning event may be executed by using at least one of the factory input plan (Release Plan) information, the input plan (In Plan) information (including quantity and timing), the operation target (Step Target) information, and the pegging history (Peg history) information output as a result of the backward planning as an input value of the forward planning.

As an example, in an event queue, events may be executed in the following order: work item generation (Release) 3701 and work item input (In) 3702, followed by work item placement (Route) 3703, work item transfer (Transfer) 3704, work item waiting (Buffer) 3705, input decision-making (Dispatching) 3706, and operation processing (Processing) 3708. Additionally, some of the events arranged in the event queue may be excluded and the remaining events may be executed. As another example, a work item placement (Route) 3703 event may be executed followed by a work item out (Out) 3709 event.

Optionally, after the input decision making (Dispatching) 3706 event is executed, an equipment change (Tool Change) 3707 event may be executed, and after the work item transfer (Transfer) 3704 event is executed, a dummy operation processing (Dummy Processing) 3710 event may be executed. The events or the event order arranged in the event queue are examples and are not limited thereto.

Additionally, input decision-making 3706 is managed by a dispatching agent, and the dispatching agent corresponds to a logical variable among the state variables described above. Additionally, input decision makings are one of the most important factors influencing performance in production planning.

The input decision making (Dispatching) 3706 may be performed at different times depending on the type of subject on which the event is executed. For example, this may occur when a work item is in a work item waiting (Buffer) 3705 state, when the equipment becomes idle after the operation processing (Processing) 3708, or periodically at regular intervals. Regarding dispatching decision 3706, this will be explained again below.

Meanwhile, in forward planning logic, in a physical manufacturing environment, a large amount of computation may be required due to the high level of detail in the process of setting a movement path with respect to equipment or work items, the work items moving along the set path and selected by equipment. In particular, a large amount of computation may be required during the work item filtering (not shown) or input decision-making (Dispatching) 3706. However, in cases where the equipment is not a bottleneck, the operation has a fast processing speed, or there is a sufficient number of equipment in the factory, a large amount of computation may not be necessary, so operation processing is required to reduce this unnecessary detail.

Dummy operation processing (Dummy Processing) 3710 corresponds to an event that causes work item placement (Routing) 3704 for the next process to be performed after a certain period of time has elapsed after the transfer of work item in forward planning logic. That is, dummy processing 3710 is a method for shortening the execution time by omitting complex operations such as work item filtering (not shown) or dispatching 3706. In this embodiment, it is described that dummy processing 3710 is performed after a work item transfer (Transfer) event, but it is also possible for dummy operation processing (Dummy Processing) 3710 to be performed after a work item waiting (Buffer) event.

In the case of dummy operation processing (Dummy Processing) 3710, the subject step for dummy processing 3710 is determined at the time of work item generation (Release) 3701 or work item input (In) 3702, that is, at the input value. Accordingly, when the subject step or equipment for the dummy operation processing (Dummy Processing) 3710 is set, work item placement (Route) 3703 is performed without going through work item filtering (not shown) or input decision making (Dispatching) 3706.

Additionally, even if dummy operation processing (Dummy processing) 3710 is set in the input value, it may be configured such that execution does not exceed the production capacity by receiving the production capacity of the step or equipment as a parameter.

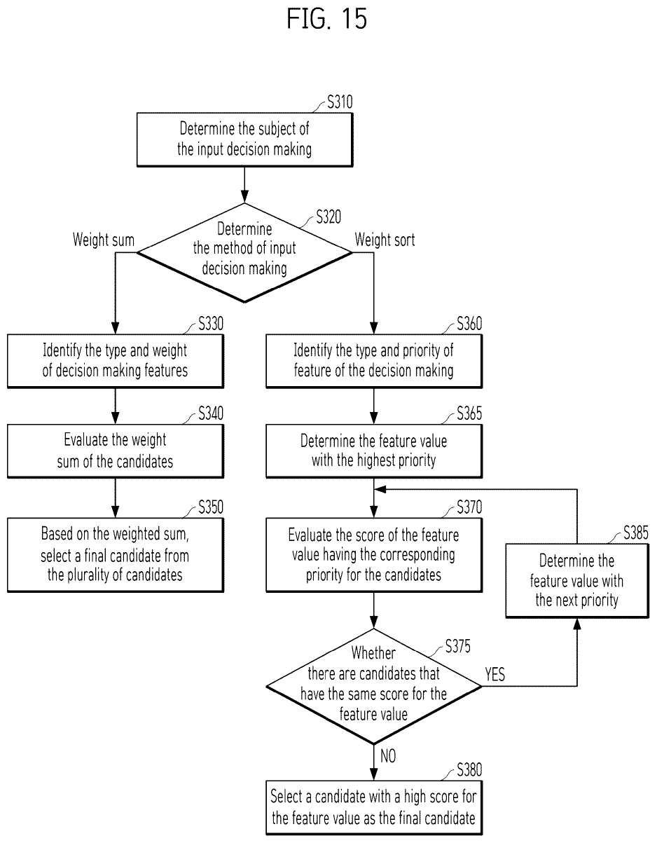

FIG. 15 is a diagram illustrating steps of an input decision-making execution executed by forward planning logic according to an embodiment.

Hereinafter, in order to facilitate the description of an embodiment of the forward planning logic within a library engine set, an example of performing input decision making by a dispatching agent, which is a type of system dynamics, will be described.

As described above, dispatching is a factor that affects the performance of production plans in forward planning logic. The timing at which a dispatching event is executed may vary depending on whether it is based on a work item or an equipment.

At the point where an input decision making is executed, first, the subject of the input decision making may be determined S310. As described above, the input decision making event may include a filtering event. That is, filtering may be performed to determine the subject of the input decision making before deciding on the method for the input decision making.

For example, a single piece of equipment that has entered an idle state may become the subject of an input decision making to select one from among n candidate work items, and a single work item that has been added to a queue after completing a previous step may become the subject of an input decision making to select one from among m candidate pieces of equipment. Additionally, for example, a pair of work items and equipment that may occur throughout the factory at any given time could be the subject of an input decision making.

Next, the method of input decision making may be determined S320. In the present disclosure, the input decision-making method may include a weight sum method, a weight sort method, and a hybrid method of weight sum and weight sort. The input decision-making method may be determined based on the type or quantity of work items or equipment within the factory, or by user settings.

Here, the weight sum method is a method that calculates the product of all feature values (dispatching features) and weights for input subject candidates (the plurality of work items or the plurality of pieces of equipment) and selects the candidate (work item or equipment) with the largest weight sum. In addition, the weight sort method is a method of selecting one candidate (work item or equipment) by evaluating the dispatching feature value starting with a high priority among the input subject candidates (the plurality of work items or the plurality of pieces of equipment).

If the method of input decision making is determined by a weight sum method, the types and weights of dispatching features for input subject candidates may be identified S330. Here, the features of the input decision making may correspond to the numerical value representing the features (or characteristics) of the alternatives that may arise from the input decision making, and the feature weight may correspond to the weight of each feature. Additionally, the types and weights of features may change during the input decision-making process by using the weight sum method. Next, the weight sum of the candidates may be evaluated S340. More specifically, a weight sum may be calculated by multiplying the features and weights for each of the plurality of candidates.

Here, the weight sum evaluation may include a linear weight sum or a nonlinear weight sum utilizing a nonlinear structure such as a neural network. The nonlinear weight sum method using a nonlinear structure is a method that may calculate scores for each task through a neural network consisting of at least one neural network layer that uses a nonlinear activation function, and makes decisions based on the scores. For example, you may select the task with the maximum score or use the SoftMax function based on the score.

Finally, based on the weighted sum, a final candidate may be selected from the plurality of candidates S350. As an example, a weight sum may be calculated for each of the plurality of candidates, and the final candidate with the highest weight sum may be selected. As another example, a weight sum may be calculated for each of the plurality of candidates, and the final candidate with the lowest weight sum may be selected. Regarding the input decision-making of the weight sum method, it is explained again below.

Meanwhile, when the method of input decision making is determined by a weight sort, the type and priority of the characteristic value of the input decision making may be identified S360. Here, the priority may correspond to the order in which feature values are compared, according to the characteristics of the plant, equipment, or work item. Next, the feature value with the highest priority among the plurality of feature value types may be determined S465. In this embodiment, the feature value with the highest priority is determined as an example, but it may be set to be determined as the feature value with the lowest priority.

Next, the scores of the feature values having the corresponding priority for the candidates may be evaluated S370. For example, one may compare the scores of feature values with first priority for the plurality of candidates. Afterwards, it may be determined whether there are candidates among the plurality of candidates that have the same score for the feature value S375. For example, if there are five candidates, it may be determined whether at least two candidates have the same high score. Here, the high score could correspond to the highest score among the individual scores of the plurality of candidates.

If there are no candidates with the same high score for a feature value, a candidate with a high score for that feature value may be selected as the final candidate S380. In this embodiment, it is exemplified that a candidate with a high score is selected as the final candidate, but it may be set that a candidate with a low score is selected as the final candidate.

If there are candidates with the same high score for a feature value, the feature value with the next priority may be determined S385. More specifically, it is possible to determine the feature value with the next priority only for candidates with the same high score, excluding the remaining candidates that do not have the same high score. For example, if there are two candidates with the same high score in the feature value having the first priority among five candidates, the feature value having the second priority may be determined only for two candidates.

Next, the scores of the feature values having the corresponding priority are evaluated for the candidates, and if there are no candidates having the same high score, the process proceeds to step S380. Additionally, if there are candidates with the same high score, step S385 is repeated again.

In other words, the weight sorting method is a decision-making method that repeats sorting the plurality of candidates based on the same feature value until only one candidate remains without the same score. Such the weight sorting methods may include nonlinear decision-making structures such as decision trees. The nonlinear structures include, but are not limited to, decision trees.

Meanwhile, although not shown in this embodiment, the weight sum method and the weight sorting method may be performed in combination in the input decision-making. For example, among the ten work items that are the subject of input decision making, the five work items with the highest weight sum may be selected, and one candidate may be finally selected through weight sorting of the selected five work items. In addition, for example, if among the ten work items that are the subject of the input decision making, there are five taskwork items that have the same score until the last priority after weight sorting, one candidate may be selected as the final candidate through the weight sum method for the five work items. At this time, in order to prevent computational waste, the features used in weight sort and the features used in the weight sum method may correspond to different features.

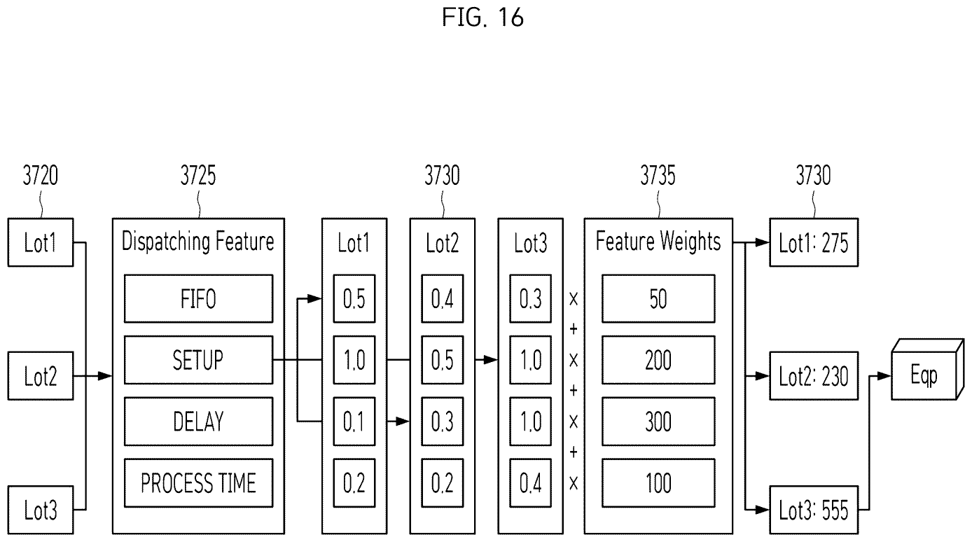

FIG. 16 is a diagram illustrating an example of dispatching executed by forward planning logic according to an embodiment.

More specifically, this diagram is an example of a weight sum method of input decision making, assuming that there are three work items for one piece of equipment.

First, in this embodiment, the subject of the input decision is a work item 3720 and may include the plurality of candidates (Lot1, Lot2, Lot3). Next, the features and weights of the input decision making may be determined. In this embodiment, the type of features of the input decision making (Dispatching Feature) 3725 is determined as FIFO, SETUP, DELAY, and PROCESS TIME, and each work item may have different feature values 3730 depending on the characteristics of the work item.

The FIFO (First In First Out) feature indicates a feature that a task that entered earlier than other tasks may be processed first, the SETUP feature indicates a feature that a task causes a setup change, DELAY indicates a feature that a task is delayed, and PROCESS TIME may indicate a feature related to the time that a task is in progress. In this embodiment, four features are described, but the types of features are not limited thereto. In addition, the features of input decision making may include a variety of features that may be quantified within the factory.

For example, for candidate 1 (Lot1), the FIFO feature value is 0.5, the SETUP feature value is 1.0, the DELAY feature value is 0.1, and the PROCESS TIME feature value is 0.2; for candidate 2 (Lot2), the FIFO feature value is 0.4, the SETUP feature value is 0.5, the DELAY feature value is 0.3, and the PROCESS TIME feature value is 0.2; and for candidate 3 (Lot3), the FIFO feature value is 0.3, the SETUP feature value is 1.0, the DELAY feature value is 1.0, and the PROCESS TIME feature value is 0.4.

As an example, the weight (Feature Weights) 3735 for the input decision making may be determined according to the equipment that serves as the basis for the input decision making. In this embodiment, the weight of the FIFO feature value is 50, the weight of the SETUP feature value is 200, the weight of the DELAY feature value is 300, and the weight of the PROCESS TIME feature value is 100 based on the equipment.

Next, for each candidate, the weight sum, which is the sum of the product of the feature value and the weight for each candidate, can be calculated. In this embodiment, the weight sum of candidate 1 (Lot1) is 275, the weight sum of candidate 2 (Lot2) is 230, and the weight sum of candidate 3 (Lot3) is 555. Therefore, the subject of the input decision making in this embodiment corresponds to candidate 3 (Lot3), which is the candidate with the highest weight sum.

In the present embodiment, although the case in which the plurality of work items for one piece of equipment is described by way of example, the same weight sum method may also be applied to make an input decision making in a case where the plurality of pieces of equipment for one piece of work item. The weight sum method has the advantage of producing high-performance production plans because decision-making takes into account all feature values.

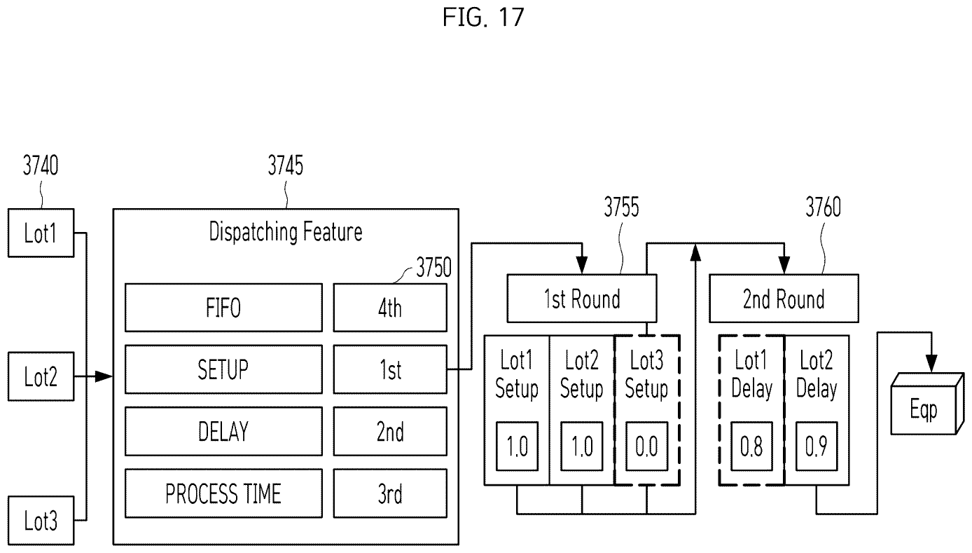

FIG. 17 is a diagram illustrating another example of dispatching executed by forward planning logic according to an embodiment.

More specifically, this diagram is an example of an input decision-making process using the weight sort method, assuming that there are three work items for one piece of equipment.

First, in this embodiment, the subject of the input decision making is a work item 3740 and may include the plurality of candidates (Lot1, Lot2, Lot3). Next, decision-making features and priorities (Dispatching Feature) may be determined. In this embodiment, the type 3745 of the feature value of the input decision making is determined as FIFO, SETUP, DELAY, and PROCESS TIME, and the priority 3750 of the feature value is determined in order of priority by the most important factor for each feature value type. In this embodiment, the SETUP feature value has the first priority, the DELAY feature value has the second priority, the PROCESS TIME feature value has the third priority, and the FIFO feature value has the fourth priority.

Next, we may evaluate the scores between the candidates in order of highest priority. In this embodiment, when the first evaluation 3755 is performed on the SETUP feature value with the highest priority, candidate 1 (Lot1) and candidate 2 (Lot2) are evaluated as having the same score, except for candidate 3 (Lot3). In this case, a second evaluation 3760 is performed on the DELAY feature value, which is the second priority, and the score of candidate 1 (Lot1) is evaluated to be lower than the score of candidate 2 (Lot2). Therefore, the subject of the input decision making in this embodiment corresponds to candidate 2 (Lot2), which is the last remaining candidate in the weight sorting.

Although not shown in this embodiment, if the scores of candidate 1 (Lot1) and candidate 2 (Lot2) are the same in the second evaluation 3760, additional evaluation may be performed on the PROCESS TIME feature value, which is the third priority. In addition, although not shown in this embodiment, if all candidates have different SETUP feature values in the first evaluation 3755, the candidate with the highest score among the candidates may be finally selected as the subject of the input decision making in the first evaluation.

In this example, the case where there are the plurality of work items for one piece of equipment is described by way of example. However, conversely, even in the case where there are the plurality of pieces of equipment for a single work item, the weight sort method may be performed in the same manner to make an input decision making. The weight sorting method has the advantage of reducing the number of cases as decision-making progresses and reducing the amount of computation because not all feature values need to be calculated. Additionally, since the amount of computation is reduced, quick decisions may be made, so in cases where simulation is difficult in a complex factory (it is too complex and takes too much time), decisions may be made quickly, allowing for efficient production planning.

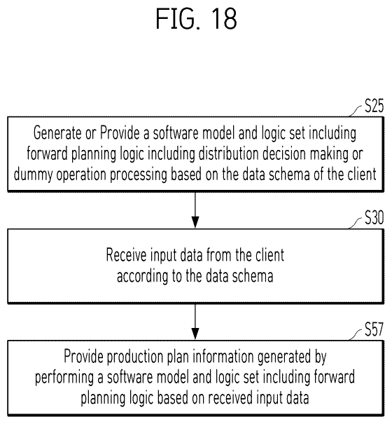

FIG. 18 is a flowchart for generating a production plan using forward planning logic according to an embodiment.

A software model and logic set including forward planning logic including distribution decision making or dummy operation processing based on the data schema of the client manufacturing production system may be generated or provided S25.

Additionally, based on the software model and logic set including the above-described backward planning logic, a software model and logic set including forward planning logic may be generated or provided.

That is, the software model and logic set may include the forward planning logic disclosed above, and may use at least one of the factory input plan (Release Plan) information, the input plan (In Plan) information, the operation target (Step Target) information, and the pegging history (Peghistory) information, which are outputs of the backward planning logic, as input data.

As described above, forward planning logic may include input decision making or dummy operation processing events. The input decision-making may include weight sum and weight sort methods, depending on the method.

Meanwhile, distribution decision making may also be applied in backward planning logic. As an example, it may be applied in the demand information preprocessing stage and/or facility distribution stage of the backward planning logic. The method for input decision making may include the weight sum method, the weight sort method, and a hybrid method of the weight sum and weight sort methods described above. For example, in the demand information preprocessing stage, the subject of input decision making may be the demand information that may be the input decision subject for selecting one out of n performances, the performance may be the input decision subject for selecting one out of n demand information, and a pair of demand information and performance may be the subject of input decision making. In addition, for example, in the facility distribution stage, the subject of the input decision making may be a facility (site) that is selected from among n demand information, the subject of the input decision making may be the demand information that is selected from among n facilities, and the subject of the input decision making may be a pair of a facility and demand information.

When a library engine set in an on-premise computing system includes forward planning logic, it is possible to generate a software model and logic set based on the client's data schema.

If the cloud system provides a production plan based on input data containing reference information from the client, this step may generate some customized logic set of the user, or this step may be omitted.

The generated software model and logic set may be used to generate production plan data in time sequence according to forward planning logic. Detailed embodiments of the forward planning logic are disclosed in FIGS. 13 to 17.

Input data is received from the client according to the data schema S30.

When generating and providing production plans using on-premise system, tests may be performed on software model and logic set by adding various conditions to the software model and logic set that contain the received forward planning logic.

It is possible to provide production plan information generated by executing a software model and logic set including forward planning logic based on received input data S57.

Forward planning logic is a method of generating a production plan and production schedule by simulating an actual factory in chronological order of equipment or work items from the time the work item is first introduced into the factory to the time it is completed.

The input data contains the results of the backward planning logic described above. Here, the input data may include at least one of factory input plan (Release Plan) information, input plan (In Plan) information, operation target (Step Target) information, and pegging history (Peg history) information.

According to an embodiment, a production plan may be established in the forward flow of time based on reference information received from a client manufacturing production system. The actual production plan of work items or equipment within a factory may be simulated according to the time forward method. Using this forward planning method, efficient production plan information may be generated and provided.

Clients may simulate the actual factory situation in a time forward manner and obtain more efficient production plans based on the generated production plan.

Referring to FIG. 8, an embodiment of a device providing digital production plan information including forward planning logic is described as follows.

An embodiment of a device providing digital production plan information may include an input unit 310, a storage unit 320, an in-memory 330, a processor 340, an output unit 350, and a user interface 360.

An embodiment of a device providing digital production plan information below may be controlled by user control and management via a user interface 360.

The input unit 310 may receive the data schema of the manufacturing production system from the client manufacturing production system.

The storage device 320 may store the data schema received by the input unit 310 or, if a standardized data schema is prepared in advance, store the standardized data schema in the storage device 320. The storage device 320 may include volatile memory or non-volatile memory.

In-memory 330 may store the library engine set disclosed above.

A library engine set may contain a production planning engine, which is a number of encapsulated function block files that generate production plans. The production planning engine may include files for the forward planning logic described above.

Additionally, the library engine set may further include a core library, which is a file containing data structures that implement a production plan together with a production planning engine, and a production domain-specific engine that inherits some of the functions of the production planning engine and implements logic used in a specific production domain.

The processor 340 of the embodiment may receive a data schema stored in the storage device 320. Additionally, the processor 340 may generate a software model and logic set based on the data schema and the engine or library stored in the in-memory 330. The generated software model and logic set may generate production plan data in a time-forward manner according to the forward planning logic based on the software model and logic set including the backward planning logic. As described above, forward planning logic may include input decision making or dummy operation processing event. Embodiments of generating production plan data in a time-forward manner according to forward planning logic are disclosed in FIGS. 14 to 17.

The processor 340 may obtain production plan data by testing or pre-executing the generated software model and logic set according to a user request of the user interface 360. And the processor 340 may analyze or test the software model and logic that generates production plan data according to the user's request and provide the results to the user through the user interface 360.

The processor 340 may receive input data including reference information of the manufacturing production system according to the data schema received from the input unit 310. The processor 340 may generate production plan data by executing a software model and logic set including a time-forward method according to forward planning logic. Detailed examples of generating production plan data according to forward planning logic are disclosed in FIGS. 14 to 17.

The output unit 350 may provide production plan data based on the execution results of a software model and logic set including forward planning logic to a client manufacturing production system so that the client system may manage production or processes.

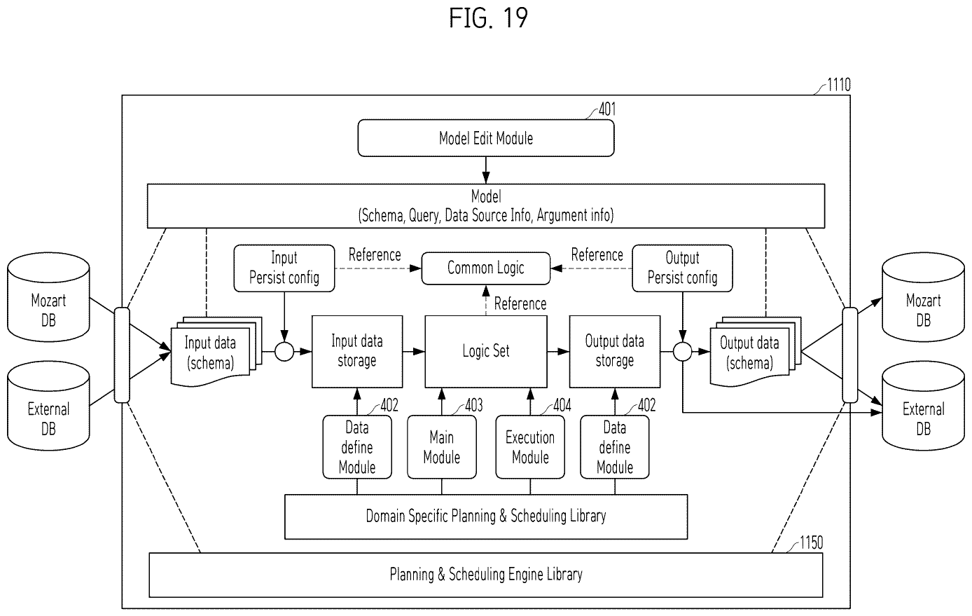

FIG. 19 is a diagram illustrating an example of generating a software model and a logic set based on a data schema and library engine set according to an embodiment.

In the illustrated example, the model development unit 1100 of the on-premise computing system 1000 provides a frame for developing a software model and logic set that may generate a production plan based on a data schema and library engine set 1150.

In an embodiment, the model development unit 1100 may include a model edit module 401, a data define module 402, a main module 403, and an execution module 404.

The model edit module 401 may generate a software model for a client manufacturing production system. In an embodiment, the software model may be edited by modifying parameters related to the software model for the client manufacturing system. In an embodiment, the software model may include at least one of a data schema, a data source, a query, and global variables for the client manufacturing system.

Here, the data schema may represent the data structure and format required to perform a software (SW) model or logic. In an embodiment, the data schema may include an input data schema and an output data schema. In an embodiment, the input data schema may be received from a client manufacturing system. Additionally, the output data schema may be determined based on the input data schema or may be specified by the developer.

Additionally, a data source may establish a database connection to retrieve data. Additionally, data sources may include data sources that define input data and output data and generate data actions. Additionally, a query means requesting data from a data source, and a query management unit, that may consist of at least one query, may be referred to as a data action. Global variables may contain variables that define an option and a setting value for executing logic used at runtime. For example, global variables may include, but are not limited to, the start time of logic execution, the completion time of logic execution, the name of the model file, etc.

In an embodiment, the model edit module 401 may generate persist configuration information for input data and output data. Here, the persist configuration information may include input persist configuration information for loading input data corresponding to the data schema into memory and output persist configuration information for storing output data corresponding to the data schema in memory.

The data define module 402 may define data classes used when executing the main module 403 and execution module 404 that perform logic processing. In an embodiment, the data define module 402 may redefine data classes provided by the library engine set 1150. In an embodiment, the data define module 402 may define data storage settings for input data storage and output data storage.

In an embodiment, the input data storage and the output data storage may mean a data collection defined according to the data class of the data and a repository that stores input data, intermediate data, and output data. Here, data collection may mean a data table in which the data is defined in table form according to the data class. In an embodiment, data storage may be referenced when a software model and logic set are executed.

The main module 403 may control the execution of the execution module 404. In an embodiment, the main module 403 may set property and execution option for the software model. In an embodiment, the main module 403 may control the entire execution to provide production plan data. For example, the main module 403 may control the process of loading initial input data, executing the execution module 404, and then storing output data.

The execution module 404 may generate and execute the logic set including at least one of pegging logic or simulation logic for the client manufacturing system based on the data schema and library engine set 1150. The execution module 404 may include at least one of a pegging module that generates pegging logic or a simulation module that generates simulation logic. Here, the pegging logic may include logic for pegging work in process based on demand information according to backward planning logic and generating an input target (In Target) and an output target (Out Target) for each process for the remaining quantity. In addition, the simulation logic may simulate an actual production plan by executing events that may occur within the factory in chronological order from the time of first input of work items based on the results of the backward planning logic according to the forward planning logic.

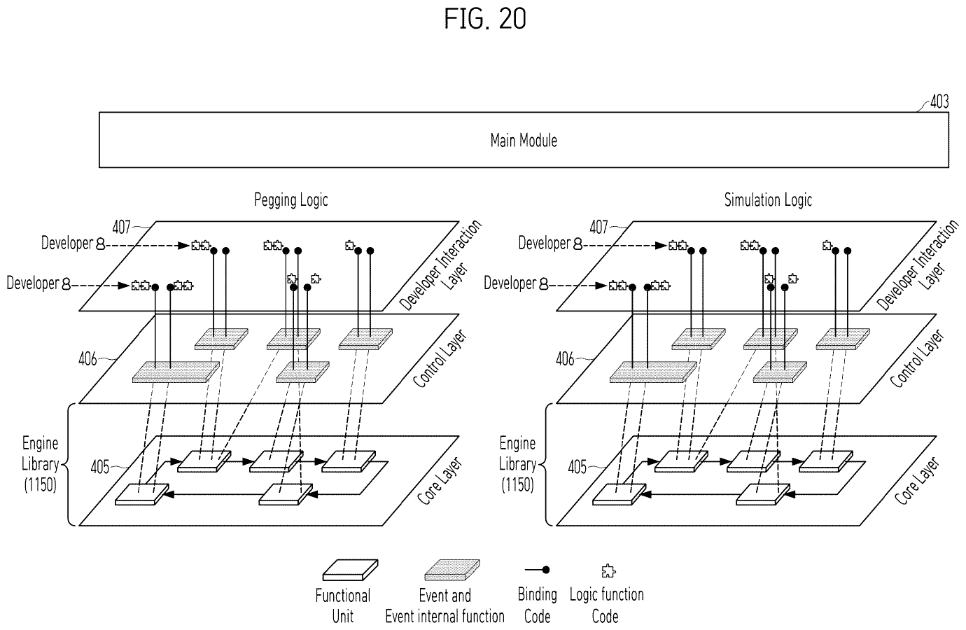

FIG. 20 is a diagram illustrating an example of generating the logic set including pegging logic and simulation logic according to an embodiment.

In the illustrated example, the logic set including pegging logic and simulation logic may be generated through a core layer 405 and a control layer 406 of a library engine set 1150 and a developer interaction layer 407 for a user interface for interaction with a user.

The core layer 405 may include functional units of backward planning logic corresponding to pegging logic and forward planning logic corresponding to simulation logic, as well as information on the relationship and interaction between these functional units. For example, functional units may include, but are not limited to, factory, transfer, dispatching, and equipment for simulation logic.

The control layer 406 may include events and event internal functions that control the functional units included in the core layer 405. In an embodiment, at least one event and event internal function corresponding to each functional unit may be configured. For example, it might include an event that evaluates the value of an alternative feature for an input decision making.

The developer interaction layer 407 may include logic function code corresponding to at least one of an event or an event internal function. Here, the logic function code may include function code for implementing pegging logic and simulation logic. In an embodiment, pegging logic and simulation logic may be generated by implementing a binding code for binding events of the control layer 406 with an event internal functions and logic function code, and implementing logic function code. In an embodiment, the logic function code of the developer interaction layer 407 may be pre-implemented and pre-stored.

In this case, the binding code for the logic point corresponding to the event and the event internal function may have a 1:N relationship with the logic function code. That is, the plurality of logic function codes may be set for one logic point. For example, at a logic point that evaluates the value of an alternative feature for an input decision making, logic function codes may be set equal to the number of evaluation conditions. In this way, when there are the plurality of logic function codes for binding code, the execution order between the logic function codes may be specified.

In an embodiment, a set of logic development layers including a core layer 405, a control layer 406 and a developer interaction layer 407 may be configured for each of the pegging logic and the simulation logic. In an embodiment, the process of generating the logic set based on a set of logic development layers may be controlled by the main module 403.

In an embodiment, the logic set managed by the main module 403 is not limited to the pegging logic and simulation logic, and various logics may be added depending on the function.

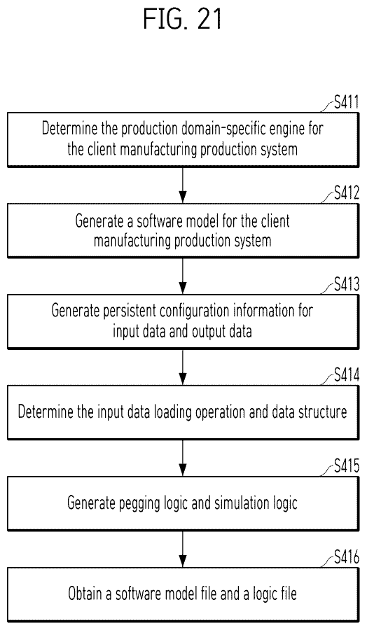

FIG. 21 is a diagram illustrating an example of a method for providing digital production plan information according to an embodiment of the present invention, which generates the software model and the logic set.

A production domain-specific engine for a client manufacturing production system is determined S411. In an embodiment, since the production fields are different for each client and each field has its unique characteristics, the production domain-specific engine may be determined by selecting which field, i.e., a specific production domain, of the client's manufacturing production system to be modeled. In an embodiment, it is possible to determine which production domain-specific engine to use among pre-generated production domain-specific engines based on the client manufacturing production system.

In an embodiment, the production domain-specific engine of the library engine set 1150 may be defined differently depending on the industry or manufacturing production system, as it is a data set that implements logic used in a specific production domain by inheriting some functions of the production planning engine.

In an embodiment, a production domain-specific engine for a specific production domain inherits the logic for the general domain as is, and may additionally include logic related to the specific production domain. For example, a particular production domain may include an LCD domain. In this case, the production domain-specific engine corresponding to the LCD domain inherits the backward planning logic and forward planning logic for the general domain, and may additionally include logic related to the TFT (Thin Film Transistor) process, CF (Color Filter) process, and LC (Liquid Crystal) process for the LCD domain.

In step S412, a software model for the client manufacturing production system is generated. In an embodiment, a software model may be generated that includes at least one of a data schema, a data source, a query, or a global variable for a client manufacturing production system. In an embodiment, the software model may be edited based on user input via a user interface. Detailed descriptions thereof are provided in the foregoing description.

In step S413, persistent configuration information for input data and output data is generated. In an embodiment, the persistent configuration information may include input persistent configuration information and output persistent configuration information. In this case, the input persistence configuration information may indicate the procedure and method for loading the input data as data in memory. For example, input persistence configuration information may include, but is not limited to, the execution order of queries in the DB, the number of threads performing the queries in the DB, and the number of retry attempts upon disconnection of the DB network.

Additionally, the output persistence configuration information may indicate the procedure and method for storing output data in memory to a file or database (DB). For example, output persistence configuration information may include, but is not limited to, a setting for whether to save data and a setting for whether to record the time of data saving.

In an embodiment, persistent configuration information may be generated according to the user input, based on at least one of a data schema, a data source, a query, or a global variable.

In step S414, the input data loading operation and data structure is determined. In an embodiment, the input data loading operation may mean an operation of reading input data from a DB. For example, an action to load data might include an event executed each time one line of data is read, and an event executed after all data has been read.

In an embodiment, the data structure to be used in the internal logic of the model may be preprocessed during the process of reading data. For example, if there are Product, Process, Operation tables respectively exist, logic may be implemented to interdependently link each of Product, Process, and Operation.

In an embodiment, the data structure may include a data structure automatically generated and stored as defined in a data schema and a data structure generated by user input. In an embodiment, elements that are involved in input values and will be used continuously in the internal logic of the model may be stored in the input data memory space, and elements that are involved in output values and intermediate and/or final outputs of the internal logic of the model may be stored in the output data memory space. Here, the data memory space may include a virtual memory space that temporarily exists when a program runs in memory.

In step S415, pegging logic and simulation logic is generated S415. In an embodiment, the pegging logic and simulation logic may be generated by writing detailed logic function codes for events and event internal functions for the functional units related to backward planning logic and forward planning logic of the library engine set.

In an embodiment, when a user's click input for a user interface for implementing a logic function is obtained, a logic function code for that the corresponding function and a binding code for connecting the function to an engine set may be automatically generated.

In an embodiment, the implemented portion among functions to be implemented may be stored in a specific file format (e.g., xml, etc.), and even when the model development unit 1100 is executed again, the editing contents may be continuously checked.

In step 416, a software model file and a logic file are obtained. In an embodiment, a software model file and a logic file including pegging logic and simulation logic may be obtained. In an embodiment, the model file and logic file may be obtained through save and build.

In an embodiment, steps S414 to S416 may be performed in any order and may be performed simultaneously or separately. Additionally, at least one step may be omitted if the information is predetermined.

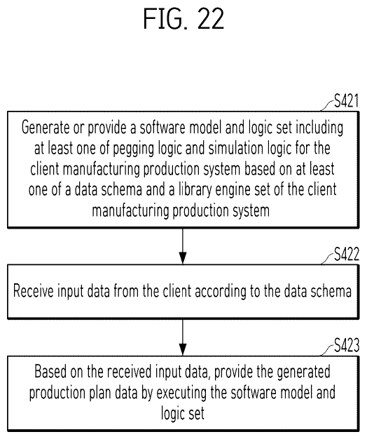

FIG. 22 is a diagram illustrating an example of a method for providing digital production plan information according to an embodiment to generate a production plan.

In step S417, a software model and logic set including at least one of pegging logic or simulation logic for the client manufacturing production system based on at least one of data schema or a library engine set of the client manufacturing production system, are generated and provided. In an embodiment, a software model may be generated based on at least one of the data schema, a data source for the input data, a query for the data schema, or a global argument.

In an embodiment, at least one of an event or an internal function of the event related to a work item or equipment included in at least one functional unit of a library engine set, may be configured, and at least one of the pegging logic or the simulation logic may be generated by binding logic function code corresponding to at least one of the event or the internal function of the event.

In an embodiment, the library engine set may include at least one of backward planning logic in a time-reverse manner or forward planning logic in a time-forward manner. For this, reference is made to the description given above in FIGS. 19 to 21.

In step 422, input data including reference information is received from the client according to the data schema. In an embodiment, the input data may include at least one of product information, production flow information, operation information, equipment information, transfer time information, in-factory work item information, or pre-produced quantity information. In an embodiment, the input data may include the results of the backward planning logic described above. For this, reference is made to the descriptions given in FIGS. 19 to 21.

In step S423, based on the received input data, the software model and logic set are executed to provide the generated production plan data. In an embodiment, when the software model and logic set include forward planning logic, production plan information may be generated in the time-forward direction using operation target information (Step Target) and factory release plan information (Release Plan) obtained from the backward planning logic. For this, reference is made to the descriptions in FIGS. 19 to 21.

Referring to FIG. 8, an embodiment of a device providing digital production plan information based on a software model and logic set including at least one of pegging logic or simulation logic is described as follows.

An embodiment of a device providing digital production plan information may include an input unit 310, a storage unit 320, an in-memory 330, a processor 340, an output unit 350, and a user interface 360.

An embodiment of a device providing digital production plan information below may be controlled by user control and management via a user interface 360.

The input unit 310 may receive the data schema of the manufacturing production system from the client manufacturing production system.

The storage device 320 may store the data schema received by the input unit 310 or, if a standardized data schema is prepared in advance, store the standardized data schema in the storage device 320. The storage device 320 may include volatile memory or non-volatile memory.

In-memory 330 may store the library engine set disclosed above. A library engine set may contain a production planning engine, which is a number of encapsulated function block files that generate production plans. The production planning engine may include files for at least one of the backward planning logic or the forward planning logic disclosed above.

Additionally, the library engine set may further include a core library, which is a file containing data structures that implement a production plan together with a production planning engine, and a production domain-specific engine that inherits some of the functions of the production planning engine and implements logic used in a specific production domain.

The processor 340 of the embodiment may receive a data schema stored in the storage device 320. Additionally, the processor 340 may generate a software model and logic set based on the data schema and the engine or library stored in the in-memory 330. In an embodiment, the processor 340 may generate or provide a software model and logic set including at least one of pegging logic or simulation logic for the client's manufacturing production system based on at least one of data schema or a library engine set of the client's manufacturing production system. Detailed descriptions thereof are provided in the foregoing description.

The processor 340 may obtain production plan data by testing or pre-executing the generated software model and logic set according to a user request of the user interface 360. And the processor 340 may analyze or test the software model and logic that generates production plan data according to the user's request and provide the results to the user through the user interface 360.

The processor 340 may receive input data including reference information of the manufacturing production system according to the data schema received from the input unit 310. The processor 340 may generate production plan data by executing a software model and logic set according to the pegging logic and simulation logic based on input data.

The output unit 350 may provide production plan data based on the execution results of a software model and logic set including forward planning logic to a client manufacturing production system so that the client system may manage production or operations.

In the following embodiments, an example of providing production plan data using a software model and logic set generated based on an installed library engine set will be described in detail.

As described, the model development unit 1100 of the on-premise computing system 1000 provides a frame for developing a software model and logic set capable of generating a production plan based on a library engine set 1150.

As another example, the cloud computing system 2000 may provide a number of standardized software model and logic set that may generate production plans based on a set of library engines 2210.

In an embodiment, the software model may include at least one of a data schema, a data source, a query, or global variables for the client manufacturing system. Additionally, the logic set may include other logic that defines the manufacturing system, as well as pegging logic or simulation logic for the client manufacturing production system.

In the following embodiment, an example of performing a procedure for generating tasks necessary for executing a software model and logic set and setting an execution period and dependency through a system operation unit 110 is described.

As described above, the system operation unit 110 may transfer the software model and logic set generated by the model development unit 1100 to the client and cause the client's manufacturing production system 100 to generate production plan data so that production operation may proceed.

The system operation unit 110 may manage projects or tasks of the client's manufacturing production system 100, manage triggers (execution conditions) for operating the project or task according to a plan, and change and set the monitoring and performance thereof.

For example, the system operation unit 110 may provide a server management unit 1200, which is a user interface for trigger management, monitoring, and performance changes for operating tasks, so that tasks may be generated and managed through the system operation unit 110. That is, it may be explained that generating and managing tasks is performed through the system operation unit 110 or the server management unit.

For example, the system operation unit 110 may include a user interface (UI) that visually displays to the user the generation and management of tasks and a backend system for the generation and management of tasks.

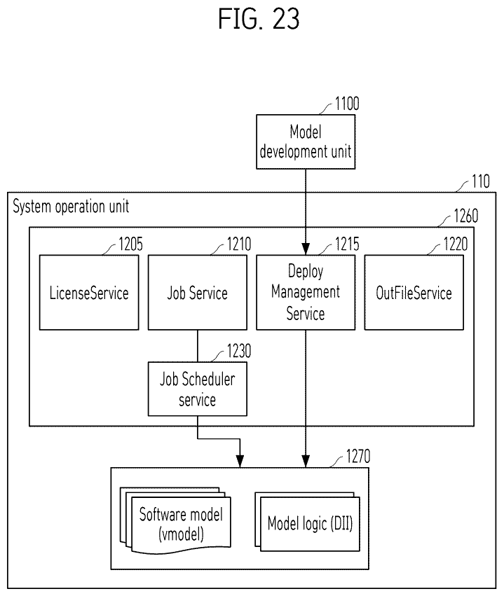

FIG. 23 is a diagram illustrating an example of generating an operational task based on a software model and logic set according to an embodiment.

The system operation unit 110 may generate an operational task based on the uploaded software model and logic set and may set conditions for performing the operational task.

As described above, the model development unit 1100 may obtain (develop) a software model and logic set including pegging logic and simulation logic. For example, a software model may include at least one of a data schema, a data source, a query, or a global variable.

Additionally, the software model and logic set acquired from the model development unit 1100 may be uploaded to the system operation unit 110. As described above, the system operation unit 110 includes a user interface provided to the user, allowing the user to check and control the operation of the system operation unit 110.

The system operation unit 110 may include a service unit 1260 including various services and a history management storage unit 1270.

The service department 1260 may include a license service unit 1205, a job service unit 1210, a deploy management service unit 1215, an outfile service unit 1220, a job scheduler service unit 1230, etc.

The license service (LicenseService) 1205 is a part that manages whether the services allocated to each user have been legally purchased. For example, it may operate by checking whether the license purchased by the user has expired.

The job service (Job Service) 1210 is a part that generates operational tasks, and operational task periods, etc., and the deploy management service (Deploy Management Service) 1215 is a part that uploads files received from the model development unit 1100 to the history management storage unit 1270, and may be set to manage the usage version according to the user's input.

The external file service (OutFile Service) 1220 is a part that allows the results of an operational task to be downloaded externally, and the job scheduler service (Job Scheduler service) 1230 may correspond to a part that executes an operational task edited in the job service unit 1210 according to execution conditions.

In addition, the history management storage unit 1270 may temporarily store software model and logic set required to generate and set an operational task in the system operation unit 110, and may store files related to an operational task. In addition, various setting values (such as data source, operational task list, execution period, dependency conditions for each project) used in the system operation unit 110 may be stored in the history management storage unit 1270 or a separate storage unit.

For example, the deploy management service provided by the deploy management service unit 1215 may store a file in the path for each project to which the deploy subject belongs in the history management storage unit 1270 when deployment (upload) occurs. At this time, the deploy management service unit 1215 may provide history management of software model and logic set by deployment time when storing files.

Here, history management separately manages the version applied to current operations and the version applied to past operational tasks, allowing to use the past or current version as needed. For example, it may be assumed that the software model and logic set of the weekly planning project were uploaded and operational tasks were executed as of January 1. In this case, on February 2nd, logic for a new product was added at the customer's request, and a new software model and logic set were uploaded to run an operational task. At this time, the February 2nd version may correspond to logic that requires additional computings. If the production plan for a new product is canceled on March 3 due to customer circumstances and it is decided to use the January 1 logic instead of the February 2 logic that requires additional computation, the deploy management service unit 1215 may change and execute the January 1 deployment version.

Additionally, operational tasks may be generated through the job service unit 1210 of the system operation unit 110. At this time, operational tasks correspond to tasks required to execute (operate) software model and logic set. The operational tasks (job type) may include three types: sending e-mail, executing a program, and executing a model. In addition, various other execution tasks may be added, such as executing an experiment hub or performing a task for dynamic operation depending on user settings or system settings. Additionally, an operational task may correspond to a unit of job executed by the job scheduler service unit 1230.

The e-mail sending job type includes a task of sending an e-mail in association with the execution of a software model and logic set. For example, such as a sender, a recipient, a subject, a body, and an attachment may be specified as global arguments, and a sending mail server (SMTP) may be configured. Here, global variables may correspond to variables that define option and setting for logic execution. Additionally, when the configured e-mail sending is executed, the e-mail may be sent according to the predefined settings. The e-mail sending job type may be set to send an e-mail when a specific operational task executed for management purposes by the system operation department 110 fails, etc.

A program execution job type may cause a program or script to be executed associated with the execution of a software model and logic set. For example, if the operation of a software model or logic set fails, a verification script may be executed.

The model execution (model task) job type corresponds to a job type for executing a software model developed through the model development unit 1100. The model execution job type contains basic global variables for setting an operation method of the model. As an example, the global variables of a software model stored in the history management storage unit 1270 may be used as basic global variables of a model execution job type.

Additionally, the job service unit 1210 may set execution conditions (triggers) for operational tasks. Here, the execution conditions (triggers) correspond to execution period, dependencies between operational tasks, etc. That is, an operational task refers to a job unit for execution, and an execution condition may refer to detailed conditions such as the execution period and dependencies of an operational task. At least one execution condition may be generated for an operational task, and it is also possible for at least one second execution condition to be generated for a first execution condition. The set execution conditions may be stored in the system operation unit.

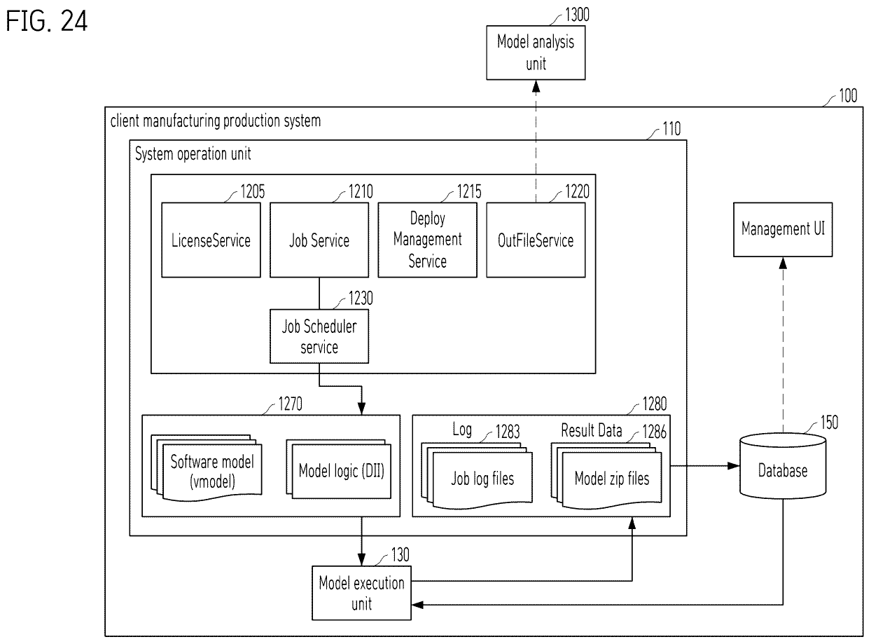

FIG. 24 is a diagram illustrating an example of executing an operational task based on a software model and logic set according to an embodiment.

The model execution unit 130 may execute operational tasks according to execution instructions from the job scheduler service unit 1230.

For example, when an execution condition set for the operation task has been satisfied, the job scheduler service unit 1230 may execute the model execution unit 130 and transfer the software model and logic set as a parameter. At this time, the software model and logic set may include connection information and data table mapping information of data to be extracted from the database 150.

In this case, the model execution unit 130 may receive actual input data from the client database 150 based on the software model and logic set. That is, the model execution unit 130 may retrieve data included in the database 150 of the client system by querying based on the parameter.

In one embodiment, the model execution unit 130 may generate an output file 1286 as an output file 1280 when model execution is performed according to the logic set. As an example, the format of the output file 1286 may be determined according to the setting values of the software model (e.g., added as a parameter when generating a task through the job service unit 1210) and may include a compressed (zip) file format, etc.

At this time, the output file 1286 may include production plan data. Here, the production plan data corresponds to a production plan derived by executing input data received from the client's database on the developed software model and logic set. Additionally, a job log file 1283 regarding the results of executing the operational task may also be generated. At this time, the job log file 1283 may include information about when and how the operational task was executed, whether the execution failed, or whether the execution was successful.

Meanwhile, when an experimental hub task is generated as an operational task, an experimental hub executor is added so that one or more model execution units 130 may be executed in parallel.

The generated output file 1286 and job log file 1283 may be uploaded to the database 150 of the client's manufacturing production system 100. When uploading, it is possible to upload in the form of a model zip file 1286 or to upload without compressing the contents contained in the model zip file 1286.

Meanwhile, the stored output file 1286 and the job log file 1283 may be retrieved in the model analysis unit 1300 by providing the results through the retrieval interface included in the client's manufacturing production system 100 or the out file service unit 1220.

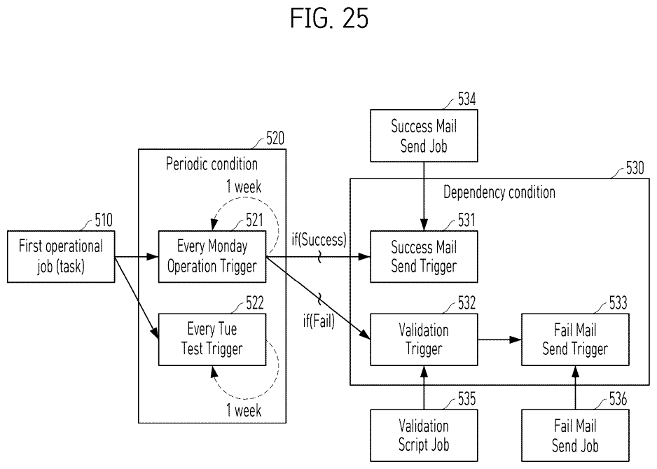

FIG. 25 is a diagram illustrating an example of setting an operational task in a system operation unit according to an embodiment.

The operational tasks generated through the job service unit 1210 may set an execution condition (trigger) for the operational task through the job service unit 1210. This corresponds to setting the conditions for executing operational tasks related to the execution of the developed software model and logic set.

The execution condition set through the execution condition service unit 1225 may be stored in the system operation unit 110.

Additionally, at least one execution condition may be set for one operational task. For example, an execution condition may include periodic condition, dependency condition, etc. Additionally, periodic conditions or dependency conditions may be set between the plurality of execution conditions. For example, at least one second execution condition may be set for a first execution condition. Meanwhile, it is also possible that the second execution condition is not set for the first execution condition and is set to terminate at the first execution condition.

Additionally, even if execution condition is set, whether the execution condition is actually to be executed is included as a parameter. As an example, not only the configuration of execution conditions but also a procedure for setting the activation or deactivation of the execution conditions may be additionally included. For example, even if a periodic condition 520 or a dependency condition 530 is set for the first operational job (task) 510, execution may be performed after first determining whether each execution condition is activated or deactivated.

In an embodiment, two periodic conditions 520 may be set for the first operational job (task) 510. The first periodic condition (Every Monday Operation Trigger) 521 corresponds to the condition of operating the model every Monday. The second periodic condition (Every Tue Test Trigger) 522 may correspond to a condition to test the model every Tuesday. In addition, periodic conditions may be generated in various ways by the system or users.

Additionally, dependency conditions 530 may be generated for at least some of the periodic conditions 520. The first dependency condition (Success Mail Send Trigger) 531 may correspond to a condition for sending a success email, the second dependency condition (Validation Trigger) 532 may correspond to a condition for performing validation, and the third dependency condition (Fail Mail Send Trigger) 533 may correspond to a condition for sending a failure email. In addition, dependency conditions may be generated in various ways by the system or users.

In an embodiment, a dependency condition 530 that depends on the success or failure of the first periodic condition (Every Monday Operation Trigger) 521 may be set. If the first periodic condition (Every Monday Operation Trigger) 521 is successfully performed, the first dependency condition 531 may be set. That is, when actual operation is performed every Monday, a condition is set to send a success email, and accordingly, the task of sending a success email (Success Mail Send Job) 534 may actually be performed. The success e-mail send job 534 may correspond to sending an e-mail among the job types described above.

Additionally, if the execution of the first periodic condition 521 fails, the second dependency condition 532 and the third dependency condition 533 may be set. That is, if actual operation is not performed on Monday of every week, verification is set to be performed for the reason for failure, and verification task (Validation Script Job) 535 may be performed accordingly. The verification task (Validation Script Job) 535 may correspond to program execution among the job types described above.

In addition, when verification is performed, a condition is set to send a failure email without a separate condition for success/failure of the verification, and accordingly, a task of sending a failure email (Fail Mail Send Job) 536 may be performed. Sending a failed e-mail (Fail Mail Send Job) 536 may correspond to sending an e-mail of any of the job types described above.

In this embodiment, the second periodic condition 522 is illustrated as not generating another dependent condition 530, but it is also possible to set another dependent execution condition 530 to be generated. Additionally, it is possible to set additional conditions in addition to the periodic conditions 520 and dependency conditions 530 shown in the first operating job 510.

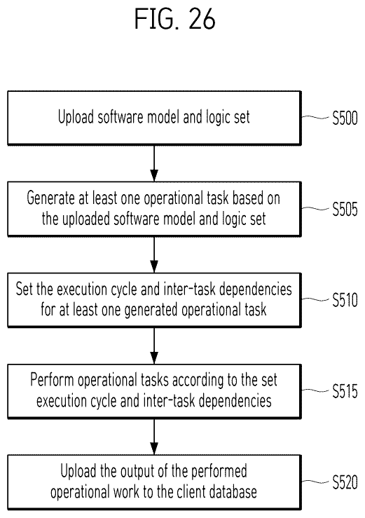

FIG. 26 is a diagram illustrating an example of generating and executing an operational task in an on-premise computing system according to an embodiment.

Although not shown, prior to the generation of an operational task, the user's license eligibility may be checked by the license service unit (LicenseService) 1205.

Software model and logic set may be uploaded to the system operation unit S500. The system operations unit may generate and set operational tasks related to the actual execution of developed software model and logic set. As described above, the software model and logic set acquired in the model development unit 1100 may be uploaded to the system operation unit 110. Additionally, the deploy management service unit 1215 of the system operation unit 110 may store files in a path for each project when storing files.

At least one operational task may be generated based on the uploaded software model and logic set S505. As described above, the at least one operational task (job type) may include sending an e-mail, executing a program, model work, or the like related to the execution of the software model and logic set. Additionally, various tasks such as running an experimental hub may be added to the types of operational tasks.

Next, the execution period and inter-task dependencies may be set for at least one generated operational task S510. As described above, at least one execution condition may be set for one operational task. Additionally, when there are the plurality of execution conditions corresponding to different types, conditions may also be set between the execution conditions. As an example, it may additionally include a procedure for setting whether to activate/deactivate the execution condition in addition to setting the execution condition.

Additionally, operational tasks may be performed according to the set execution period and inter-task dependencies S515. For example, when there is an execution instruction from the job scheduler service unit 1230, the model execution unit 130 may execute an operational task based on input data. At this time, the model execution unit 130 may receive the software model and model file stored in the history management storage unit 1270 as parameters. In addition, the model execution unit 130 may extract actual data from the client database 150 based on parameters and logic (connection information, schema, mapping information, etc.) and execute operational tasks according to the logic set to generate an output file. In addition, log files regarding the execution status of operational tasks may also be generated.

The results of the performed operational work may be uploaded to the database S520. For example, the generated output files and log files may be uploaded to the database 150 of the client's manufacturing production system. Additionally, for example, result from operational tasks may include production plans, operational system logs, etc.

Although not shown, uploaded results may be retrieved in the model analysis unit or in the retrieval interface. For example, output files and log files may be retrieved by the model analysis unit 1300 through a retrieval interface included in the client's manufacturing production system or an external file service unit 1220.

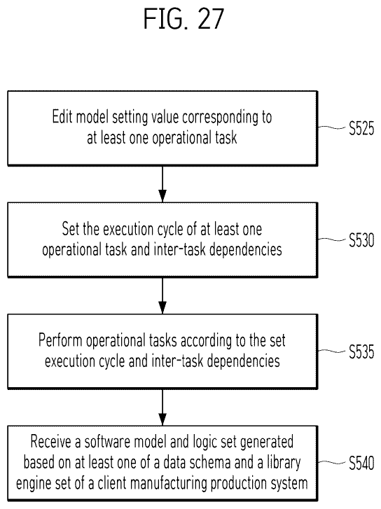

FIG. 27 is a diagram illustrating an example of generating and performing an operational task in a cloud computing system according to an embodiment.

Unlike the on-premise computing system described above, in a cloud computing system, at least one operational task has already been generated, so the procedure of uploading a software model file and logic set file to the job operation unit or generating an operational task may be omitted.

The client manufacturing production system 100 may execute inbound logic that converts the schema of input data stored in the database 150 and upload the converted input data to the cloud database 2500. Additionally, input data including the client's reference information data may be stored in the cloud database 2500 according to the execution of the inbound logic of the client manufacturing production system 100.

The operation management unit 2100 of the cloud computing system may perform the same role as the system operation unit 110 of the on-premise computing system and may include the same components.

First, model setting values corresponding to at least one operational task may be edited S525. As an example, at least one parameter related to at least one operational task in a cloud computing system may be set, including, for example, whether to use a dispatching agent in forward planning, whether to use a weight sum method or a weight sort method when using a dispatching agent, etc. As described above, model setting values may be edited through the operation management unit 2100 of the cloud computing system 2000.

Next, the execution period of at least one operational task and inter-task dependencies may be set S530. As described above, the operation management unit 2100 may set the execution period and inter-task dependencies. In this regard, refer to step S510 of the on-premise computing system.

Additionally, operational tasks may be performed according to the set execution period and inter-task dependencies S535. For example, the model execution unit 2400 of the cloud computing system 2000 may execute an operational task based on input data when there is an execution instruction from the job scheduler service unit of the operation management unit 2100. In this regard, refer to step S515 of the on-premise computing system.

The output of the performed operational work may be uploaded to the database S540. For example, the generated output files and log files may be uploaded to a cloud database 2500 of a cloud computing system.

Additionally, output files and log files stored in the cloud database 2500 may be retrieved from a client system through an outbound API 2710 provided as a user interface.

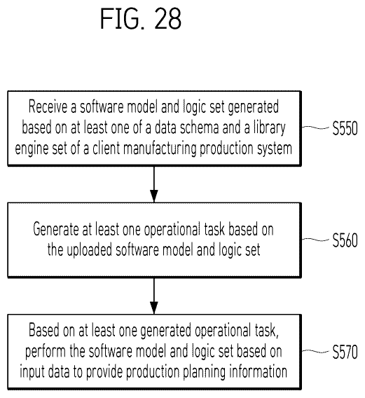

FIG. 28 is a diagram illustrating a method for providing digital production plan information according to an embodiment.

A software model and logic set generated based on at least one of the data schema or the library engine set of a client manufacturing production system may be received from an on-premise computing system S550.

As described above in FIGS. 23 to 25, the software model and logic set generated in the model development unit may be uploaded to the system operation department through the server management unit.

At least one operational task may be generated based on the uploaded software model and logic set S560.

The system operation unit may generate at least one operational task and set execution conditions for the operational task. The operational tasks may include sending e-mails, executing programs, executing models, etc. Additionally, execution conditions may include periodic conditions, dependency conditions, etc.

In the case of cloud computing systems, this step may be omitted, and instead, model setting values corresponding to the operational tasks and parameters of the predefined operational tasks and execution conditions may be edited.

As described above in FIGS. 23 to 27, the system operation unit may execute the model execution unit based on the software model and logic set transmitted through the server management unit.

Based on at least one generated operational task, the software model and logic set may be performed based on input data to provide production plan information S580.

As described above in FIGS. 23 to 27, the model execution unit may execute a software model and logic set based on input data to generate results including production plan information, operating system logs, etc., and upload them to a database of a client system.

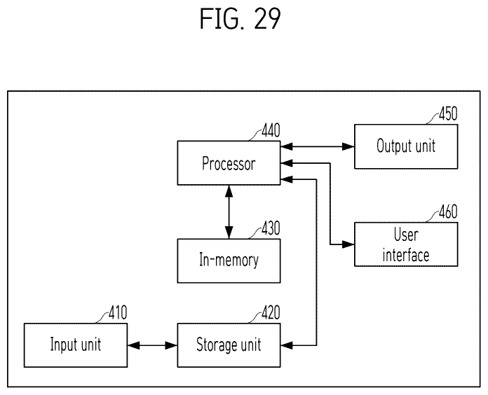

FIG. 29 is a diagram illustrating an embodiment of a device providing digital production plan information.

An embodiment of a device providing digital production plan information may include an input unit 410, a storage unit 420, an in-memory 430, a processor 440, an output unit 450, and a user interface 460. For example, a device that provides digital production plan information may correspond to a client's manufacturing production system.

An embodiment of a device providing digital production plan information below may be controlled by user control and management via a user interface 450.

The input unit 410 may receive a software model and logic set generated based on at least one of the data schema or library engine set of the client manufacturing production system from the on-premise computing system.

The storage device 420 may store pre-prepared reference information or store received software model and logic set. The storage device 420 may include volatile memory or non-volatile memory.

In-memory 430 may store a library engine set disclosed above.

The processor 440 of the embodiment may generate at least one operational task based on the software model and the logic set according to a user's request. Additionally, the processor 440 may set the execution period of at least one operational task and inter-task dependencies, detailed examples of which are disclosed in FIGS. 23 to 28. And the processor 440 of the embodiment may obtain production plan data by executing the received software model and logic set according to a user's request of the user interface 460.

The processor 440 of the embodiment may execute an operational task based on input data according to logic set, and generate an output file and a log file on the execution status of the operational task.

The output unit 450 may provide production plan data based on the execution results of the software model and logic set to enable the client system to manage production or operations.

Through this embodiment, a series of processes may be automatically performed in a manufacturing production system that requires production plans of various levels of detail.

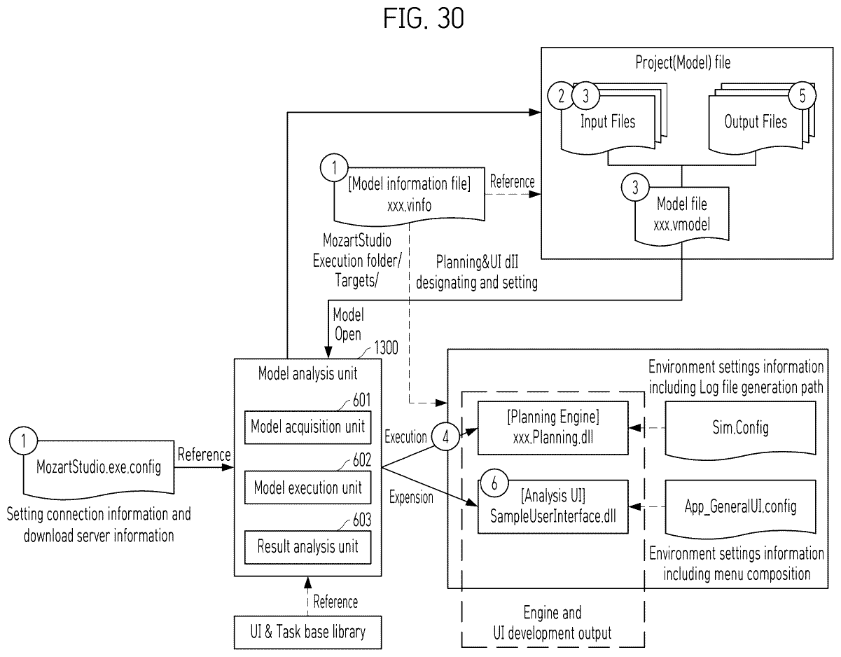

FIG. 30 is a diagram illustrating an example of analyzing a production plan based on a software model and logic set according to an embodiment.

In the illustrated example, the model analysis unit 1300 of the on-premise computing system 1000 provides a frame that may analyze production plans based on software model and logic set.

In an embodiment, the model analysis unit 1300 may include a model acquisition unit 601, a model execution unit 602, and a result analysis unit 603.

The model acquisition unit 601 may acquire a software model and logic set for a client manufacturing production system. In an embodiment, the model acquisition unit 601 may acquire a software model and logic set including input data and output data after calculating a production plan from an operation server or a server management unit.

In an embodiment, the model acquisition unit 601 may acquire a software model and logic set based on model analysis unit configuration information (e.g., exe. config) including at least one of software automatic update information of the model analysis unit 1300, log file storage information, connection information for an operation server or server management unit, or model download service path information.

In an embodiment, the model acquisition unit 601 may acquire a software model (e.g., xxx. vmodel) based on a pre-stored model information file (e.g., xxx. vinfo). In this case, the model information file may include at least one of the assembly information of the simulation logic file (Dll), the configuration file path of the simulation logic file, the assembly information of the user interface (UI) logic file, or the configuration file path of the user interface logic file. In an embodiment, the model information file may be a separate file from the software model, or may be included in the software model and configured as a single file.

In an embodiment, the model acquisition unit 601 may acquire a software model and logic set generated by the model development unit. In this case, the software model and logic may include input data prior to generating production plan.

The model execution unit 602 may generate production plan related data based on the software model and logic set. In an embodiment, the production plan related data may include at least one of model information, experimental plan information, or experimental result information.

In an embodiment, the model execution unit 602 may execute the logic set for a software model based on a configuration file (e.g., Sim. config) of the simulation logic file. Here, the configuration file of the simulation logic file may indicate at least one of a folder for recording simulation logs according to experiment execution, a format of the log file, or a memory caching setting used in the simulation.

The results analysis unit 603 may provide data related to production planning. In an embodiment, the result analysis unit 603 may provide production plan related data through various screens via a user interface. This is explained in more detail below.

In an embodiment, in an embodiment, the result analysis unit 603 may provide data related to the production plan as an analysis result through an analysis user interface based on a configuration file (e.g., App_GeneralUI. config) of the user interface logic file. Here, the configuration file of the user interface logic file may indicate at least one of the menu configuration information of the analysis user interface, assembly connection information of the menu and the executable file, or screen setting information of input/output data.

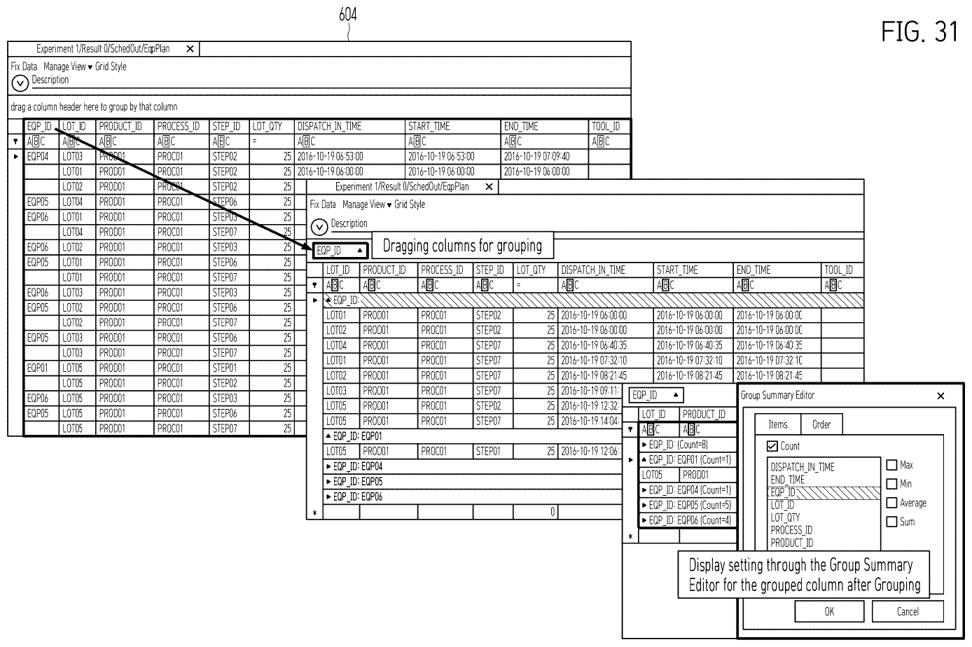

FIG. 31 is a diagram illustrating an example of a data retrieval screen according to an embodiment.

In the illustrated example, a data retrieval screen 604 may be provided through the user interface of the model analysis unit 1300 according to the present disclosure. Here, the data retrieval screen 604 may display data related to the production plan of the client manufacturing production system. For example, the production plan related data may include at least one of input data and output data for the production plan of the client manufacturing production system.

In an embodiment, data items (i.e., fields) of input data and output data included in production plan related data may be displayed in a grid format on a data query screen 604. In this case, the grid may be formed in a matrix of rows and columns. For example, columns in a grid may include, but are not limited to, equipment ID (EQP_ID), lot ID (LOT_ID), product ID (PRODUCT_ID), and job ID (PROCESS_ID).

In an embodiment, data retrieval, data copy, data filtering, data sorting and grouping functions may be performed on data included in the grid based on user input to the data retrieval screen 604. For example, a drag input for a column may be used to group the corresponding drag area, and display settings for the grouped column may be performed through the group summary editor for the grouped column. In an embodiment, the display settings may represent a summary value of the settings for that group. For example, the display settings may include at least one of the number of rows corresponding to the relevant group, and an average, a maximum, a minimum, or a sum for numeric columns other than the grouped columns.

Additionally, in an embodiment, the position of a column within the grid may be changed based on user input for that column in the data retrieval screen 604. For example, you may move the position of the job ID column (PROCESS_ID) from the right to the left of the PRODUCT_ID column by clicking and dragging the input for the PROCESS_ID column. Therefore, according to the present disclosure, visibility may be improved in observing correlations between columns by changing the positions of the columns. That is, when the number of columns is large and data exceeding the data retrieval screen 604 occurs, the location of the columns may be changed to provide convenience in data analysis to the user.

In an embodiment, the plurality of data tables in grid form may be joined to retrieve the corresponding data. In an embodiment, various forms of data may be imported or exported to the software model. For example, you may import data in the form of an Excel file or text file, or extract data in the form of an Excel file, text file, HTML, XML, Rtf, Pdf, or MHT file.

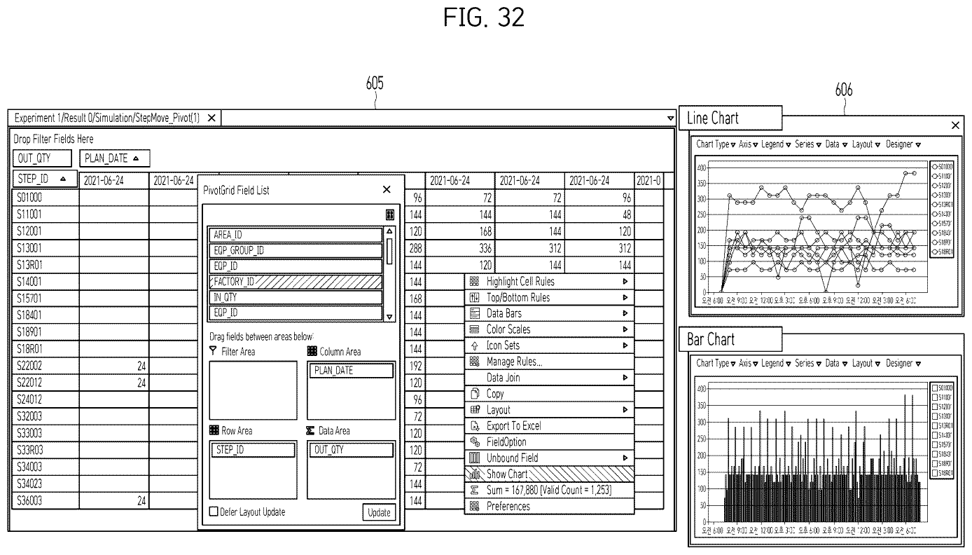

FIG. 32 is a diagram illustrating an example of a pivot grid retrieval screen according to an embodiment.

In the illustrated example, a pivot grid retrieval screen 605 may be provided through the user interface of the model analysis unit 1300 according to the present disclosure. Here, the pivot grid retrieval screen 605 may display data related to the production plan of the client manufacturing production system in the form of a pivot grid.

In an embodiment, a filter area, a column area, a row area, and a data area may be set through the pivot grid retrieval screen 605 to selectively check data values for data items requiring analysis.

For example, if the column area is set to the production plan date (PLAN_DATE), the row area is set to the operation ID (STEP_ID), and the data area is set to the production quantity (OUT_QTY), you may check the production quantity by each operation for each production plan date as a number.

In an embodiment, a data analysis chart screen 606 may be provided. Here, the data analysis chart screen 606 may display data generated using a pivot grid in the form of a chart. For example, chart types may include, but are not limited to, line charts, bar charts, point charts, and area charts, and various types of charts may be used.

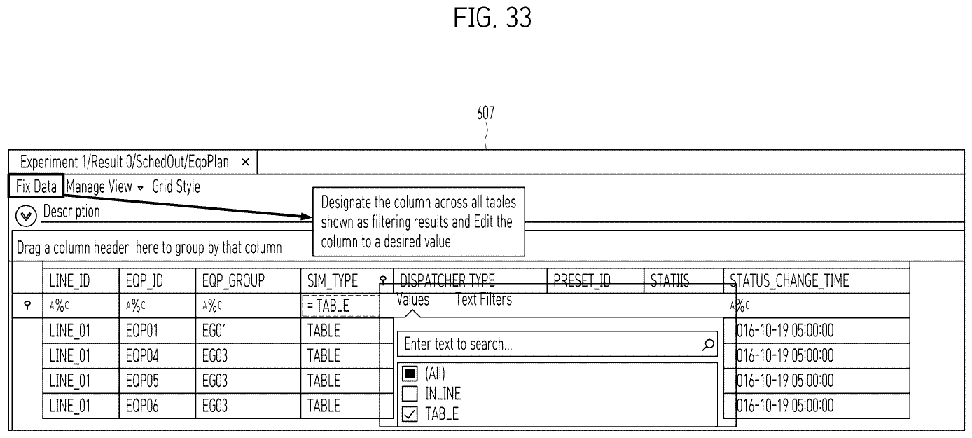

FIG. 33 is a diagram illustrating an example of a data editing screen according to an embodiment.

In the illustrated example, a data editing screen 607 may be provided through a user interface of a model analysis unit 1300 according to the present disclosure. Here, editing of production plan related data may be performed through data editing screen 607.

In an embodiment, each data item of production plan related data displayed in a grid format on a data editing screen 607 may be edited by user input. In an embodiment, filtering may be performed on the data editing screen 607, and batch modifications may be performed on the filtered data. For example, if you select at least one column of filtered data and enter a value, the data items in the selected column may be bulk updated to that value.

For example, if you select the LINE_ID column and enter LINE01 as the value of that column, the values of each column in the LINE_ID column may be batch-edited to LINE01. Also, as another example, the LINE_ID in the EQP table may be filtered to LINE01, and the STATUS may be batch modified to UP.

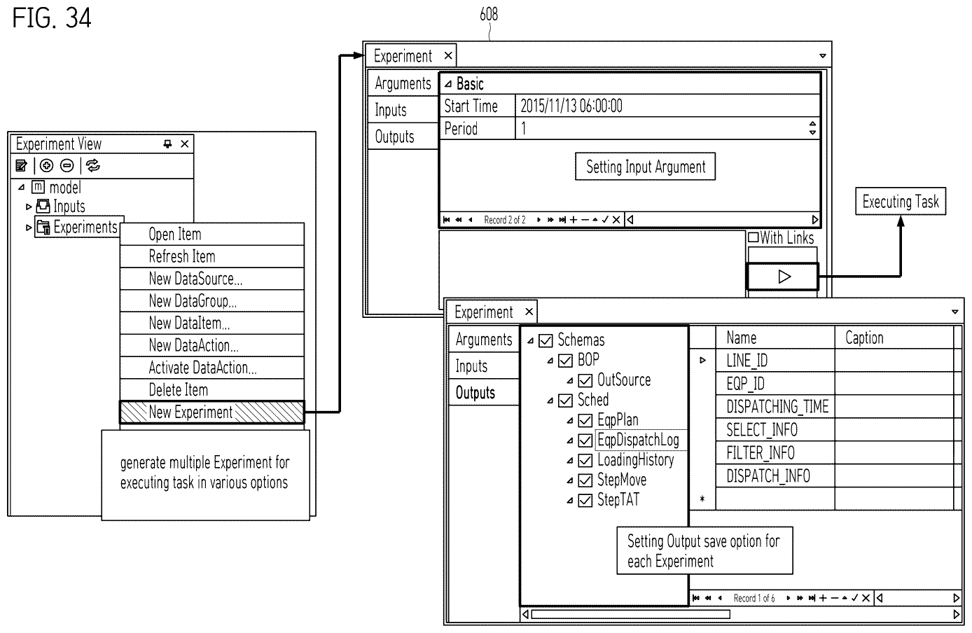

FIG. 34 is a diagram illustrating an example of an experimental setup and execution screen according to an embodiment.

In the illustrated example, an experiment setup and execution screen 608 may be provided through a user interface of a model analysis unit 1300 according to the present disclosure. Here, the experiment setup and execution screen 608 may include at least one of experiment plan information or experiment result information according to experiment execution.

In an embodiment, an experiment including at least one scenario may be generated, and experimental plan information for the experiment may be set. In an embodiment, the experimental plan information may represent an experimental plan for one scenario corresponding to an input data table viewable through the experiment setup and execution screen 608 among at least one scenario included in the experiment. In this case, there is one experimental plan corresponding to each scenario, and as the experiment is executed, the experimental results for the scenario may be added to the experiment one by one. In an embodiment, the experimental plan information may include at least one of global argument setting information, input data, input setting information, or output setting information.

In an embodiment, the global argument setting information may include global arguments for at least one of parameters such as a version of a software model, an experiment start time, a backward planning engine, a forward planning engine, a debug or a job change agent. Additionally, the output setting information may indicate a storage method for results generated as the experiment is performed.

In an embodiment, the input setting information may indicate a data collection order according to an input data schema. For example, input setting information may include a data collection order editing function among input persist configuration information.

In an embodiment, an experiment may be executed in a local environment based on set experimental plan information to generate experimental result information. In an embodiment, the generated experimental result information may be saved according to the output save option. In an embodiment, the global argument setting information may include the results of a previously performed experiment based on the currently acquired software model or global argument setting information corresponding to a different version of the software model.

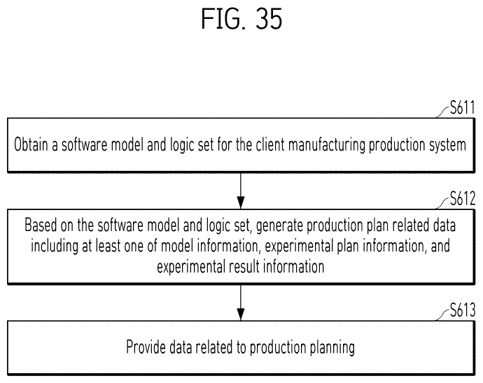

FIG. 35 is a flow chart illustrating an example of analyzing a production plan based on a software model and logic set according to an embodiment.

A software model and logic set for the client manufacturing production system is obtained S611. In an embodiment, the software model and logic set may be obtained including at least one of input data or output data for a production plan of a client manufacturing production system. In this regard, reference is made to the descriptions above.

Based on the software model and logic set, production plan related data including at least one of model information, experimental plan information, or experimental result information is generated S612. In an embodiment, the model information may include at least one of a data schema for the software model, a data source for input data, a query for the data schema, or a global argument.

In an embodiment, the experimental plan information may include at least one of experimental setting information for input data and output data and experimental global arguments before performing an experiment based on the software model and logic set.

In an embodiment, the experimental result information may include input data and output data resulting from performing an experiment based on the experimental plan information using the software model and logic set. For this, reference is made to the contents described in FIGS. 30 to 34.

Data related to production planning is provided S613. In an embodiment, the production planning related data may include output generated by performing an experiment including at least one scenario set by changing input data of a software model. For this, reference is made to the descriptions described in FIGS. 30 to 34.

Referring to FIG. 8, an embodiment of a device for analyzing a production plan based on a software model and logic set and providing digital production plan information is described as follows.

An embodiment of a device providing digital production plan information may include an input unit 310, a storage unit 320, an in-memory 330, a processor 340, an output unit 350, and a user interface 360.

An embodiment of a device providing digital production plan information below may be controlled by user control and management via a user interface 360.

The input unit 310 may obtain a software model and logic set for the client manufacturing production system. The storage device 320 may store the software model and logic set received by the input unit 310 or store the software model and logic set in the storage device 320. The storage device 320 may include volatile memory or non-volatile memory. In-memory 330 may store the set of library engines disclosed above. A library engine set may contain a production planning engine, which is a number of encapsulated function block files that generate production plans.

The processor 340 of the embodiment may obtain a software model and logic set for a client manufacturing production system, and based on the software model and the logic set, may generate production plan related data including at least one of model information, experimental plan information, or experimental result information, and may provide the production plan related data. For further details, reference is made to the descriptions above.

The processor 340 may obtain production plan data by testing or pre-executing the software model and logic set according to a user's request through the user interface 360. And the processor 340 may analyze or test the software model and logic that generates production plan data according to the user's request and provide the results to the user through the user interface 360. For further details, reference is made to the descriptions above.

The output unit 350 may provide analysis result data of a software model and logic set and result data of an experiment performed based on the software model and logic set to enable management of production or operations in a local environment and client system.

The following examples detail an example of providing production plan data via an experiment hub using a software model and logic set generated based on an installed library engine set.

As described above, when the system operation unit 110 of the client's manufacturing production system 100 receives the software (SW) model and model logic developed by the model development unit 1100 through the server management unit 1200, it receives input data including reference information data from the database 150 and may use this to execute the received software model and logic set to generate production plan data.

When generating production plan data using a single software model and single logic, the production plan data may be provided through the model execution unit 130. In this case, the model execution unit 130 may execute the software model and model logic and generate production plan data to provide production plan data that may be analyzed by the model analysis unit 1300.

On the other hand, there may be cases where running a single software model alone is not sufficient for the task. In this case, it is necessary to automatically execute the plurality of tasks through the introduction of the plurality of software models and external logic. For example, when the plurality of software models or logics are used, they may be performed through experiment hub 140 that includes the plurality of experiments.

An experiment hub is a collection of data that stores information and experimental results required to conduct various experiments using at least one software model and at least one model logic. In addition, the experimental hub unit 140 corresponds to a configuration for retrieving, editing, executing, and analyzing the experimental hub described above.

In the disclosed embodiment, an example of performing a complex task based on the experimental hub unit 140 is described.

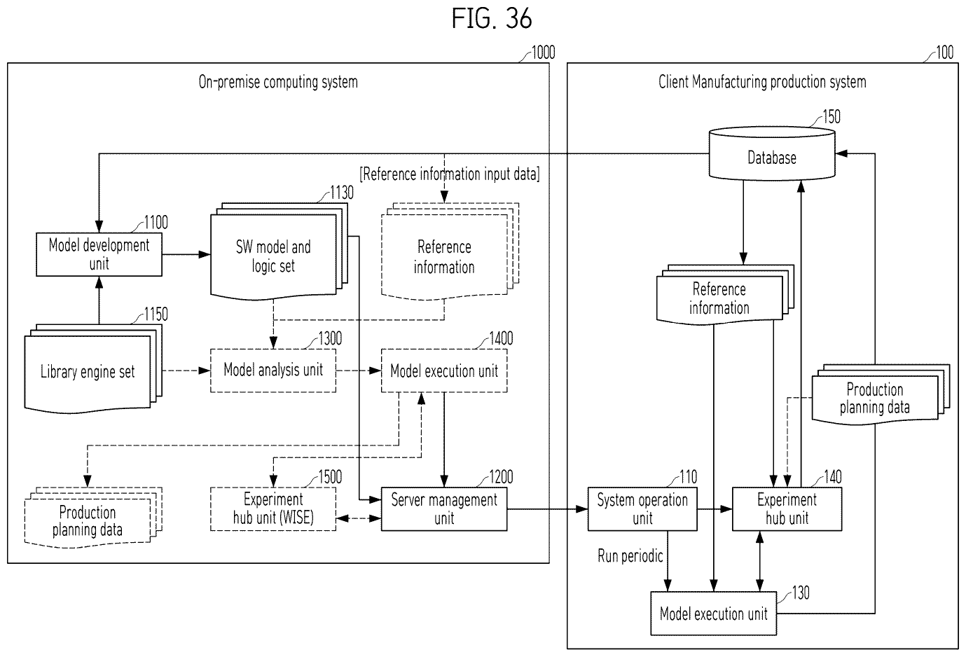

FIG. 36 discloses an embodiment of a computing system that provides digital production plan data according to an embodiment.

This figure discloses an embodiment of an on-premise computing system that provides digital production operations data. In this embodiment, the on-premise computing system 1000 and the manufacturing production system 100 may further include an experimental hub unit in the embodiment of FIG. 2 described above.

In an embodiment, a client's manufacturing production system 100 that executes a production plan in a manufacturing production system, etc., provides input data including reference information for production execution to an on-premise computing system 1000, and a model development unit 1100 may generate a software model and model logic.

The server management unit 1200 transmits the software model and model logic generated by the model development unit 1100 to the client, and the system operation unit 110 of the client 100 may define, reserve, register, and execute tasks related to the execution of the software model and model logic.

In an embodiment, the manufacturing production system 100 includes a system operation unit 110 that operates and manages the manufacturing process as a whole, a model execution unit 130 that generates production plan data in response to an execution request from the system operation unit 110, an experiment hub unit 140 that requests the model execution unit 130 to perform various experiments, and a database 150 that stores production plan data that is the execution result of the model execution unit 130.

As described above, the experiment hub is a collection of data that stores information and experimental results necessary to conduct various experiments using at least one software model and at least one model logic. The on-premise computing system 1000 and/or the client manufacturing process system 100 may include an experimental hub 140, 1500. In addition, the experimental hub unit 140, 1500 includes an experimental hub editing unit, an experimental hub execution unit, and an experimental hub analysis unit to search, edit, and execute the experimental hub, and this will be described below.

The experimental hub 140, 1500 may design experiments including various scenarios based on at least one software model and at least one model logic, and perform experiments based on input data prepared in advance in the database 150 to provide production plan data. Production plan data may correspond to experimental results, including experimental summaries and scenario results.

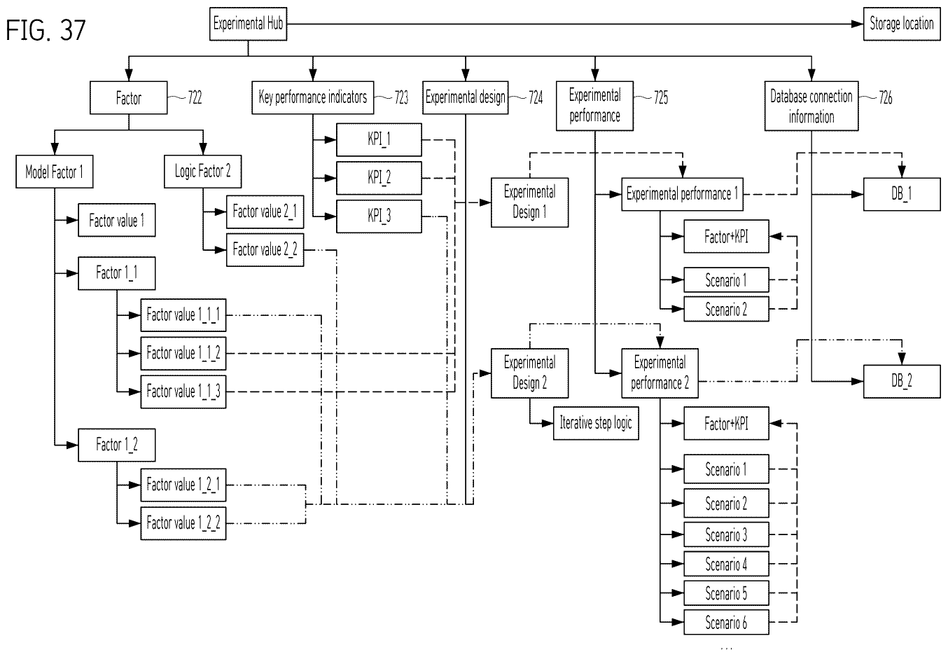

FIG. 37 is a diagram illustrating an example of the basic structure of an experimental hub based on a software model and logic set according to an embodiment.

As illustrated, the experimental hub corresponds to a collection of information including factors 722, key performance indicators 723, experiment design 724, experimental performance 725, and database connection information 726.

Factor 722 is a type of information that specifies a changeable element to be used in an experiment. A factor value is the value of information that a specific variable represents to be used in an experiment.

A factor may include at least one model type factor and at least one logic type factor, and each model type factor or logic type factor may have its own factor value, and may also have a lower level factor value, including a lower level factor.

Key Performance Indicator KPI 723 corresponds to a function for processing and quantifying individual scenario results. A key performance indicator may have its own value, the key performance indicator value. The key performance indicator value (KPI value) corresponds to the actual value obtained by applying the formula applied to the key performance indicator to the scenario results through experimental performance.

Meanwhile, a scenario represents one set of software models ready to be executed using determined logic, with determined factor values as input. The scenario result is the result obtained by executing the scenario and may be displayed in table form. An experiment is a unit that contains the plurality of scenarios. For example, referring to the figure, an experiment designed through Experiment design 1 corresponds to an experiment that includes two scenarios.

Experiment design 724 corresponds to a structure that includes information on combinations of scenarios to be performed using variables and key performance indicators. For example, experiment design 1 of this embodiment may correspond to a combination of two scenarios including variable values 1_1_2 and 1_1_3 of model variable 1_1 in a fixed-size experiment design. In addition, the experiment design 2 of this embodiment is an iterative experiment design, and may correspond to six or more scenario combinations including factor value 1_1_1 of model factor 1_1, factor value 1_2_1 of model factor 1_2, factor value 1_2_2, factor value 2_2 of logic factor 2, key performance indicator KPI_3, and iteration logic, but is not limited thereto and may increase or decrease. The fixed-size experiment design and the iterative experiment design are described below.

In addition, experiment execution 725 is a structure in which individual scenarios are generated based on an experiment design, factor values are changed and executed, and then key performance indicators are calculated and stored from the results, and may include experimental results as execution results. For example, an experimental summary might correspond to a table containing factor values and key performance indicator values. Additionally, experimental results may include experimental summaries and scenario results. Here, the scenario results may include output data, including result data from running a single model, log data, etc.

For example, the experiment execution 1 of the present embodiment may include an experiment summary, which is a set of at least one variable value and at least one key performance indicator value, as a result of executing an experiment by changing factor values for two scenarios according to the experiment design 1. Additionally, the results obtained through executing experiments may be uploaded to the database according to the DB connection information. When using the experimental hub described above, the plurality of model logics may be performed in a single experiment, rather than changing the factor values of a single model logic for the plurality of times through the model execution unit, so complex tasks may be performed more efficiently.

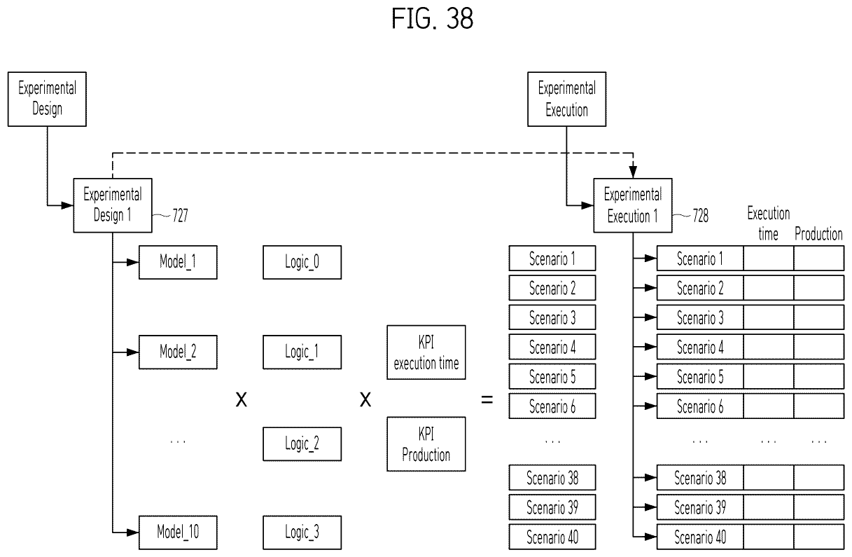

FIG. 38 is a diagram illustrating an example of generating an experimental hub file based on a software model and logic set according to an embodiment.

First, the experimental hub unit 140 may generate an experimental hub file. At this time, the experimental hub file corresponds to the target file that will later register and generate factors related to the model and logic. Additionally, the storage path (storage location) may be given as a parameter when generating an experiment hub file. At this time, the path may be an absolute path or a relative path on the software operating system (OS). For example, after the experiment hub file is generated, the storage location of edited information is managed by default using the relative path to the experiment hub file, but an absolute path may also be designated.

Experiment hub files may store both edited information and execution results, and may also be managed by splitting them into separate files. For example, factor information and factor value information may be saved as separate files from the execution results, so that factor information and factor value information may be loaded and reused in other experiment hub files. Additionally, only the result files for each experimental unit may be output, and retrieved separately from the experimental hub file that contains the edited information.

After an experiment hub file is generated, at least one model type factor and at least one logic type factor may be registered in the generated experiment hub file. For example, each model and logic may be registered as a factor. In this case, the factor value of the model type factor corresponds to the model itself at the time of registration, which is an information set that includes input data, output data, logic, etc. Additionally, the factor value of the logic type factor may correspond to an absolute/relative path or a compressed file including an absolute/relative path where logic files to be used together with the model are in the model execution unit 130.

For example, referring to FIG. 38, it may be assumed that a situation is proposed a dispatching logic has been improved and proposed in three versions in a specific logic. Logic_0 represents the original logic, and logic_1 to logic_3 represent improved logic. A user may want to check the execution time of logic and the planned production quantity in the past 10 models of the manufacturing production system and reflect the three versions of logic that performed well. The experiment design reflecting this corresponds to Experiment design 1 of FIG. 38.

In this case, after registration for the key performance indicators in the future is completed, a decision may be made by reviewing the results of an experiment that includes a total of 40 scenarios which consist of four logic versions (original logic and three improved logics) and ten past models. For example, if the results of the experiment show that the operating time is shortened and the production volume is increased in Scenario 1, the user may make a decision to use the logic version corresponding to Scenario 1.

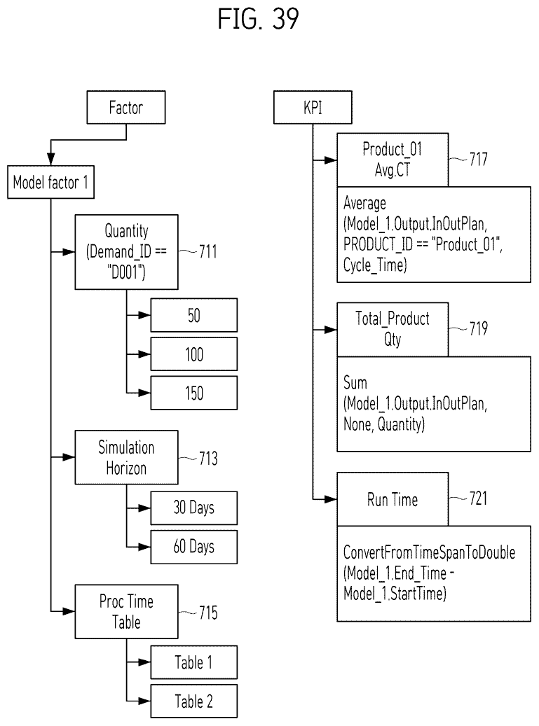

FIG. 39 is a diagram illustrating an example of generating an experimental hub file based on a software model and logic set according to an embodiment.

More specifically, FIG. 39 is a diagram illustrating an example of registering data type factors, factor values, and key performance indicators in an experimental hub file. Data type factors are sub-concepts of model type factors and may be defined dependently according to the data defined in the model type factors. Additionally, factor values may include values of model type factors and values of data type factors. The factor value of model factor 1 in FIG. 37 corresponds to the model as a value of the model type factor.

As an example, a data type factor may be any individual data that exists in the input data of a software model. For example, individual data may be specified by the name of a model argument. Additionally, a single cell may be specified in the data table via the key and target columns that exist in the data schema. In this case, factor values may be determined according to the type of individual data. Data types may include not only numeric data, but also character data, date data, etc.

For example, in the Demand table of Model 1, Demand_ID/Quantity is given as quantity, Demand_ID is the Key, and the target column is quantity, and if the data is given as Demand_1/100, Demand_2/200, Demand_3/100, then the quantity that satisfies the condition of Demand_ID==“Demand_1” may be specified in one cell.

As another example, a data type factor may target all input data tables of the model. In this case, the factor values may correspond to data tables, and the schema of the data table may be determined according to the original data schema. For example, a data table may have at least one data cell value modified from the original data table. Additionally, data tables may be editable by importing external files, or batch-changing all data corresponding to a key condition, etc.

For example, in FIG. 39, the data type variables of model variable 1 may include quantity (Quantity) 711, simulation horizon (Simulation Horizon) 713, and processing time table (Proc Time Table) 715. For example, quantity 711 is a single-cell factor, and three factor values of 50, 100, and 150 may be generated. For example, the simulation horizon 713 is a global argument, and two factor values of 30 days and 60 days may be generated. In addition, for example, the processing time table 715 as a table factor, may generate two factor values: Table1 and Table2.

Key performance indicators KPIs may include function information for processing the information contained in scenario input data and output. In addition, registered model type factors and data type factors in various functions, all types of data included in the model (global arguments, input/output data), and other key performance indicators may be used as parameters. The values of key performance indicators are numeric data and may include single numeric values (scalar) and vector values.

For example, a key performance indicator may be specified as a parameter, such as whether a higher value is better or a lower value is better, and this may be used later when indicating improvement points through the experimental hub analysis unit of the experimental hub unit or a separate result retrieval user interface, and when determining color distinction, arrow direction, etc.

When more than one KPI is included, there is a calculation order between the KPIs, and this may be editable, as different KPIs may be used as parameters. For example, it may be assumed that the weight sum of three numerical values-production quantity, number of equipment replacements, and quantity of delivery delays—is derived in order to represent a single indicator, i.e., a comprehensive score, in the production plan evaluation. In this case, the three key performance indicators, the production quantity, the number of equipment replacements, and the quantity of delivery delays, must be registered first, and the comprehensive score may also be considered a key performance indicator. At this time, the independent key performance indicators such as production quantity, number of equipment replacements, and quantity of delivery delays may be calculated first, and then the comprehensive score, which is a dependent indicator, may be calculated.

Meanwhile, if weekly production, monthly production, and quarterly production are key performance indicators, independent indicators may be calculated first, and then dependent indicators may be calculated. In this embodiment, the weekly production volume may be calculated first, and then the monthly production volume affected by the weekly production volume may be calculated, and further, the quarterly production volume may be calculated after the monthly production volume is calculated. Previously calculated key production indicator values may be used as parameters in the arithmetic formula for the next key production indicator, thus avoiding duplicate calculations.

Additionally, the functions provided in the key performance indicators may support table summaries/arithmetic expressions/data type conversions, etc. For example, summary functions include, but are not limited to, Sum, Count, Avg, Min, Max, and Std. Also, for example, mathematics includes, but is not limited to, addition, subtraction, multiplication, division, ceiling, floor rounding, roots, squares, logarithms, etc. For example, data type conversion may include converting a date format to an integer format.

For example, referring to FIG. 39, the key performance indicator is the average product production time (Product_01 Avg. CT) 717, total product quantity (Total Product Qty) 719, and running time (Running Time) 721. For example, the average product production time 717 is the average cycle time from when Product 01 enters the factory to when it leaves, and may include function information such as Average (Model_1. Output. InOutPlan, PRODUCT_ID==“Product_01”, Cycle_Time). For example, the total product quantity 719 may include function information such as Sum (Model_1. Output. InOutPlan, None, Quantity) by looking at the production records of all products to calculate the total sum of production quantity. In addition, for example, the running time 721 is converted into numerical data by subtracting the start time from the completion time to obtain the execution time, and may include function information such as ConvertFromTimeSpanToDouble (Model_1. End_Time-Model_1. StartTime).

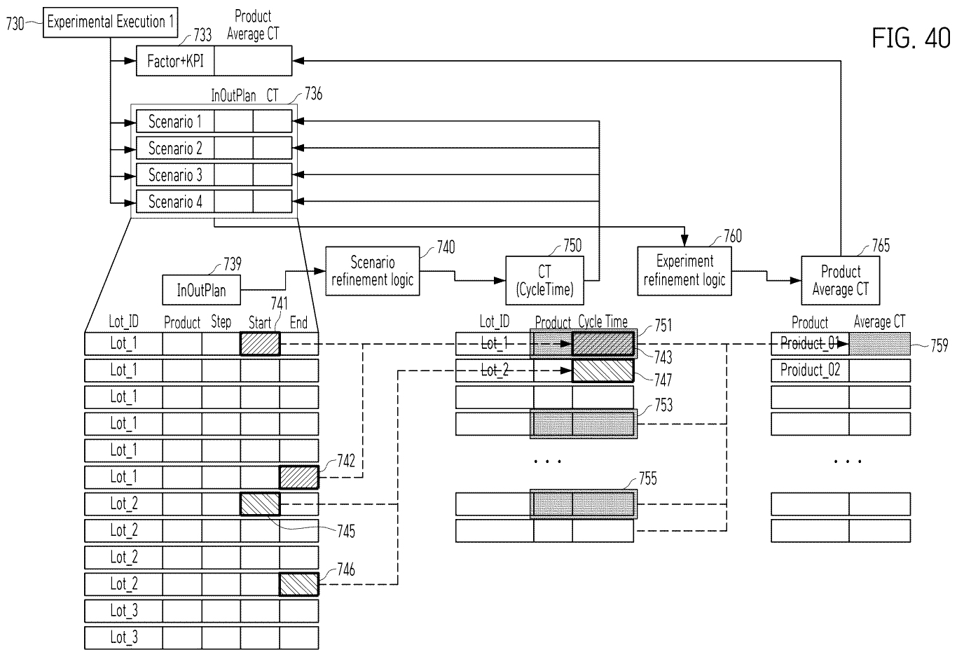

FIG. 40 is a diagram illustrating an example of generating refinement logic from an experimental hub file based on a software model and logic set according to an embodiment.

In order for a user to use a desired model, the software model and model logic are usually developed in the model development unit 1100. However, as an exception, another engineer performing the experiment hub may want to check some additional information while reviewing the model, even though the model and logic cannot be edited through the model development unit 1100. In this case, refinement logic may be utilized, and this embodiment describes an example in which a scenario sets result refinement logic for each scenario or experiment.

The refinement logic may include result refinement logic for each scenario and result refinement logic for each experiment. The refinement logic is not a mandatory component and may be used when the desired result cannot be obtained with the existing schema defined in the model file.

As an example, the result refinement logic for each scenario could refine the scenario result at the end of each scenario and generate a new table. In this case, by allowing data to be stored in a separate schema, it is possible to generate a schema and input data externally without going through the model development unit 1100. At this time, the data used is limited to the data included in the results for each scenario. For example, referring to FIG. 40, it is assumed that the model development unit 1100 has a model output schema in which the input time and completion time (InOutPlan) 739 of each work item by each process exist, but the time (CycleTime (CT)) taken for the work item to enter and leave the factory is not recorded. In this case, the CycleTime (CT) table is generated using the result refinement logic for each scenario, and the job ID, job type, and cycle time are generated as a schema. For example, the CycleTime 743 of Lot_1 is the difference between the first process time 741 and the last process time 742 of Lot_1, and the CycleTime 747 of Lot_2 is the difference between the first process time 745 and the last process time 746 of Lot_2.

Additionally, tables generated by result refinement logic for each scenario may be used as parameters for key performance indicators. For example, referring to FIG. 40, a custom schema may be generated and data may be entered to output the Cycle Time for each work item as the time difference between the start time of the first operation and the completion time of the last operation for each lot by referring to the InOutPlan of each scenario. Additionally, this may be used as a key performance indicator to quantify the maximum and average cycle times for each scenario.

Additionally, at the end of each scenario execution, the time difference between the input time of the first operation and the completion time of the last operation for each work item may be calculated and a table may be inserted into a new cycle time schema to provide a new table in the scenario results. As illustrated in FIG. 40, when executing the scenario refinement logic 740 for scenario 1, a CycleTime table 750 may be generated and each CycleTime data 743, 747 may be added. If the scenario refinement logic 740 is executed for all scenarios, not just scenario 1, the acquired CycleTime data may be added to the results for each scenario 736.

As another example, the results refinement logic for each experiment may produce result other than the combinations of factors and key performance indicators that are basically provided.

For example, referring to FIG. 40, it is assumed that all scenarios are performed and that cycle time tables for all scenarios are generated through refinement logic. In this case, an average cycle time table may be generated through the result refinement logic for each experiment and input the work item type and average cycle time into the schema. Additionally, the cycle time table of all scenarios may be read to obtain the average cycle time for each work item type, and then an average cycle time table may be provided.

When executing the experimental refinement logic 760, an average CycleTime table 765 may be generated and average CycleTime data 759 for each product may be added. For example, the average Cycle Time could be the average of the Cycle Times 751, 753, 755 for the entire lot per product. When the experimental refinement logic 760 is executed, the obtained average Cycle Time data may be added to the experimental results 733.

For each scenario, or experimental refinement logic allows users to obtain additional results that are not included in the schema defined in the model file by the model development unit.

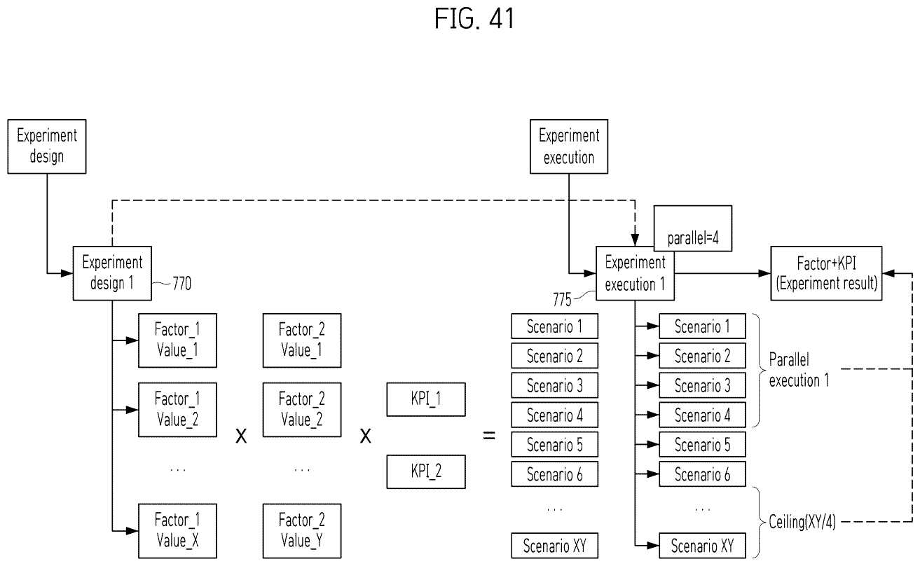

FIG. 41 is a diagram illustrating an example of generating an experimental hub file based on a software model and logic set according to an embodiment.

Once at least one model type factor and at least one logic type factor are registered, and the related model variables, variable values, and key performance indicators are registered, an experiment may be designed and the designed experiment may be performed.

As described above, the experiment design may be designed using the factor and key performance indicator information registered in the experimental hub file. For example, an experiment design represents setting combinations of factor values and key performance indicators. Additionally, experiment designs may include fixed-size experiment designs and iterative experiment designs. Fixed-size experiment design is an experiment design that designs experiments using combinations of pre-registered factors and factor values, and corresponds to an experiment design in which the number of possible scenarios that may occur is known before the experiment is conducted.

Experiment execution refers to generating a scenario based on the information included in the experiment design, executing the experiment hub file, and then outputting the results. For example, the experiment hub execution unit of the experiment hub unit 140 generates the plurality of scenarios based on the information entered in the generated experiment hub file and transmits a file corresponding to each scenario as a parameter to the model execution unit 150 so that it may be executed. After the model execution unit 150 performs the plurality of scenarios, the experiment hub execution unit may calculate key performance indicators for each scenario and collect them as an experiment summary.

The result may include information about factors and factor values for the start time and the completion time of the scenario, key performance indicators, and values of the key performance indicators. Additionally, the experimental execution may include the number of parallel executions as a parameter. The number of parallel executions refers to the number of scenarios that may be performed simultaneously when performing an experiment. For a fixed-size experiment design, if the number of scenarios is N and the number of parallel executions is M, the total number of executions is Ceiling(N/M), which is N divided by M and rounded up. Here, the number of parallel executions may be set to the number of physical cores of the CPU, and may also be set by the user.

For example, referring to FIG. 41, experiment design 1 770 is a fixed experiment design and may be composed of a combination of factor values and key performance indicators. Based on the combination of factor values and key performance indicators in Experiment design 1 770, it may be confirmed that the number of all possible scenarios is XY. In this case, a user interface may be provided that shows a preview of all XY scenarios and allows the user to optionally delete/edit them to confirm the experiment. For example, you may change the order of experiments through the interface. In addition, Experimental execution 1 775 may be executed by generating XY scenarios based on the information included in Experiment design 1 770 and dividing by the number of parallel executions 4 776 and rounding up to Ceiling(XY/4) times.

Meanwhile, fixed-size experiment designs may involve status where both factors and factor values are fixed. As an example, assume a case where, when receiving orders from a customer, an expected production scenario is provided considering the quantity of orders received up to the present. For example, if orders for three products, A, B, and C, have been received for 100, 100, and 100 respectively by January 30, an existing customer may request that product A be produced in as much quantity as possible in addition to the existing order quantity. From the perspective of generating a production plan, you need to be able to explain to the customer how much additional product A you may produce and by when. In this case, by setting the quantity of product A as a factor among the quantity of orders received by January 30 for products A, B, and C, and increasing it by 10 from 100 to 300, then 21 scenarios are generated and executed to derive the quantity of unsatisfactory delivery dates and the total production quantity for each product. Once this information is provided to the customer, if the overall production quantity no longer increases and the unsatisfactory delivery quantity for each product is below a certain level, the customer may decide that X additional units of product A may be produced by January 30th. Similarly, by providing information by adding the due date of product A as a factor, the customer may determine whether X additional units may be produced by Y date.

Additionally, fixed-size experiment designs may include situations where factors are fixed but factor values are unknown. Assume a case where the dispatching agent performs a weighted sum (WeightSum) or weighted sorting (WeightSort) using N features, and an experiment is conducted by changing the feature priorities or feature weights. For example, there may be a situation where weight sorting is performed based on the three features: FIFO/SETUP/DELAY, and a lower priority indicates a higher preference. The number of possible priorities that can be generated amount to six cases—1,2,3/1,3,2/2,1,3/3,1,2/3,2,1, corresponding to 3! permutations for three features. In this case, you may select the priority cell of the three features as factors, and enter values generated from the permutation for the feature values that have not yet been determined. This allows customers to execute the experiment and then adopt the priority combination that results in the lowest number of equipment replacements as the final scenario.

Additionally, when the experiment is completed, an experimental summary and scenario results may be obtained. At this time, the experimental summary corresponds to information related to factors and key performance indicators. For example, an experiment summary may include variable values for each scenario, key performance indicator values derived from scenario execution, execution/completion time, success or failure of execution, execution order, etc. If at least one key performance indicator is registered in the experiment, the key performance indicator value may be derived based on the predefined calculation order. As described above, the scenario results may include output data including data generated by refinement logic and production plan data, as a result of executing a single model.

Meanwhile, in the case of executing experiments, whether to delete at least part of the input/output after executing the scenario may be used as a parameter. This is because retaining all the information for all scenarios may result in insufficient storage space. Additionally, whether to upload the experimental results to a database 150 after executing the experiment may be a parameter. That is, as needed, a compressed file containing all experimental hub information, experimental results, etc. may be uploaded to the database 150.

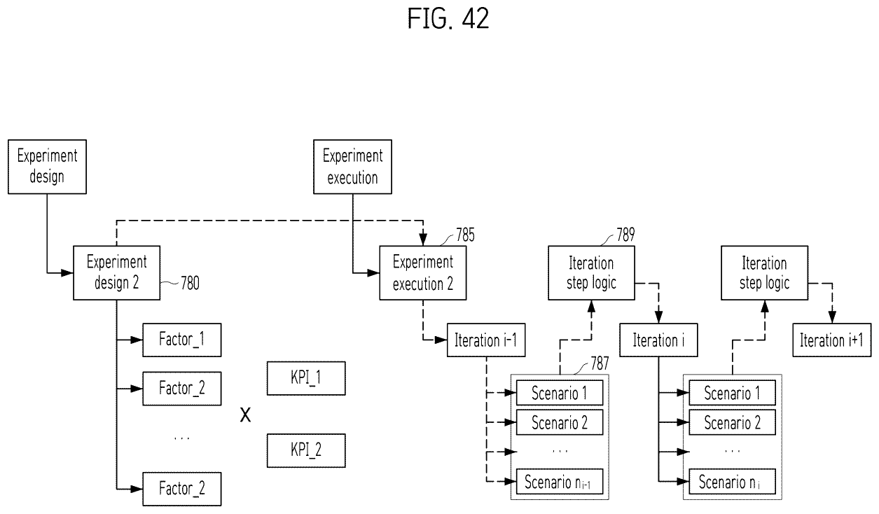

FIG. 42 is a diagram illustrating an example of generating an experimental hub file based on a software model and logic set according to an embodiment.

As described above, the experiment design may include a fixed experiment design and an iterative experiment design. Iterative experiment design is a design of an experiment in which factor values are determined through iteration logic for pre-registered variables. Therefore, the number of scenarios and factor values to be executed at each experimental step may be determined based on the corresponding iteration logic. A repeated experiment design may also be configured as an adaptive experiment design depending on the form of the iteration logic. For example, adaptive experiment design is when the scenarios for the next iteration are designed to improve certain key performance indicators based on the results of the scenarios included in each iteration. At this time, the direction means the direction of change in variable values for improving a specific performance indicator, and may be applied differently based on the algorithm used in the iteration logic.

Additionally, an iterative experiment design may include experimental terminal conditions and iteration logic as parameters. For example, experimental terminal condition may include number of iterations, target time, target performance value, run time, etc.

Additionally, the input and output values of at least one iteration logic included in the iterative experiment design may be determined based on a random value that the user designates a generation method, an initial factor value input by the user, the logic itself input by the user, or a sample extracted from a specific distribution assumed in the logic.

Experimental execution in an iterative experiment design may include the number of parallel executions as a parameter, just like in a fixed experiment design. In the case of an iterative experiment design, if the number of scenarios (L) to be performed in the iterative step exceeds the number of parallel executions (M), the number of parallel executions is Ceiling (L/M), and the number of parallel executions is the number of L divided by M rounded up, and after performing the iteration logic and move to the next iterative step.

Referring to FIG. 42, experiment design 2 780 is an iterative experiment design and may be composed of a combination of factors and key performance indicators. In this case, the factor value for the factor may be arbitrarily assigned an initial value or may use a factor value derived from a previous iteration logic, which corresponds to a value affected by the iteration logic as a value that is not dependent on a previously set variable. In addition, experiment execution 2 785 may perform parallel execution 787 on the plurality of scenarios in the first iteration stage based on the information included in experiment design 2 780, receive the results of the parallel execution as parameters, execute iteration step logic (also referred to as the iteration logic) 789, and then move to the next iteration stage. At this time, in the iteration step logic 789, the number of scenarios and factor values to be performed in the next iteration may be determined. Depending on the value determined in the iteration step logic 789, parallel execution may be performed in the next iteration step, and the order of performing the iteration step logic and then moving to the next iteration step may be repeated.

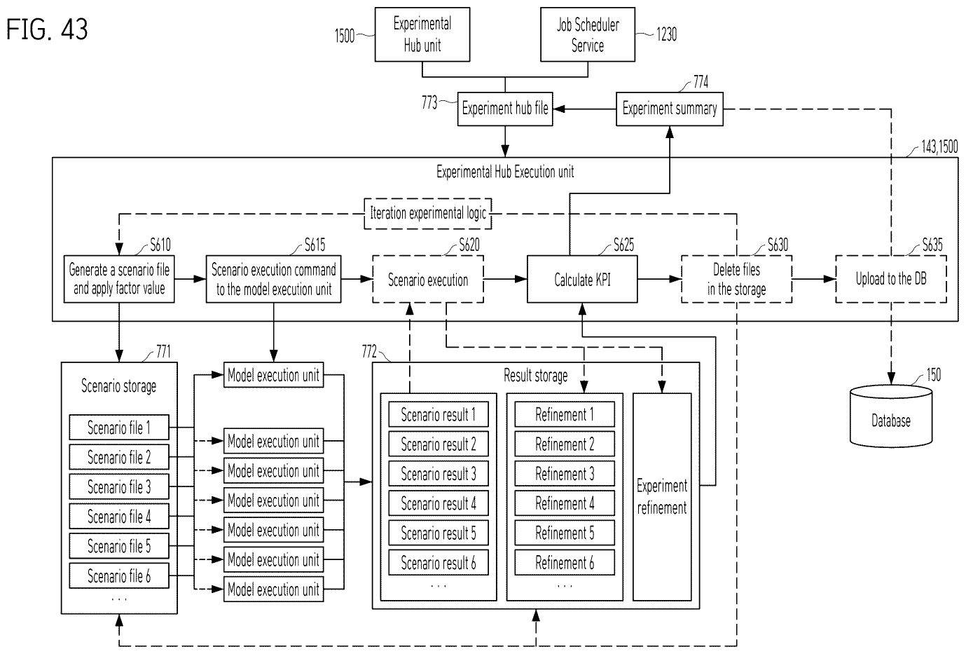

FIG. 43 is a diagram illustrating an example of executing an experiment based on a software model and logic set according to an embodiment.

The experimental hub unit may include an experimental hub editing unit, an experimental hub analysis unit, and an experimental hub execution unit. This may be configured identically in the experimental hub 140 of the client manufacturing production system and the experimental hub 1500 of the on-premise computing system.

In the case of an on-premise computing system 1000, an experiment hub file may be transferred as a parameter from the experiment hub analysis unit of the experiment hub unit 1500 to the experiment hub execution unit. In addition, in the case of the client manufacturing production system 100, the experiment hub file edited through the experiment hub editing unit may be transmitted as a parameter to the experiment hub execution unit 143 through the task scheduler service unit 1230 of the system operation unit 110. Additionally, a parameter may be transferred indicating which of at least one experiment contained in the experiment hub file to execute. That is, in this case, the plurality of experimental hub execution units may be called simultaneously. For example, the experiment hub execution unit may process the plurality of experiments contained in a single experiment hub file in parallel, or may deliver the order among the plurality of experiments as a parameter.

The operations performed in the following experimental hub execution unit correspond to those performed identically in the client manufacturing production system and on-premise computing system. First, a scenario file is generated and factor values may be applied S610. For example, the generated scenario file may be generated by copying the model of the basis model type factors and changing some of the factor values. Meanwhile, in the case of an iterative experiment design, the step S610 may be performed after the iterative experiment logic is performed first.

As described above, a scenario file is generated according to the number of factor values, and at least one generated scenario file may be stored in the scenario storage 771. Additionally, at least one scenario file stored in the scenario storage 771 corresponds to a state that has not yet been executed.

Next, a scenario execution command may be transmitted to the model execution unit for at least one scenario file S615. As illustrated in FIG. 43, for example, at least one scenario file may be executed entirely in one model execution unit. Additionally, for example, each of at least one scenario file may be assigned a corresponding model execution unit that may be executed in parallel.

Additionally, at least one scenario may be executed according to a scenario execution command of the model execution unit S620. At this time, as described above, experimental refinement logic may be performed as well as scenario execution depending on the selection. For example, if the scenario results are used as parameters in the experiment refinement logic, the scenario may be refined and the experiment may be refined according to the experiment refinement logic. Additionally, as illustrated in FIG. 43, the scenario results, scenario refinement results, and experimental refinement results may be stored in the result storage 772. At this time, data stored in the result storage 772 may correspond to result data 1266. For example, scenario results may include such as result data or log data from running a single model.

Next, based on the scenario results, key performance indicators may be calculated and key performance indicator values may be derived S625. For example, key performance indicator values may be represented as scalars or vectors. Key performance indicator values may be included in the experiment summary 774, and factor values for each scenario, execution/completion time, success or failure of execution, execution order, etc. may be included.

In the case of an experiment hub 1500 of an on-premise computing system 1000, an experiment summary 774 may be stored in an experiment hub file 773, and in some cases, the original file of the experiment hub file 773 may be modified. Additionally, in the case of the experimental hub 140 of the client manufacturing production system 100, the experimental summary 774 may be transmitted as result data 1266.

Since the files stored in the result storage 772 are large in size, the files in the storage may be deleted depending on the settings S630. However, deleting files in the repository is not mandatory, and it is possible for files in the storage to remain without being deleted.

Next, the experimental results may be uploaded to the database S635. Additionally, if the performed experiment is by an iterative experiment design, the iterative experiment logic may be followed and the process may be repeated from step S610.

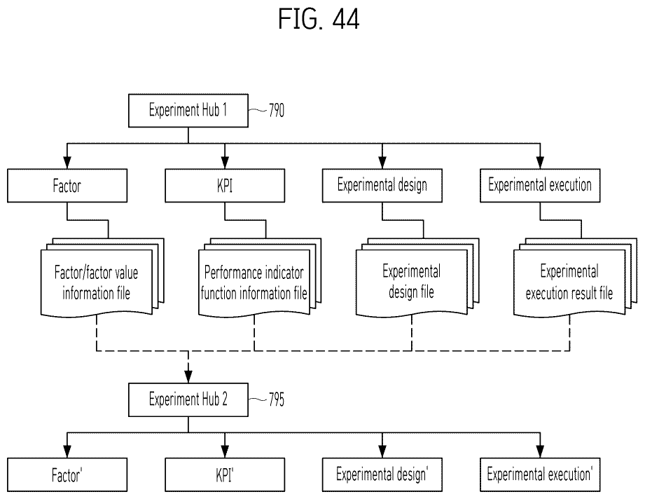

FIG. 44 is a diagram illustrating an example of outputting information about an experimental hub file based on a software model and logic set according to an embodiment.

After the experimental hub file is generated, a user interface may be provided to design an experiment and perform the designed experiment, allowing the user to check the experimental results. For example, result validation may be provided through a separate user interface or through an outbound API on the web. In addition, when an experiment is performed, the results may be automatically uploaded to a database 150.

The experiment summary file may exist as a separate file containing a summary of the experiment hub and may contain various types of information, such as factors, key performance indicators, experiment design, and information related to the experiment execution. In addition, it may include results of key performance indicators, combinations of factors, factor values and key performance indicators, and results of experiment execution, etc.

Additionally, information on factors, key performance indicators, experiment design, and experimental performance included in an experimental hub may be utilized by importing from other experimental hubs. For example, when generating Experiment Hub 1 790 for Customer A, a scenario file for factors, key performance indicators, experiment design, and experiment execution may be generated, and then a new experiment hub, Experiment Hub 2 795, may be generated for Customer A. In this case, instead of newly generating factors, key performance indicators, and the like for customer A, an export procedure of the factor/factor value information file, performance indicator function information file, experiment design file, experimental execution result file, and the like, which were generated and used in experiment hub 1 790, may be performed, or an import procedure may be performed in experiment hub 2 795, so that reusability may be ensured in experiment hub 2 795 by using the data of experiment hub 1 790.

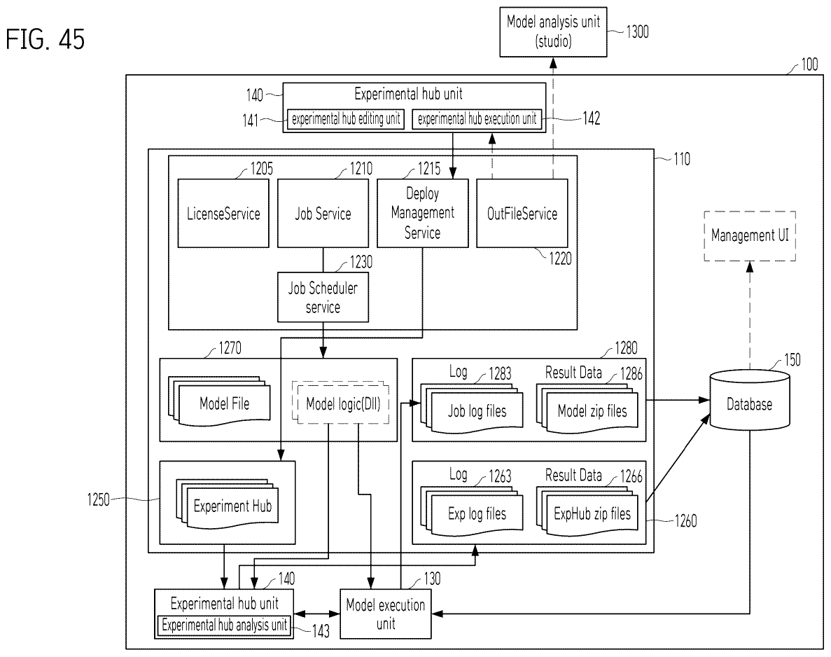

FIG. 45 is a diagram illustrating an example of performing and executing an experiment in an experimental hub based on a software model and logic set according to an embodiment.

As described above, the experimental hub unit 140 may include an experimental hub editing unit 141, an experimental hub execution unit 142, and an experimental hub analysis unit 143. The experimental hub editing unit may generate an experimental hub file 1250 and edit factors and key performance indicators, etc., and upload the experimental hub file included in the experimental hub storage unit 1250 to the system operation unit 110. The experimental hub execution unit may execute the experimental hub file uploaded to the system operation unit 110. The experimental hub analysis unit may analyze the experimental hub result file 1266.

Among the output files 1280 of the model execution unit, the log file 1283 is an operating system log and corresponds to a log recorded by the job scheduler service 1230. Among the output files 1280, the result data 1286 may include a model log for the result of the model execution unit 130 executing a single model and production plan data for the single model. Among the output files 1260 of the experimental hub execution unit, the log file 1263 is an operating system log and corresponds to a log for the experimental hub recorded by the job scheduler service 1230. Among the output files 1260, the result data 1266 may include logs of results performed by the plurality of model execution units and production plan data for the plurality of models. As described above, the experimental hub unit 140 may generate an experimental hub, register at least one model type factor and at least one logic type factor, generate model factors, factor values, and key performance indicators, and then generate an experiment design based on them.

The experimental hub unit 140 may upload the generated experiment design to the experimental hub storage unit 1250 through the deploy management service unit 1215 of the system operation unit 110.

The job service unit 1210 of the system operation unit 110 corresponds to a part that generate operational tasks, operational task cycles, etc., and the job scheduler service unit 1230 corresponds to a part that executes operational tasks edited in the job service unit 1201 according to execution conditions.

Additionally, the experimental hub storage unit 1250 may store at least one software model and at least one logic set received from the model development unit 1100. In addition, the deploy management service provided by the deploy management service unit 1215 may store files in the path for each project to which the deploy target belongs in the experiment hub storage unit 1250 when deployment (upload) occurs. At this time, the deployment management service unit 1215 may provide history management of software models and logic sets for each deployment time when storing the files.

Experimental hub files stored in the experimental hub storage unit 1250 may be used to perform experiments in the model execution unit 130 according to the execution command of the experimental hub unit 140. That is, the model execution unit 130 may execute a single model uploaded to the system operation unit 110, and the experiment hub execution unit of the experiment hub unit 140 may sequentially or simultaneously call the plurality of model execution units 130 based on information recorded in the experiment hub.

The model execution unit 130 may execute an operational task and generate an output file 1280 according to the execution instructions of the job scheduler service unit 1230. At this time, the output file 1280 may include production plan data as an output file 1286 and may include a log file 1283 regarding the results of the operational task execution.

The experimental hub file executed in the model execution unit 130 transmits its results to the experimental hub unit 140, and the experimental hub unit 140 may generate an experimental hub output file 1266 as an output file 1260. Additionally, a log file 1263 for the execution of the experimental hub may also be generated.

The output file 1280 may be uploaded to the database 150 of the client's manufacturing production system 100. Additionally, the output file 1260, which is the result of performing the experiment hub, may be uploaded to the database 150 of the client manufacturing production system. When uploading, it is possible to upload in the form of a model compressed file (Model zip file) 1286 or an experimental hub compressed file (ExpHub zip file) 1266, or to upload the result itself without compressing it.

Meanwhile, the output files 1260, 1280 provide results through the retrieval interface included in the client manufacturing production system 100 or the external file service unit 1220 so that they may be retrieved in the model analysis unit 1300 or the experiment hub analysis unit of the experiment hub unit 140.

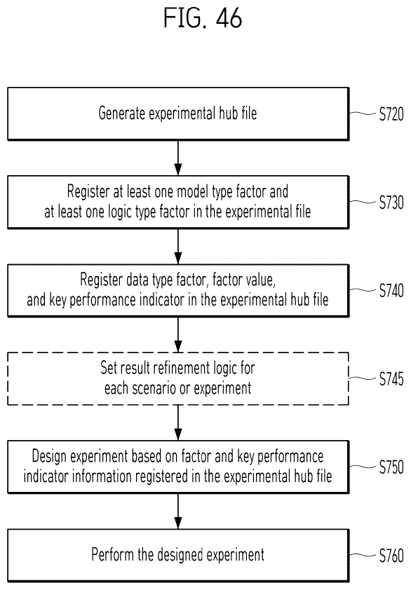

FIG. 46 is a flowchart illustrating an example of generating and performing an experimental hub according to an embodiment.

As described above, the experimental hub unit 140 may generate an experimental hub file S720. More specifically, an experimental hub file may be generated in the experimental hub editing unit of the experimental hub unit 140. The experiment hub file is the target for editing or executing the experiment, and the storage path may be set as a parameter.

Next, the experimental hub unit 140 may register at least one model type variable and at least one logic type variable in the generated experimental hub file S730. As illustrated in FIG. 37, in order to proceed an experiment through the experiment hub, at least one model and at least one logic need to be registered in the experiment hub file. Additionally, at least one registered model and at least one logic may correspond to a factor.

In addition, the experimental hub unit 140 may generate data type factors, factor values, and key performance indicators in the experimental hub file S740. For example, a data type factor might correspond to a single cell. A single cell may be identified via a key that exists in the model global arguments and data schema. Additionally, factor values are determined based on the type of individual data. Additionally, for example, a data type factor may correspond to all input data tables of the model. For example, when an input data table variable is registered, the type of the variable value may be a table type with the same schema as the input data table. In this case, users may load internal data from the original data table of the model type factor or from an external file. Additionally, a table that reflects at least one modification in the input data table may be used as a factor value.

Key performance indicators correspond to function information that processes information contained in the input data and result data of the scenarios included in the experiment. The values of key performance indicators correspond to numerical data that appear according to experimental results.

Meanwhile, depending on the selection, result refinement logic may be set for each scenario or experiment S745. As shown in FIG. 40, if it is difficult to obtain the desired result with the schema defined in the model development unit, the result refinement logic may be used to generate a separate schema and derive the result.

Additionally, experiments may be designed based on factor and key performance indicator information registered in the experimental hub file S750. For example, registered factor information may include the model type factor, logic type factor, data type factor, and factor value described above. As described above, the experiment design may include a fixed experiment design and an iterative experiment design. The number of parallel executions corresponding to the number of scenarios that may be run simultaneously in fixed experiment designs and iterative experiment designs could be set.

Next, the designed experiment may be performed S760. Referring to FIG. 44, the experiment hub editing unit of the experiment hub unit generates a designed experiment hub file and uploads it to the system operation unit, and the experiment hub execution unit generates a scenario based on the information entered in the generated experiment hub file and transmits a file corresponding to each scenario to the model execution unit 130 as a parameter so that it can be executed. Additionally, the model execution unit may transmit result data to the experiment hub execution unit, and in the case of a client manufacturing production system, the experiment hub execution unit may transmit result data to the system operation unit. Additionally, the system operation unit may upload the experimental results to the database or output the results through the analysis unit of the model analysis unit or the experiment hub unit.

When using the experiment hub, complex tasks can be easily performed compared to performing executions on a single model. Additionally, through the experiment hub, results may be automatically summarized through key performance indicators, and time may be saved through parallel execution.

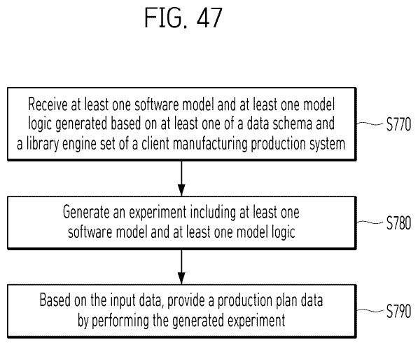

FIG. 47 is a flowchart illustrating a method for providing digital production plan information according to an embodiment.

At least one software model and at least one model logic generated based on at least one of data schema or a library engine set of a client manufacturing production system may be received from an on-premise computing system S770. As described above, the software model and logic set generated in the model development unit may be uploaded to the system operation unit through the server management unit.

An experiment including at least one software model and at least one model logic may be generated S780. As described above, generating an experiment may include generating an experiment hub file, registering factors and key performance indicators, and designing the experiment.

Based on the input data, a generated experiment may be performed to provide at least one production plan data S790. More specifically, at least one of the production plan data may include an experiment summary and scenario results, which are the results of a performed experiment. For example, input data is data representing the status of a client manufacturing production system and may include data at a specific point in time with a certain format and content. In addition, for example, in the experimental hub, at least some of the input data input to the model execution unit 130 may be designated as factors and may correspond to input data that has been modified according to the experiment design. As described above, at least one designed experiment may be performed to provide at least one production plan data including at least one experiment summary and at least one scenario result. Additionally, the refined results obtained additionally through the refinement logic may be included and provided in the experiment summary. In this regard, reference is made to FIGS. 36 to 45 as described above.

Scenario results include output data which includes results from executing a single model, log data, etc. Additionally, the experiment summary may include factor values for each scenario, key performance indicator values derived from scenario execution, execution/completion time, success or failure of execution, execution order, etc. Additionally, the experimental summary and scenario results may be uploaded to a database or transmitted to the analysis unit of the model analysis unit or the experiment hub unit.

Referring to FIG. 29, an embodiment of a device providing digital production plan information including an experimental hub is described as follows.

An embodiment of a device providing digital production plan information may include an input unit 410, a storage unit 420, an in-memory 430, a processor 440, an output unit 450, and a user interface 460. For example, a device that provides digital production plan information may correspond to a client's manufacturing production system.

An embodiment of a device providing digital production plan information below may be controlled by user control and management via a user interface 460.

The input unit 410 may receive a software model and logic set generated based on at least one of the data schema or the library engine set of the client manufacturing production system from the on-premise computing system.

The storage device 420 may store pre-prepared reference information or store received software model and logic set. The storage device 420 may include volatile memory or non-volatile memory.

In-memory 430 may store the software model, input data, library engine set, and products obtained in the process of performing the library engine, model execution unit, and experiment hub unit disclosed above. A library engine set may contain a production planning engine, which is a number of encapsulated function block files that generate production plans.

The processor 440 of the embodiment may generate an experiment hub including at least one software model and at least one model logic. The processor 440 may generate an experiment hub file and register at least one model type factor and at least one logic type factor in the generated experiment file. Additionally, the processor 440 may generate data type factors, factor values, and key performance indicators in the experimental hub file. The processor 440 may design an experiment based on factor information and key performance indicator information. At this time, the designed experiment may consist of a fixed experiment design or an iterative experiment design. Detailed examples are disclosed in FIGS. 38 to 42. And the processor 440 of the embodiment may perform a generated experiment based on input data and obtain production plan data corresponding to the experimental results. In this regard, refer to FIGS. 36 to 45 described above.

The processor 440 of the embodiment may execute a designed experiment and generate an output file and a log file on the execution status of the experiment hub task.

The output unit 450 may provide production plan data based on the execution results of the designed experiment so that production or processes may be managed in the client system.

The following examples detail an example of providing production plan data via an experiment hub using a software model and logic set generated based on the installed library engine set.

As described above, the experiment hub is a collection of data that stores information and experimental results necessary to execute various experiments using at least one software model and at least one model logic. In addition, once an experiment hub file is generated and at least one model type factor and at least one logic type factor are registered in the generated experiment hub file, and data type factors, factor values, and key performance indicators related thereto are registered, an experiment may be designed and performed.

At this time, the experiment design may be designed using the factor and key performance indicator information registered in the experimental hub file. In addition, the experiment design may include a fixed-size experiment design that designs an experiment with a combination of pre-registered factors and factor values, and an iterative experiment design that designs an experiment by determining factor values for pre-registered factors through iteration logic. In the case of a fixed-size experiment design, it corresponds to an experiment design that is executed in a state where all cases are confirmed in advance, and an iterative experiment design corresponds to an experiment design that is executed in a state where the number of scenarios and factor values executed at each stage are continuously changed while the factors are pre-registered.

The disclosed embodiment describes an example of designing an iterative experiment through an experimental hub 140, 1500.

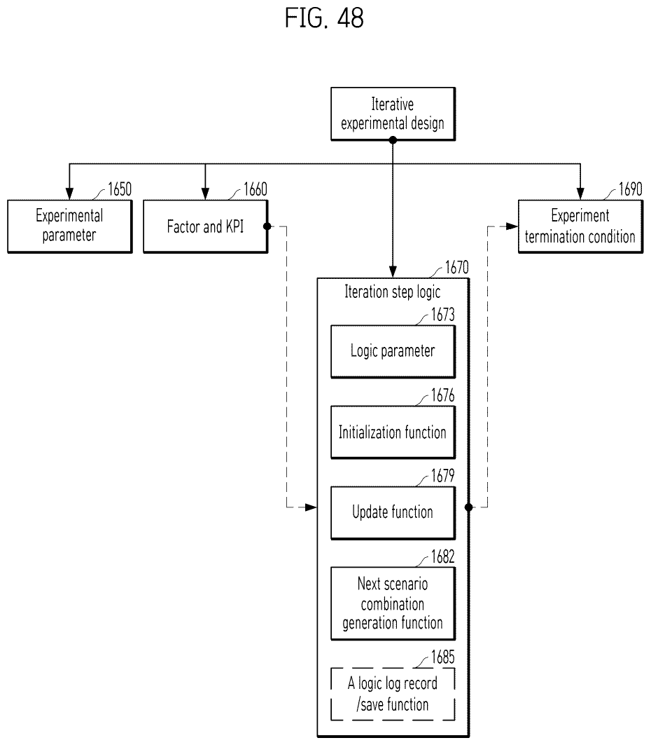

FIG. 48 is a diagram illustrating the configuration of an iterative experiment design based on a software model and logic set according to an embodiment.

An iterative experiment design may include at least one iteration logic and at least one repeat step. The iteration logic may be predefined in advance. An iterative experiment design may be set up with a multi-objective function or a single objective function. The iteration step corresponds to the step where a combination of scenarios containing at least one scenario is executed. In the case of an iterative experiment design, the iteration logic and iteration steps may be designed to be executed cross-wise and continuously until the terminal condition is satisfied.

The iteration logic for single objective optimization may include a single objective algorithm and logic to generate the next scenario. A single-objective algorithm is an algorithm that aims to maximize or minimize a single goal. For example, single-objective algorithms may include Stochastic Gradient Descent Method (SGD), Genetic Algorithm (GA), Simulated Annealing (SA), Particle Swarm Optimization (PSO), Bayesian Optimization (BO), Cross Entropy Method (CEM), Policy Exploration with Parameter-based Exploration Gradient (PEPG), genetic algorithms, etc. Additionally, single-objective algorithms may include custom or user-written logic. A multi-objective algorithm is an algorithm that optimizes the plurality of objectives simultaneously, some of objectives may be conflicting, and may aim to find a Pareto front. For example, multi-objective algorithms may include Non-dominated Sorting Genetic Algorithms (NSGA), Non-dominated Sorting Genetic Algorithms II (NSGA-II), Strength Pareto Evolutionary Algorithm (SPEA), Strength Pareto Evolutionary Algorithm II (SPEA-II), etc. Additionally, multi-objective algorithms may include custom or user-written logic.

As illustrated, the iterative experiment design includes experimental parameters 1650, factors and key performance indicators 1660, iteration step logic 1670, and experiment terminal conditions 1690, which may correspond to input values of the iterative experiment design.

Experimental parameters 1650 are parameters for the experiment itself and may correspond to options for executing the experiment. For example, it may include the number of repetitions, the number of parallel experiments, whether to record to a DB, etc. Factors and key performance indicators 1660 may include target factors and target key performance indicators to be used in the experiment. For example, a factor may include at least one of the input/output data or global arguments belonging to the software model. For example, factors may include, but are not limited to, input intervals in a demand information table, feature weights used by dispatching agents, quantities, and operating hours. Additionally, for example, key performance indicators may include, but are not limited to, the total production volume of the production plan, the number of delayed work items, the number of equipment replacements, and the average operating time, by processing the production results.

The iteration step logic 1670 may be provided in a manner of setting parameters and functions to be used in the logic as illustrated, or it may also be provided in the form of a plug-in in which the logic is implemented in advance using the single/multi-objective algorithm.

The iteration step logic 1670 may include logic parameters 1673, an initialization function 1676, an update function 1679, and a next scenario combination generation function 1682. Additionally, optionally, a logic log record/save function 1685 may also be included. The functions included in the iteration step logic 1670 are not limited thereto, and functions may be added or removed according to user settings.

Among the functions included in the iteration step logic 1670, the initialization function 1676 may be called first, followed by the scenario combination generation function 1682, and then the update function 1679. However, the calling order of the functions is not limited to this, and the calling order between the functions may be changed, such as when the update function 1679 is called and then the next scenario combination generation function 1682 is called.

Additionally, logic parameters 1673, various functions and contents of functions, factors and performance indicators may correspond to input values of the iteration step logic 1670. The result of executing the next scenario combination and log record/save function generated in the iteration step logic 1670 may correspond to an intermediate output value or a final output value of the iteration step logic 1670. Additionally, when the plurality of iteration logic is executed, the output value of the previous iteration logic may be used as the input value of the subsequent iteration logic.

Common logic parameters 1673 in single-objective algorithms or multi-objective algorithms include random seeds and random streams, and in addition, there may be various parameters depending on the type of multi-objective algorithm or single-objective algorithm. For example, in the case of PEPG, it may include the shape of the distribution, distribution parameter values for factors, and learning rates for each parameter. Additionally, for example, a genetic algorithm may include population size of a generation, crossover rate, and mutation rate.

The initialization function 1676 may initialize the input logic parameters. For example, when using PEPG logic, the initialization function 1676 may perform the task of generating a distribution to be used throughout the iteration steps using the input distribution parameter values and random stream. The update function 1676 may update the logic parameters. For example, when using PEPG logic, the update function 1676 may include a process of updating the factor distribution described above by utilizing the results performed in the previous iteration step (scenario factor values and key performance indicator values of the previous step) to generate a distribution with a higher probability of producing higher performance indicator values. The next scenario combination generation function 1682 may generate the next scenario combination based on the updated logic parameters. For example, when using PEPG logic, the following scenario combination generation function 1682 may include logic for symmetrically extracting factor values from the updated distribution and designating them as factor values of a scenario to be performed in the next iteration step. The logic log record/save function 1685 may generate records of intermediate process outputs, final outputs, etc. generated while the iteration logic is being executed. For example, a log of initialization of logic parameters, a log of update of logic parameters, or a log of generation of the following scenario combinations may be recorded. As an example, in the case of PEPG logic, the final distribution may be recorded as a log, and in the case of genetic algorithms, the population genetic change trend at each step may be recorded as a log.

The experiment terminal condition 1690 is a condition for finishing an experiment of an iterative experiment design and may be set in advance. For example, the experimental terminal condition 1690 may include when the predetermined (target) number of iterations has been performed, when the predetermined execution time has been reached, when a target key performance indicator value has been reached, etc.

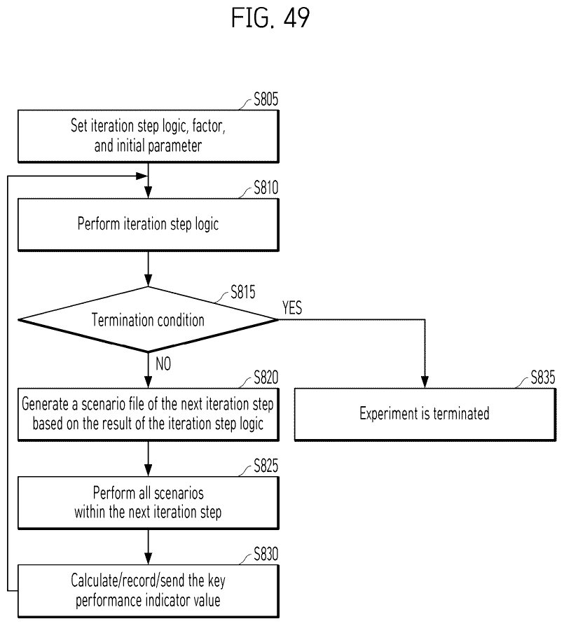

FIG. 49 is a diagram illustrating an example of performing an iterative experiment design based on a software model and logic set according to an embodiment.

If the experiment design is determined by an iterative experiment design, the iteration logic, factors, and initial parameters may be set S805. For example, setting the initial parameters corresponds to executing the initialization function 1676 described above.

Additionally, the factor set in step S805 may correspond to at least one of the model type factor, logic type factor, or model data factor described above.

Meanwhile, the set iteration logic may include first scenario combination information. Here, the first scenario combination information may mean a combination of information required for a scenario file to be generated in the future. For example, if it is decided as a logic to apply the PEPG algorithm among the single-objective algorithms, the initial values of the parameters (mean, variance) of the distribution of the target factors, the learning rate of the mean and variance, the corresponding model type factors, the logic type factors, and the main performance indicators are included, and the first scenario combination may be generated based on this thereafter.

Next, Here, the execution of the first iteration logic corresponds to the execution of the update function 1679 described above or the next scenario combination generation function 1682. Additionally, when the first iteration logic is executed, the result of the first iteration logic may include information of a scenario file to be used in the next first iteration step. For example, information in a scenario file may include combinations of factor values, key performance indicators, etc.

After the first iteration logic is executed, it may be determined whether the experiment terminal condition is satisfied S815. As described above, experimental terminal conditions include, but are not limited to, performing a predetermined number of iterations, time of executing the experiment, and achieving key performance indicator target values.

If the experimental terminal condition is satisfied, the experiment is terminated S835, and experimental results including scenario results and an experimental summary may be derived. For example, scenario results may include result data and log data from executing each single scenario among the plurality of scenarios included in the experiment. Additionally, the experiment summary may include factor values for each scenario, key performance indicator values derived from scenario execution, execution/completion time, success or failure of execution, execution order, etc.

If the experimental terminal condition is not satisfied, a scenario file of the first repetition step may be generated based on the result of the first iteration logic S820. Generating a scenario file of the first iteration step means generating at least one scenario file to be performed in an actual iteration step based on the scenario combination information of operation S810. Here, the first iteration step may correspond to a step in which the first iteration logic is executed and then scenario files generated based on the results of the first iteration logic is executed. In addition, factor values, key performance indicators, etc., which are results obtained by performing the first iteration step, may be passed as parameters to the second iteration logic to execute the logic.

Additionally, factors used in the iteration step of the iterative experiment design are predefined, but factor values may be determined based on the iteration logic executed immediately before the iteration step. That is, although the factors used in at least one iteration step included in the iterative experiment design are predefined, the factor values are determined based on the results of the execution of the iteration logic, and therefore correspond to variable values. Additionally, factors and factor values used in at least one iteration step may be set in the immediately preceding iteration logic.

Next, all scenarios within the first iteration step may be performed S825. In this regard, the experiment hub execution unit may command the model execution unit to execute a scenario file. For example, an experiment hub execution unit may command one model execution unit to run an entire scenario file. Additionally, for example, the experiment hub execution unit may command the plurality of model execution units to execute each entire scenario file by corresponding it to one model execution unit. Additionally, all scenarios within the first iteration stage may be executed in parallel n times, depending on the set number of parallel executions.

When the scenario is performed, key performance indicator values may be calculated, stored in a database, and the calculated key performance indicator values may be transmit to the second repetition stage logic S830. At this time, the second iteration logic may be determined based on the scenario results performed in the first iteration step. Alternatively, the second iteration logic may be set independently or dependently on the scenario results performed in the first iteration step. Additionally, the number of scenarios in each iteration step may be changed depending on the iteration logic.

Next, after the second iteration logic is performed, if the terminal condition is not satisfied, the second iteration step is performed, and then the third iteration logic may be repeatedly performed. That is, steps S810 to S830 described above may be repeatedly executed, and the experiment may be completed when the terminal condition is satisfied. In this case, when step S810 is performed, the update function 1679 of the above-described iteration logic may be executed.

In addition, the logic log record/save function of FIG. 48 described above may be called at all stages of the present embodiment, and may record/save logs for different information when called at each stage. For example, if a logic log record/save function is called at each stage, logs for intermediate and final outputs at each stage may be recorded/save.

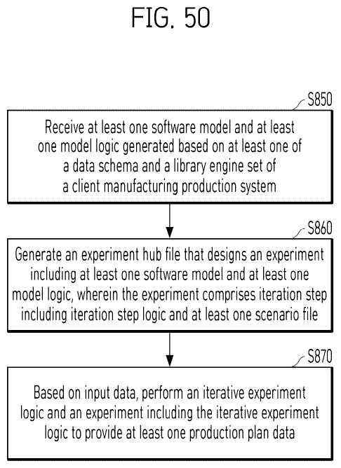

FIG. 50 is a flowchart illustrating a method for providing digital production plan information according to an embodiment.

At least one software model and at least one model logic generated based on at least one of the data schema or the library engine set of a client manufacturing production system may be received from an on-premise computing system S850. As described above, the software model and logic set generated in the model development unit may be uploaded to the system operation unit through the server management unit.

An experiment hub file that designs an experiment including at least one software model and at least one model logic may be generated S860. Generating an experiment means generating an experiment hub file, registering factors and key performance indicators, setting factor values, etc., and designing an experiment consisting of the plurality of scenarios. At this time, when generating an iterative experiment design as described above in FIGS. 48 and 49, at least one iteration logic may be executed, and at least one iteration step may be configured to be repeatedly performed. At least one iteration step may contain the plurality of scenarios. The scenario results from one iteration step may be used as input to the logic of the next iteration step.

Based on input data, an experiment including an iterative experiment logic and at least one scenario may be performed to provide at least one production plan data S870. More specifically, as described above in FIGS. 48 and 49, by performing an iterative experiment design, at least one iteration step and at least one iterative experiment logic are performed, and when a terminal condition is satisfied, the experiment may be completed. When the experiment is terminated, at least one production plan data is generated and stored in the database or deletion may be performed for some files. At least one production plan data may include an experimental result, an experimental summary and a scenario result.

Referring to FIG. 29, an embodiment of a device providing digital production plan information including an experimental hub is described as follows.

An embodiment of a device providing digital production plan information may include an input unit 410, a storage unit 420, an in-memory 430, a processor 440, an output unit 450, and a user interface 460. For example, a device that provides digital production plan information may correspond to a client's manufacturing production system.

An embodiment of a device providing digital production plan information below may be controlled by user control and management via a user interface 460.

The input unit 410 may receive a software model and logic set generated based on at least one of the data schema or the library engine set of the client manufacturing production system from the on-premise computing system.

The storage device 420 may store pre-prepared reference information or store received software models and logic set. The storage device 420 may include volatile memory or non-volatile memory.

In-memory 430 may store the software model, input data, library engine set, and products obtained in the process of performing the library engine, model execution unit, and experiment hub unit disclosed above. A library engine set may contain a production planning engine, which is a number of encapsulated function block files that generate production plans. The in-memory 430 of the embodiment may store intermediate outputs and/or final outputs related to the iteration logic and logs thereof.

The processor 440 of the embodiment may generate an experiment hub file including at least one software model and at least one model logic. The processor 440 may generate an experiment hub file and register at least one model type factor and at least one logic type factor in the generated experiment file. Additionally, the processor 440 may generate data type factors, factor values, and key performance indicators in the experimental hub file. The processor 440 may design an experiment based on factor information and key performance indicator information.

At this time, the designed experiment may consist of a fixed experiment design or an iterative experiment design. An iterative experiment design may include iteration logic and repeat steps. As described above in FIGS. 48 and 49, the processor 440 may set the iteration logic as a multi-objective function or a single-objective function and set factor values according to the set algorithm.

And the processor 440 of the embodiment may perform a generated experiment based on input data to obtain production plan data. When the iteration logic is executed, the processor 440 may generate scenario combination information of the iteration step to be performed thereafter and generate a scenario file. Additionally, the processor 440 may execute the generated scenario file and perform the next iteration logic based on the scenario result.

The processor 440 of the embodiment may execute a designed experiment and generate an output file and a log file on the execution status of the experiment hub task. After the iteration logic is executed, if the terminal condition is satisfied, the processor 440 may terminate the experiment and derive the experimental result. Experimental results serve as production plan data, which may include experiment summaries and scenario results.

The output unit 450 may provide production plan data based on the execution results of the designed experiment so that production or processes may be managed in the client system.

As described above, the software model and logic set acquired (developed) in the model development unit 1100 may be uploaded to the system operation unit 110. The system operation unit 110 may generate an operational task based on the uploaded software model and logic set and set conditions for performing the operational task. At this time, the operational task is a task required to execute (operate) a software model and logic set, and may correspond to a unit of job executed by the system operation unit 110.

When executing a single software model is not sufficient for a task, it is necessary to automatically execute the plurality of tasks by introducing the plurality of software models and external logic. When the plurality of software models or logics are used, they may be performed through an experiment hub 140 that includes the plurality of experiments. In this regard, the system operation unit 110 may generate an operational task for the experimental hub and set conditions for performing the operational task.

As described above, the system operation unit 110 includes a service unit including various services, and the service unit may include a license service unit 1205, a job service unit 1210, a deploy management service unit 1215, an outfile service unit 1220, a job scheduler service unit 1230, etc.

Operation tasks may be generated through the job service unit 1210 of the system operation unit 110. At this time, the operational task correspond to a task required to execute (operate) the software model and logic set. Operational tasks (job type) may include three types: transmitting an e-mail, running a program, and running a model. In addition, various execution tasks, such as running an experiment hub and running dynamic operation logic, may be added depending on user settings or system settings. Additionally, an operational task may correspond to a unit of job executed by the job scheduler service unit 1230.

Additionally, the job service unit 1210 may set execution conditions (triggers) for operational tasks. Here, the execution conditions (triggers) correspond to execution cycles, dependencies between operational tasks, etc. That is, an operational task refers to a job unit for execution, and an execution condition may refer to detailed conditions such as the execution cycle and dependencies of an operational task. At least one execution condition may be generated for an operational task, and it is also possible for at least one second execution condition to be generated for a first execution condition. The set execution conditions may be stored in the system operation unit.

The following describes the case where the system operation unit 110 generates and performs operational tasks related to the experimental hub.

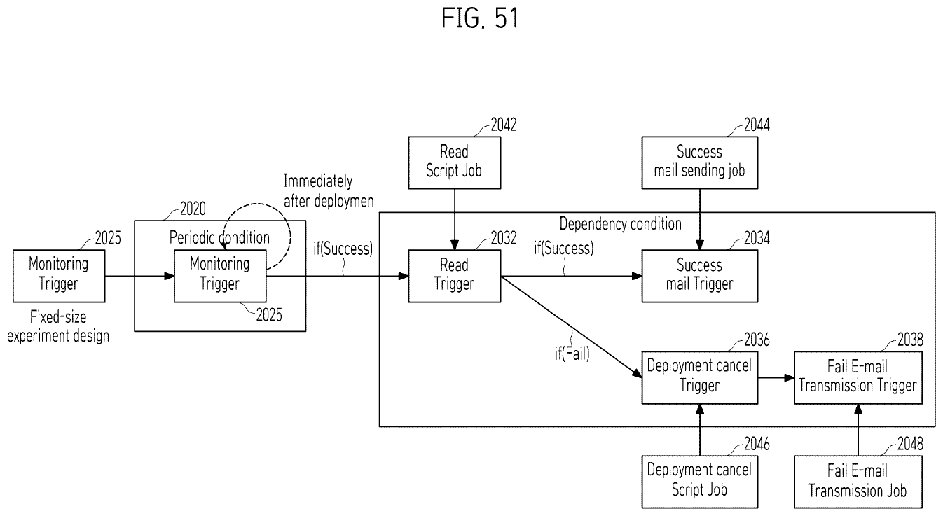

FIG. 51 is a diagram illustrating an example of setting up an operational task in a system operation unit according to an embodiment.

More specifically, FIG. 51 is an example of generating a deployment logic monitoring operational task using an experimental hub and setting an execution condition (trigger) for it. This figure is an example of operational tasks related to the experimental hub, and it is obvious that various other operational tasks related to the experimental hub can be generated.

This embodiment illustrates an example of an operational task for an experimental hub for monitoring deployment logic during the experimental hub operational task, but may also include, but is not limited to, an operational task based on an experimental hub generated for a given target, such as an operational task for a data collection experimental hub and an operational task for a data evaluation experimental hub.

As illustrated, a deployment logic monitoring operation task 2010 may be generated by the job service unit 1210. Here, the deployment logic monitoring operational task 2010 is an operational task that monitors whether there are changes in the production plan results, execution time, etc. when deploying the logic, and the monitoring results may be used in deployment decision making. For example, if a logic is newly deployed and the result is the same but the execution time increases drastically, making it difficult to use, there may be cases where you need to roll back to the previous version of the logic. Additionally, for example, if a logic is newly deployed and execution time is reduced while producing improved results, the new version of the logic needs to be actively used.

Additionally, an experimental hub consisting of a fixed-size experiment design may be set up in relation to the deployment logic monitoring operational task 2010. For example, a fixed-size experiment may be designed to perform all combinations by selecting N of the latest models or user-defined models from the operating server as model factor values and M of the latest logics as logic factor values. In addition, for example, the key performance indicators of a fixed-size experiment design may be selected, but are not limited to, indicators that may read results, such as execution time, the number of rows in a result table, the sum of specific columns, and improved production planning indicators.

At least one execution condition may be set for an operational task. For example, the execution conditions may include periodic conditions, dependency conditions, etc. Additionally, periodic conditions or dependency conditions may be set between the plurality of execution conditions. Additionally, even if the execution conditions are set, an additional procedure for setting actual activation/deactivation may be included.

As shown in figure, the deployment logic monitoring operational task 2010 is a periodic condition 2020 which corresponds to the condition 2025 of performing monitoring according to a predefined cycle. For example, the predefined cycle may be set to various settings, such as immediately after logic deployment, 5 minutes after logic deployment, or 1 hour after the official deployment schedule.

Additionally, a dependency condition 2030 may be generated (set) for the periodic condition 2020. In an embodiment, if the periodic condition 2020 is successful, the first dependency condition 2032 may be set to be performed. In this embodiment, the first dependency condition 2032 may be set to perform reading when monitoring is successfully performed according to a predefined periodic condition. When the first dependency condition 2032 is performed, the reading script job 2042 may be performed. Here, the reading script job refers to the job of reading the deployed logic to determine whether any abnormalities have occurred.

Additionally, at least one dependency condition may be set for the first dependency condition 2032. In an embodiment, if the first dependency condition 2032 is successful, the second dependency condition 2034 may be set to be performed. In this embodiment, the second dependency condition 2034 may be set to transmit a success email if the reading is successful. If the second dependency condition 2034 is performed, the success mail transmitting job 2044 may be performed. Here, the success email transmitting job refers to the job of transmitting an email indicating that there is no problem with the deployment logic.

Additionally, in an embodiment, if the first dependency condition 2032 fails, the third dependency condition 2036 may be set to be performed. In this embodiment, the third dependency condition 2036 may be set to transmit a failure email if the reading fails. As the third dependency condition 2036 is performed, the deployment cancel script job 2046 may be performed. Here, the deployment cancel script job corresponds to a job to cancel additional deployments for the deployed logic, and further, a job to roll back to a previous version of the logic may also be additionally set. Additionally, when the deployment cancel condition 2036 is performed, the failure mail transmitting condition 2038 may be set to be performed. In this case, as the failure mail transmitting condition 2038 is performed, the failure mail transmission job 2048 may be performed.

In relation to the deployment logic monitoring operational task 2010, additional periodic conditions and dependency conditions may be set, although not shown. In addition, even if each periodic condition and dependency condition is set, the operational task may be performed after a judgment is made as to whether to activate/deactivate. In addition, with regard to the experimental hub, it goes without saying that various operational tasks related to the performance of the experimental hub, as well as the deployment logic monitoring operational task 2010, may be set.

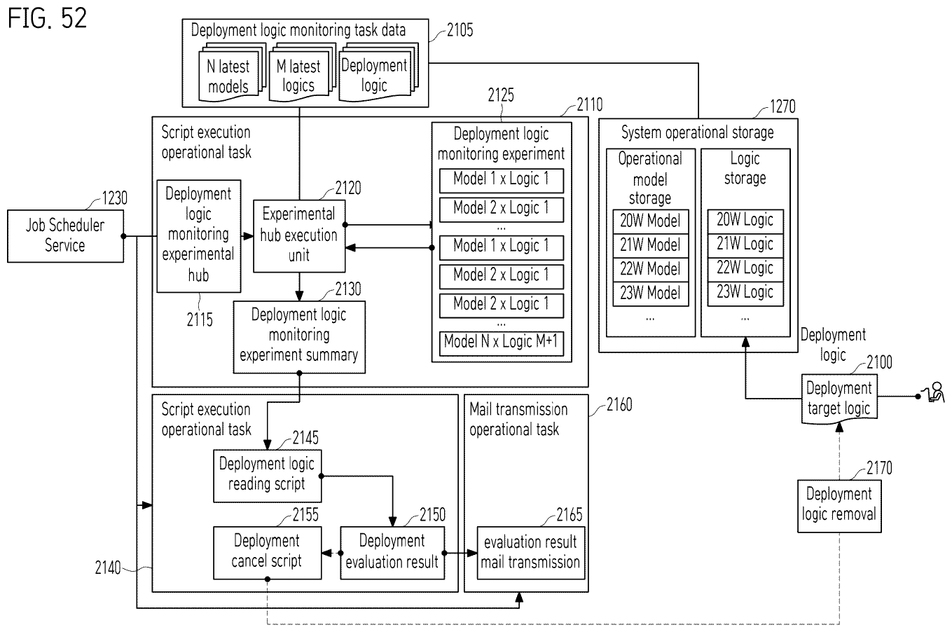

FIG. 52 is a diagram illustrating an example of an operational task performed using a fixed-size experiment design in an operating environment according to an embodiment.

In more detail, FIG. 52 describes an example of a deployment logic monitoring operational task 2010 described in FIG. 51 in the system operation unit 110. First, the experimental hub operational task 2110, script execution operational task 2140, and mail transmission operational task 2160 may be generated (set) by the job service unit. In this embodiment, the experimental hub operational task 2110 may correspond to the deployment logic monitoring operational task 2010 of FIG. 51, the script execution operational task 2140 may correspond to the reading script job 2042 or the deployment cancel script job 2046 of FIG. 51, and the mail transmission operational task 2160 may correspond to the successful mail transmission job 2044 or the failed mail transmission job 2048 of FIG. 51.

In this embodiment, when the deployment target logic 2100 is determined, it may be uploaded to the history management storage unit 1270 of the system operation unit 110 through the deployment service 1215 of the system operation unit 110. Here, the history management storage unit 1270 may store software model and logic set required to generate or set operational tasks in the system operation unit, and may store files related to the operational tasks. At this time, the deployment target logic 2100 may be determined by the user or according to predefined rules. For example, the deployment target logic 2100 may be determined through the model development unit. Additionally, for example, in a cloud computing system, the deployment target logic may be pre-implemented and uploaded. The database 150 is a database of the client system and may include an operational model storage and a logic storage. Additionally, the operational model storage may contain the plurality of software models, and the logic storage may store the plurality of logic sets.

The latest software models N, latest logic sets M, and deployment target logic 2100 included in the database 150 may be extracted as deployment logic monitoring task data 2105. For example, by selecting N of the latest software models of the database 150 as model factor values, M of the latest logic sets as logic factor values, and 1 deployment target logic 2100, a fixed-size experiment design may be performed by the experiment hub editing unit so that all scenario combinations may be performed.

The experimental hub operational task 2110 may include a deployment logic monitoring experimental hub 2115, an experimental hub execution unit 2120, and a deployment logic monitoring experiment summary 2130. In this regard, the deployment logic monitoring experiment hub 2115 generated by the experiment hub editing unit may be set by the system operation unit as an operational task of the experiment hub. The deployment logic monitoring experiment hub 2115 may correspond to a state in which N*(M+1) scenario combinations are generated in the deployment logic monitoring experiment 2125 to be executed through a command of the experiment hub execution unit 2120. In this embodiment, the key performance indicators of the fixed-size experiment design of the deployment logic monitoring experiment 2125 may be selected from indicators that may read results, such as execution time, the number of rows in the result table, the sum of specific columns, and improved production planning indicators.

The script execution operational task 2140 is set by the 2115 periodic condition or dependency condition for the experimental hub operational task 2110, and a deployment logic reading script 2145, a deployment cancel script 2155, etc. may be set. In addition, the mail transmission operational task 2160 is set by a periodic condition or dependency condition for the experimental hub operational task 2110, and evaluation result mail transmission 2165, etc. may be set.

Before an operational task is executed, a procedure may be performed to determine whether to activate/deactivate the predetermined periodic condition or dependency condition. In this embodiment, it is assumed that all conditions related to the experimental hub operational task 2110 are set to be activated.

When the experimental hub operational task 2110 is executed by the job scheduler service unit 1230, the deployment logic monitoring experiment 2125 set in the deployment logic monitoring experiment hub 2115 is executed as a fixed-size experiment, and a deployment logic monitoring experiment summary 2130 may be output. Here, the deployment logic monitoring experiment summary 2130 may include results such as factor values by scenario, key performance indicator values according to the design objective of the deployment logic monitoring experiment hub derived through scenario execution, for example, the execution time, the number of rows in the result table, the sum of specific columns, etc.

In this regard, the experimental hub execution unit 2120 may be included in the category of the experimental hub execution unit 143 of the experimental hub unit 140. In addition, according to the execution command of the experiment hub execution unit 143, the model execution unit 130 may execute the plurality of scenarios included in the deployment logic monitoring experiment 2125, and the experiment hub execution unit 143 may generate a deployment logic monitoring experiment summary 2130.

The job scheduling service unit 1230 may perform a deployment logic reading script 2145 among the script execution operational tasks 2140 based on the deployment logic monitoring experiment summary 2130. Additionally, when deployment logic reading is performed, deployment logic evaluation results 2150 may be produced. Although not shown, when the deployment logic experiment hub 2110 is running, each scenario result may also be output in addition to the deployment logic monitoring experiment summary 2130. For example, one of the latest software models N and the scenario results for the deployment target logic are output, so that the deployment logic may be read. In addition, for example, the deployment logic reading script may make a decision to approve the deployment if the number of rows in the table of the deployment logic monitoring experiment summary 2130 and the above scenario results are the same as the number of previous operational logic versions and the execution time is within ±10%, otherwise, to cancel the deployment.

If the deployment logic evaluation result is successful, evaluation result mail transmission 2165 may be performed during the mail transmission operational task 2160. For example, if the deployment logic evaluation result is successful, a success email may be transmitted as described above.

If the deployment logic evaluation result is a failure, a deployment cancel script 2155 may be performed during the script execution operational task 2140, and an evaluation result mail transmission 2175 may be performed during the mail transmission operational task 2160. When the deployment cancel script 2155 is executed, the deployment logic removal 2170 may be executed so that the deployment target logic 2100 may be removed. In addition, if the deployment logic evaluation result is a failure, the deployment cancel script 2155 may be executed, and then the failure email transmission 2048 of FIG. 51 may be executed.

Unlike this embodiment, it is also possible to set a condition for transmitting an email for evaluation result 2165 to be transmitted only when any abnormalities occur in the result of reading. In addition, unlike the present embodiment, when the deployment cancel script 2155 is executed, it is also possible to roll back to a previous version of the logic in addition to removing the deployment logic 2170. Additionally, when the deployment cancel script 2155 is executed, it is also possible to roll back to the version of the logic with the best values for key performance indicators based on the deployment logic monitoring experiment summary 2130 and/or the deployment logic evaluation results 2150.

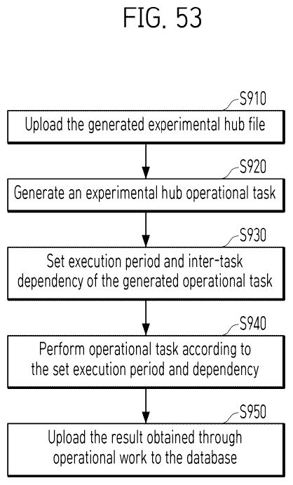

FIG. 53 is a flowchart illustrating an example of setting up and performing operational tasks of an experimental hub according to an embodiment.

As described above, the generated experimental hub file may be uploaded S910. More specifically, experimental hub files generated through the experimental hub editing unit may be uploaded to the system operation unit. An experimental hub file is a file in which at least one model type factor, at least one logic type factor, data type factor, factor value, and key performance indicator are registered. Although not shown, before the generation of an operational task, the user's license eligibility may be checked through the license service unit 1205.

An experimental hub operational task may be generated S920. More specifically, operational tasks may be generated after data sources of the software model and logic set to be used in the experiment hub are connected. For example, in the case of the deployment logic monitoring operation described above, connecting a data source refers to entering information that may specify the storage from which to retrieve the latest software model and logic set. Here, information that may specify a storage may include connection information of a system storing a software model and logic set to be used as a factor value of the experiment hub, a path to a history management storage, etc. As described above, an experiment hub operational task may be set up for an experiment hub that includes a combination of scenarios for the plurality of software models and the plurality of logic sets.

Next, the execution period and inter-task dependencies of the generated operational tasks may be set S930. As described above, at least one execution condition may be set for one operational task. Execution conditions may include periodic conditions and dependency conditions. Additionally, prior to execution of an operational task, a procedure for setting whether to activate/deactivate an execution condition may be additionally included. For example, an experiment hub operational task may be set up in conjunction with a script execution operational task or a mail transmitting operational task.

Additionally, operational tasks may be performed according to the predetermined execution period and dependencies S940. For example, if there is an execution instruction from the job scheduler service, the experiment hub execution unit may send the experiment hub execution instruction to the model execution unit, and the model execution unit may execute a combination of scenarios included in the experiment hub operational task. Additionally, when the model execution unit is terminated, the experimental hub execution unit may analyze the scenario results, calculate key performance indicator values, and refine the results. As shown in FIG. 52, when the experimental hub operational task is performed, the related script execution operational task and mail transmission operational task may be performed according to conditions.

The results obtained through operational work may be uploaded to the database S950. For example, generated result may include production plans, operating system logs, etc. Additionally, the results obtained through the experimental hub operational task may be retrieved through the user interface of the client system or the experimental hub analysis unit.

An example of setting up and performing experimental hub operational tasks with reference to FIG. 45 is described below.

As described above, the experiment hub editing unit 141 of the experiment hub unit 140 may generate an experiment hub file. As described above, the experimental hub is a collection of information including such as factors, key performance indicators, experiment design, experimental execution and database connection information, result refinement data schema, and logic. Here, the experiment design may include a fixed-size experiment design and an iterative experiment design. Experimental execution involves generating a scenario based on the information included in the experiment design, executing the experimental hub file, and then outputting the results.

The generated experimental hub file may be uploaded through the deployment management service unit 1215 of the system operation unit 110 and stored in the experimental hub storage unit 1250.

The work service unit 1210 may generate an experiment hub operational task based on the experiment hub file. In addition, the job service unit 1210 may generate (set) execution conditions such as the execution cycle and execution dependency of the experimental hub operation work. The job scheduler service unit 1230 may execute operational tasks according to execution conditions set in the job service unit 1210.

According to the command of the job scheduler service unit 1230, the experiment hub execution unit 143 may perform the experiment. That is, the experimental hub execution unit 143 may execute the plurality of scenario combinations included in the experimental hub file through the model execution unit 130.

The results of the experimental hub file executed in the model execution unit 130 are transmitted to the experimental hub unit 140, and the experimental hub unit 140 may also generate an experimental hub output file 1266 as an output file 1260 and a log file 1263 for the experimental hub execution. The experiment hub output file 1266 may include a log of the results of the experiment hub file execution and production plan data for the plurality of models.

The output file 1260 may be uploaded to the database 150 of the client manufacturing production system 100. When uploading, uploading in the form of an experimental hub compressed file 1266, or uploading the results not in the form of a compressed file is possible. In addition, the output file 1260 may be retrieved through a retrieval interface included in the client manufacturing production system 100, or the result may be provided through an external file service unit 220 so that it may be retrieved in the model analysis unit 1300 or the experiment hub analysis unit of the experiment hub unit 140.

Through the experimental hub operation described above, information may be easily obtained by combining/processing the results of the plurality of scenarios. This is because a series of processes, such as automatically generating scenarios based on factor values, performing in parallel, and calculating/merging key performance indicators, are automated.

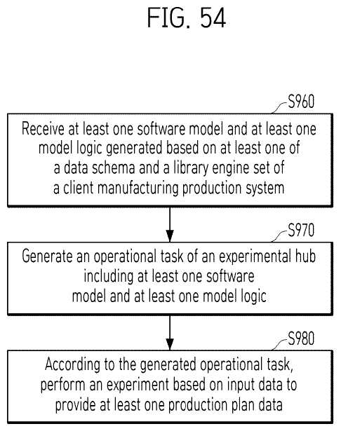

FIG. 54 is a flowchart illustrating a method for providing digital production plan information according to an embodiment.

At least one software model and at least one model logic generated based on at least one of data schema or library engine set of a client manufacturing production system may be received S960. As described above, the software model and logic set generated in the model development unit may be uploaded to the system operation unit through the server management unit.

An operational task of an experimental hub including at least one software model and at least one model logic may be generated S970. As described above in FIGS. 51 and 52, the system operation unit may generate an experiment hub operational task based on the uploaded experiment hub file. In addition, it is possible to generate execution conditions for experimental hub operational tasks. Additionally, prior to performing an operational task, the predetermined execution conditions may be set whether to be activated or deactivated.

According to the generated operational task, an experiment may be performed based on input data to provide at least one production plan data S980. At least one of the production plan data may include an experiment summary and scenario results, which are the results of a performed experiment. Additionally, if the refinement logic is set, the refinement results may be provided as included in the experiment summary. The experiment summary may include factor values for each scenario, key performance indicator values derived from scenario execution, execution/completion time, success or failure of execution, execution order, etc. Additionally, scenario results may correspond to output data, including result data from running a single model, log data, etc.

In addition, input data is data that represents the status of the client manufacturing production system and may correspond to data at a specific point in time with a certain format and content. As described above, the experimental hub unit may generate results including production plan information, operating system logs, etc. based on the execution results of the model execution unit and upload them to the database of the client system.

Referring to FIG. 29, an embodiment of a device providing digital production plan information including an experimental hub is described as follows.

An embodiment of a device providing digital production plan information may include an input unit 410, a storage unit 420, an in-memory unit 430, a processor 440, an output unit 450, and a user interface 460. For example, a device that provides digital production plan information may correspond to a client's manufacturing production system.

An embodiment of a device providing digital production plan information below may be controlled by user control and management via a user interface 460.

The input unit 410 may receive a software model and logic set generated based on at least one of the data schema or the library engine set of the client manufacturing production system from the on-premise computing system.

The storage device 420 may store pre-prepared reference information or store received software model and logic set. The storage device 420 may include volatile memory or non-volatile memory.

In-memory 430 may store the software model, input data, library engine set, and products obtained in the process of performing the library engine, model execution unit, and experiment hub unit disclosed above. A library engine set may contain a production planning engine, which is a number of encapsulated function block files that generate production plans. The in-memory 430 of the embodiment may store intermediate outputs and/or final outputs related to the experimental hub operation work.

The processor 440 of the embodiment may generate an operational task of an experimental hub including at least one software model and at least one model logic. The processor 440 may set the execution cycle of the generated operational tasks and the dependencies between tasks. As described above, the operation service unit may generate (set) at least one of a script execution operational task or a mail transmission operational task in relation to the operational task of the experimental hub. Additionally, the processor 440 may perform an experiment based on input data according to the generated operational task to obtain at least one production plan data. At least one of the script execution operational task or the mail transmission operational task may be performed based on the experiment summary which is the result of performing the experiment hub operational task. Additionally, the processor 440 may upload results obtained through operational tasks to a database. In this regard, reference is made to FIGS. 51 to 53 as described above.

The output unit 450 may provide production plan data based on the execution results of the designed experiment so that production or operations may be managed in the client system.

As described above, the experiment hub is a collection of data that stores the information and experimental results necessary to execute various experiments using at least one software model and at least one logic set.

Editing, execution, and analysis related to the experiment hub may be performed through the experiment hub user interface, and the disclosed embodiments describe examples of performing tasks related to the experiment hub through the experiment hub user interface. Additionally, in relation to the experimental hub user interface, “button” means a software button, which may include an icon that may receive user input.

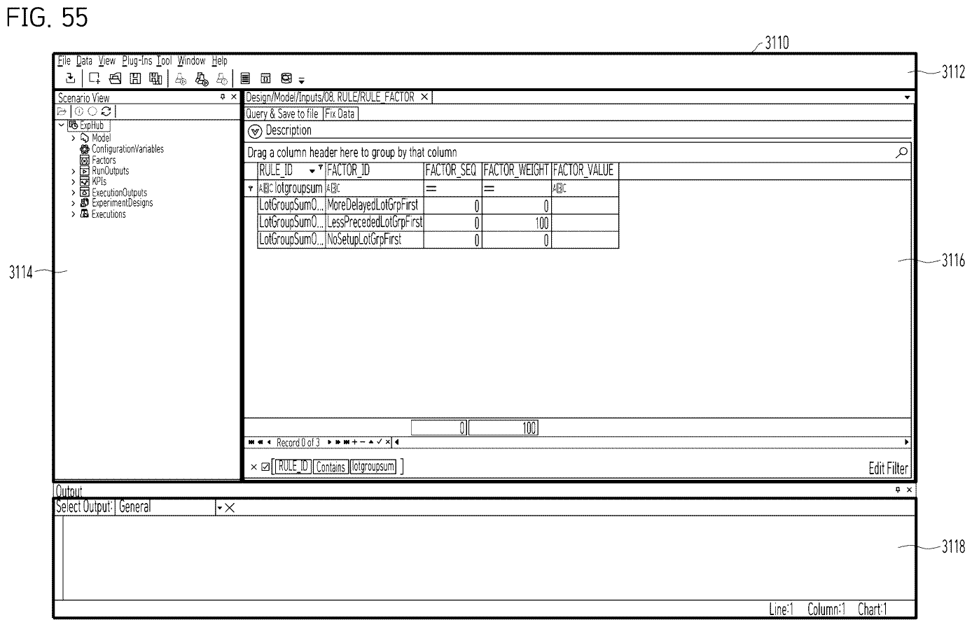

FIG. 55 is a diagram illustrating an example of an experimental hub screen according to an embodiment.

In the illustrated example, an experiment hub user interface 3110 may be provided for editing and running an experiment hub. The experimental hub user interface 3110 may include at least one of a menu area 3112, a component area 3114, a data retrieval area 3116, or a log output area 3118. In the illustrated example, the experimental hub user interface 3110 is illustrated as an embodiment, with the menu area at the top, the output area at the bottom, the component area at the left, and the data retrieval area at the right, but the locations of each area are not limited thereto. Through the experiment hub user interface 3110, experiment hub file generation, data retrieval, modification, and editing may be performed based on the software model and logic set.

As an example, the menu bar of the menu area 3112 may include file, data, view, plug-in, tool, etc., and the toolbar may display menus such as import, new, save, run single experiment, run the plurality of experiments, etc. as quick execution menus, but is not limited thereto.

As an example, the component area 3114 may include components related to design and execution of an experiment hub file, and may be displayed as divided into experiment design and experiment execution. For example, the experiment design may include, but is not limited to, submenus such as Model, Factors, RunOutputs, Key Performance Indicators (KPIs), and ExecutionOutputs. In this embodiment, the model is displayed as a menu at the same level as the factor, but it is also possible for the model to be displayed as a submenu of the factor.

As an example, the data retrieval area 3116 may display data related to an experiment. For example, the data retrieval area 3116 may display data (e.g., input data, output data) corresponding to at least one item selected in the component area. The data retrieval area 3116 may be displayed as a data table expressed in a grid format, or may also be displayed in a graph format.

As an example, the log output area 3118 may display a log for a scenario or model when an experiment is performed through the experiment hub 140 and a scenario based on a software model included in the experiment is performed. For example, the log output area 3118 may display logs for a single software model, logs for the plurality of software models, or logs for only some factors and key performance indicators included in the scenario, depending on user settings. Through the experiment hub user interface 3110, it is possible to more easily register model type factors and logic type factors, and generate, edit, design, and perform experiment component information including data type factors, factor values, and key performance indicators.

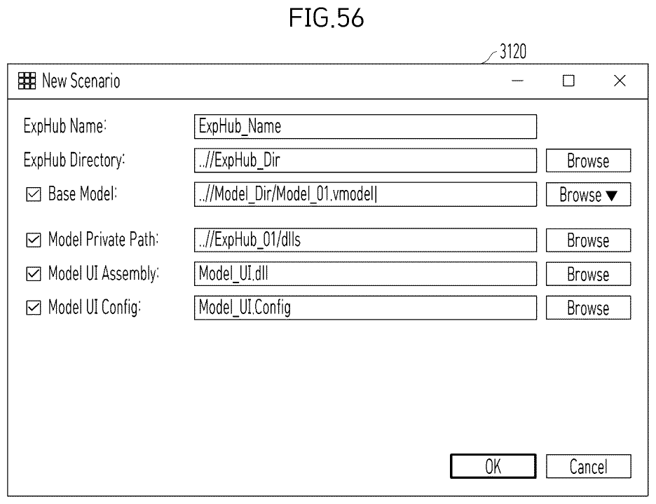

FIG. 56 is a diagram illustrating an example of file generation and factor registration on an experimental hub screen according to an embodiment.

The embodiment of FIG. 56 is a new experiment hub registration screen 3120, which corresponds to a screen provided when an input for a new generation menu is received in the experiment hub user interface described above. Additionally, the new experiment hub registration screen 3120 may be overlaid on the experiment hub user interface 3110 and displayed in a pop-up form.

A new experiment hub file may be generated through the new experiment hub registration screen 3120, and at least one model type and at least one logic type factor may be registered for the new experiment hub file. In ExpHub Name, a user input for the name of a new experiment hub file (ExpHub file) is displayed, and ExpHub Directory refers to the path where the ExpHub file is stored when a new ExpHub file is first generated. In this example, the experimental hub path is specified as a relative path of “ . . . //ExpHub_Dir”, but it may also be specified as an absolute path. The Base Model refers registering model type factors, and at least one software model to be used in a new experiment hub file may be registered. A Model Private Path refers registering a logic type factor, and at least one set of logic for executing a software model may be registered. Model UI Assembly and Model UI Config are used to register UIs to be used in software models, and it is possible to register custom UIs that may be linked with the model analysis unit. The experimental hub name and experimental hub path included in the new experimental hub registration screen 3120 are required input elements, and the remaining parts are optional input elements that are registered according to the user's choice.

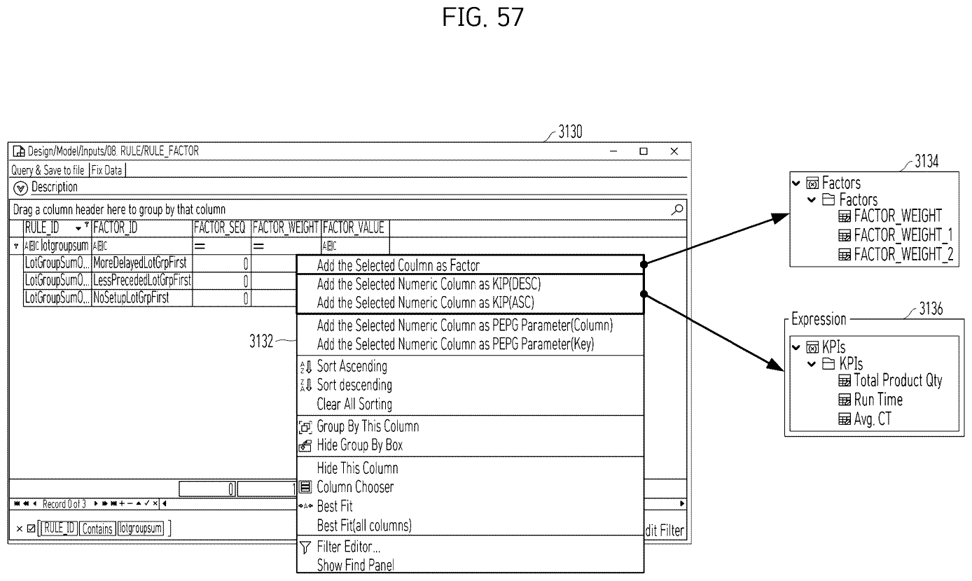

FIG. 57 is a diagram illustrating an example of generating data type factors and key performance indicators on a data table of an experimental hub file according to an embodiment.

The embodiment of FIG. 57 shows an example of adding data type factors and key performance indicators in the data retrieval area 3116 of the experimental hub user interface 3110 described above. Unlike the embodiments of new factor registration and key performance indicator registration described below, in the present embodiment, if an input signal is received while the data search area 3116 is activated, an additional pop-up 3132 for factor registration or key performance indicator registration may be output. For example, the state in which the data lookup area 3130 is activated may include a case in which the mouse point is located in the data lookup area 3116, a case in which there is a mouse click within the data lookup area 3116, etc. Additionally, for example, input signals may include a right mouse click, a double mouse click, a mouse wheel click, etc.

The additional pop-up 3132 may display a menu for adding items related to factors used in the experimental hub file, such as additional factor items and additional key performance indicator items. When an input signal for an additional factor item is received, an additional factor pop-up 3134 may be displayed. The factor addition pop-up 3134 may be output as an overlay on the data retrieval area 3116 or the additional pop-up 3132. In the factor addition pop-up 3134, factors that may be registered are displayed, and when an input signal for a factor is received, the factor may be registered and output with a column that is suitable for the current filter condition as a target column in the data retrieval area 3130.

When an input signal for adding a key performance indicator is received, a key performance indicator addition pop-up 3136 may be displayed. The key performance indicator addition pop-up 3136 may be output as an overlay on the data retrieval area 3116 or the additional pop-up 3132. The add key performance indicator pop-up 3136 displays the key performance indicators that may be registered, and when an input signal for the key performance indicator is received, the selected key performance indicator may be output on the data retrieval area 3116. For example, in the case of TotalProductQty, the table related to production quantity among the model's output data is opened and the sum of the values by column at the bottom of the grid is registered as a key performance indicator. In addition, if there is a refinement table that records the average cycle time (Avg. CT) by product, for example, it may be registered as a key performance indicator by specifying the filter condition (KPI_NAME=“ ”) and target column (Target Column KPI_VALUE) of the table.

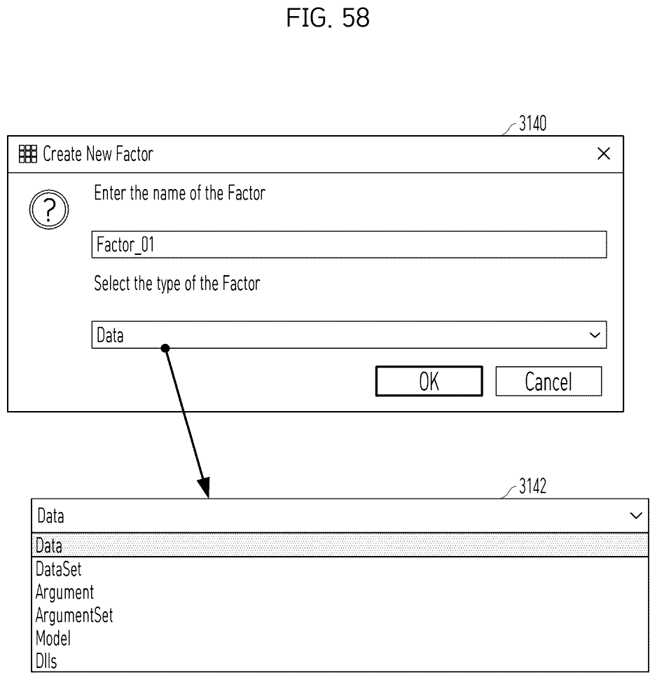

FIG. 58 is a diagram illustrating an example of generating model data factors of an experimental hub file according to an embodiment.

The embodiment of FIG. 58 shows an example of generating a new factor in the experimental hub user interface 3110. When an input signal for a factor generation menu (not shown) included in the experimental hub user interface 3110 is received, a new factor generation pop-up 3140 may be output. For example, when an input signal for Factors included in the component area 3114 of the experimental hub user interface 3110 is received, a new factor generation pop-up 3140 may be output. For example, input signals for Factors may include various forms of input, such as right-clicking, double-clicking, and hovering. The new factor generation pop-up 3140 may include an enter name area and a factor type selection area for the new factor.

When an input signal for a factor type selection area is received, options for selectable factor types may be output. In this embodiment, the factor type may include, but is not limited to, data (Data) representing a single data cell factor, a data set (DataSet) representing a table factor, a global argument (Argument), a set of global arguments (ArgumentSet), model (Model), and logic set (Dlls). When a signal is received to select one of several options included in the factor type option, a new factor for that option may be generated.

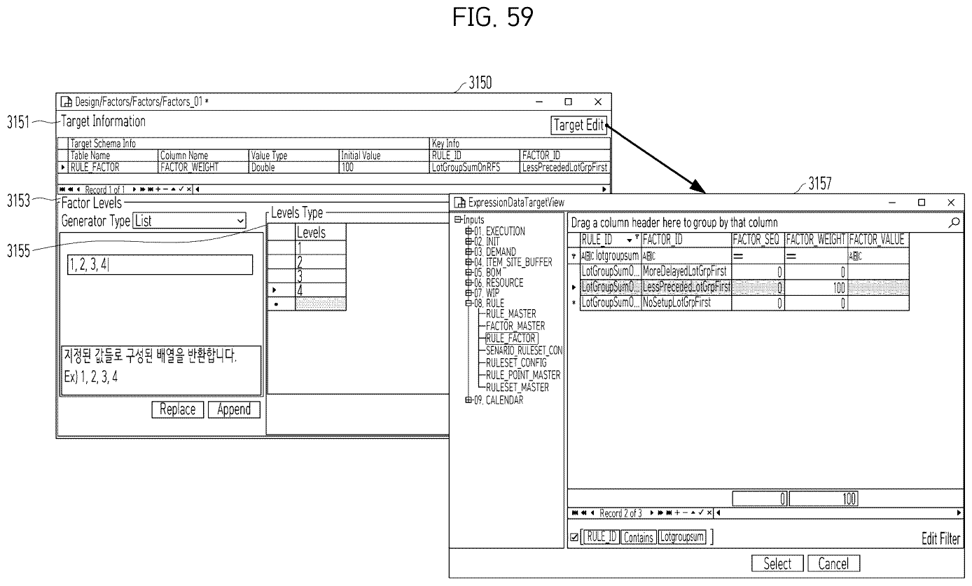

FIG. 59 is a diagram illustrating an example of generating a data type factor of an experimental hub file according to an embodiment.

The embodiment of FIG. 59 shows an example of editing a single data in the factor value editing screen 3150 in the data retrieval area 3116 of the experimental hub user interface 3110 described above. The factor value editing screen 3150 may include a target information area 3151, a factor level area 3153, and a level indication area 3155. The example shown is an example of registering a single data as a data type factor in the rule factor (RULE_FACTOR) data table.

When the target edit icon located on one side of the factor value edit screen 3150 is selected, the target edit screen 3157 may be output as an overlay on the factor value edit screen 3150. The target edit screen 3157 may include a menu area and an edit area indicating the type of data table. In this embodiment, when RULE_FACTOR, a sub data table of RULE, is selected, information about the RULE_FACTOR data table may be displayed.

When a specific cell (key) in the RULE_FACTOR data table is selected and an input for the select button is received, information for the selected cell may be output. In this embodiment, when the FACTOR_WEIGHT column is targeted in the RULE_FACTOR table in the table schema, the factor type is Double, and the initial value is 100, the information on the Key, which is a single data, such that the Rule ID is LotGroupSumOnRFS and the FACTOR_ID is LessPrecededLotGrpFst, may be output on the target information area 3151. This allows to enter factor values for a single cell in a data table. As shown in this example, it is possible to input the plurality of factor values for one factor.

Meanwhile, in the target information area 3151, the factor weight (FACTOR_WEIGHT) in the rule factor (RULE_FACTOR) data table becomes the target of factor value editing, and List is selected among the plurality of options selectable in the factor level area 3153. When List is selected, factor levels may be specified based on user input. In this embodiment, depending on what is input as “1,2,3,4”, the corresponding factor level may be output in the level indication area 3155. In addition, in the factor level area 3153, it is also possible to select Range or Distribution in addition to List. Range is a type that may set the minimum value (min), maximum value (max), and increase amount, and Distribution is a type that randomly extracts level values from a specified distribution. Additionally, the factor level (value) registered in the level indication area 3155 may be used as a factor value in a later experiment design.

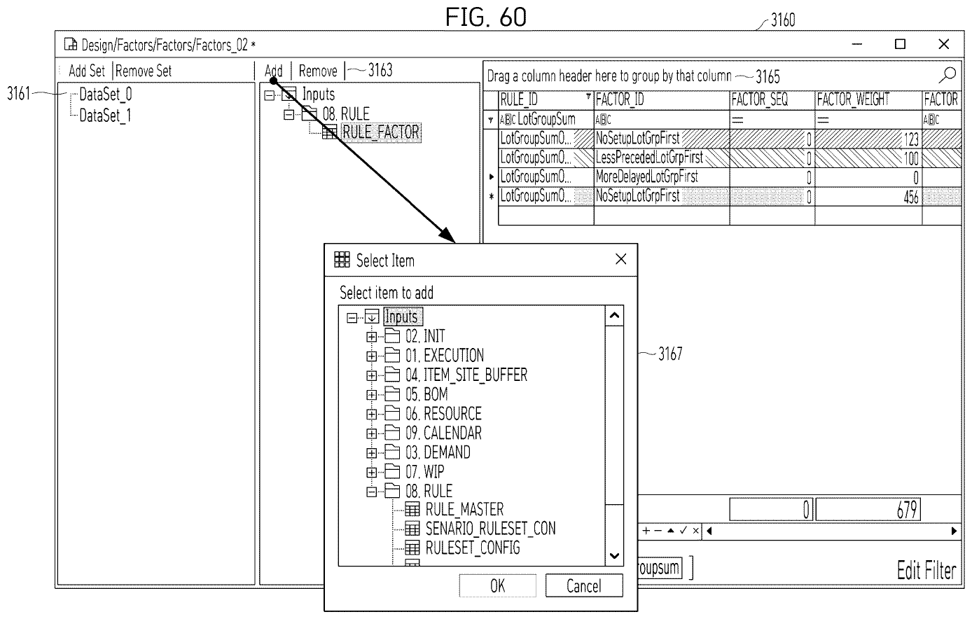

FIG. 60 is a diagram illustrating an example of generating a data type factor of an experimental hub file according to an embodiment.

The embodiment of FIG. 60 shows an example of editing the plurality of data in a data table editing screen 3160 in the data retrieval area 3116 of the experimental hub user interface 3110 described above. The data table editing screen 3160 may include a dataset menu area 3161, a table to change area 3163, and an editing area 3165. The example shown is an example of editing the factor values of the table itself in the rule factor (RULE_FACTOR) data table.

The dataset menu area 3161 indicates factor values as the dataset currently being edited, and in this embodiment, corresponds to the case where DataSet_1 is being edited. The table to change area 3163 corresponds to an area that indicates the table factor value to be edited. When an input is received to add a table in the table to change area 3163, an add table pop-up 3167 may be displayed. The add table pop-up 3167 may include details of table factors to be edited. When an input for selection and OK button for one of the table factor details is received, the table factor value may be displayed in the edit area 3165.

Additionally, if there are edits to each row in the table factor values, it may be displayed through graphic effects. For example, graphic effects may correspond to color coding, indicating in yellow if there is an edit to the data contained in a row, in red if there is a deletion to the row itself, and in green if a row is added, but these are only examples and are not limited to these examples. This allows users to quickly recognize which table factor values have been edited.

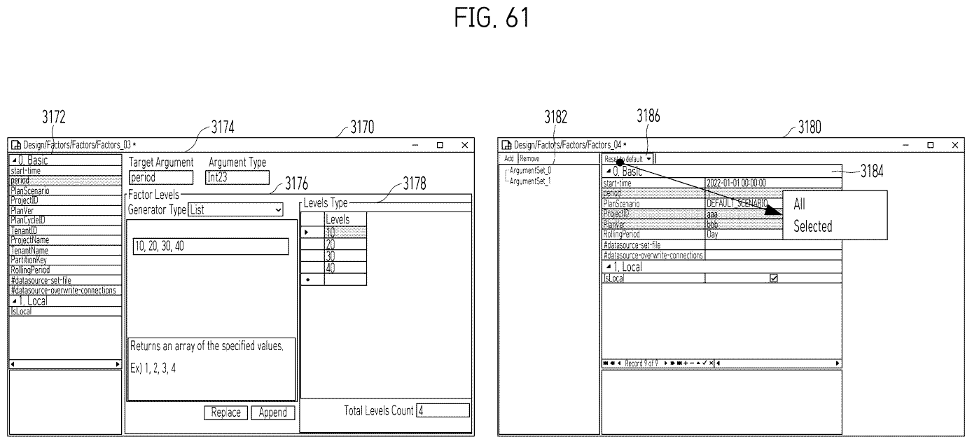

FIG. 61 is a diagram illustrating an example of generating a data type factor of an experimental hub file according to an embodiment.

The embodiment of FIG. 61 shows an example of registering a data type factor in the data retrieval area 3116 of the experimental hub user interface 3110. The example on the lefts is for a case of registering a single global argument, and the example on the rights is for a case of registering the plurality of global arguments.

A single global argument edit screen 3170 may include a global argument list area 3172, a target global argument 3174, a factor level area 3176, and a level table area 3178. The example shown is an example of registering information about a global argument when specifying a name for the global argument, and is an example of editing information about the period global argument. For example, if a period global argument is selected among at least one global argument included in the global argument list 3172, the selected period global argument may be displayed in the target global argument 3174 and Int may be displayed in the global argument type. Additionally, for example, when the PlanVer global argument included in the global argument list 3174 is selected, PlanVer may be displayed in the target global argument 3174 and String may be displayed in the global argument type. The Period global argument may represent the time period during which an operation is performed or the production plan interval. In addition, as described above, it is possible to set factor levels in various ways by determining a type for adjusting the factor level in the factor level area 3176. When List is selected, factor levels may be specified based on user input. In this embodiment, according to the input as “10, 20, 30, 40” in the factor level area 3176, the corresponding factor level may be output in table form in the level table area 3178.

The plurality of global argument editing screen 3180 may include a global argument set area 3182 and a global argument collection area 3184. A global argument set may be added by selecting add in the global argument set area 3182, and when a selection is received for each global argument set, the contents of the corresponding global argument set may be output to the global argument set area 3184. The value for each item in the output global argument set may be the global argument set in the model when the model factor was initially registered. It is possible to modify the factor values for each of the plurality of global arguments output. Meanwhile, if there are edits to global argument values, graphical effects such as color changes can be used to indicate that it has been edited. For example, if a global argument value is modified, it may be highlighted in yellow, and if a global argument value is deleted, it may be highlighted in red. Additionally, when initialize the global argument modifications, the reset button 3186 included in the global argument set area 3184 may be selected. When the reset button 3186 is selected, an option to select all or part of the selection may be output. If all are selected, the values of all global arguments are initialized, and if some part are selected, it is possible to initialize the values of global arguments that have been modified (parts with graphic effects).

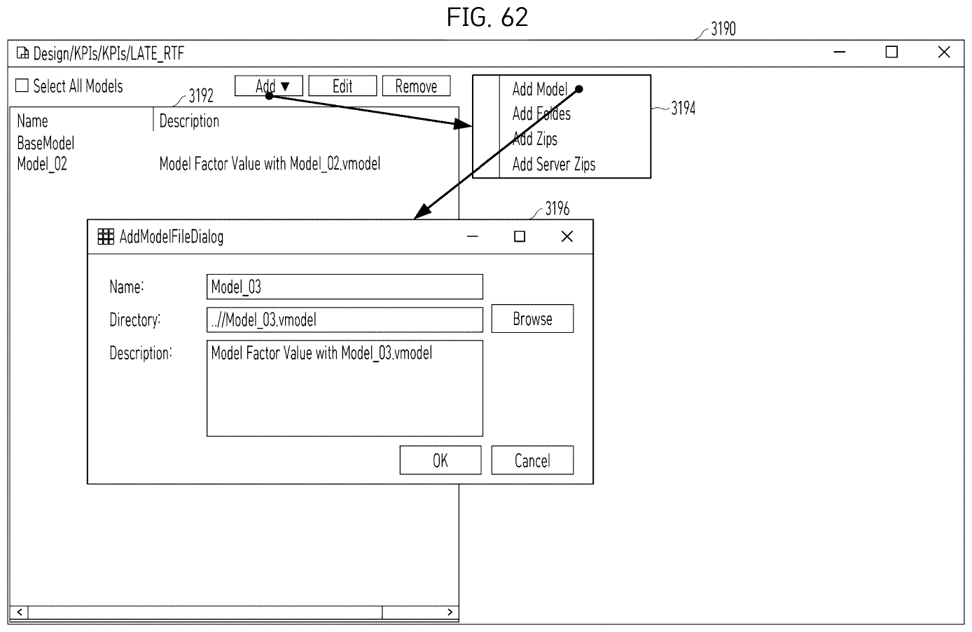

FIG. 62 is a diagram illustrating an example of registering a model type factor of an experimental hub file according to an embodiment.

The model type factor registration screen 3190 may include a model list area 3192 that outputs a list of registered models. In the illustrated example, the registered model list may include BaseModel, Model_02. The model list area 3192 may display an Add button for adding a model, an Edit button for editing a model, and a Remove button for removing a model. When a selection for the Add button is received, add options 3194 may be overlaid and output on the model type factor registration screen 3190. Add options 3194 may include adding a model by specifying a single model file for registration, adding a folder for registering the plurality of models contained within the folder, adding a compressed file (zip) for registering a model contained within a single (or the plurality of) compressed file, and adding a server compressed file for registering a model from a file saved in the form of a compressed file after being operated on the system operation unit.

When adding a model (Add Model) is selected among the add options 3194, the model addition screen 3197 may be overlaid and output on the model type factor registration screen 3190. The model addition screen 3197 may include a name area for entering a name to identify the model, a model directory area, and a description area for entering a description of the model. Additionally, the model directory may be set as a relative or absolute directory. In this embodiment, when data for each area is entered and a selection for the Ok button is received, the added model, Model_03, may be displayed on the model list area 3192. Since the model itself corresponds to a factor value and model addition is possible, it becomes possible to design experiments by applying various models rather than applying a single model to each scenario included in the experiment hub.

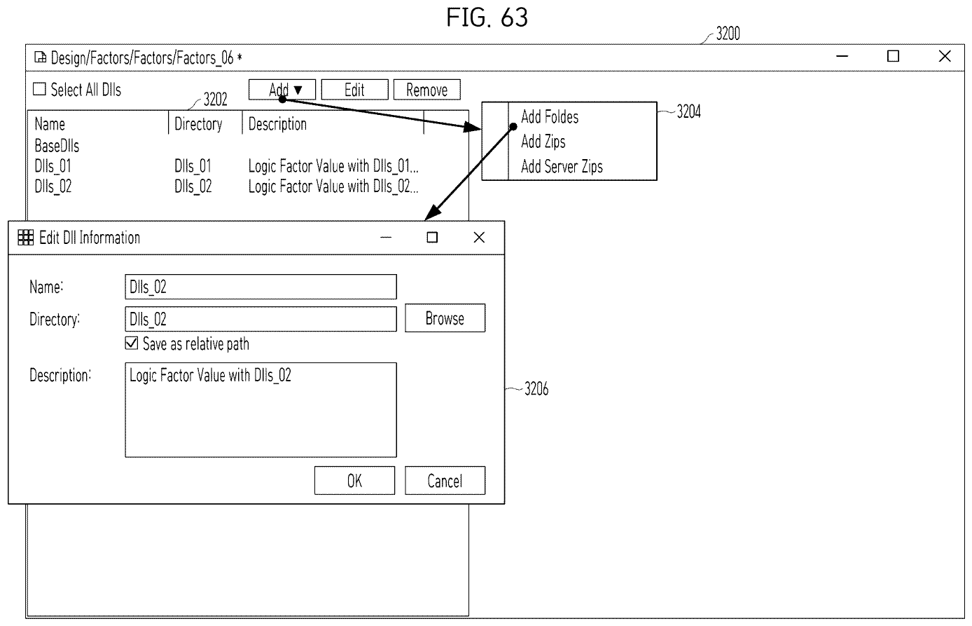

FIG. 63 is a diagram illustrating an example of registering a logic type factor of an experimental hub file according to an embodiment.

The logic type factor registration screen 3200 may include a logic list area 3202 that outputs a registered logic set. In the illustrated example, the registered logic set may include Dlls_01. The logic list area 3202 may display an Add button for adding the logic set, an Edit button for editing the logic set, and a Remove button for removing the logic set. When a selection for the Add button is received, an add option 3204 may be overlaid and output on the logic type factor registration screen 3200. Add options 3204 may include adding a folder to enter a single path containing logic files, adding the plurality of folders to add the plurality of paths containing logic files, adding a compressed file to add a single (the plurality of) compressed file containing logic files, etc.

When adding a folder is selected among the add options 3204, the logic addition screen 3206 may be overlaid and output on the logic type factor registration screen 3200. The add logic screen 3206 may include a name area for describing a name that specifies the logic, a logic directory area, and a description area for describing the logic. Additionally, the logical directory may be set as a relative directory or an absolute directory. In this embodiment, when data for each area is entered and a selection for the Ok button is received, the logic Dlls_02 added to the organization list area 3203 may be displayed. By adding the logic set, it is possible to design experiments by applying different logic to each model for the execution of each scenario included in the experiment hub.

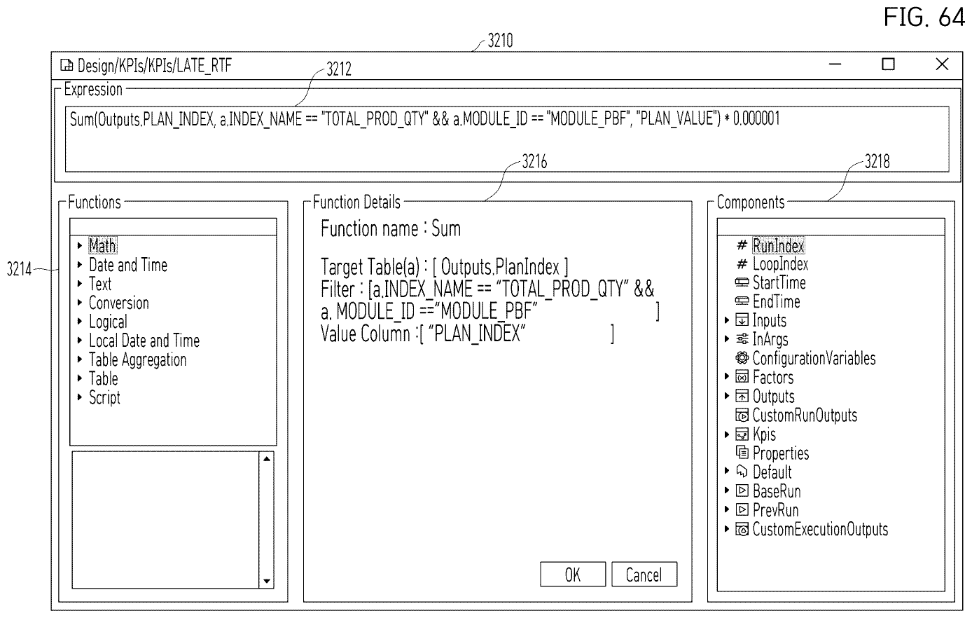

FIG. 64 is a diagram illustrating an example of registering key performance indicators of an experimental hub file according to an embodiment.

The key performance indicator registration screen 3210 may include a key performance indicator calculation area 3212, a key performance indicator list area 3214, a key performance indicator editing area 3216, and a key performance indicator component area 3218. In the key performance indicator list area 3214, the pre-set functions may be displayed, such as Math, Data and Time, Text, Conversion, Logical, Logical Date and Time, Table Aggregation, Table, Script. When each function is selected, lower level functions may be displayed additionally. In this example, Table Aggregation is selected and Sum, which is a lower level of Table Aggregation, is displayed.

When a function is selected in the key performance indicator list area 3214, information that needs to be entered in relation to the function may be output in the key performance indicator edit area 3216. In the present embodiment, when sum is selected, “Target Table (a): [ ] Filter: [ ] Value Column: [ ]” may be output in the key performance indicator editing area 3216. In addition, the items to be entered may be output as components in the key performance indicator component area 3218, and the components may be displayed by moving them from the key performance indicator component area 3218 to the key performance indicator editing area 3216 through drag and drop. For example, components may include but are not limited to RunIndex, LoopIndex, StartTime, EndTime, Inputs, Factors, Outputs, CustomRunOutputs, KPIs, Default, BaseRun, PrevRun, etc. Each component may have the plurality of sub-components depending on the characteristics of the component. For example, in the case of Outputs. PlanIndex shown in this embodiment, it corresponds to a component at a lower level of Outputs.

In the present embodiment, by utilizing the components displayed in the component area 3218, “Target Table (a): [Outputs. PlanIndex]” in the key performance indicator editing area 3216 may correspond to the meaning that the Target Table is referred to as ‘a’ and the table of PLAN_INDEX will be used in the output. “Filter: [a. INDEX NAME==“TOTAL_PROD_QTY” && a. MODULE ID==“MODULE_PBF”]” may refer that in the PLAN_INDEX table where INDEX NAME is TOTAL_PROD_QTY and MODULE ID only applies MODULE_PBF data. “Value Column: [“PLAN_INDEX”]” may refer to add the value of the column corresponding to PLAN_INDEX.

When the OK button is selected after the description is completed, the edited key performance indicator may be output on the key performance indicator calculation area 3212. For example, if the numerical unit of the content displayed in the key performance indicator calculation area 3212 is large, it is possible to simplify the number by adding *0.0000001 through additional user input. In addition, editing of key performance indicators is performed not only through selection of functions included in the key performance indicator list area 3214 and components included in the key performance indicator component area 3218, but also by directly entering functions and components into the key performance indicator editing area 3216.

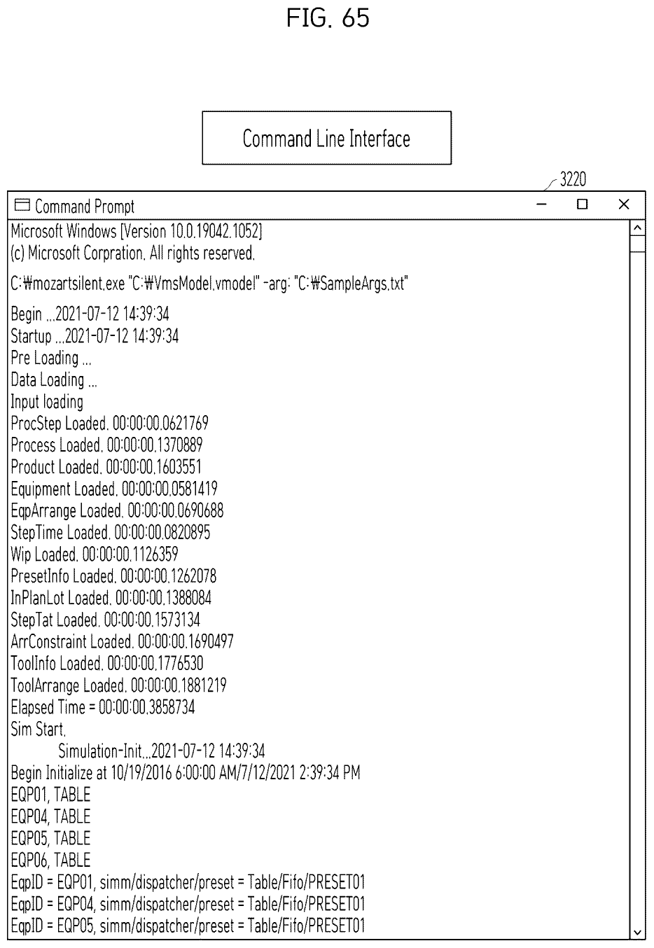

FIG. 65 is a diagram illustrating another example of a method for editing an experimental hub according to an embodiment.

As described above, the experiment hub may be edited via the experiment hub user interface 3110. In this case, it is possible to edit the information contained in the experiment hub through the downloaded program or on the Web UI. In addition, when using the experiment hub user interface 3110, it is possible to perform execution commands through linkage with the experiment hub execution unit and it is possible to output log data of the experiment in progress in real time.

In addition, the experimental hub may be edited through the command interface 3220. Even when using the command interface 3220, it is also possible to perform execution commands through linkage with the experiment hub execution unit and it is possible to output log data of the experiment in progress in real time.

As an example, on the command interface 3220, a command for generating an experiment hub may be described as “CreateHub-Path: userpath\HubFolderPath”, a command for adding a model factor may be described as “AddModelFactor-Name:Model01-ModelPath: userpath\ModelFolderPath\Model_01.vmodelv”, and a command for adding a logic factor may be described as “AddLogicFactor-Name: Logic01-LogicPath: userpath\LogicFolderPath\ or userpath\LogicFolderPath\Logic_01.zip”.

As an example, a command for adding an experiment design may be written as “AddExpDesign-Name: ExpDesign01-Type: Fixed or Iterative (Adaptive)”, a command for adding an experimental execution may be written as “AddExecution-Name: Execution01-TargetDesign: ExpDesign01”, and a command for modifying an experimental execution may be written as “AddExecution-Name: Execution01-TargetDesign: ExpDesign01”.

In this way, editing of the experimental hub may be performed by directly entering a command in addition to using the user interface 3110.

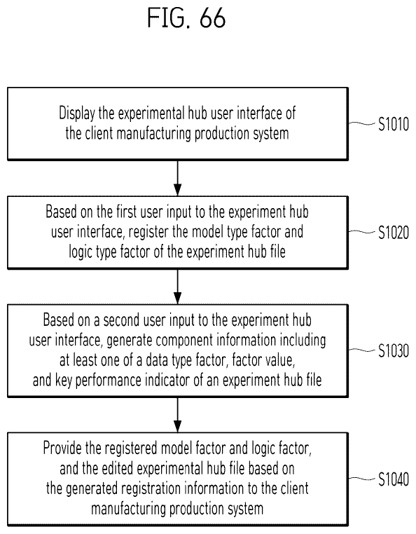

FIG. 66 is a flowchart illustrating an example of providing digital production plan information according to an embodiment.

The experimental hub user interface of the client manufacturing production system may be displayed S1010. As described above in FIG. 1, the experiment hub editing user interface may include at least one of a menu area 3112, a component area 3114, a data retrieval area 3116, or a log output area 3118. As described above in FIG. 65, editing and retrieving of the experimental hub is possible not only through the experimental hub user interface but also through the command interface.

Based on the first user input to the experiment hub user interface, the model type factor and logic type factor of the experiment hub file may be registered S1020. The first user input may correspond to not only a single input but also the plurality of inputs. It is possible to generate component information including at least one of a data type factor or a key performance indicator S1020. In this regard, an example is given in FIG. 56. Model type factors of an experimental hub file may be registered in the registration screen of a new experimental hub file. In addition, as described above in FIG. 62, the model type factor of the experimental hub file may be registered through a separate model type factor registration screen.

Based on a second user input to the experiment hub user interface, component information including at least one of a data type factor, factor value, or key performance indicator of an experiment hub file may be generated S1030. The second user input may correspond to a single input or the plurality of inputs. More specifically, generating component information may include generating single data factors, table factors, single global argument variables, global argument set variables, and key performance indicators. As an example, a single data factor may be set through data specific information, factor type, and level indication of the factor type. As an example, a single global argument may be specified via the target global argument, the global argument type, and the level indication of the global argument type. In this regard, reference is made to the contents described above in FIGS. 57 to 77.

An edited experimental hub file based on the generated registration information may be provided to the client manufacturing production system S1040. The edited experimental hub files may be provided for future experiment design and execution.

Referring to FIG. 29, an embodiment of a device for analyzing a production plan based on a software model and logic set and providing digital production plan information is described as follows.

An embodiment of a device providing digital production plan information may include an input unit 410, a storage unit 420, an in-memory unit 430, a processor 440, an output unit 450, and a user interface 460. For example, a device that provides digital production plan information may correspond to a client's manufacturing production system.

An embodiment of a device providing digital production plan information below may be controlled by user control and management via a user interface 460.

The input unit 410 may receive a software model and logic set generated based on at least one of the data schema or library engine set of the client manufacturing production system from the on-premise computing system.

The storage device 420 may store the pre-prepared reference information or store the received software model and logic set. The storage device 420 may include volatile memory or non-volatile memory.

In-memory 430 may store the software model, input data, library engine set, and products obtained in the process of performing the library engine, model execution unit, and experiment hub unit disclosed above. A library engine set may contain a production planning engine, which is a number of encapsulated function block files that generate production plans. The in-memory 430 of the embodiment may store intermediate outputs and/or final outputs related to the experimental hub operational task.

The processor 440 of the embodiment may display an experimental hub user interface of the client manufacturing production system. As described above in FIG. 55, the experimental hub user interface may include at least one of a menu area 3112, a component area 3114, a data retrieval area 3116, or a log output area 3118. Additionally, the processor 440 of the embodiment may register model type factors and logic type factors of the experimental hub file based on a first user input to the experimental hub editing user interface. In this regard, reference is made to FIG. 56 described above. Additionally, the processor 440 of the embodiment may generate component information including at least one of a data type factor, a factor value, or a key performance indicator based on a second user input to the experimental hub user interface. In this regard, reference is made to 70 to 77 described above. Additionally, the processor 440 may provide an edited experimental hub file based on the registered model factors and logic factors and the generated component information, to the client manufacturing production system.

The output unit 450 may provide the edited experiment hub file to enable production or operation management in a client system.

As described above, the experiment hub is a collection of data that stores the information and experimental results necessary to execute various experiments using at least one software model and at least one logic set.

Editing, execution, and analysis related to the experiment hub may be performed through the experiment hub user interface, and the disclosed embodiments describe examples of performing tasks related to the experiment hub through the experiment hub user interface. Additionally, in relation to the experimental hub user interface, “button” means a software button, which may include an icon that may receive user input. As described above in FIG. 55 (based on WISE editing UI), the experiment hub user interface 3110 may include at least one of a menu area 3112, a component area 3114, a data retrieval area 3116, or a log output area 3118.

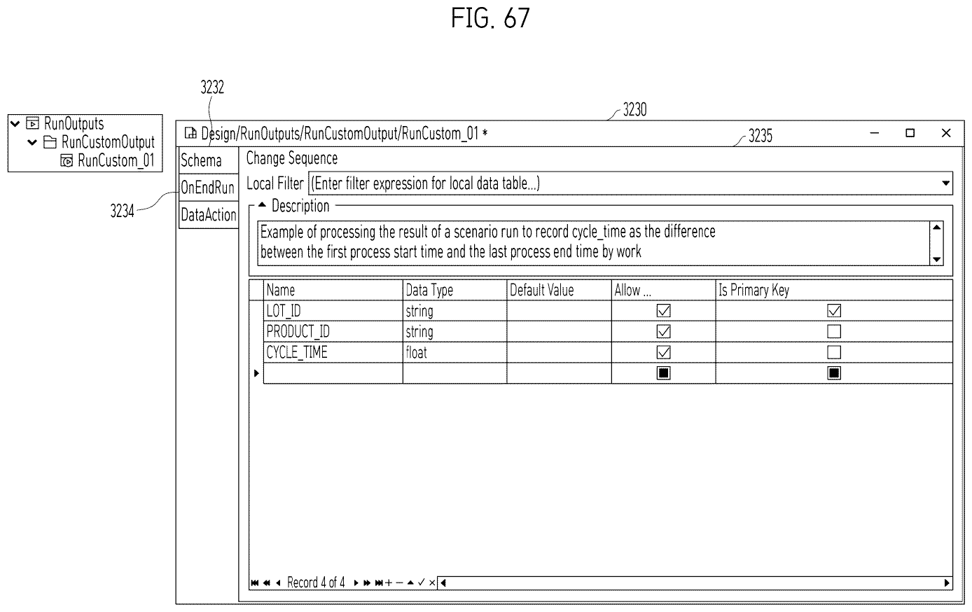

FIG. 67 is a diagram illustrating an example of a scenario refinement included in an experimental hub according to an embodiment.

As described above, the model development unit 1100 develops a software model and logic set, but in exceptional cases where the model and logic can be edited through the experiment hub, a refinement logic may be set. For example, the exceptional cases include cases where the model development unit modifies configurations that were difficult to reflect in the model and logic through experimental hub modifications, thereby refining the scenario data and obtaining the results. The refinement logic may be set for each scenario or experiment, and this embodiment describes an example of setting the refinement logic for each scenario.

FIG. 67 corresponds to a state in which a RunCustomOutput group is generated in a submenu of the RunOutputs component in the component area 3114 of the experimental hub user interface 3110 described above, and RunCustom_01, which is the subject of the scenario refinement logic, is generated within the RunCustomOutPut group. When an input signal for RunCustom_01, which is the subject of the scenario refinement logic, is received, a scenario refinement screen 3230 may be output in the data retrieval area 3116.

A menu required for scenario refinement may be output on one side of the scenario refinement screen 3230, and schema 3232, OnEndRun 3234, etc. may be included. Schema 3232 refers to a user interface that defines the data schema of the refined results for each scenario, and OnEndRun 3234 refers to a user interface that defines the format, logic, etc. for generating data that follows the previously defined data schema and collecting it into the data collection. Here, the data schema corresponds to the structural information of the data collection, and the data collection corresponds to where the data is actually stored.

When an input signal for the Schema menu 3232 is received, the Schema setting screen 3235 is displayed. This embodiment is an example of editing a data schema for refining scenario results at the end of each scenario, obtaining CycleTime by Lot, and then storing it. LOT_ID, PRODUCT_ID, and CYCLE_TIME may be set as data schema in the Schema setting screen 3235. LOT_ID is the work item ID and may be designated as a key, PRODUCT_ID corresponds to the product ID, and CYCLE_TIME corresponds to the difference between the start time of the first operation and the completion time of the last operation. Properties for the data schema may include Data Type, Default Value, Allow Nulls, IsPrimaryKey, etc. DataType indicates the type of data schema, Default Value indicates the value entered by default when no value is entered, Allow Nulls indicates whether to allow when a value is not entered, and IsPrimaryKey indicates whether to use it as a key of the data schema.

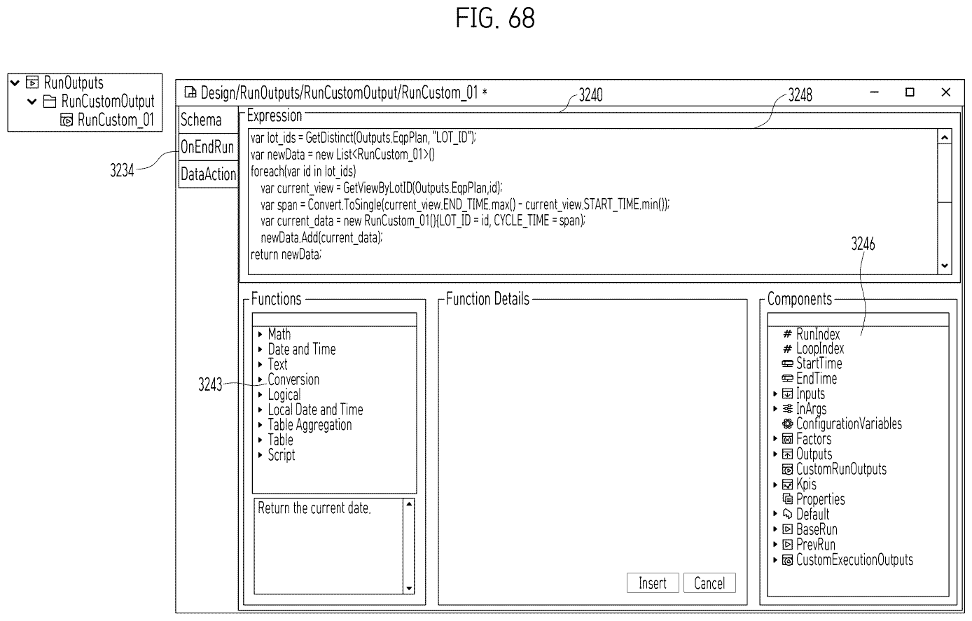

FIG. 68 is a diagram illustrating an example of a scenario refinement included in an experimental hub according to an embodiment.

This embodiment describes following the description of FIG. 67, an example of setting OnEndRun after Schema is set in the refinement logic for each scenario. OnEndRun is a user interface that may perform formatting, logic, programming, coding, etc. to collect data into a data collection by generating data that follows the previously defined data schema when refining the scenario results.

When an input signal for the OnEndRun menu 3232 is received, the OnEndRun setting screen 3240 is displayed. The OnEndRun settings screen 3240 may include Expressions 3248, Functions 3243, Components 3246, etc. Functions 3243 represents a list of functions provided to fill in the data schema, and Components 3246 represents a list of parameters that may be used in the functions, and parameter search is possible through a search window. In addition, Expression 3248 represents the written code to generate a data table according to the data schema, and data may be generated/output in various ways, such as executing a script through LinQPad or performing C# coding directly on the Expression 3248 screen.

In this embodiment, ‘var lot_ids=GetDistinct(Outputs. EqpPlan, “LOT_ID”);’ described in Expression 3248 means getting a list of values of the “Lot_ID” column that are not duplicated in the output table “EqpPlan”. ‘var newData=new List<RunCustom_01>( )’ means generating a Collection (List) with the generated schema RunCustom_01 as an item. ‘foreach(var id in lot_ids) var current_view=GetViewByLotID(Outputs. EqpPlan, id);’ means to sequentially look up a list of IDs that do not have duplicates and generate a View in EqpPlan with the Lot ID as the key. ‘var span=Convert. ToSingle(current_view. END_TIME. max ( )−current_view. START_TIME. min ( ));’ means finding the difference between the maximum end time and the minimum start time in the view specified by the current Lot ID. ‘var current_data=newRunCustom_01( ){LOT_ID=id, CYCLE_TIME=span, PRODUCT_ID=current_view. PRODUCT_ID};’ refers to generating data that follows the current schema (RunCustom_01) and input it so that it corresponds to each factor value (LOT_ID, CYCLE_TIME, PRODUCT_ID) when generating it. ‘newData. Add(current_data);’ refers input it into the generated Collection (list). The above process is repeated for all ids included in lot_ids in the foreach logic. Also, ‘return newData;’ refers to the process of returning/outputting the data collection after all foreach processes are finished.

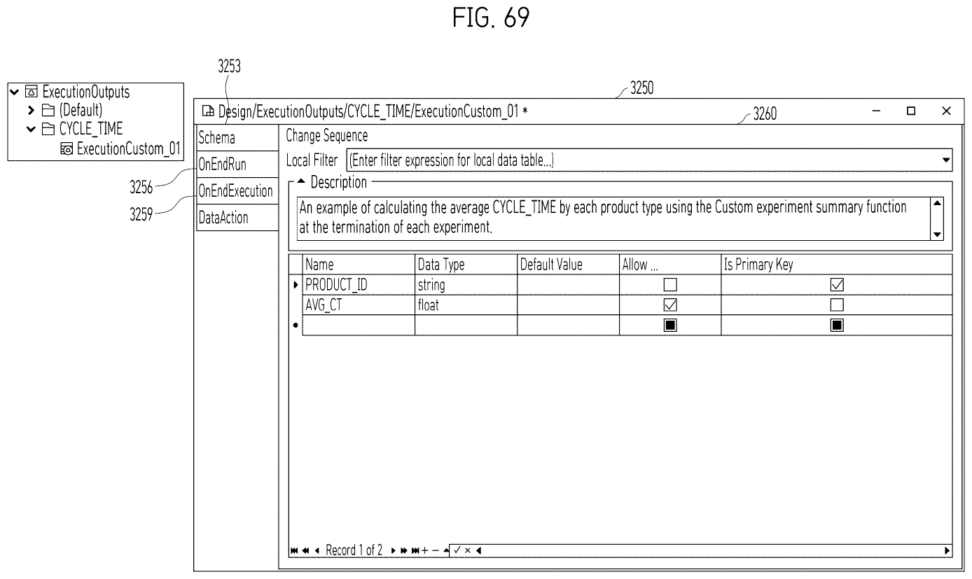

FIG. 69 is a diagram illustrating an example of an experimental refinement included in an experimental hub according to an embodiment.

This embodiment describes an example of providing an average cycle time through experiment refinement after an experiment is performed. This corresponds to a state in which a CYCLE_TIME group is generated in a submenu of the ExecutionOutputs component in the component area 3114 of the experiment hub user interface 3110, and ExecutionCustom_01, which is the subject of the experiment refinement logic, is generated within the CYCLE_TIME group. When an input signal for ExecutionCustom_01, which is the subject of the experimental refinement logic, is received, an experimental refinement screen 3250 may be output in the data retrieval area 3116.

A menu required for experimental refinement may be displayed on one side of the experimental refinement screen 3250, and may include a Schema menu 3253, an OnEndRun menu 3256, an OnEndExecution menu 3259, etc. Schema 3253 corresponds to a user interface that defines a data schema for an experiment, OnEndRun 3256 corresponds to a user interface that defines code, logic, programs, etc. for refining data that follows the defined data schema whenever a single scenario ends, and OnEndExecution 3259 corresponds to a user interface that may edit code for refining data using the plurality of scenario data included in an experiment when the experiment terminates.

When an input signal for the Schema menu 3253 is received, the Schema setting screen 3260 is displayed. This example corresponds to an example of calculating the average cycle time by each product type using the custom experiment summary function at the termination of each experiment. PRODUCT_ID and AVG_CT may be set as data schemas in the Schema setting screen 3260. PRODUCT_ID is the product ID and may be designated as a key, and AVG_CT corresponds to the average cycle time by product type. Properties for the data schema may include Data Type, Default Value, Allow Nulls, IsPrimaryKey, etc., the same as in the refinement for each scenario.

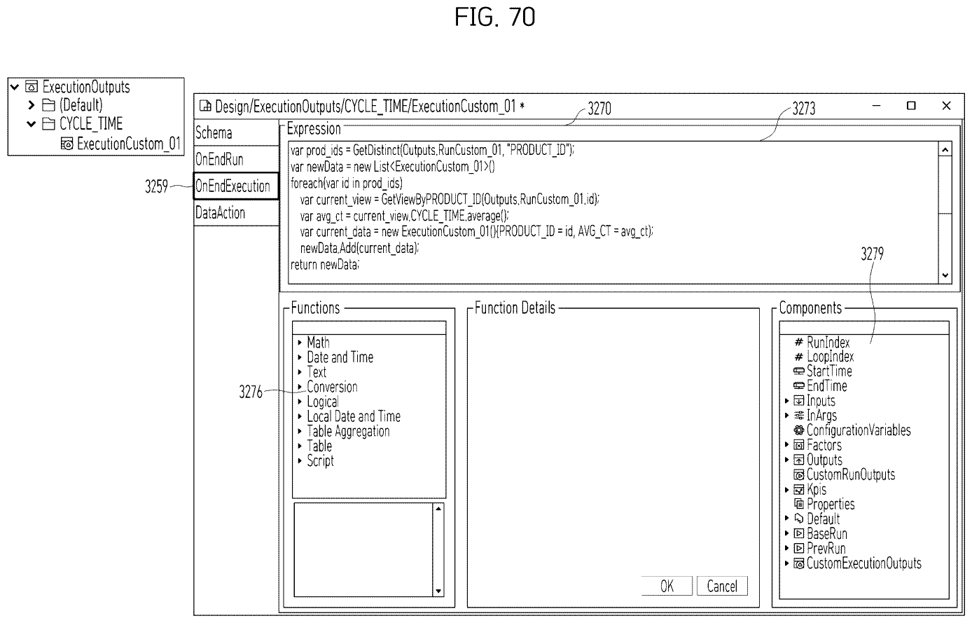

FIG. 70 is a diagram illustrating an example of an experimental refinement included in an experimental hub according to an embodiment.

In the above-described FIG. 69, after the data schema is set in the experiment refinement logic, an example of setting OnEndExecution so that RunCustom_01 may be utilized in the scenario refinement function is described. OnEndExecution is a user interface that allows you to edit code that refines the plurality of scenario data included in the experiment after the experiment has ended.

When an input signal for the OnEndExecution menu 3259 is received, the OnEndExecution setting screen 3270 is displayed. The OnEndExecution setting screen 3270 may include Expressions 3273, Functions 3276, Components 3279, etc. Functions 3276 represents a list of functions used for editing code, and Components 3279 represents a list of parameters that may be used in the functions. Additionally, Expression 3273 may provide a screen where the code may be edited directly.

In this embodiment, ‘var prod_ids=GetDistinct(Outputs. RunCustom_01, “’” described in Expression (3273) means getting a list of values of the “ ” column that are not duplicated in the RunCustom_01 refined output table of the examples in FIGS. 67 and 68. ‘var newData=new List<ExecutionCustom_01>( )’ means generating a Collection (List) with the created schema ExecutionCustom_01 as an item. ‘foreach(var id in prod_ids) var current_view=GetViewByPRODUCT_ID(Outputs. RunCustom_01, id);’ means to sequentially retrieve a list of IDs that do not have duplicates and generate a View in RunCustom_01 with PRODUCT_ID as the key. ‘var avg_ct=current_view. CYCLE_TIME. average ( )’ means calculating the average value of the CYCLE_TIME Column in the view specified by the current PRODUCT_ID. ‘var current_data=new ExecutionCustom_01 ( ){PRODUCT_ID=id, AVG_CT=avg_ct};’ means to generate data that follows the current schema (ExecutionCustom_01) and input each factor value (PRODUCT_ID, AVG_CT) to correspond when generated. newData. Add(current_data); means inputting it into the generated Collection (list). The above described process is repeated for all ids included in prod_ids in the foreach logic. ‘return newData;’ is the process of returning/outputting the data collection after all foreach processes are finished.

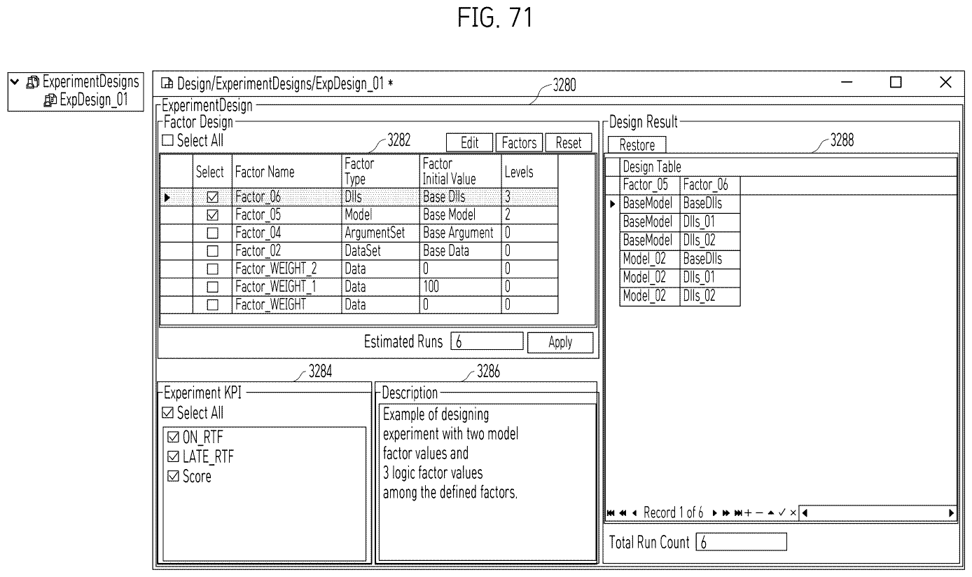

FIG. 71 is a diagram illustrating an example of editing an experiment design of an experimental hub file according to an embodiment.

As described above, the experiment design may be designed using the factor and key performance indicator information registered in the experimental hub file. Experiment design refers to setting combinations of factor values and key performance indicators, and experiment design may include fixed-size experiment design and iterative experiment design. This example illustrates editing a fixed-size experiment design. Although not shown, editing an iterative design may be done through a separate user interface from the editing user interface for fixed-size designs.

This embodiment corresponds to a state in which ExpDesign_01, which is the subject of the experiment design, is generated among the components of Experiment Designs in the component area 3114 of the experimental hub user interface 3110. When an input signal for ExpDesign_01, which is the subject of the experiment design, is received, the experiment design screen 3280 may be output in the data retrieval area 3116.

The experiment design screen 3280 may include a factor design area 3282, a key performance indicator area 3284, a description area 3286, and a design result area 3288. The factor design area 3282 is an area that outputs a list of factors defined in the experiment, and may include information on factor name, factor type, factor initial value, number of factor values, and whether to use (select) them in the experiment. The key performance indicator area 3284 may include a list of key performance indicators defined in the experiment hub, and key performance indicators selected from the output list of key performance indicators may be calculated in the experiment. The description area 3286 may represent a description of an experiment designed in the factor design area 3286. The design result area 3288 may output a list of scenarios generated by combining factor values to be performed in the experiment. After selection of factors to be included in an experiment is completed in the factor design area 3282, when an input signal is received for the apply button located on one side of the factor design area 3282, all possible combinations that can be experimented may be output to the design result area 3288. In this example, Factor_05 is a model type factor with a factor value count of 2, and Factor_06 is a logic type factor with a factor value count of 3, so six design results are output in the design result area 3288. For example, BaseModel described in the Factor_05 column and BaseDlls described in the Factor_06 column in row 1 of the design result area 3288 correspond to one scenario combination. Additionally, it is possible to selectively delete the plurality of scenario combinations described in the design result area 3288.

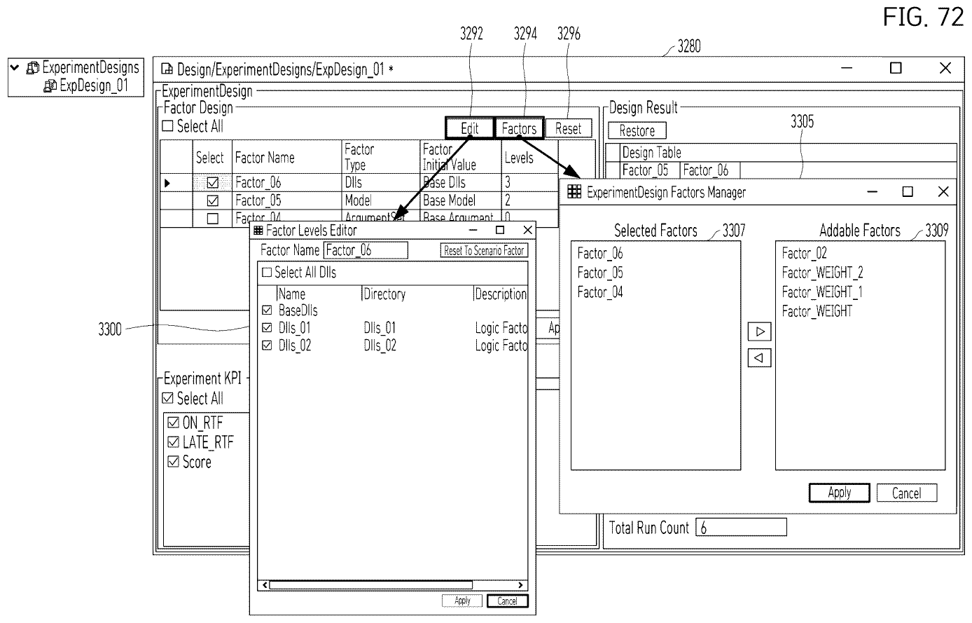

FIG. 72 is a diagram illustrating an example of editing an experiment design of an experimental hub file according to an embodiment.

This embodiment describes an example of editing factors to be used in an experiment design or editing logic type factors included in an experiment design in the experiment design screen 3280. The factor design area 3282 may include a design edit button 3292, a factor edit button 3294, and a reset button 3296 on one side. The design edit button 3292 is a button for performing editing on a specific factor, the factor edit button 3294 is a button for performing editing on a factor list displayed in the factor design area 3282, and the reset button 3296 is a button for initializing to the initial factor values included in the experiment hub.

When an input signal for the design edit button 3292 is received, a first design edit pop-up 3300 may be displayed on the experiment design screen 3280. In this embodiment, the input signal for the design edit button 3292 corresponds to an input received in a state where the data table for the Factor_06 factor in the factor design area 3282 is specified. At this time, the factor of Factor_06 is a logic type factor, and the output first design editing pop-up 3300 corresponds to a user interface for editing the logic type factor. It is possible to check the list of logic type factors included in the Factor_06 factor through the first design editing pop-up 3300 and select the logic to apply.

When an input signal for the factor editing button 3296 is received, a factor editing pop-up 3305 may be displayed on the experiment design screen 3280. The factor editing pop-up 3305 output in response to an input signal for the factor editing button 3296 may include a selected factor 3307 and an additional factor 3309. The selected factor 3307 shows a list of factors currently output in the factor design area 3282, and the addable factor 3309 shows a list of factors that are not currently output in the factor design area 3282, but may be added and output in the factor design area 3282. By user selection, some of the selected factors 3307 may be moved to the addable factors 3309, thereby excluding them from the list output in the current factor design area 3282. Additionally, by user selection, some of the addable factors 3309 may be moved to the selected factors 3307 and added to the list output in the current factor design area 3282.

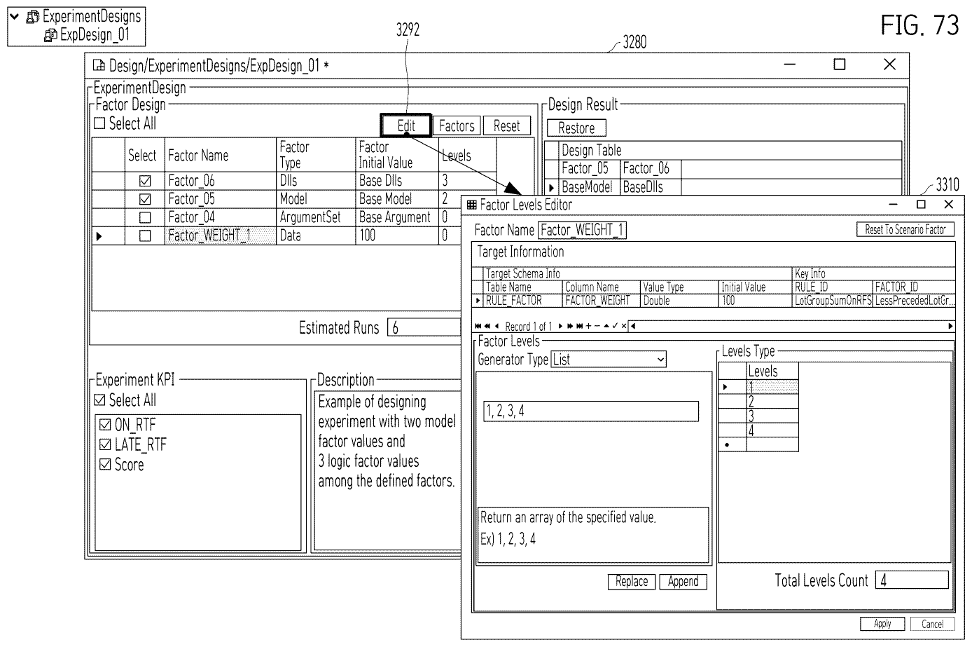

FIG. 73 is a diagram illustrating an example of editing an experiment design of an experimental hub file according to an embodiment.

This embodiment describes an example of editing data type factors included in an experiment design in the experiment design screen 3280. When an input signal for the design edit button 3292 is received, a second design edit pop-up 3310 may be displayed on the experiment design screen 3280. In this embodiment, the input signal for the design edit button 3292 corresponds to an input received in a state where FACTOR_WEIGHT_1, which is a single data of the factor design area 3282, is specified. At this time, the single data FACTOR_WEIGHT_1 is a data type factor, and the output second design editing pop-up 3310 corresponds to a user interface for editing the data type factor. Through the second design editing pop-up 3310, it is possible to check the information of the data type included in the FACTOR_WEIGHT_1 factor and edit the factor level, level indication, etc.

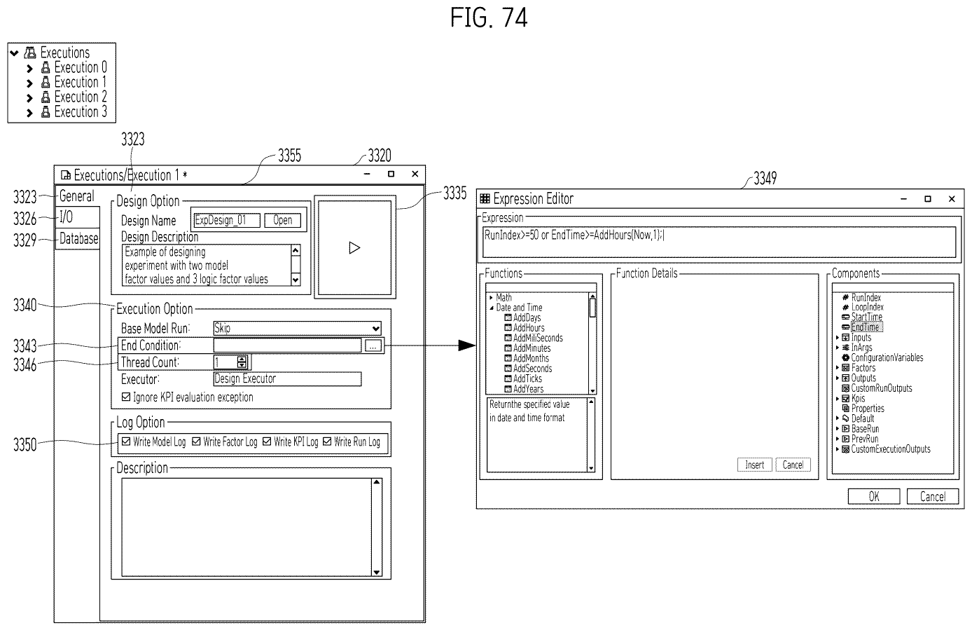

FIG. 74 is a diagram illustrating an example of editing an experimental performance of an experimental hub file according to an embodiment.

This embodiment describes an example of executing an experiment according to the experiment design set in the above-described embodiment. In the component area 3114 of the experiment hub user interface 3110, the Execution 0, Execution 1, Execution 2, and Execution 3 groups are generated in the submenu of the Executions component, and the state corresponds to the generation of ExpDesign_01, within one of the plurality of groups that is subject of the experiment. When an input signal for ExpDesign_01, which is the subject of the experiment, is received, an experiment execution screen 3320 may be output in the data retrieval area 3116.

A menu required for executing an experiment may be displayed on one side of the experiment execution screen 3320, and may include a general menu 3323, an input/output menu 3326, a database menu 3329, etc. The general menu 3323 corresponds to a user interface that sets general items required for executing an experiment, the input/output menu 3326 corresponds to a user interface that sets input options and output options related to executing an experiment, and the database menu 3329 corresponds to a user interface that sets options for downloading data to be used in an experiment or uploading experimental data.

When an input signal for the general menu 3323 is received, the general menu setting screen 3355 is displayed. The general menu setting screen 3355 is a screen for setting overall contents of the performed experiment, and may include design options 3323, execution options 3340, log options 3350, and a performance button 3335. Design options 3323 may set the experiment design to be performed. In this embodiment, the ExpDesign_01 experiment design described above in FIG. 71 is set, and a description thereof may be described in the design description. Execution options 3340 set options for performing an experiment and may include end conditions 3343, number of parallel executions (thread count) 3346, executor, etc. When an input signal is received for a button for setting the end condition 3343, the end condition setting pop-up 3349 may be displayed on the experiment execution screen 3320.

The end condition setting pop-up 3349 may include Expressions, Functions, Components, etc. Functions shows the list of functions provided, Components shows the list of parameters that may be used in functions, and the search bar allows to search for parameters. Expression is an area that describes the end condition (also referred to as “the terminal condition”). In this example, an example is described that terminates when the number of runs exceeds 50 or 1 hour has passed since the execution time. The number of parallel executions 3343 may set the number of scenarios that are performed simultaneously in the experiment design.

Log options 3350 determine the logs to be displayed or recorded according to the performance of the experiment, and may include a model log, a factor log, a key performance indicator log (KPI Log), a run log, etc. The model log displays (records) the internal log of each scenario model, the factor log displays (records) the log to which factor values are applied, the key performance indicator log displays (records) the log to which key performance indicators are calculated, and the execution log displays (records) the log (Run ID, start/completion time) to execute each scenario.

After the settings for the general menu 3323 described above, as well as the input/output menu 3326 and database menu 3329 are completed, when an input signal for the execution button 3335 is received, an experiment execution command may be transmitted to the experiment hub execution unit.

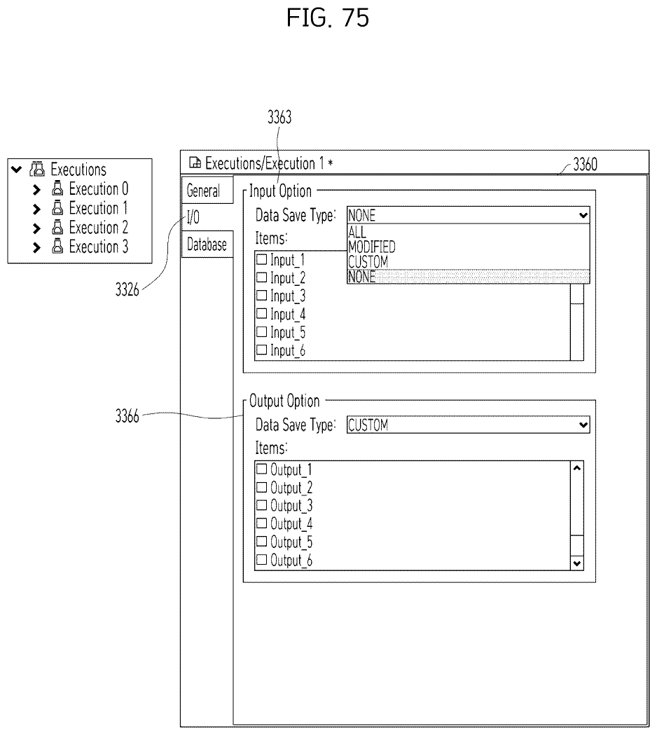

FIG. 75 is a diagram illustrating an example of experiment execution editing of an experiment hub file according to an embodiment.

This embodiment describes an example of setting the input/output menu 3326 in the experiment execution screen 3320 described above. When an input signal for the input/output menu 3326 is received, the input/output menu setting screen 3360 is displayed. The input/output menu setting screen 3360 corresponds to a screen for setting input options 3363 and output options 3366 related to experiment performance.

Input options 3363 may be set to determine whether to delete related files after performing individual scenarios for input. Data storage types may include leaving the entire file (ALL), deleting except tables modified by factors (MODIFIED), deleting the entire file (NONE), and deleting except for selected items (CUSTOM). Additionally, the selection of items listed in the input options 3363 may be determined, and the data storage type may be determined.

Output options 3366 may be set to whether or not to delete related files after performing individual scenarios for the output. Data save types may include leaving all files (ALL), deleting all files (NONE), and deleting everything except selection (CUSTOM). The items listed in output options 3366 may be selected or not, and the data save type may be determined.

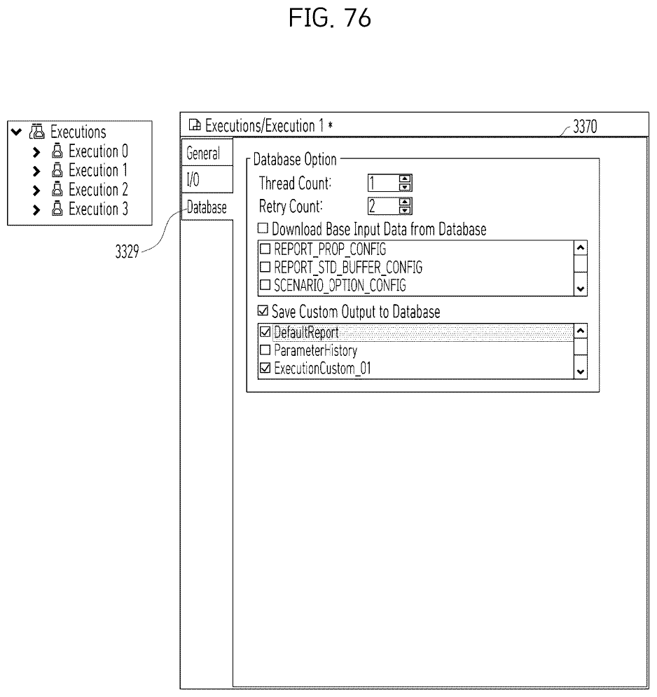

FIG. 76 is a diagram illustrating an example of editing an experimental performance of an experimental hub file according to an embodiment.

This embodiment describes an example of setting a database menu 3329 in the experiment execution screen 3320 described above. When an input signal for the database menu 3329 is received, the database setting screen 3370 is displayed. The database setting screen 3370 may be used to set whether to retrieve input data for a model to be used in an experiment from a database before starting the experiment. Additionally, the database setting screen 3370 may set which experimental data to upload to the database after the experiment is completed.

After the settings for the general menu 3323 described above, as well as the input/output menu 3326 and database menu 3329 are completed, when an input signal for the execution button 3335 included in the general menu setting screen 3350 is received, an experiment execution command may be transmitted to the experiment hub execution unit. Performing experiments simultaneously in parallel may require a high-performance processor and/or memory.

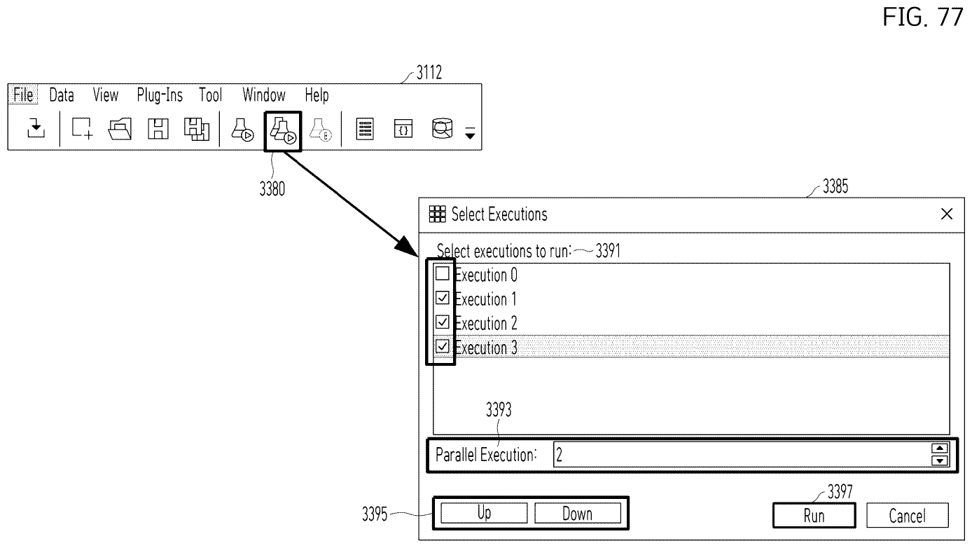

FIG. 77 is a diagram illustrating an example of editing an experiment performance of an experiment hub file according to an embodiment.

This embodiment describes an example of setting up a simultaneous parallel experiment included as a quick menu in the menu area 3112 of the experiment hub user interface 3110. When an input signal for the simultaneous parallel experiment icon 3380 is received in the menu area 3112, a simultaneous parallel experiment setting pop-up 3385 may be displayed.

The simultaneous parallel experiment setup pop-up 3385 may include options such as an experiment list 3391, the number of parallel experiments execution 3393, a priority adjustment menu 3395, and a run button 3397. The experiment list 3391 lists the subjects of experiments to be performed, and only selected experiments may be setup to be performed. The number of parallel experiments execution 3393 may be setup to the number of parallel experiments performed simultaneously. The priority adjustment menu 3395 may be used to set priorities for the list listed in the experiment list by moving them to the top or bottom. In addition, when the settings for the experiment list 3391, the number of parallel experiments execution 3393, and the priority adjustment menu 3395 are completed and an input signal for the run button 3397 is received, simultaneous parallel experiments may be performed. There is a difference in that the number of parallel executions 3343 in the above-described FIG. 74 indicates the number of scenarios executed simultaneously, whereas the number of parallel experiments execution 3393 in FIG. 77 indicates the number of experiments executed simultaneously.

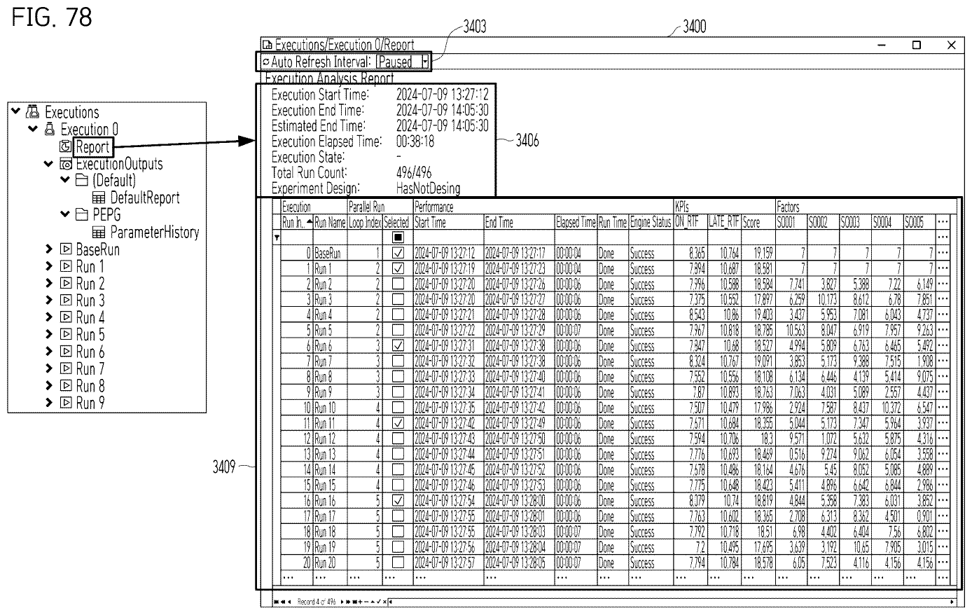

FIG. 78 is a diagram illustrating an example of confirmation of experimental performance results of an experimental hub file according to an embodiment.

When the experiment is completed, a Report may be generated in the submenu of the Execution_0 group in the component area 3114 of the experiment hub user interface 3110. When an input signal for a report including experimental results is received, an experimental analysis report screen 3400 may be output in the data retrieval area 3116.

The experimental analysis report screen 3400 may include an auto refresh interval menu 3403, experimental summary information 3406, and a data search menu 3409. The auto refresh interval menu 3403 is a menu for setting an automatic update cycle for experimental results. Experimental results may be retrieved during the experiment even if the experiment is not completed, and manual updates are also possible. Experiment summary information 3406 is summary information about the experiment itself, and may include experiment execution start/completion time, execution time, total number of scenarios, etc. The data retrieval menu 3409 provides data related to the experiment, and may include execution order, start/completion time, scenario performance time, status, key performance indicator values, variable values, etc. Additionally, the data included in the data retrieval menu 3409 may be provided in the same manner as the function of retrieving grid data of the model analysis section.

Additionally, although not shown, the menu area 3112 of the experimental hub user interface 3110 includes an Import menu and an Export menu. The Import and Export menus allow you to import various types of data related to the experiment hub in a selected file format (e.g., Excel, text file, etc.) or export them as an extracted file format.

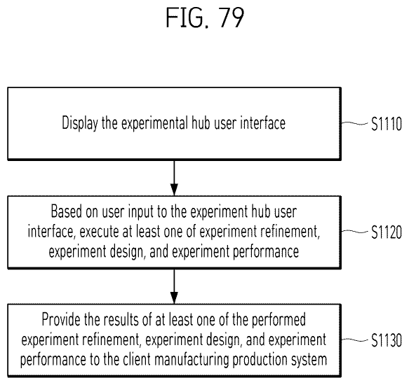

FIG. 79 is a flowchart illustrating an example of providing digital production plan information according to an embodiment.

The experimental hub user interface of the client manufacturing production system may be displayed S1110. As described above, the experiment hub user interface may include at least one of a menu area 3112, a component area 3114, a data retrieval area 3116, or a log output area 3118.

Based on user input to the experiment hub user interface, at least one of experiment refinement, experiment design, or experiment performance may be executed S1120. As described above in FIGS. 67 to 70, refinement may be performed on a scenario-by-scenario or experiment-by-experiment basis through user input, but this is not a mandatory procedure. As described above in FIGS. 71 to 73, it is possible to add and delete factors used in fixed-size experiment designs, and to edit logic type factors and data type factors. Although not shown, editing may be performed for iterative experiment designs in the same way as for fixed-size experiment designs. As described above in FIGS. 74 to 76, options related to experimental performance may be edited through the general menu 3323, input/output menu 3326, and database menu 3329. Additionally, as described above in FIG. 77, simultaneous parallel experiment execution may be performed.

The results of at least one of the performed experimental refinement, experiment design, or experimental performance may be provided to the client manufacturing production system through the experimental hub user interface S1130. As described above in FIG. 78, when the experiment is completed, the experimental results may be provided as a report.

Referring to FIG. 29, an embodiment of a device for analyzing a production plan based on a software model and logic set and providing digital production plan information is described as follows.

An embodiment of a device providing digital production plan information may include an input unit 410, a storage unit 420, an in-memory unit 430, a processor 440, an output unit 450, and a user interface 460. For example, a device that provides digital production plan information may correspond to a client's manufacturing production system.

An embodiment of a device providing digital production plan information below may be controlled by user control and management via a user interface 460.

The input unit 410 may receive a software model and logic set generated based on at least one of the data schema or library engine set of the client manufacturing production system from the on-premise computing system.

The storage device 420 may store the pre-prepared reference information or store the received software model and logic set. The storage device 420 may include volatile memory or non-volatile memory.

In-memory 430 may store the software model, input data, library engine set, and products obtained in the process of performing the library engine, model execution unit, and experiment hub unit disclosed above. A library engine set may contain a production planning engine, which is a number of encapsulated function block files that generate production plans. The in-memory 430 of the embodiment may store intermediate outputs and/or final outputs related to the experimental hub operation work.

The processor 440 of the embodiment may display an experimental hub user interface of a client manufacturing production system. As described above, the experiment hub editing user interface may include at least one of a menu area 3112, a component area 3114, a data retrieval area 3116, or a log output area 3118. Additionally, the processor 440 of the embodiment may execute at least one of experiment refinement, experiment design, or experiment execution based on user input to the experiment hub user interface. Examples of refinement by scenario or experiment are illustrated in FIGS. 67 to 70 described above, examples of experiment design are illustrated in FIGS. 71 to 73 described above, and examples of experimental performance are illustrated in FIGS. 74 to 77 described above. Additionally, the processor 440 may provide the results of at least one of the performed experimental refinement, experiment design, or experimental execution to the client manufacturing production system through the experimental hub user interface. The experimental results report is exemplified in FIG. 78 described above.

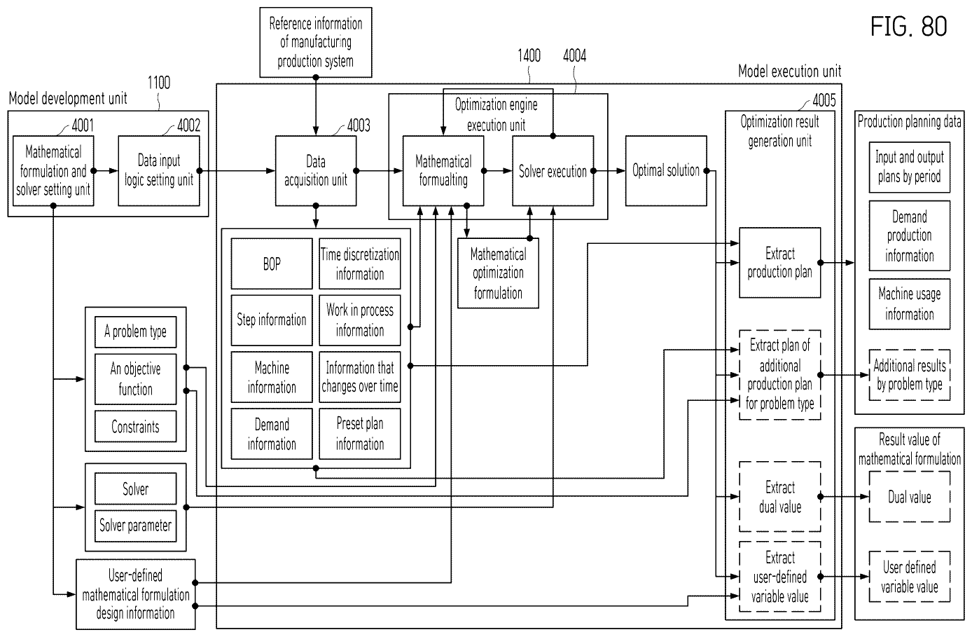

FIG. 80 is a diagram illustrating an example of providing digital production plan information based on a mathematical optimization formulation-based model according to an embodiment.

In the illustrated example, the model development unit 1100 and model execution unit 1400 of the on-premise computing system 1000 provide a frame for establishing a production plan of a manufacturing production system based on a mathematical optimization model. In an embodiment, the production plan of the manufacturing production system may include at least one of planning or scheduling depending on the level of detail.

In this case, planning may consist of a broad range of production plans, for example, a factory-level production plan. In addition, planning may calculate at least one of the feasibility of the production plan, site resource allocation, or the factory input plan by considering at least one of the material flow, raw material input, assembly, inventory management, or performance capability of equipment within the manufacturing production system. Additionally, scheduling may be consist of a narrow-scope production plan, for example, a production plan scope for each of equipment line unit. In addition, scheduling may produce a work plan for each equipment unit by taking into account at least one of the material flow, raw material input, assembly, inventory management, or performance capabilities of the equipment, work sequences of the equipment, and operation characteristics of the equipment within the manufacturing production system. According to the present disclosure, a production plan that best achieves a goal at least one of the planning and scheduling processes can be obtained in by utilizing mathematical optimization.

In an embodiment, the model development unit 1100 may include at least one of a mathematical formulation or solver setting unit 4001 and a data input logic setting unit 4002.

The mathematical formulation and solver setting unit 4001 may obtain at least one of the mathematical formulation design information or the solver information according to user input. In an embodiment, the mathematical formulation design information may include at least one of a problem type, an objective function, constraints, or user defined mathematical formulation design information for a manufacturing production system. Here, the problem type may indicate the type of problem that is to be solved for the manufacturing production system. That is, the form of the output value of the mathematical optimization formulation-based model may be determined depending on the problem type. Additionally, problem types may be used to provide additional result information at the expense of reducing the freedom of problem structure that may be selected by the user. In an embodiment, additional information may be entered depending on the problem type.

For example, if the problem type is site allocation, the weight or priority information for each site for each demand and the last buffer information may be entered. At this time, the objective function of the last phase may be fixed to maximizing the flow amount entering the BOM. Additionally, production plans for each production site for each demand may be provided. Here, BOM may represent the relationship between the buffers.

Additionally, for another example, if the problem type is bottleneck detection, the target machine may be input. At this time, the objective function of the last phase may be restricted to maximizing the machine capacity and production capacity to be added, and minimizing the machine capacity to be removed. Additionally, a constraint may be added that makes the short amount of demand zero. Additionally, information on the minimum additional capacity to make all the machine demands or the maximum deductible capacity to make all the demands may be provided.

In an embodiment, the objective function may represent a function to be optimized. In an embodiment, the type of objective function used for each phase and related information (phase, weight, slack, filter) may be input. For example, the types of objective functions may include various types, such as maximizing the amount of demand fulfilled by the due date, maximizing the amount of demand fulfilled by the max lateness date, maximizing the production quantity by the due date, maximizing the production quantity by the max lateness date, maximizing the added machine capacity, minimizing the removed machine capacity, maximizing the flow into the BOM, and minimizing WIP.

Additionally, the phase may represent the phase value at which the objective function is used. In an embodiment, the phase may represent a round of optimization using an objective function included in a mathematical optimization formulation. Weights may represent the corresponding weight values when the input objective function is used as a weighted sum objective function. Slack may represent the percentage of free space allowed at the objective function level when applying the objective function level maintenance constraint after the phase at which the objective function is used. Filters may include variable filters and objective function filters. In this case, a specific objective function may require the introduction of additional variables to implement the objective function. At this time, in the case of variable filters, the variables to be introduced have already been determined, but some of the variables to be introduced may be removed by using the variable filter by the user. For objective function filters, it is possible to indicate which variables among the constituent variables of the objective function to keep and which to remove.

In an embodiment, the constraints may represent constraints (conditions) that exist in the problem. In an embodiment, the type of constraint to be used and related information (e.g., right-side constant, filter) may be entered. For example, the types of constraints may include various constraints such as a maximum number of setups per time interval, a maximum buffer level limit, and a maximum buffer input limit. In the case of a right-side constant, the value of the right-side constant of the constraint may be specified. Filters may include variable filters and constraint filters. For variable filters, certain constraint may require the introduction of additional variables to implement the constraint. At this time, the variables to be introduced have already been determined, but some of the variables to be introduced may be removed by using a variable filter by the user. For constraint filters, it can indicate which constraints in a set of constraints to keep and which constraints to remove.

In an embodiment, the user-defined mathematical formulation design information may include decision variables, constraints, and objective functions set by the user. In an embodiment, the user-defined mathematical formulation design information may be coded by the user. In an embodiment, for a user-defined decision variable, the variable name, the range of the variable value, whether it is an integer variable, whether it is a binary variable, and whether to store the value may be setup. Additionally, for user-defined constraints, the name of the left-side variable and its coefficients, the type of constraint, and the value of the right-side constant can be specified. Additionally, for a user-defined objective function, the names of the variables used in the objective function and their corresponding variable coefficients, whether to maximize or minimize, the phase, weights, and slack may be specified. At this time, not only user-defined variables, but also basic variables and variables generated when adding objective functions and constraints may be used.

Additionally, the solver information may include at least one of a solver or a parameter for the specified solver. In an embodiment, the solver may include software that solves a mathematical optimization formulation. In an embodiment, the solver may be specified by the user depending on the problem for the mathematical optimization formulation. For example, if a given problem is a linear programming formulation and a mixed integer programming formulation, separate solvers may be specified for each formulation. Additionally, the solver parameters may include parameters of the solver that the solver uses when solving the mathematical optimization formulation. For example, solver parameters may include various parameters such as the algorithm used by the solver to solve a mathematical optimization formulation, the numerical error tolerance, and the MIP gap, which indicates the required optimality of the solution of a mixed integer programming formulation. In an embodiment, default solver parameter values may be setup by the user.

The data input logic setting unit 4002 may generate data input logic that converts the reference information of the manufacturing production system into a data format used in a mathematical optimization formulation-based model. In this case, the data format used in the model based on the corresponding mathematical optimization formulation may be specified in advance.

In an embodiment, one of the mathematical formulation design information and solver information set by the mathematical formulation and solver setting unit 4001 of the model development unit 1100 and the data input logic set by the data input logic generation unit 4002 may be transferred to the model execution unit 1400.

In an embodiment, a software model and logic set generated by a model development unit 1100 may be transferred to a model execution unit 1400. In an embodiment, the software model and the logic set may include at least one of logic for generating a mathematical optimization formulation, logic for calculating a result value of the mathematical optimization formulation, logic for generating a mathematical optimization formulation-based model, or logic for calculating production plan data using the mathematical optimization formulation-based model.

In an embodiment, the model execution unit 1400 may use at least one of the mathematical formulation design information, the solver information, or the data input logic to derive an optimal solution for a production plan based on input data including reference information of a manufacturing production system.

In an embodiment, the model execution unit 1400 may include at least one of a data acquisition unit 4003, an optimization engine execution unit 4004, or an optimization result generation unit 4005.

The data acquisition unit 4003 may acquire input data including reference information of the manufacturing production system from the client manufacturing production system 100. In an embodiment, input data including reference information may include at least one of operation flow information (BOP, Bill of Process), operation step information, machine information, demand information, time discretization information, work in progress (WIP) quantity information, information that changes over time, pre-set plan information, or additional input information by each problem type.

For example, the operation step information may include at least one of whether a dummy operation process is being processed, a machine capable of processing the operation step, unit work item machine processing time, yield information, or operation time information (TAT). The demand information may include at least one of a demand quantity, a demand due date, a maximum lateness production date, or a maximum earliness production date.

Time discretization information may include information about discrete points in time, which is used in the process of formulating the flow of time as changes at discrete points in time. In an embodiment, the time discretization information may include at least one time bucket (TB) included in a planning interval for a specific period of time. In this case, according to the present disclosure allows for non-constant time intervals to be formulated in the mathematical optimization formulation.

The work-in-progress quantity information may indicate about how much work is being put into which buffer and when.

Information that changes over time may include at least one of production capacity, BOM availability, or arrange availability. Here, production capacity may represent the change over time in the maximum exhaustion rate of the machine's production capacity. In an embodiment, the production capacity may be determined based on the length of at least one time bucket. In this case, at least one time bucket may contain variable time buckets with different lengths. For example, if the maximum production capacity exhaustion rate is 0.9 and the time bucket length is 1,000 seconds, the machine's capacity may be 900 seconds. BOM availability may represent changes over time in the ability of inputting a work item into a particular operation. Arrangement availability may represent changes over time in whether a particular operation is possible on a particular machine. The pre-set plan information may reflect information on how much of work item must be processed on which machine and for how long.

The optimization engine execution unit 4004 may perform a mathematical formulating using at least one of input data including reference information, mathematical formulation design information, or user-defined mathematical formulation design information based on a software model and logic set to generate a mathematical optimization formulation. In an embodiment, the mathematical optimization formulation may include at least one of a decision variable, an objective function, or a constraint derived from the input data. In an embodiment, the decision variable may represent something that is not yet known in the problem, i.e., the variables that are desired to be produced as a result.

In addition, the optimization engine execution unit 4004 may obtain a solution to a mathematical optimization formulation based on input data using a solver to produce an optimal solution for a production plan. That is, the optimization engine execution unit 4004 may execute a solver to solve a mathematical optimization formulation and produce an optimal solution for the production plan. In an embodiment, the production plan optimal solution may include the results of a mathematical optimization formulation. This is explained in more detail below.

The optimization result generation unit 4005 may generate a mathematical optimization formulation-based model based on a software model and logic set. In addition, the optimization result generation unit 4005 may generate production plan data of a manufacturing production system using the result values of a mathematical optimization formulation based on a mathematical optimization formulation-based model. In an embodiment, the optimization result generation unit 4005 may store the output value of a mathematical optimization formulation-based model including at least one of the production plan data of the manufacturing production system or the result value of the mathematical optimization formulation. In an embodiment, the production plan data may include at least one of input and output plans by period, demand production quantity information, machine usage information, or additional results by problem type. For example, input and output plans by period may include the input (in)/output (out) amount for each buffer per time bucket TB and the input amount for each step of each item per time bucket. In an embodiment, the production plan data may include at least one production plan data for each time bucket included in the time discretization information.

Demand production information may include production quantity up to the due date of each demand and production quantity up to the maximum lateness production date of each demand. Machine usage information can include the available production capacity of each machine per time bucket and the production capacity usage history of each machine per time bucket, indicating how much production capacity was used at which step. Additional results by problem type may include site distributions indicating the production plan for each production site of demand, the minimum additional production capacity to make all of the demand from the machines, the maximum deductible production capacity to make all of the demand, and bottlenecks indicating the machines or operations with the least remaining production capacity.

In an embodiment, the output value of the mathematical optimization formulation may include at least one of the mathematical formulation dual value or the user-defined variable value. For example, the dual value of a mathematical formulation may represent the dual value of a constraint. A user-defined variable value may contain the name of a variable among the user-defined variables whose value is to be stored, as well as the value itself.

In addition, according to the present disclosure, by using a formulating method for a mathematical optimization formulation, two multi-objective function optimization methods, a weighted sum objective function and hierarchical optimization, are provided, and a variable time bucket is supported, and the functions of a filter, a user-defined variable, a user-defined constraint, and a user-defined objective function are supported, thereby securing the degree of freedom of formulating. In addition, according to the present disclosure, the formulating process and the solution process of the mathematical optimization formulation are separated, so that an appropriate solver may be selected in the solution process.

In an embodiment, production plan data may be provided to a client manufacturing production system according to reference information. Additionally, in an embodiment, the production plan data may be used as basic information for providing production plan data to a client manufacturing system.

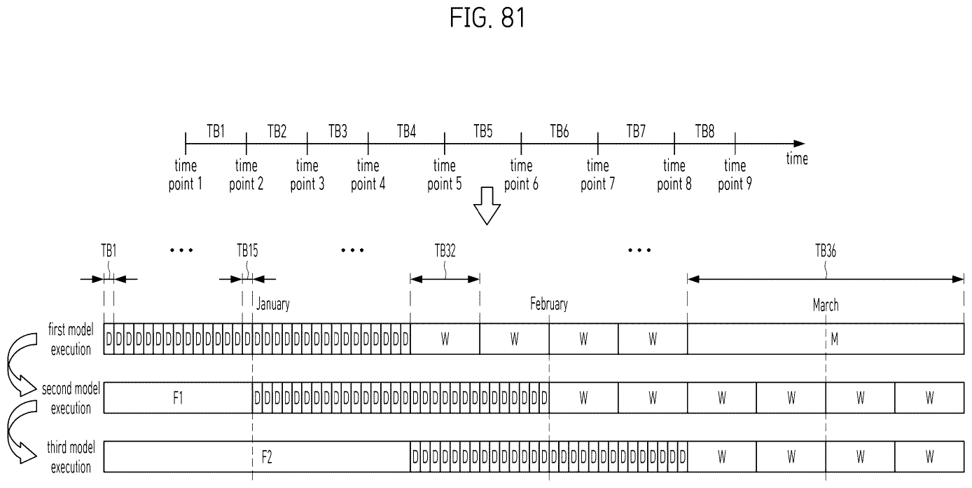

FIG. 81 is a diagram illustrating an example of using variable time buckets according to an embodiment.

In the illustrated example, the constraints of the mathematical optimization formulation may be setup based on at least one variable time bucket having different lengths. That is, the mathematical optimization formulation of the present disclosure can be formulating to the flow of time in a manufacturing production system as changes in discrete time points.

In an embodiment, the constraints of the mathematical optimization formulation may include at least one of a constraint representing the state of the manufacturing production system at each point in time or a constraint representing the relationship between the states of the manufacturing production system between different time points. Here, the manufacturing production system status at each time point may represent at least one of the amount of work item existing in the buffer at each time point, the amount of work item leaving the buffer and entering the operations at each time point, or the amount of work item output from the operation and entering the buffer at each time point. In addition, the relationship between the manufacturing production system status at different points in time may indicate that a work item input into a target operation at a specific time point (T) is output from the target operation at some time point (T′) after a specific time point (T), with or without passing at least one consecutive time bucket (TB) based on predefined process time information (TAT). In an embodiment, if the value of the operation time information is 0, it can be calculated from the target operation at that point in time without passing through the time bucket.

For example, the constraints of the mathematical optimization formulation may be derived as (constraints representing the state of the manufacturing production system at time 1)+(constraints representing the state of the manufacturing production system at time 2)+ . . . +(constraints representing the relationship between the state of the manufacturing production system at time 1 and the state of the manufacturing production system at time 2)+(constraints representing the relationship between the state of the manufacturing production system at time 1 and the state of the manufacturing production system at time 3)+ . . . +(constraints representing the relationship between the states of the manufacturing production system at time i and the states of the manufacturing production system at time j).

In this case, each time interval is called a time bucket (TB), and all events occurring in the same time bucket may be considered as events occurring simultaneously. Accordingly, as the time bucket length becomes shorter, the detail and complexity of the mathematical optimization formulation may increase. Therefore, by setting the length of the time bucket corresponding to the interval between the first time point and second time point to be shorter than the length of the time bucket corresponding to the interval between the third time point and fourth time point, the level of detail may be increased only where necessary. For example, the time bucket (TB1) between time points 2 and 1 may be setup shorter than the time bucket (TB4) between time points 5 and 4. In an embodiment, optimization for all time buckets in a single phase may be performed simultaneously.

In an embodiment, the granularity of the plan may be increased by setting the length of the time bucket near the planning time point to be shorter than a threshold value. Additionally, the complexity of the problem may be reduced by setting the length of the time bucket at distant time point at the planning time point to be longer than a threshold value. In an embodiment, the number of time buckets for a planning time point may be adjusted by adjusting the granularity according to the planning time point. For example, 31 time buckets (TB1 to TB31) corresponding to January (Jan) may be setup as units of days (DAY), 4 time buckets (TB32 to TB35) corresponding to February (Feb) may be setup as units of weeks (WEEK), and 1 time bucket (TB36) corresponding to March (Mar) may be setup as units of months (MONTH).

Afterwards, by sequentially performing optimization for each variable time bucket from the preceding time point in each model execution, the optimization result value (e.g., production plan) for each time bucket may be produced with the shortest length.

For example, in the first model run, optimization may be performed for at least one time bucket (e.g., TB1 to TB15) with the shortest length (Day) corresponding to the sequentially preceding time point to fix the production plan (F1) for that time bucket (i.e., TB1 to TB15). That is, when the first model is executed, the production plan data for each time bucket is calculated based on the time discretization information for the time buckets (TB1 to TB36) that divide the planning section from January 1 to the end of March, and the production plan (F1) for January 1 to January 15 (TB1 to TB15) may be fixed and stored separately. In an embodiment, the number of time buckets may change or be reallocated upon each model run. That is, the number of the time bucket disclosed in the figure, for example, TB 1 to TB 36, may represent the time bucket number used for the first model run.

Thereafter, in the second model execution, optimization is performed for at least one time bucket with the shortest length (Day) among each of the reassigned variable time buckets from a time point after the fixed production plan (F1), so that the production plan (F2) for that time bucket may be fixed. For example, for time buckets divided into the planning section from January 16 to the end of March, production plan data for each time bucket may be calculated based on time discretization information, and the production plan from January 16 to January 31 may be fixed and stored separately.

Thereafter, in the third model execution, optimization is performed for at least one time bucket with the shortest length (Day) among each of the reassigned variable time buckets from a time point after the fixed production plan (F2), thereby fixing the production plan (not shown) for that time bucket. For example, for time buckets that divides the planning interval from February 1 to the end of March, production plan data for each time bucket may be produced based on time discretization information, and the production plan may be fixed and stored separately until the next planning fixed interval.

By repeating this process, optimization may be performed for each time bucket in the state with the shortest length to produce a result value. That is, the length of the time bucket where optimization is performed may be setup to the shortest to increase the detail, and the length of the remaining time buckets may be setup to relatively long to reduce the complexity.

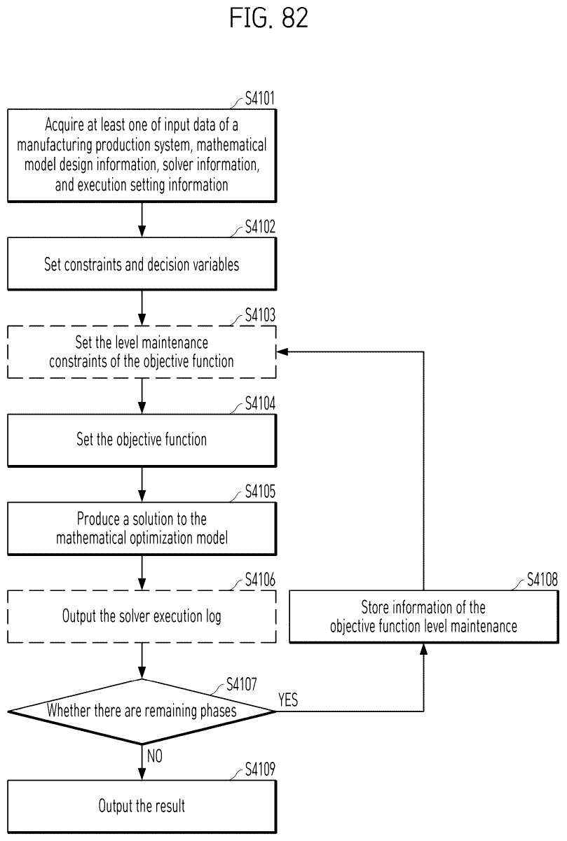

FIG. 82 is a flowchart illustrating an example of model execution based on a mathematical optimization formulation according to an embodiment.

At least one of input data of a manufacturing production system, mathematical formulation design information, solver information, or execution setting information is acquired S4101. For detailed examples of each information, reference is made to the above.

Set constraints and decision variables of the mathematical optimization formulation S4102. In an embodiment, at least one of a basic constraint, an additional constraint, or a user-defined constraint of a mathematical optimization formulation may be setup, and at least one of a basic decision variable, an additional decision variable, or a user-defined decision variable may be setup.

Set the level maintenance constraints of the objective function of the mathematical optimization formulation S4103. In an embodiment, the objective function level maintenance constraint may include a constraint to maintain the level of the objective function near the optimum during subsequent phase optimization.

Set the objective function of the mathematical optimization formulation S4104. In an embodiment, the objective function may be setup based on at least one of input data, constraints, decision variables, or objective function level maintenance constraints.

The solver is executed to produce a solution to the mathematical optimization formulation including the set objective function, constraints, and decision variables S4105. In an embodiment, the solver may be setup based on the solver type and solver parameters included in the solver information. In an embodiment, calculating a solution to the mathematical optimization formulation may include solving the mathematical optimization formulation using a solver.

Output the solver execution log S4106. In an embodiment, the solver execution log may include various logs related to the solver execution, such as solver execution time, optimality status, etc.

It is determined whether there are remaining phases for the execution of the mathematical optimization formulation-based model S4107. In an embodiment, if there are remaining phases, the process may proceed to step S4108. In an embodiment, if there are no remaining phases, the process may proceed to step S4109.

If there are remaining phases, information of the objective function level maintenance for the phase is stored S4108. In an embodiment, after storing, the objective function level maintenance constraint of step S4103 may be setup in the next phase, or the objective function of step S4104 may be setup. In an embodiment, the objective function level maintenance information may include information about objective function level maintenance constraints up to that phase.

If there are no remaining phases, the result value of the mathematical optimization formulation for the phase is output S4109. In an embodiment, the values of variables obtained by the solver from the output mathematical optimization formulation may be stored in a form that is meaningful based on input data of the manufacturing production system.

In an embodiment, some of the steps according to the present disclosure may be omitted, and at least one step may be performed sequentially, in reverse order, or in parallel. For example, steps S4103 and S4106 may be omitted.

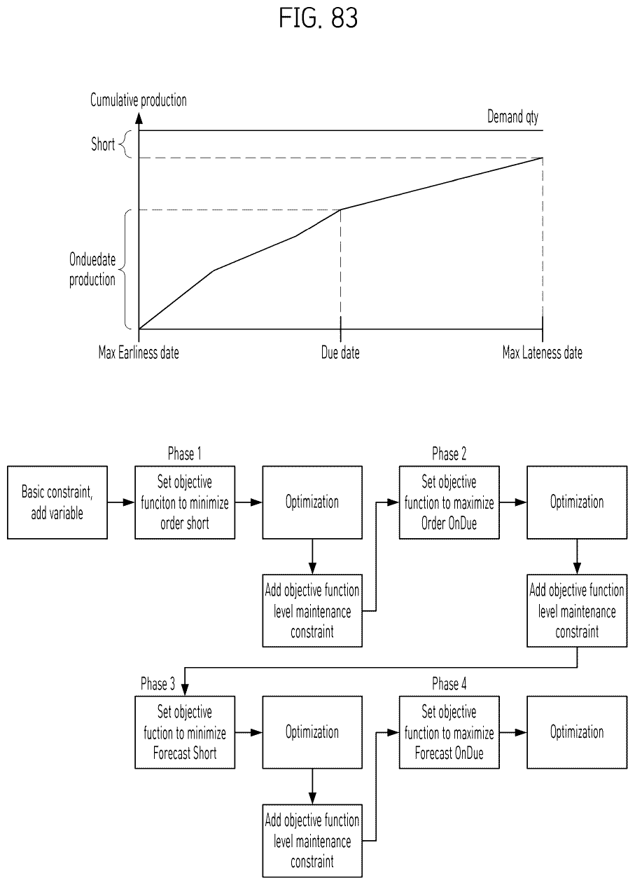

FIG. 83 is a diagram illustrating an example of model execution based on a mathematical optimization formulation according to an embodiment.

In the illustrated example, hierarchical optimization may be performed using a mathematical optimization formulation-based model. In an embodiment, the demand included in the target optimal solution may be composed of two types: an order type and a forecast type. In this case, the demand of the order type may represent an order record that has already been received, and the demand of the forecast type may represent an expected virtual order record.

In an embodiment, when the importance of demand of the order type is greater than the importance of demand of the forecast type, the order demand short amount of the demand of the order type may be reduced as much as possible, and the forecast demand short amount of the demand of the forecast type may be reduced while the order demand short amount is reduced as much as possible.

In an embodiment, the due date for a demand may consist of two types: a due date and a max lateness date. In this case, the max lateness date may represent the maximum allowable delay based on the due date by which the product must be produced. That is, the max lateness date may represent the maximum allowable delay date if the product is not delivered on time. Therefore, depending on the demand type, four decision variables may be setup for demand: the due date and max lateness date of the order type, and the due date and max lateness date of the forecast type.

In an embodiment, since delivery cannot be made after the max lateness date, the production amount up to the max lateness date for each demand may be increased as much as possible, and the production amount until the due date may be increased as much as possible while the production amount up to the max lateness date has been increased as much as possible.

In an embodiment, the order demand short amount may be minimized, the order demand due date production amount may be maximized, the forecast demand short amount may be minimized, and the forecast demand due date production amount may be maximized based on the mathematical optimization formulation.

In this case, hierarchical optimization may be performed using a mathematical optimization formulation-based model. In an embodiment, the hierarchical optimization for demand may minimize the amount of order demand short, maximize the production amount of order demand on due date, minimize the amount of forecast demand short, and maximize the production amount of forecast demand on due date.

Here, the demand short quantity represents the difference between the demand quantity (qty) and the production quantity for the maximum lateness production date, and the on-due-date demand production quantity represents the difference between the production quantity for the due date and the production quantity for the maximum earliness production date. At this time, the maximum earliness production date may represent the earliest date that the product may be provided to the customer. That is, the maximum earliness production date may represent a reference date to ensure that the product is not delivered too early before the date the customer needs it.

In an embodiment, in the first phase, constraints and decision variables may be added, and a first objective function may be setup to minimize the order short production amount for demand. Afterwards, optimization may be performed on a mathematical optimization formulation based on the first objective function to obtain an optimal solution for the order short production quantity. Additionally, it is possible to add objective function level maintenance constraints for the first objective function. In this case, at least one first candidate solution that violates the objective function level maintenance constraint may be excluded from the set of possible optimization candidate solutions. For example, if the optimal solution for minimizing the order short production quantity is 12,000, an objective function level maintenance constraint of “order short production quantity less than or equal to 13,000” may be added. Accordingly, candidate solutions with an order short production of 14,000 may be excluded from the set of the plurality of optimization candidate solutions.

Additionally, in the second phase, a second objective function may be setup to maximize the order demand on-due-date production quantity for demand. Afterwards, optimization may be performed on a mathematical optimization formulation I based on the second objective function to derive the optimal solution for the order demand on-due-date production quantity. Additionally, it is possible to add objective function level maintenance constraints to the second objective function. In this case, at least one second candidate solution that violates the objective function level maintenance constraint may be excluded from the set of the plurality of optimization candidate solutions from which the first candidate solution has been excluded. For example, if the optimal solution for maximizing order demand on-due-date production quantity is 10,000, a constraint that “order demand on-due-date production quantity is less than or equal to 11,000” may be added. Accordingly, candidate solutions with an order demand on-due-date production quantity of 12,000 may be excluded from the set of the plurality of optimal candidate solutions from which the first candidate solution is excluded.

Additionally, in the third phase, a third objective function may be setup to minimize the forecast demand short production quantity. Afterwards, optimization may be performed on a mathematical optimization formulation based on the third objective function to obtain an optimal solution for forecast shot production quantity. Additionally, it is possible to add objective function level maintenance constraints for the third objective function. In this case, at least one third candidate solution that violates the objective function level maintenance constraint may be excluded from the set of the plurality of optimization candidate solutions from which the first and second candidate solutions are excluded. For example, if the optimal solution for minimizing the forecast demand shot production amount is 70,000, an objective function level maintenance constraint of “forecast demand shot production quantity less than or equal to 75,000” may be added. Accordingly, from the set of the plurality of optimization candidate solutions, candidate solutions with a forecast demand shot production quantity of 80,000 may be excluded.

Additionally, in the fourth phase, a fourth objective function may be setup to maximize the forecast demand on-due-date production quantity for demand. Afterwards, optimization may be performed on a mathematical optimization formulation based on the fourth objective function to obtain an optimal solution for forecast demand on-due-date production quantity. For example, if the optimal solution for maximizing the forecast demand on-due-date production quantity is 68,000, then among the set of the plurality of optimal candidate solutions excluding the first to third candidate solutions, the candidate solution with the forecast demand on-due-date production quantity of 68,000 is calculated as the final optimal solution of the mathematical optimization formulation based on the fourth objective function, and the output value of the mathematical optimization formulation-based model may be calculated based on the optimal solution.

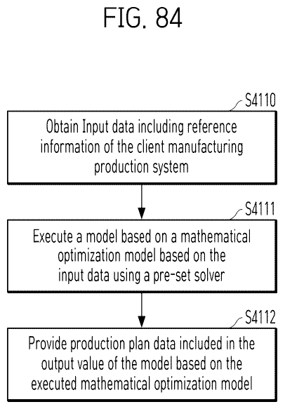

FIG. 84 is a flowchart illustrating an example of providing digital production plan information according to an embodiment.

Input data including reference information of the client manufacturing production system may be obtained S4110. In an embodiment, based on the pre-set data input logic, the input data may be converted into a data format used in the mathematical optimization formulation-based model. For this, reference is made to the contents described in FIG. 80.

A mathematical optimization formulation-based model derived from the input data is executed using a pre-set solver S4111. In an embodiment, a mathematical optimization formulation-based model may be generated using a mathematical optimization formulation including at least one of a decision variable, an objective function, or constraints derived from the input data, based on a software model and logic set. In an embodiment, a mathematical optimization formulation-based model may be executed to produce decision variable values that maximize or minimize an objective function according to the constraints derived from the input data. In an embodiment, prior to operation S4111, a solver and parameters for the solver corresponding to the type of the mathematical optimization formulation-based model may be setup. For this, reference is made to the description described in FIGS. 80 to 83.

Production plan data included in the output value of the model based on the executed mathematical optimization formulation may be provided S4112. In an embodiment, at least one of the production plan data of the manufacturing production system included in the output value of the mathematical optimization formulation-based model or the result value of the mathematical optimization formulation may be provided. For this, reference is made to the description described in FIGS. 80 to 83.

Referring to FIG. 8, an embodiment of a device for analyzing a production plan based on a software model and logic set and providing digital production plan information is described as follows.

An embodiment of a device providing digital production plan information may include an input unit 310, a storage unit 320, an in-memory 330, a processor 340, an output unit 350, and a user interface 360.

An embodiment of a device providing digital production plan information below may be controlled by user control and management via a user interface 360.

The input unit 310 may obtain at least one of input data of a manufacturing production system, mathematical formulation design information, solver information, or data input logic. The storage device 320 may store at least one of input data, mathematical model design information, solver information, or data input logic received by the input unit 310 in the storage device 320. The storage device 320 may include volatile memory or non-volatile memory. In-memory 330 may store the result of optimization performed on the mathematical optimization formulation. In an embodiment, the in-memory 330 may include at least one of production plan data of the manufacturing production system or result values of a mathematical optimization formulation.

The processor 340 of the embodiment may obtain input data including reference information of a client manufacturing production system, execute a mathematical optimization formulation-based model based on the input data using the pre-set solver, and provide production plan data included in the output value of the executed mathematical optimization formulation-based model. For further details, reference is made to the description above.

The processor 340 may develop a software model and logic set according to a user's request of the user interface 360. Additionally, the processor 340 may obtain production plan data by testing and pre-executing the developed software model and logic set. And the processor 340 may analyze or test the software model and logic that generates production plan data according to the user's request and provide the results to the user through the user interface 360. For further details, reference is made to the description above.

The output unit 350 may provide a software model and logic set, and may provide analysis result data of the software model and the logic set and result data of an experiment performed based on the software model and the logic set to enable management of production or operations in a local environment and client system.

As described above, the system operation unit 110 may generate an operational task based on the uploaded software model and logic set and set conditions for performing the operational task. The system operation unit 110 may include a service unit 1260 including various services and a history management storage unit 1270.

The service department 1260 may include a license service unit 1205, a job service unit 1210, a deploy management service unit 1215, an outfile service unit 1220, a job scheduler service unit 1230, etc. The job scheduler service 1230 may correspond to a unit that executes an operational task edited in the job service unit 1210 according to execution conditions.

Additionally, operational tasks may be generated through the operational service unit 1210 of the system operation unit 110. At this time, operational tasks correspond to tasks required to execute (operate) software model and logic set. Operational tasks (job type) may include three types: sending e-mail, running a program, and running a model. In addition, various execution tasks, such as running an experiment hub or performing dynamic operations, may be added depending on user settings or system settings. Additionally, an operational task may correspond to a unit of work executed by the job scheduler service unit 1205.

Additionally, the job service unit 1210 may setup execution conditions (triggers) for operational tasks. Here, the execution conditions (triggers) correspond to execution cycles, dependencies between operational tasks, etc. That is, an operational task refers to a job unit for execution, and an execution condition may refer to detailed conditions such as the execution cycle and dependencies of an operational task. At least one execution condition may be generated for an operational task, and it is also possible for at least one second execution condition to be generated for a first execution condition. The setup execution conditions may be stored in the system operation unit.

Meanwhile, dynamic policy management may be performed to derive better quality production planning results in the manufacturing production system. Here, Policy represents a decision-making method in a manufacturing production system that may affect the production plan results obtained through simulation of the manufacturing production system, and may include parameters (values, numbers) and decision-making structures (weight sum, weight sorting) for determining the decision-making method. For example, a policy may include a dispatching agent, a compare agent, etc. The compare agent corresponds to a method for selecting alternative policies in various situations (PegPart selection, BOM selection, WIP selection, equipment changeover group selection, production capacity bucket selection, batch selection, route selection, BOP selection, input equipment selection, etc.) The types of data included in a policy correspond to the parameters and decision-making structures that determine the policy. In a manufacturing production system, establishing a good production plan and schedule is equivalent to finding a good policy through virtual simulation. Additionally, repeated trial and error is required to find a good policy, and through this, the policy may be changed/learned in a direction that improves the performance indicator. Below, we will explain an example of improving a policy involved in decision-making by repeatedly going through trial and error through the plurality of scenarios and generating a feedback loop from the trial and error through the operational task of an experimental hub.

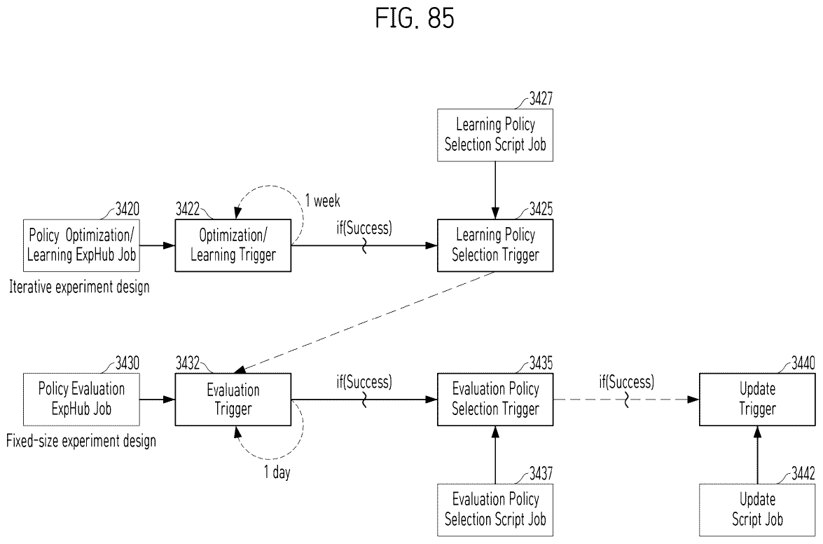

FIG. 85 is a diagram illustrating an example of setting up an operational task for dynamic policy operation in a system operation unit according to an embodiment.

More specifically, FIG. 85 is a diagram illustrating an example of setting operational tasks and operational task execution conditions (triggers) based on an experimental hub for dynamic policy operation.

As described above, operational tasks and execution conditions for operational tasks may be setup through the job service unit 1210. The execution conditions of operational tasks correspond to the conditions for executing operational tasks related to the execution of the developed software model and logic set.

As described above, in relation to the execution of the experimental hub, a policy optimization experimental hub job 3420 and a policy evaluation experimental hub job 3430 may be generated by the job service unit 1210. The policy optimization experiment hub job 3420 may learn policies (also referred to as “training” policy) periodically by an optimization trigger 3422, which is a periodic execution condition. At this time, the learning policy selection trigger 3425, which is a dependency condition of the optimization trigger 3422, may perform a learning policy selection script job 3427 that selects an optimal policy from the plurality of software models. The policy evaluation experiment hub job 3430 periodically provides the results of evaluating policies learned by the policy evaluation trigger 3432 using various software models. At this time, the policy evaluation trigger 3432 is connected to the learning policy trigger 3425 as a dependency condition so that the policy evaluation experiment hub job 3430 may be executed after the learning policy selection script job is completed.

As an example, the policy optimization experiment hub job 3420 corresponds to an experiment hub through an iterative experiment design, and the policy evaluation experiment hub job 3430 corresponds to an experiment hub through a fixed-size experiment design.

As described above, at least one execution condition may be setup for an operational task. For example, execution conditions may include periodic conditions, dependency conditions, etc. Additionally, periodic conditions or dependency conditions may be setup between the plurality of execution conditions. For example, at least one second execution condition may be setup for a first execution condition. Meanwhile, it is also possible for the second execution condition not to be setup for the first execution condition, and for it to be setup to terminate at the first execution condition. Additionally, even if execution conditions are set, whether or not to actually execute the execution conditions is included as a parameter. As an example, it may additionally include a procedure for setting whether to activate/deactivate the execution condition in addition to setting the execution condition.

For example, even if a periodic condition or a dependency condition is setup for the policy optimization experiment hub job 3420, execution may be performed after determining whether each execution condition is activated/deactivated. In this embodiment, for each periodic condition and dependency condition, whether to activate/deactivate is firstly determined and then execution may be performed.

In an embodiment, the policy optimization experiment hub job 3420 may be setup by the job service unit 1210 (see FIG. 45) to have a periodic condition in which the optimization/learning trigger 3422 is executed once a week. The optimization/learning trigger 3422 corresponds to an execution condition for optimizing and learning scenario outputs to optimize policy parameters, and serves to execute optimization tasks and learning tasks. Additionally, if the optimization/learning trigger 3422 is successful, the learning policy selection trigger 3425 may be setup to operate as a dependency condition. The learning policy selection trigger 3425 corresponds to an execution condition for selecting one policy among the plurality of policies. Additionally, a learning policy selection script job 3427 may be performed by a learning policy selection trigger 3425.

In another embodiment, an evaluation trigger 3432, which is a periodic condition for the policy evaluation experiment hub job 3430 to be executed daily, may be setup to be operated by the job service unit 1210. The evaluation trigger 3432 corresponds to an execution condition for evaluating the policy resulting from the optimization/learning trigger 3422 and the selection filter trigger 3425 and at least one policy selected by the user, and serves to execute a task corresponding to each trigger. Additionally, if the policy evaluation experiment job 3430 is successful, an evaluation policy selection trigger 3435 may be setup as a dependency condition. The evaluation policy selection trigger 3435 corresponds to the task of selecting one policy among the results of the evaluation trigger 3432. In this case, an evaluation policy selection script job 3437 may be performed by an evaluation policy selection trigger 3435. Additionally, if the evaluation policy selection script job 3437 is successful, an update trigger 3440 may be setup as a dependency condition. In this case, an update script job 3442 may be performed by an update trigger 3440. In addition, the update trigger 3440 is an execution condition for updating the policy selected by the evaluation policy selection trigger 3435, and serves to execute a task for updating the policy, and may be selectively performed by the production operation manager as needed.

Meanwhile, dependency conditions may be setup between the policy optimization experiment hub job 3420 and the policy evaluation experiment hub job 3430. In this embodiment, if the policy optimization experiment hub job 3420 is successfully performed, the learning policy selection trigger 3425 may be caused to perform the learning policy selection script job 3427. Additionally, when the learning policy selection script job 3427 is performed, a dependency condition may be setup so that the policy evaluation trigger 3432 is executed so that the policy evaluation experiment hub job 3430 is performed. At this time, the policy evaluation experiment hub job 3430 may be setup to be performed selectively. That is, after the policy optimization experiment hub job 3420 is performed, the policy evaluation experiment hub job 3430 may be performed as needed, or may be terminated without performing the policy evaluation experiment hub job 3430. In addition, the policy evaluation experiment hub job 3430 may be performed independently regardless of whether the policy optimization experiment hub job 3420 is previously performed.

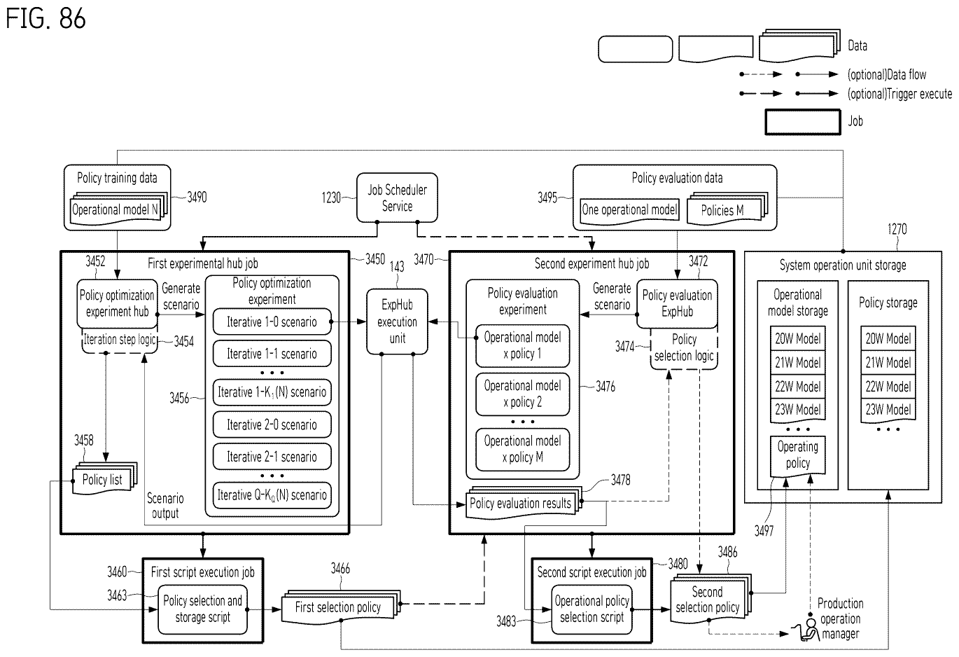

FIG. 86 is a diagram illustrating an example of an operational task performed for dynamic policy operation in an operational environment according to an embodiment.

More specifically, FIG. 86 shows an example in which an operational task based on an experimental hub for dynamic policy operation in FIG. 85 described above is setup in a job service unit 1210 and the operational task is performed by a job scheduler service unit 1230. This example may correspond to an operational task of performing a design for policy optimization through an iterative experiment design, and for the best scenario, selecting one policy by performing a comparative evaluation of policies through a fixed-size experiment design. In addition, this embodiment corresponds to a process of periodically learning the policy of the manufacturing system through the operational task of the experimental hub and reflecting the optimal operational policy at each operation point.

In this embodiment, the first experimental hub job 3450 may correspond to the policy optimization experimental hub job 3420 of FIG. 85, and the first script execution job 3460 may correspond to the learning policy selection script job 3427 of FIG. 85. Additionally, in this embodiment, the second experiment hub job 3470 may correspond to the policy evaluation experiment hub job 3430 of FIG. 85, and the second script execution job 3480 may correspond to the evaluation policy selection script job 3437 of FIG. 85.

The system operation unit's storage 1270 may include an operation model storage and a policy storage. An operation model storage may contain the plurality of software models, and a policy storage may contain the plurality of policies. Additionally, the operation model storage may contain operational policies separate from the policy storage. Although not shown, it is assumed that the system operation unit storage 1270 includes a logic storage that includes a plurality of logic sets.

For policy learning, N models may be extracted as data for policy learning 3490 from the system operation unit storage 1270. The N models extracted at this time may or may not include models to be used in actual operation, depending on the user's selection. Although not shown, the set of configured logic may also be extracted. A policy optimization experiment hub 3452 is generated for N models, and a policy optimization experiment 3456 may be generated through an iterative experiment design. In this embodiment, the policy optimization experiment 3456 is an iterative experiment with Q iterations, and the experiment may be designed to include scenario 0 to scenario Ki(N) for one experiment run. The designed policy optimization experiment 3456 may be performed as a job 3450 according to a cycle setup by a command of the job scheduler service unit 1230. In this case, the experiment hub execution unit 143 may transmit the execution command of the policy optimization experiment 3456 to the model execution unit 130 (see FIG. 45) so that the experiment may be performed.

When an experiment is performed, the output of each scenario may be transmitted to the iteration step logic 3454. For example, the output of the plurality of scenario results of the first iteration is transmitted to the iteration step logic 3454, where the iteration step logic 3454 is executed, and determines whether the terminal condition of the experiment is satisfied. If the terminal condition of the experiment has been satisfied, the experiment is completed without performing additional experiments, and if the terminal condition of the experiment is not satisfied, the policy optimization experiment hub 3452 may generate the plurality of scenarios for the second iteration. In addition, when the output of the plurality of scenario results of the second iteration is transmitted to the iteration step logic 3454, the iteration step logic 3454 is performed to determine whether the terminal condition of the experiment is satisfied again. That is, if the end condition of the experiment is repeated Q times, the scenario design and experiment execution are repeated from the 1st to the Qth times, and a policy list 3458 may be output as a result. In addition, experiment end conditions may include reaching a run time limit, reaching a limit on the total number of scenarios in the experiment, or reaching a target performance value.

The policy list 3458 is a record of learned policies that have changed while performing the iteration step logic 3454 the plurality of times, and the type of data in the policy list may correspond to log data. A policy corresponds to a set of policy parameters, and a policy list corresponds to a set of policies. For example, assuming that the policy at the end of iteration step logic 1 is policy 1, and policy 2 at the end of iteration step logic 2 is policy 2, the policy list 3458 includes policies 1 through policy Q.

Next scenario combination generation function 1682 is performed, in which case a scenario combination including scenarios 0 to scenario Ki(N) may be generated. The generated scenario combination is executed by the experiment hub execution unit 143, and the scenario output may have policy parameters updated through the update function 1679. That is, the scenario output may be learned in the iteration step logic through the update function. Additionally, updated policy parameters may be recorded via the logic log record/save function 1685. Next, Ki(N) scenario combinations from scenario 0 to scenario K are generated by next scenario combination generating function 1682, and the above-described process may be repeatedly performed until the end condition is satisfied.

Additionally, data learning may be performed by a set algorithm as a process of updating policy parameters. For example, it may include single-objective algorithms such as Stochastic Gradient Descent Method (SGD), Genetic Algorithm (GA), Simulated Annealing (SA), Particle Swarm Optimization (PSO), Bayesian Optimization (BO), Cross Entropy Method (CEM), Policy Exploration with Parameter-based Exploration Gradient (PEPG), genetic algorithms, and multi-objective algorithms such as Non-dominated Sorting Genetic Algorithms (NSGA), Non-dominated Sorting Genetic Algorithms II (NSGA-II), Strength Pareto Evolutionary Algorithm (SPEA), and Strength Pareto Evolutionary Algorithm II (SPEA-II), and in addition, it may include various algorithms that may be used for data learning, but is not limited thereto. In this example, data learning is performed using the PEPG algorithm.

If the first experimental hub job 3450 is successfully completed, the job scheduler service unit 1230 may execute the first script execution job 3460. When the first script execution job 3460 is executed, the policy selection and storage script 3463 may be performed. The policy list 3458, which is the result of the first experimental hub job 3450, may include the plurality of policies, and one policy may be selected based on the predefined conditions. For example, the predefined conditions may include a condition in which the weight sum of the plurality of key performance indicators (KPIs) is the highest, a condition in which a specific item among the key performance indicators (KPIs) is the highest, etc. Setting the conditions for policy selection may be set by the user when the experimental hub job is designed.

The policy selection script is the process of specifying the policy with the best performance among all policies derived from the optimization or learning process. Here, the policy with the best performance may be determined by the internal logic of the operational policy selection script 3483. For example, if at least one policy with the highest or lowest production quantity, equipment replacement frequency, or delayed delivery quantity is selected, the policy with the highest weight sum among them may be determined as the selected policy.

Additionally, when the policy selection and storage script 3463 is performed, the first selection policy 3466 may be stored in the policy storage of the system operation unit storage 1270. Optionally, if the second experiment hub job 3470 is executed as a dependent execution condition after the first script experiment job 3460, the first selection policy 3466 may be utilized as policy evaluation data in the second experiment hub job 3470 by trigger execution.

For policy evaluation, one operation model and M policies may be extracted from the storage 1270 of the system operation unit as policy evaluation data 3495. Policy evaluation job 3470 is a job to find the policy that shows the best performance in the current operating situation among the policies optimized or learned according to the changing situation of the factory. At this time, if trigger execution is performed after the first script execution job 3460, the M policies may include the first selection policy 3466 as a result of the first experiment hub job 3450 and the first script execution job 3460.

However, whether the first selection policy 3466 is included or not may be determined by the settings, and it does not necessarily have to be included in the M policies. For example, if the second experimental hub job 3470 is performed arbitrarily by the settings of the job scheduler service unit 130 independently from the first experimental hub job 3450, the first selection policy 3466 is not included in the M policies. Additionally, although not shown, the policy evaluation data 3495 may also include one logic set. A policy evaluation experiment hub 3472 is generated for one operational model and M policies, and a policy evaluation experiment 3476 may be generated through a fixed-size experiment design.

In this embodiment, the policy evaluation experiment 3476 may be designed as a fixed-size experiment including M scenarios. The M policies may include at least one of the base policy or one of the policies used in the previous operation cycle. The baseline policy refers to the policy that was already in use before the policy evaluation experiment 3476 was executed. If the M policies include at least one of the base policy and the policy used in the previous operation cycle, the second script execution job 3480 is to select a policy that is at least equal to or better than the base policy and the policy used in the previous operation cycle.

For example, a policy evaluation experiment 3476 could be designed to include different policies, but with the same operational model and logic set. The designed policy evaluation experiment 3476 may be performed as a job 3470 according to a cycle setup by a command of the job scheduler service unit 1230. In this case, the experiment hub execution unit 143 may transmit the execution command of the policy evaluation experiment 3476 to the model execution unit 130 so that the experiment may be performed. When an experiment is executed, policy evaluation results 3478 for the plurality of scenarios may be derived. The policy evaluation result 3478 is the result of executing the plurality of scenarios and refers to the execution result for each policy. Additionally, the policy evaluation results 3478 may correspond to a set of key performance indicators for M scenarios. For example, Scenario 1 (Policy 1) might correspond to production 100, delay 10, and replacement 20, Scenario 2 (Policy 2) might correspond to production 90, delay 0, and replacement 0, and Scenario 3 (Policy 3) might correspond to production 150, delay 30, and replacement 10.

As an example, if the second experimental hub job 3470 is successfully performed, the job scheduler service unit 1230 may execute the second script execution job 3480. When the second script execution job 3480 is executed, the operation policy selection script 3483 may be executed for the policy evaluation result 3478. When the operational policy selection script 3483 is executed, one of the M policies may be determined as the second selection policy 3486.

As another example, optionally, the policy evaluation result 3478 may not be transmitted to the operation policy selection script 3483, but may be transmitted to the policy selection logic 3474 included in the second experimental hub job 3470, so that a second selection policy 3486 may be selected among the evaluation results for the plurality of scenarios included in the policy evaluation result 3478. Here, the method by which the second selection policy 3486 is selected may be selected by a logic previously inputted in the same way as the first selection policy 3486 is selected in the policy selection and storage script 3463.

The second selection policy 3486 may be stored as an operational policy 3497 for use in operations in the operational model storage of the system operation unit storage 1270. In this embodiment, the selection policy 3466 is a policy determined through an evaluation process for selecting an appropriate policy, and the operational policy 3497 may refer to one policy to be used in actual operation. Additionally, depending on the operational policy selection method, the second selection policy 3486 may also be manually selected by the production operation manager and uploaded to the operational model storage.

If fixed policies are continuously used in situations where factory conditions change, it may be difficult to derive a production plan that is suitable for the changing situation. In this case, through this embodiment, it is possible to establish a production plan and schedule using a policy that is most suitable for the changing manufacturing system situation.

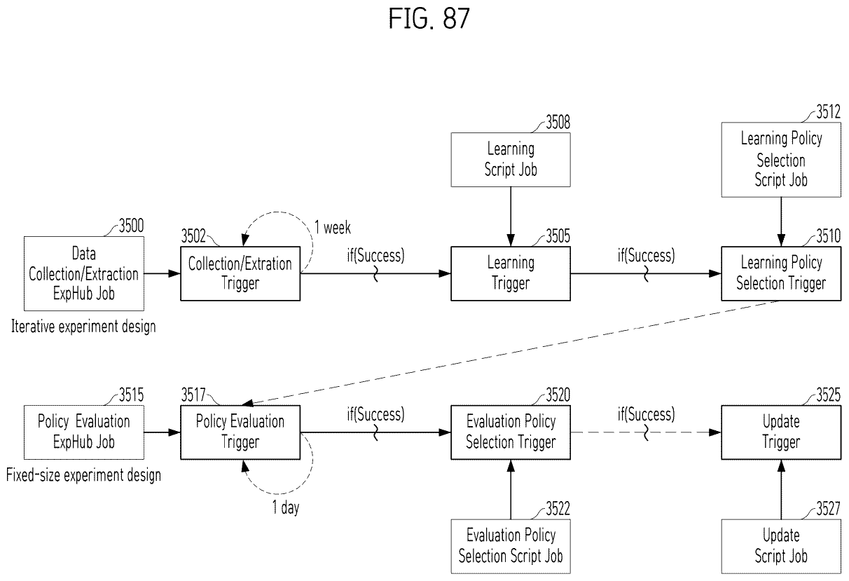

FIG. 87 is a diagram illustrating an example of setting up an operational task for dynamic policy operation in a system operation unit according to an embodiment.

More specifically, FIG. 87 shows an setting the operational tasks and the execution conditions of the operational tasks based on the experimental hub for dynamic policy operation, but unlike FIG. 85 described above, only the training data is collected in the policy optimization experimental hub job, and the training logic is executed in an external script. For configurations that overlap with FIG. 85, the description will be simplified or omitted.

In this embodiment, policy optimization may include data collection/extraction, learning, and learning policy selection. In order to optimize the policy, data to be evaluated are collected and extracted, training the collected and extracted data, and then selecting the best policy among the trained policies to derive the optimal policy.

In relation to the execution of the experimental hub, the data collection/extraction experimental hub job 3500 and the policy evaluation experimental hub job 3515 may be setup by the job service department 1210. In this embodiment, the data extraction experiment hub job 3500 corresponds to an experiment hub through an iterative experiment design, and the policy evaluation experiment hub job 3515 corresponds to an experiment hub through a fixed-size experiment design.

The data collection/extraction experiment hub job 3500 may be predefined by the job service unit 1210 (see FIG. 45) such that the collection/extraction trigger 3502 is executed once a week. The collection/extraction trigger 3502 corresponds to an execution condition for collecting/extracting scenario outputs to optimize policy parameters, and serves to execute the collection/extraction experiment hub job 3500. Additionally, a learning trigger 3505 may be predefined as a dependency condition of a collection/extraction trigger 3502. The learning trigger 3505 is responsible for executing the learning script job 3508. When the learning script job 3508 is performed, the accompanying learning policy selection script job 3512 may be performed. A learning policy selection trigger 3510 may be predefined as a dependency condition of a learning trigger 3505. The learning policy selection script job 3512 may be performed by the learning policy selection trigger 3510.

Additionally, the policy evaluation experiment hub job 3515 may be setup by the job service unit 1210 so that the policy evaluation trigger 3517 is executed daily. Additionally, an evaluation policy selection trigger 3520 may be setup as a dependency condition of a policy evaluation trigger 3517. By the evaluation policy selection trigger 3520, an accompanying evaluation policy selection script job 3522 may be performed. An update trigger 3525 may be setup as a dependency condition of an evaluation policy selection trigger 3520. The update trigger 3525 is an execution condition that updates the selected policy and causes the update script job 3527 to be executed, which may be selectively performed by the production operation manager as needed. An update trigger may cause the associated update script job 3527 to be performed.

Meanwhile, a dependency condition may be setup between the learning policy selection script job 3512 and the policy evaluation experiment hub job 3515. In this embodiment, if the learning script job 3508 is successfully performed, the learning policy selection trigger 3510 may be setup to perform the learning policy selection script job 3512. Additionally, when the learning policy selection script job 3508 is performed, the policy evaluation trigger 3517 may be optionally setup to be executed so that the policy evaluation experiment hub job 3515 is performed. That is, the policy optimization experiment hub job 3500 and the policy evaluation experiment hub job 3515 may be performed independently or dependently.

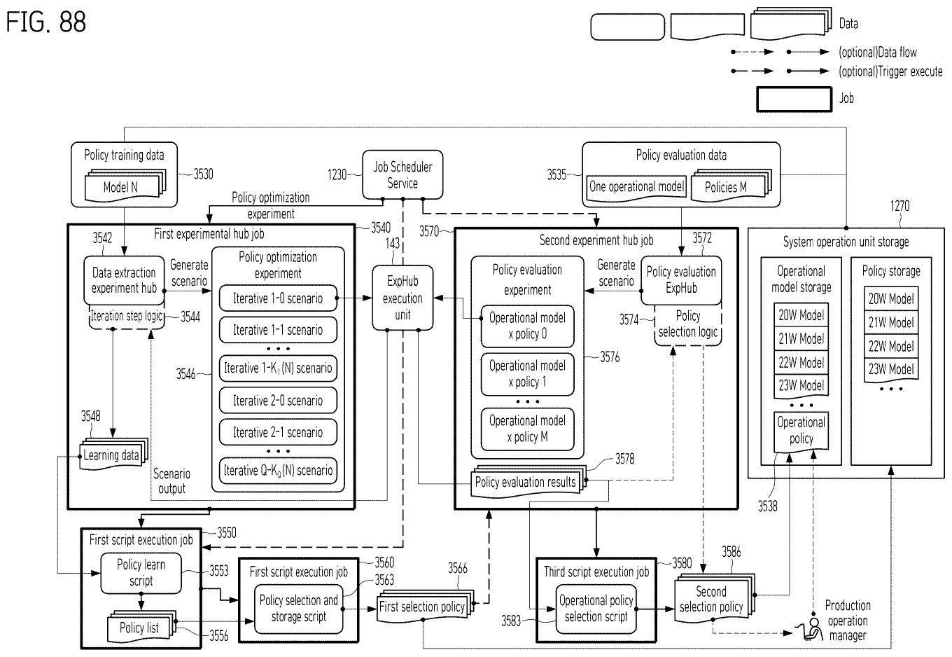

FIG. 88 is a diagram illustrating an example of an operational task performed for dynamic policy operation in an operational environment according to an embodiment.

More specifically, FIG. 88 shows an example in which an operational task based on an experimental hub for policy optimization in FIG. 87 described above is setup and the operational task is performed by the job scheduler service unit 1230. Unlike the above-described FIG. 86, there is a difference in that only training data is collected in the first experimental hub job, and the learning logic is executed in an external script. For configurations that overlap with FIG. 86, the explanation will be brief or omitted.

In this embodiment, the first experimental hub job 3540 corresponds to the data collection/extraction experimental hub job 3500 of FIG. 87, and the first script execution job 3550 and the second script execution job 3560 correspond to the learning script job 3508 and the learning policy selection script job 3512 of FIG. 87, respectively. Additionally, in this embodiment, the second experimental hub job 3570 corresponds to the policy evaluation experimental hub job 3515 of FIG. 87, and the third script execution job 3580 corresponds to the evaluation policy selection script job 3520 of FIG. 87.

First, N operational models may be extracted for policy learning data 3530 (also referred to as “training data”) from the system operation unit storage 1270 for policy learning (also referred to as “policy training”). At this time, the extracted N models may or may not include models to be used in actual operation depending on the user's selection.

A data extraction experiment hub 3542 for model N is generated, and a data extraction experiment 3546 may be generated through an iterative experiment design. The data extraction experiment 3546 corresponds to an experiment for extracting data for learning at least one policy that is the subject of learning. In this embodiment, the data extraction experiment 3546 is an iterative experiment, and may be designed to iterate the experiment including scenarios Ki (N) from scenario 0 to scenario K for Q times until the end condition is reached. The designed data extraction experiment 3546 may be performed as an job 3540 according to a cycle setup by a command of the job scheduler service unit 1230. In this case, the experiment hub execution unit 143 may transmit the execution command of the data extraction experiment 3546 to the model execution unit 130 so that the experiment may be performed.

When an experiment is performed, each scenario output may be transmitted to the iteration step logic 3544. For example, when the scenario result of the first iteration is transmitted to the iteration step logic 3544, it is determined whether it meets the end condition of the current experiment. Scenario design and experiment execution are repeated until the Qth round, which corresponds to the end condition of the experiment, and learning data 3548 may be output as a result.

The learning data 3548 corresponds to the scenario output generated when the iteration step logic 3544 is performed the plurality of times. For example, when one iteration of the logic is completed, the state variables and reward function values of the decisions that occurred in all scenarios corresponding to each iteration step correspond to the learning data. Additionally, the learning data 3548 corresponds to data different from the data in the policy list 3556. The policy list 3556 may include policies obtained directly through the iterative step logic or policies obtained through a policy learning script using learning data 3548.

If the first experimental hub job 3540 is successfully performed, the job scheduler service unit 1230 may execute the first script execution operation job 3550. When the first script execution job 3550 is executed, the policy learning script 3553 may be executed. A policy list 3556 may be produced as a result of executing the policy learning script 3553. If the first script execution job 3550 is successfully performed, the job scheduler service unit 1230 may execute the second script execution job 3560. When the second script execution job 3560 is executed, the policy selection and storage script 3563 may be performed.

The policy selection and storage script 3563 corresponds to the process of specifying the policy with the highest performance among all policies derived from the learning process and storing it in the operation model storage. Here, the policy with the highest performance may be determined by the internal logic of the policy selection and storage script 3563.

Additionally, when the policy selection and storage script 3563 is performed, the derived first selection policy 3566 may be stored in the policy storage of the system operation unit storage 1270. Optionally, if the second experimental hub job 3570, which is a dependent execution condition, is executed after the second script execution job 3560, the first selection policy 3566 may be utilized for policy evaluation data in the second experimental hub job 3570 by trigger execution.

For policy evaluation, one operation model and M policies may be extracted from the system operation unit storage 1270 as policy evaluation data 3535. At this time, if trigger execution is performed after the second script execution job 3560, the M policies may include the first selection policy 3566.

A policy evaluation experiment hub 3572 is generated for one operation model and M policies, and a policy evaluation experiment 3576 may be generated through a fixed-size experiment design. In this embodiment, the policy evaluation experiment 3576 may be designed as a fixed-size experiment including M scenarios. The designed policy evaluation experiment 3576 may be performed as a job 3570 according to a cycle setup by a command of the job scheduler service unit 1230. When an experiment is conducted, policy evaluation results 3578 for the plurality of scenarios may be derived.

Meanwhile, when the policy evaluation results 3578 are derived, the policy to be used in actual operation may be selected through various methods. As an example, if the second experimental hub job 3570 is successfully performed, the job scheduler service unit 1230 may execute the third script execution job 3580. When the third script execution job 3580 is executed, the operation policy selection script 3583 may be executed. When the operation policy selection script 3583 is executed, one of the M policies may be determined as the second selection policy 3586. As another example, optionally, the policy evaluation result 3578 may be transmitted to the policy selection logic 3574 included in the second experimental hub job 3570, thereby selecting the second selection policy 3586. In relation to selecting the second selection policy 3586, it may be performed in the same manner as the second selection policy 3486 described in the above-described FIG. 85.

The second selection policy 3586 may be stored as an operational policy 3538 for actual operation in the operational model storage of the system operation unit storage 1270. In this embodiment, the second selection policy 3586 is a policy determined through policy evaluation and may correspond to the same policy as the operational policy 3538, which is a policy to be used in actual operation. Additionally, depending on the operational policy selection method, the second selection policy 3586 may also be manually selected by the production operation manager and uploaded as an operational policy to the operational model storage.

In addition, if learning data 3548 is stored through a separate job, the job scheduler service unit 1230 may skip the subsequent data extraction process and only proceed with the policy learning script job 3553 in a different way. Through this example, you may establish an excellent production plan and schedule by selecting a learning method that generates a policy that is most suitable for the changing manufacturing system situation.

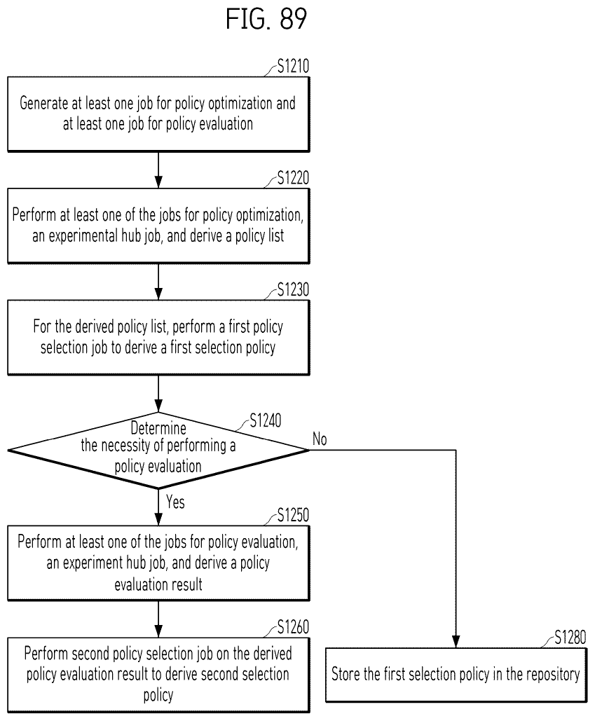

FIG. 89 is a flowchart illustrating an example of setting up and performing operational tasks for dynamic policy operation in an operating environment according to an embodiment.

First, for dynamic policy operation, experimental hub jobs for policy optimization and policy evaluation may be generated respectively. That is, at least one job for policy optimization and at least one job for policy evaluation may be generated S1210. Additionally, the generation of each job may include setting the execution cycle of the job and inter-job dependencies. As described above in FIG. 85, at least one job for policy optimization may include a policy optimization/learning experiment hub job and a learning policy selection script job. Alternatively, as described above in FIG. 87, the policy optimization experiment hub job may include a data collection/extraction experiment hub job, a learning script job, and a learning policy selection script job.

Next, at least one of the jobs for policy optimization, an experimental hub job, may be performed to derive a policy list S1220. As an example, as described above in FIG. 86, at least one job for policy optimization may correspond to a first experiment hub job including optimization and learning and a first script execution job for policy selection. The first experimental hub job, including optimization and learning, corresponds to an experiment that includes an iterative experiment design. In the embodiment of FIG. 86, the policy list may correspond to log data as a learned record of the changed policies while performing at least one iteration step logic included in the policy optimization experiment for the plurality of times. As another example, as described above in FIG. 88, at least one of the jobs for policy optimization, the experiment hub job and the first script execution job, may be performed to derive a policy list. In this embodiment, at least one job for policy optimization may correspond to a first experiment hub job for data extraction, a first script execution job for policy learning, and a second script execution job for policy selection. The first experimental hub job for data extraction corresponds to an experiment that includes an iterative experiment design. In the embodiment of FIG. 88, the policy list may correspond to log data as a learned record of policies that have been changed as a result of performing the first experimental hub job and the first script execution job.

For the derived policy list, a first policy selection job may be performed to derive a first selection policy S1230. Here, the first policy selection job may correspond to the first script execution job of FIG. 86 or the second script execution job of FIG. 88. The first policy selection job is the task of specifying the policy with the best performance among all policies derived from the optimization or learning process.

When the first selection policy is derived, the necessity of performing a policy evaluation may be determined S1240. If there is no need to perform policy evaluation, the policy optimization process may be completed after storing the derived first selection policy in the policy storage S1270. At this time, the policy stored in the policy storage may be included in the policy evaluation data and utilized when the experimental hub job for policy evaluation is performed independently in the future.

If there is a need for policy evaluation, at least one job for policy evaluation such as performing an experiment hub job, may be performed, and a policy evaluation result may be derived S1250. Here, the policy evaluation job may correspond to the second experimental hub job described in FIG. 86 and FIG. 88. Policy evaluation jobs correspond to experiments involving fixed-size experiment designs. The policy evaluation results are the results of executing the plurality of scenarios through policy evaluation experiments, and may correspond to the execution results for different policies for the same operational model.

Next, a second policy selection job may be performed on the derived policy evaluation results to derive a second selection policy S1260. Here, the second policy selection job corresponds to the task of selecting one policy among the plurality of policies. As an example, the derived second selection policy may be stored as an operational policy in the operational model storage.

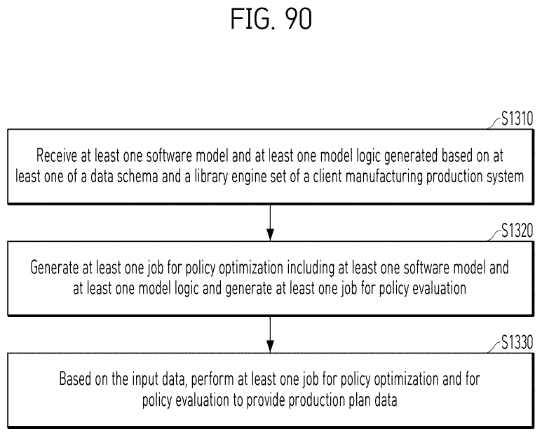

FIG. 90 is a flowchart illustrating a method for providing digital production plan information according to an embodiment.

At least one software model and at least one model logic generated based on at least one of a data schema and a library engine set of a client manufacturing production system may be received S1310. As described above, the software model and logic set generated in the model development unit may be uploaded to the system operation unit through the server management unit. Generating at least one software model and at least one model logic may involve the backward planning engine, the forward planning engine, the dispatching agent, the model development unit, etc. described above. Detailed examples of a backward planning engine are illustrated in FIGS. 4 to 8, detailed examples of a forward planning engine are illustrated in FIGS. 9 to 13, and detailed examples of a dispatching agent are illustrated in FIGS. 14 to 18, respectively. Additionally, detailed examples of the model development unit are disclosed in detail in FIGS. 19 to 22.

At least one job for policy optimization including at least one software model and at least one model logic and at least one job for policy evaluation may be generated S1320. Here, at least one job for policy optimization and at least one job for policy evaluation may be used for dynamic policy operation in a manufacturing production system. Additionally, a policy evaluation experiment may include at least one policy. As described above in FIGS. 85 and 87, in addition to generating an experimental hub job, at least one dependency condition may be setup for the job. With respect to generating an experiment hub file and generating an operation task, detailed examples of the system operation unit are illustrated in FIGS. 23 to 29, detailed examples of the experiment hub are illustrated in FIGS. 36 to 47, detailed examples of the iterative experiment design are illustrated in FIGS. 48 to 50, and detailed examples of the experiment hub job are illustrated in FIGS. 51 to 54, respectively.

Based on the input data, at least one job for policy optimization and for policy evaluation may be performed to provide production plan data S1330. As described above in FIGS. 86 and 88, production plan data may include operational policies. Detailed examples of the mathematical optimization formulation are described in detail in FIGS. 80 to 84.

Referring to FIG. 29, an embodiment of a device providing digital production plan information including an experimental hub is described as follows.

An embodiment of a device providing digital production plan information may include an input unit 410, a storage unit 420, an in-memory unit 430, a processor 440, an output unit 450, and a user interface 460. For example, a device that provides digital production plan information may correspond to a client's manufacturing production system.

An embodiment of a device providing digital production plan information below may be controlled by user control and management via a user interface 460.

The input unit 410 may receive a software model and logic set generated based on at least one of the data schema and library engine set of the client manufacturing production system from the on-premise computing system.

The storage device 420 may store pre-prepared reference information or store received software model and logic set. The storage device 420 may include volatile memory or non-volatile memory.

In-memory 430 may store the software model, input data, library engine set, and products obtained in the process of performing the library engine, model execution unit, and experiment hub unit disclosed above. A library engine set may contain a production planning engine, which is a number of encapsulated function block files that generate production plans. The in-memory 430 of the embodiment may store intermediate outputs and/or final outputs related to the experimental hub operation work.

The processor 440 of the embodiment may receive at least one software model and at least one model logic generated based on at least one of a data schema and a library engine set of a client manufacturing production system. Additionally, the processor 440 may generate at least one job for policy optimization and at least one job for policy evaluation, which includes at least one software model and at least one model logic. In this regard, the generation of experimental hub jobs and setting of dependency conditions are disclosed in FIGS. 85 and 87. Additionally, the processor 440 may perform one of the at least one job for policy optimization and at least one job for policy evaluation based on input data to provide production plan data. In this regard, the performance of the policy optimization experiment hub job and the policy evaluation experiment hub job is disclosed in FIG. 86 and FIG. 88.

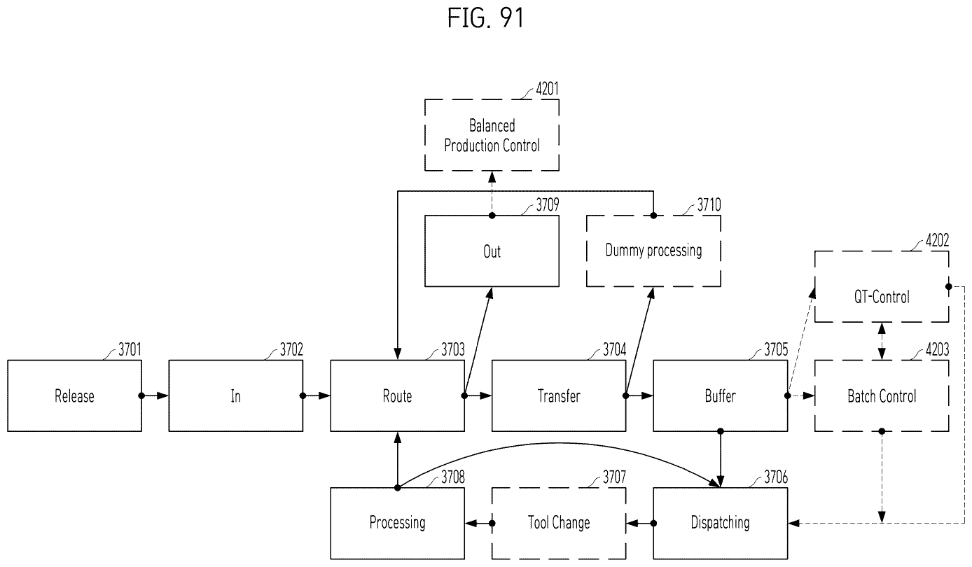

FIG. 91 discloses a diagram illustrating an example of providing digital production plan information using a domain-specific engine according to an embodiment.

In an embodiment, in the event queue, events may be executed in the following order: work item release 3701 and work item input 3702, followed by work item route 3703, work item transfer 3704, work item buffer 3705, dispatching 3706, and operation processing 3708. Additionally, some events sorted in the event queue described above may be excluded and executed. As another example, a work item placement (route) 3703 event may be executed followed by a work item out (out) 3709 event.

Optionally, after the dispatching 3706 event is executed, a tool change 3707 event may be executed, and after the work item transfer 3704 event is executed, a dummy processing 3710 event may be executed. The events and event order sorted in the event queue are examples and are not limited thereto. For more detailed information, reference is made to the above.

In an embodiment, optionally, an event related to Balanced Production Control 4201 may be executed after the work item complete (out) event 3709 is executed.

Here, balanced production control 4201 may include a process of balancing the production speeds of two production facilities (e.g., production lines) when there are parallel production facilities with different production speeds. Additionally, balanced production control 4201 may be performed based on logic and events for balanced production included in the domain-specific engine. The above logic and events may collect the completion time of the last operation of a work item after performing backward logic and forward logic for facilities with relatively slow production speeds to achieve balanced production. Additionally, the completion time of the last collected process may be converted into demand information for a facility with a relatively fast production speed, and backward logic and forward logic based on the demand information may be performed. This is explained in more detail below.

In an embodiment, optionally, an event related to queue waiting time control (QT-Control) 4202 may be executed after the work item buffer 3705 event is executed. Here, an event related to queue waiting time control 4202 calculates an expected waiting time in the target process when the target work item or the entire batch (type) work item is put into operation at the current point in time based on the waiting time control logic included in the domain-specific engine, and determines whether the waiting time constraint is satisfied based on the calculated estimated waiting time. This is explained in more detail below.

In an embodiment, optionally, an event related to a batch control 4203 may be executed after the work item buffer 3705 event is executed. Here, an event related to batch control 4203 may determine a batch composition by determining whether a batch specification for a work item of a batch production operation is satisfied based on the batch control logic included in the domain-specific engine. This is explained in more detail below.

In an embodiment, an event related to Batch Control 4203 may be executed after an event related to queue waiting time control (QT-Control) 4202 is executed, and conversely, an event related to queue waiting time control (QT-Control) 4202 may be executed after an event related to Batch Control 4203 is executed.

In an embodiment, a dispatching 3706 event may be executed after an event related to queue waiting time control (QT-Control) 4202 and an event related to Batch Control 4203 are executed.

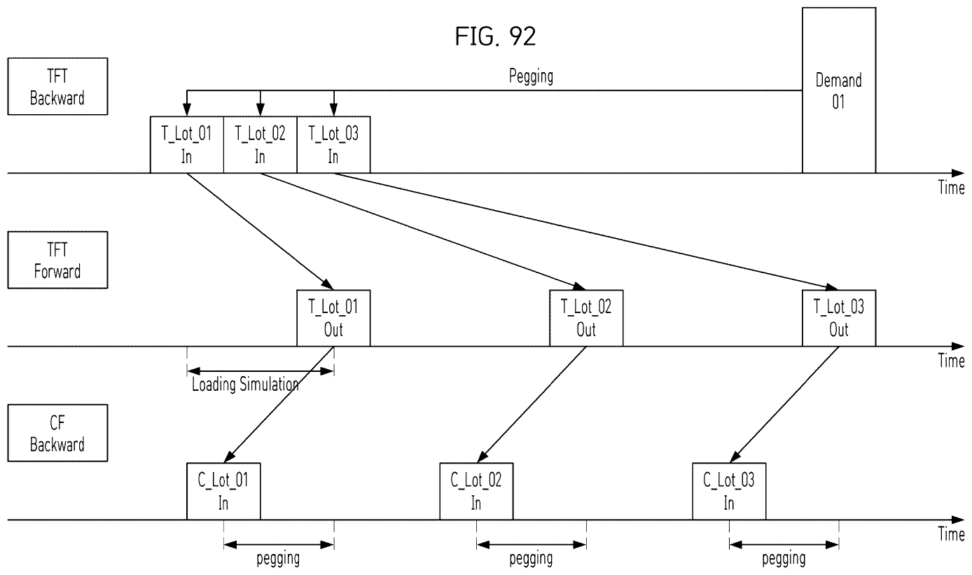

FIG. 92 discloses an example of balanced production logic according to an embodiment.

In an embodiment, for LCD, it may be composed of four facilities (shops), such as TFT, CF, Cell, and Module. In this case, TFT and CF are parallel production facilities (shops), and products to be paired in the two production facilities (e.g. products to be assembled) may be required simultaneously in the cell facility (cell shop). At this time, the process of the TFT production facility is slower than that of the CF production facility, which may result in a difference in production quantity. Accordingly, if the CF production facility's process is operated to the extent of its production capacity to manufacture products, inventory may remain, unnecessary parts may be generated, and inventory holding costs may increase. To address this, functionality could be added to domain-specific engines to synchronize production speeds between facilities (shops). In an embodiment, a production facility according to the present disclosure may include a production line performing the operation.

In an embodiment, if the domain-specific engine is specialized for the display domain, balanced production logic may be performed. In an embodiment, pegging of backward planning logic may be performed first for the first production line whose operation speed is relatively slower. For example, for a TFT production line with a slower process speed, pegging of backward planning logic may be performed based on demand information (Demand 01) to produce operation target information (T_Lot_01 In, T_Lot_02 In, T_Lot_03 In).

Here, the operation target information may include at least one of an input target and an operation target. For example, the operation target information may include at least one of information on input plan timing for operation (Inplan Date), input plan quantity information (Inplan Quantity), operation completion information (Outplan Date), and information on quantity at completion time (Outplan Quantity). As another example, the operation target information may include at least one of input target date information for the operation (In Target Date), input target date quantity information (In Target Quantity), operation completion target date information (Out Target Date), and quantity information at operation completion target date (Out Target Quantity). As above, depending on the case, the operation target information may use the operation input plan (Inplan) information and completion information (Outplan), or the input target (In Target) information and completion target (Out Target) information.

In an embodiment, forward planning for a TFT production line with a slow process speed is performed based on operation target information that is a result of backward planning for a TFT production line with a slow process speed, and a completion time of a work item produced as a result of forward planning for the TFT production line with a slow process speed may be obtained. For example, by performing a simulation of the forwarding planning logic based on the operation target information (T_Lot_01 In, T_Lot_02 In, T_Lot_03 In) for a TFT production line with a slower process speed, at least one of work item completion information (T_Lot_01 Out, T_Lot_02 Out, T_Lot_03 Out) for the last operation among at least one operation included in the TFT production line and production plan data (not shown) for all of at least one operation included in the TFT production line may be produced. In this case, the work completion information corresponding to each operation target information may be produced at different times.

Based on the completion time of the completed work, backward planning may be executed on the second production line with a faster process speed to generate operation target information, which may then be input to the second production line with a faster process speed. For example, the TFT production line may correspond to the first production line with a relatively slow process speed, and the CF production line may correspond to the second production line with a relatively fast process speed. In this case, the operation target information (C_Lot_01 In, C_Lot_02 In, C_Lot_03 In) of the CF production line may be derived by performing pegging of the backward planning logic based on the work item completion information (T_Lot_01 Out, T_Lot_02 Out, T_Lot_03 Out) of the TFT production line. At this time, each of C_Lot_01 In, C_Lot_02 In, and C_Lot_03 In for the CF production line may refer a work item that is paired with T_Lot_01 Out, T_Lot_02 Out, and T_Lot_03 Out for the TFT production line to satisfy demand information (Demand 01) for the TFT production line.

Thereafter, forward planning for the second production line with a high process speed is executed based on the operation target information which is the result of backward planning for the second production line with a high process speed, and production plan data (not shown) for at least one operation included in the second production line which is produced as a result of forward planning for the second production line with a high process speed may be obtained. Therefore, CF work items corresponding to the completion time of the TFT production line may be produced at a similar time and delivered to the cell shop.

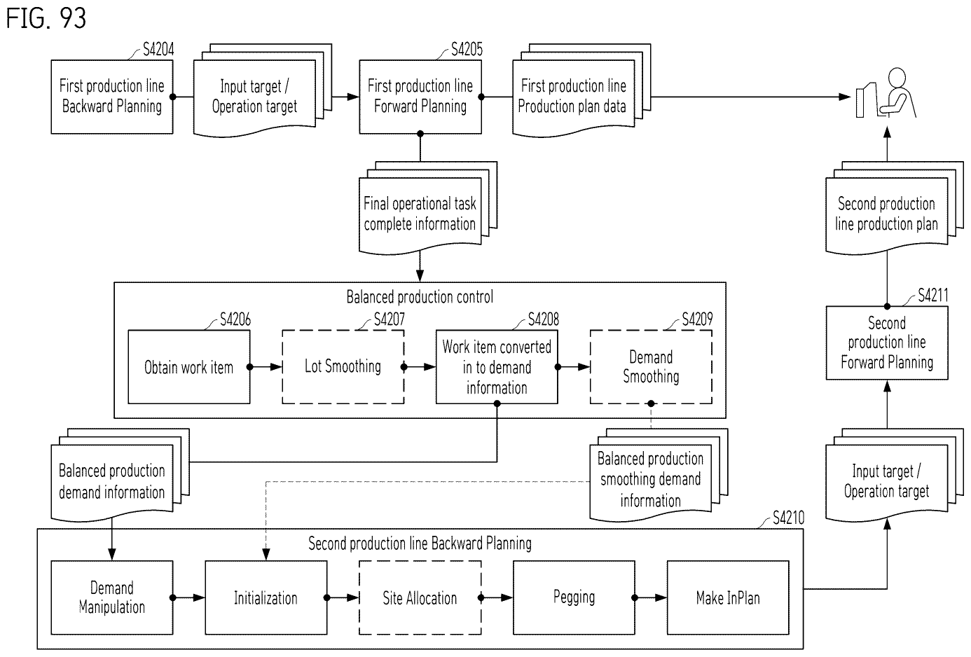

FIG. 93 discloses an example of a process of balanced production logic according to an embodiment.

Backward planning is executed on the first demand information of the first operation of the first production line, which is performed at a relatively slow production speed of the client manufacturing production system, to produce the first operation target information S4204. Here, the first operation target information may include at least one of an input target and an operation target for the first operation of the first production line. For example, the first operation may include at least one of the operations of a TFT production line of the display domain.

Forward planning for the first production line is executed using the first operation target information of the first operation to produce the first work item completion information and the first production plan data of the first operation S4205. Here, the first work item completion information may include work item completion information in the last operation among at least one operation included in the first operation. Additionally, the first production plan data may include production plan data for at least one operation included in the first operation of the first production line.

Balanced production control may be performed based on the completion information of the first work item of the first operation. Specifically, each work item included in the first work item completion information produced by performing forwarding planning is obtained S4206. In an embodiment, the completion time of each work item may be different from each other, and the completion time of each work item corresponding to the work item information regarding when and how much of each work item should be input included in the first operation target information may be calculated.

Work item (Lot) smoothing is performed for each work item S4207. In an embodiment, work item smoothing may be performed on the first work item completion information corresponding to each work item. That is, if the completion times for each of the first work item completion information overlap at least partially, work item smoothing may be performed on the overlapping first work item completion information to generate a single integrated first work item completion information. For example, work item smoothing may involve determining the work time of each work item to be equal to a specific time, and if each work item contains the same quantity, combining the quantities of those work items to generate one work item at that specific time. In this case, the specific time determined equally for each work item may be setup as the last or average of the operation completion time or operation start time of each work item.

Based on the first work item completion information of the first operation, the second demand information of the second operation of the second production line performed at a relatively fast production speed is calculated S4208. In an embodiment, the second demand information may be calculated based on the completion time of the first work item of the first operation included in the first work item completion information and the work item quantity of the second work item of the second operation corresponding to the work item quantity at the completion time. In this case, the first work completion information of the first operation and the second demand information of the second operation may be determined by predefined matching information. That is, one demand information (i.e., the second demand information) may be converted into work items of both production lines, the first production line (e.g., the TFT production line) and the second production line (e.g., the CF production line), which are parallel production lines, and the interconnection relationship between the work items may be setup with predefined matching information. For example, if two TFT work items are produced at the corresponding completion point of the operation of the TFT production line, the quantity of CF work items included in the two TFT work items is calculated to be 10, so the second demand information of the operation of the CF production line may be calculated to be 10 CF work items.

Demand information smoothing is performed on the second demand information S4209. In an embodiment, in an embodiment, work item smoothing may be performed on the second demand information corresponding to each work item. That is, if the completion times corresponding to each of the second demand information overlap at least partially, demand information smoothing may be performed on the overlapping second demand information to generate a single integrated second demand information. For example, demand information smoothing may include a process of determining the work time for each demand information to be the same as a specific time, and, if the quantity included in each demand information is the same, combining the quantities of the demand information to generate one demand information at the specific time. In this case, the specific time determined equally for each demand information may be setup as the last or average of the operation completion time or operation start time of each demand information.

Backward planning, which is a time-reversal method, is executed on the second demand information of the second operation based on the first work completion information to produce the second operation target information S4210. Here, the second operation target information may include at least one of an input target and an operation target for the second process. For example, the second operation may include an operation of a CF production line in the display domain. Here, the detailed descriptions for backward planning are described above.

Forward planning, which is a time-advancing method for the second operation target information of the second operation, is executed to produce the second production plan data of the second operation S4211. In an embodiment, the second production plan data may include production plan data for at least one operation included in the second operation of the second production line. In an embodiment, production plan data including first production plan data of a first operation of a first production line performed at a relatively slow production speed and second production plan data of a second operation of a second production line performed at a relatively fast production speed may be provided to a user. That is, according to the present disclosure, control may be performed to achieve balanced production for production lines having different production speeds.

In this way, according to the present disclosure, by balancing the production speeds of parallel production lines with different production speeds through balanced production control, work items produced in the two production lines may be uniformly put into a production line (e.g., Cell) that assembles the work items.

In an embodiment, at least some of the steps in the present diagram may be omitted. For example, at least one of operations S4207 and S4209 may be omitted.

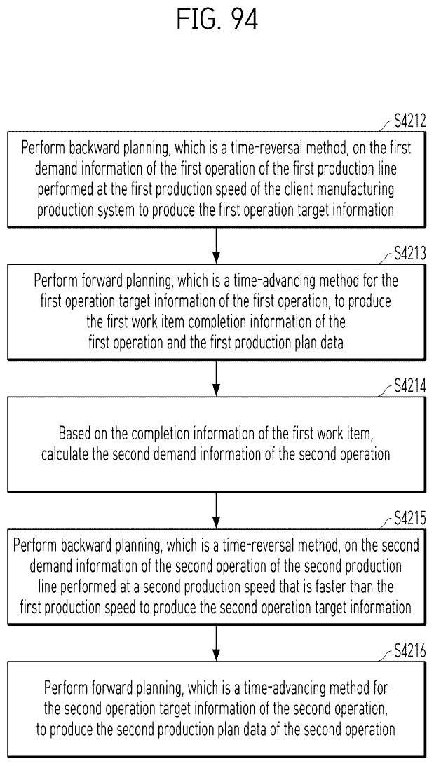

FIG. 94 discloses a flowchart illustrating an example of balanced production logic according to an embodiment.

Backward planning, which is a time-reversal method, is executed on the first demand information of the first operation of the first production line performed at the first production speed of the client manufacturing production system to produce the first operation target information S4212. In an embodiment, the first demand information may include at least one of a input waiting time (Wait TAT), a process-specific operation time (Run TAT), a process-specific yield (Yield), a BOM (Bill of Material), and a BOP (Bill of Process) for each first operation to be produced by the completion time of the first work item.

In an embodiment, the first demand information, i.e., the delivery time and quantity information of the complete product, may be used to calculate the quantity (Quantity) and the time information (Date) of the input target (In Target) of the first operation by reverse-calculating the operation time (RUN TAT) and the yield information (YIELD) based on the quantity (Quantity) and the time information (Date) of the completion target (Out Target) of the first operation to meet the due date of the first work item.

And, based on the quantity (Quantity) and date (Date) information of the input target (In Target) of the first operation to meet the due date time of the first work item, the quantity (Quantity) and date information of the completion target (Out Target) of the first operation may be reverse-calculated by considering the input waiting time (Wait TAT).

Forward planning, which is a time-advancing method for the first operation target information of the first operation, is executed to produce the first work item completion information of the first operation and the first production plan data S4213. In an embodiment, based on the first operation target information produced as a result of backward planning, a detailed first production plan may be produced by executing events such as work item (lot) or equipment placement (route), work item filtering, work item transfer, input decision (dispatching), work item input (in), and work item disappearance (out) related to the first operation.

Based on the completion information of the first work item, the second demand information of the second operation is calculated S4214. In an embodiment, the second demand information of the second operation may be derived based on the output of the last operation of the first operation, i.e., the first work item completion information, obtained by executing a loading simulation with forward planning. Here, the second demand information may be used as input data for a backward planning engine to execute backward planning for the second operation.

Backward planning, which is a time-reversal method, is executed on the second demand information of the second operation of the second production line performed at a second production speed that is faster than the first production speed to produce the second operation target information S4215. In an embodiment, the second demand information may include at least one of input waiting time (Wait TAT), operation time (Run TAT), yield (Yield), a BOM (Bill of Material), and a BOP (Bill of Process) for each second operation to be produced by the completion time of the second work item.

In an embodiment, the second demand information, i.e., the due time and quantity information of the complete product, may be used to calculate the quantity (Quantity) and the time information (Date) of the input target (In Target) of the second operation by calculating the operation time (RUN TAT) and the yield information (YIELD) based on the quantity (Quantity) and the time information (Date) of the completion target (Out Target) of the second operation to meet the due time of the second work item.

And, based on the quantity (Quantity) and date (Date) information of the input target (In Target) of the second operation to meet the due time of the second work item, the quantity (Quantity) and date information of the completion target (Out Target) of the second operation may be reverse-calculated by considering the input waiting time (Wait TAT).

Forward planning, which is a time-advancing method for the second operation target information of the second operation, is executed to produce the second production plan data of the second operation S4216. In an embodiment, based on the second operation target information produced as a result of backward planning, a detailed second production plan may be produced by executing events such as work item (lot) placement (route), lot filtering, lot transfer, input decision-making (dispatching), lot in, and lot out for lots or equipment related to the second operation.

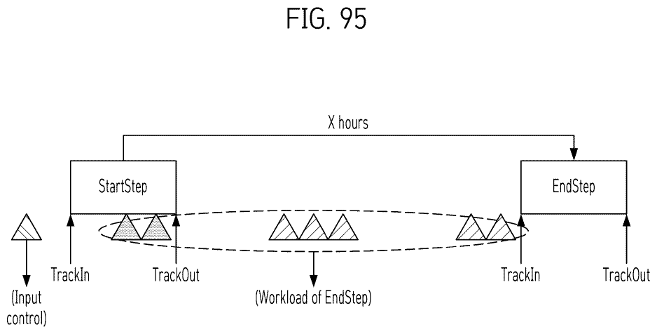

FIG. 95 discloses an example of wait time control logic according to an embodiment.

In an embodiment, in the semiconductor fab domain, the target may be a factory that produces chips by drawing them on wafers, including a photo process.

In the case of a semiconductor fab process, a queue waiting time (QueueTime) constraint may be setup, where the queue waiting time constraint may include a constraint that the time between production in the previous operation and the start the next operation, i.e., the queue waiting time must be included within a specific time. If this queue waiting time constraints are not satisfied, defective products or poor yields may result.

In an embodiment, a production line of a client manufacturing system may perform a number of operations including a start operations (StartStep) and an end operations (EndStep). In an embodiment, a queue waiting time constraint may be applied to each of at least one operation section included in a plurality of operations. At this time, the start step and end step may be determined for each operation section. In this case, at least one process may be added between the start operation (StartStep) and the end operation (EndStep). For example, to produce product A, operations 1 to 100 must be performed, and queue waiting time constraints may be applied to operation sections 2 to 4, 58 to 70, and 90 to 92. At this time, the time point for calculating the constraint may be from the completion time (TrackOut) of the starting operation of each operation section (i.e., operations 2, 58, and 90) to the input time (TrackIn) of the ending operation (i.e., processes 4, 70, and 92).

In an embodiment, the queue waiting time constraint may include a constraint that the queue waiting time (X hours) described above must be greater than a first threshold and less than a second threshold. In an embodiment, the queue waiting time of the production line may include the time between when a work item is output (TrackOut) through a start operation (StartStep) and when it is input into (TrackIn) an end operation (EndStep) through a workload.

For example, the first threshold may include a minimum queue waiting time (MinQtime), which may mean that at least a certain (X) amount of time must elapse between starting a start operation (StartStep) and proceeding to an end operation (EndStep). In this case, hold may be performed for the remaining time in the end operation (EndStep).

Additionally, the second threshold may include a maximum queue waiting time (MaxQtime), which may mean that a specific (X) time must not be exceeded from the start operation (StartStep) to the end operation (EndStep). In this case, input control may be performed in the start operation (StartStep).

In an embodiment, input control among waiting work items may be performed through queue time control (QueueTime Control). Additionally, it may be determined based on the workload currently being applied to a current operation or operation section that if the operation is applied now before the start operation (StartStep) is applied, the queue time constraint in the target operation will not be satisfied. Here, the point in time when work item is input into each operation (TrackIn) and the point in time when work is output through the operation (TrackOut) may be monitored. In this case, the workload of the end operation (EndStep) may include at least one of the workload immediately before being output (TrackOut) through the start operation (StartStep), the workload output from the start operation (StartStep) i.e. the workload waiting in the operation section, and the workload immediately before being input (TrackIn) to the end operation (EndStep).

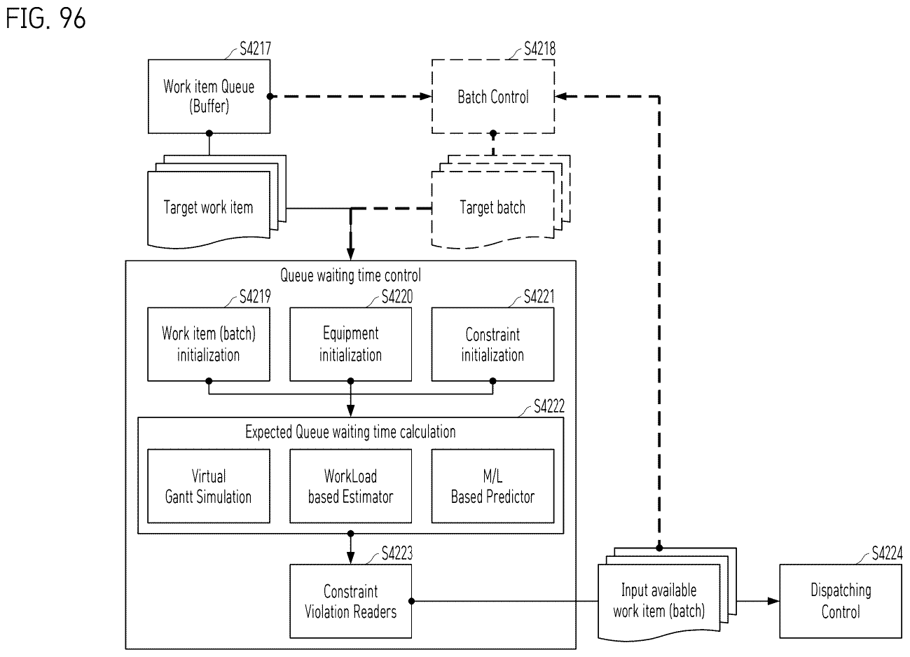

FIG. 96 discloses an example of a process of queue waiting time control logic according to an embodiment.

Determine the target work item from the work item queue (Buffer) S4217. In an embodiment, the work item queue may be referred to as a Buffer or a term having an equivalent technical meaning. In an embodiment, the target work item may be assigned a lot as a unit quantity in which production is performed.

The target batch is determined through batch control S4218. In an embodiment, a target batch may be determined that includes a target work item determined from a work item queue. That is, a bundle of pending work may be determined as the target batch.

In an embodiment, initialization may be performed on at least one of a target work item, a target batch, equipment, and a waiting time constraint. In this case, initialization could mean returning an active object, whose information changes over time in the simulation, to its initial state. That is, the initialization may be intended to be unaffected by changes that occur during the process of calculating the expected queue waiting time based on at least one of the target work items currently waiting in the queue, the target batch, the equipment, and the waiting time constraints. For example, in the case of the virtual Gantz method, in the logic for calculating the expected queue waiting time, the queue waiting time is calculated by performing a virtual simulation for a certain period of time from the current point in time through initialization, but the virtual decision-making that occurs at this time may not be reflected in reality.

In an embodiment, queue waiting time control for a target work item or target batch may be performed. Specifically, initialization is performed for the target work item or target batch S4219. In an embodiment, initializing a target work item or target batch may include returning the state, properties, characteristics, etc. of an existing work item or batch to an initial state to begin a particular production batch or operation.

Perform initialization for equipment related to the target work item or target batch S4220. In an embodiment, initializing a piece of equipment may include configuring the equipment for an operation based on a target work item or target batch, or returning the equipment's state, function, and other settings to an initial state.

Initialization of queue waiting time constraints related to target work item or target batch is performed S4221. In an embodiment, initializing the queue waiting time constraint may include returning at least one of a lower bound and an upper bound of the queue waiting time based on an operation applied in the production process according to the target work item or target batch to an initial state. In an embodiment, since constraints may vary across the plurality of products in a single operation, the plurality of queue wait time constraints may be initialized at initialization or may be retrieved and used after they are performed in the persist phase.

Calculate the expected queue waiting time for the operation based on at least one of the target work item or target batch and equipment S4222. In an embodiment, the expected queue wait time for an operation may be derived using at least one of a Virtual Gantt Simulation, a WorkLoad based Estimator, and a Machine Learning (M/L) based Predictor.

In an embodiment, the virtual Gantz simulation may generate a separate virtual simulation within the simulation for calculating the expected queue waiting time, so that the input of a work item to the starting operation may be performed for a given time, and may check whether the queue waiting time constraint is satisfied until the work item arrives at the ending operation. That is, the expected queue waiting time may be derived through a series of virtual decisions about when the work item will arrive.

In an embodiment, the workload-based outputter may output how many tasks are already in the workload (from Startstep to Endstep) or are waiting, what the priority will be when a new work item is input to the workload, and how long it will take to process all of the work items already in the workload or waiting.

In an embodiment, the machine learning-based predictor may predict when a work item should be input based on property values at a start step. Here, for example, the property values may include at least one of how many work items are in process or waiting, how many similar work items exist, how far the equipment has progressed, and how long the next operation will take.

Based on the expected queue waiting time, it is determined whether the queue waiting time constraint is satisfied S4223. In an embodiment, it may be determined whether the expected queue waiting time is greater than a first threshold value of the queue waiting time constraint and less than a second threshold value. That is, it may be verified that the expected queue waiting time is the minimum time elapsed from the start operation (StartStep) to the end operation (EndStep), and does not exceed the maximum time. In an embodiment, even if the queue waiting time constraint is not satisfied, it may be determined whether a separate exception criterion is satisfied that determines that the constraint is satisfied. Additionally, in an embodiment, even if the queue waiting time constraint is satisfied, it may be determined whether a separate exception criterion is satisfied that determines that the constraint is not satisfied. For example, even if a work item does not satisfy a queue waiting time constraint, if the work item is a work item with a test label, i.e., a test work item, it may be determined that the constraint is satisfied based on an exception criterion, so that the impact of the constraint dissatisfaction may be checked.

Based on such judgment, input available work items or input available batches may be produced, which are held for the remaining time in the end operation (EndStep) or for which input control is performed in the start operation (StartStep). For example, if there are 10 target work items, and 7 work items may be processed in the operation within the queue waiting time without violating the queue waiting time constraint, 7 work items may be determined as input available work items. In an embodiment, the produced input available work item or input available batch may be applied to batch control S4218.

A dispatching for input available work items is made based on whether the queue waiting time constraint is satisfied S4224. For detailed information on dispatching, see the description above for more information. In an embodiment, at least one step of the present drawing may be omitted or performed simultaneously. For example, step S4218 may be omitted. Additionally, at least one of steps S4219 to S4221 may be performed simultaneously.

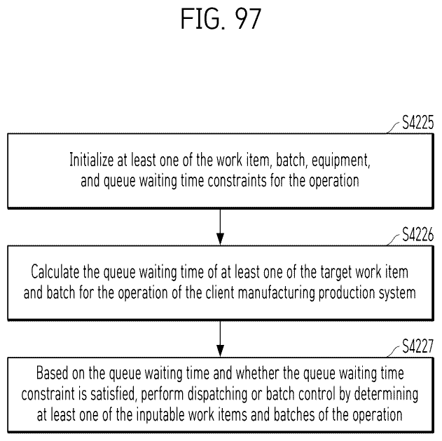

FIG. 97 discloses a flowchart illustrating an example of queue waiting time control logic according to an embodiment.

Initialize at least one of the work item, batch, equipment, and queue waiting time constraints for the operation S4225. In an embodiment, a target work item determined from a work item queue for the operation or a target batch determined by batch control and at least one of the work item, equipment and queue wait time constraints may be initialized.

Calculate the queue waiting time of at least one of the target work item and batch for the operation of the client manufacturing production system S4226. In an embodiment, the queue wait time between a start operation and an end operation for at least one of the target work item and batch may be calculated. In an embodiment, the queue waiting time may be calculated based on at least one of a workload output from a starting operation (TrackOut), a workload included in a workload between a starting operation and an end operation, and a workload input into an end operation (TrackIn). Here, the workload may include at least one of a target work item and a batch.

Based on the queue waiting time, at least one of the input available work items and batches of the operation is determined based on whether the queue waiting time constraint is satisfied, thereby performing input decision or batch control S4227. In an embodiment, input available work items and batches may be extracted based on queue waiting times that satisfy queue waiting time constraints among the initialized target work items and target batches.

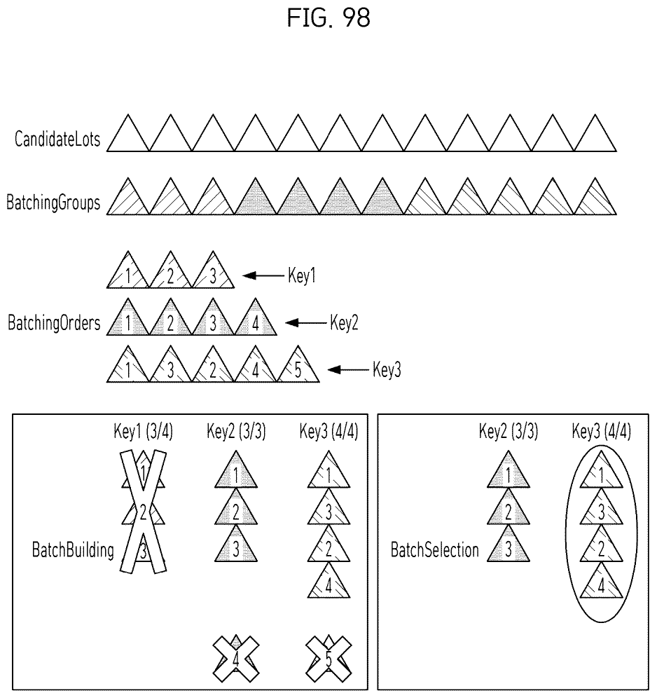

FIG. 98 discloses an example of batch control logic according to an embodiment.

In an embodiment, in the case of a semiconductor fab, an operation may be performed for a client manufacturing production system, i.e., a factory that draws and produces chips on a wafer, including a photo process.

Semiconductor fabs may include batch equipment that processes identical work items in lots. Here, lot may represent a basic unit of work item, and batch may represent a bundle of these Lots. In this case, batch control may be performed to generate a batch, which is a bundle of waiting work items.

In an embodiment, it is possible to determine a number of work items (CandidateLots) that are subject to batching. These the plurality of candidate lots may be grouped into at least one batch (BatchingGroups) with lots having the same key. In an embodiment, a key may include information relating to the identification, properties, and characteristics of a work item. For example, a key may contain various information such as the lot number of the work item, the production date, the type of lot, and the operation conditions. In an embodiment, the key may include a string designating products for which no equipment replacement (Setup) occurs during continuous production. For example, when there are six types of products, Product 1, 2, 3, 4, 5, and 6, and a string that does not cause equipment replacement is set as Group, Products 1, 2, and 3 may be set as Group 1 with Key 1, Products 4, 5 may be set as Group 2 with Key 2, and Product 6 may be set as Group 3 with Key 3. In an embodiment, the key is not limited to the equipment replacement (Setup), and can be set based on the demand customer, due date, priority, or a combination of these information.

In an embodiment, the work item composition score of the work item included in each grouped batch may be calculated, and the order of the work item included in each batch for the corresponding equipment may be determined and the work items may be sorted according to the predefined composition order rules based on the work item composition score. In this case, the order may mean the location of the work item corresponding to a lot within a batch. In an embodiment, the work item composition score may be calculated based on at least one of a due date, waiting time, priority, working time, and size of the work, and the method of calculating the work composition score may be determined in various ways and is not limited thereto.

In an embodiment, the composition order rules may include rules that order the positions in the batch, starting with those with the largest composition scores. However, the composition order rules may be determined in various ways depending on the settings, and are not limited thereto. In an embodiment, the composition ordering rules may be based on a weight sum or weight sort method. For example, the composition order rules may include a method of sorting the work composition scores by weighting them with the higher scores taken first, or a weight sort, which compares them one by one until no ties occur. In an embodiment, the order of the work items may be determined and sorted in various ways according to composition order rules.

For example, if there are three positions in the batch for the first key (Key1) for the batch equipment, the work items from Lot 1 may be arranged in the order of Lots 1, 2, and 3. In addition, if there are four positions in the layout for the second key (Key2) for the batch equipment, the work items may be arranged in the order of Lots 1, 2, 3, and 4 in the four positions starting from Lot 1.

In addition, if there are 5 positions for the 3rd key (Key3) for the corresponding batch equipment, Lot 1 is placed in the first position first, and if the composition ordering rules prevent lot 2 from being placed next due to equipment-related constraints (e.g., zone constraints), lot 3 is placed in the second spot, and the next position is checked for availability, lot 2 is placed in the third position, and thereafter Lot 4 is placed in the fourth position, and Lot 5 may be placed in the fifth position. Accordingly, the work items for the third key may be arranged in the order of lots 1, 3, 2, 4, 5.

In an embodiment, batch building may determine the batch composition in which the order of work items is arranged based on a batch specification (Spec). In an embodiment, the batch specification may include at least one of a batch size indicating the type of operation to be processed and a maximum number of work items that may put into a batch. In an embodiment, the batch composition of a batch may be determined based on the batch size of the batch specification. Here, the batch composition may represent the composition of the work items whose order within the batch is determined, and which is finally determined according to the batch size.

In an embodiment, batch compositions that do not satisfy the batch size of the batch specification may be filtered out. For example, the batch for the first key may be filtered out and removed because there is no work item to be added to the 4th position based on the batch size of the batch for the first key.

In an embodiment, at least one of the work items that the order within a batch is determined based on the batch size of the batch specification, and have been sorted in the order, may be filtered out and removed. For example, among the work items 1, 2, 3, and 4 whose order within the batch for the second key (Key2) is determined, the work item of lot 4 may be filtered out and removed from the batch according to the batch size (3). Additionally, for example, among the work items 1, 2, 3, 4, and 5 whose order within the batch for the third key (Key3) is determined, the work item of lot 5 may be filtered out and removed from the batch according to the batch size (4).

In an embodiment, a batch may be finally selected from among valid batches satisfying a minimum batch size through batch selection (BatchSelection). Here, the selection of the batch may be performed by the dispatching.

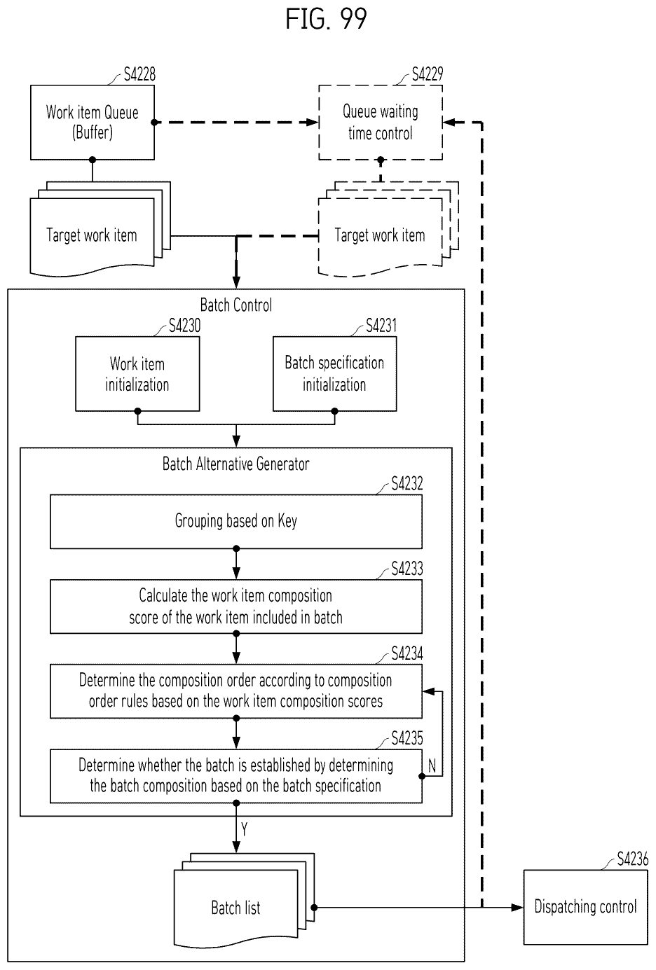

FIG. 99 discloses an example of a process of batch control logic according to an embodiment.

Determine the target work item from the work item queue (buffer) S4228. In an embodiment, the work item queue may be referred to as a Buffer or a term having an equivalent technical meaning. In an embodiment, each target work item may correspond to a lot.

The target work item is determined through queue waiting time control S4229. In an embodiment, a target work item may be determined as an input available work item through queue waiting time control. For detailed descriptions of the input available work items, reference is made the above description.

Perform initialization for the target work item S4230. In an embodiment, initializing a target work item may include reverting the state, properties, characteristics, etc. of an existing work item to an initial state to begin a particular production batch or operation.

Perform initialization for the batch specification S4231. In an embodiment, initializing a batch specification may include reverting the setup values contained in the batch specification for that piece of equipment, work item, or operation to an initial state to begin a particular production batch or operation.

Group the work items into at least one batch based on the work item key S4232. In an embodiment, the plurality of work items may be grouped into at least one batch, with work items having the same key.

Calculate the work item composition score of the work item included in each grouped batch S4233. In an embodiment, the work item composition score may include an arithmetical calculation of how well the work item fits into the batch. For example, the work item composition score may be determined in various ways, such as a suitability score that considers the characteristics of the work (e.g., size, weight, material, etc.), a productivity score calculated based on the speed or efficiency of processing the work within the batch, and a quality score of the work after processing in the batch.

The order of the work items included in each batch for the equipment is determined according to the predefined composition order rules based on the work item composition scores S4234. In an embodiment, the order of the work items within the batch may be determined by a plurality of ordered sets according to composition order rules. In this case, the batch composition may be determined by determining whether the batch is established for each order set as follows.

The batch composition of a batch of arranged work items based on batch specifications is determined S4235. In an embodiment, when work items are inserted one by one in a sequential order into a batch whose order is determined, the final batch composition may be determined by determining whether the batch is established according to the batch specification. Here, if a batch is not established, the batch or the work item within the batch may be filtered out and removed.

Performing a dispatching is made on a batch list including a batch composition determined based on the judgment of whether a batch is established S4236. In an embodiment, a batch selection (BatchingSelection) may be performed to select one of the valid batch compositions based on the batch size from the batch list through a dispatching. For detailed information on dispatching, reference is made to the description above. In an embodiment, at least one step of the present drawing may be omitted or performed simultaneously. For example, step S4229 may be omitted. Additionally, at least one of step S4230 and S4231 may be performed simultaneously.

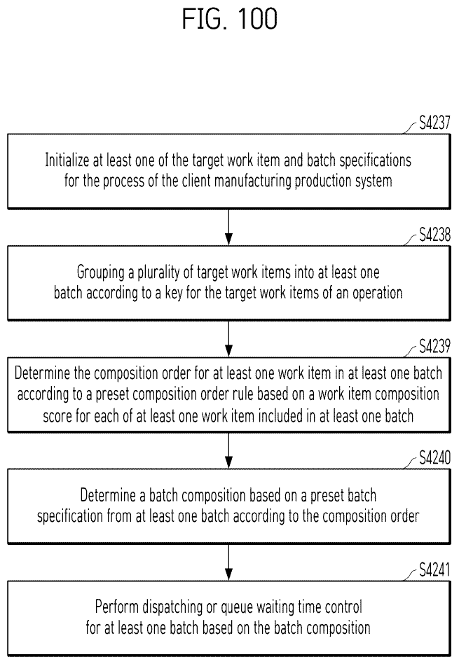

FIG. 100 discloses a flowchart illustrating an example of batch control logic according to an embodiment.

At least one of the target work item and batch specifications for the operation of the client manufacturing production system may be initialized S4237. In an embodiment, initializing a target work item may include reverting the state, properties, characteristics, etc. of an existing work item to an initial state to start a production batch or operation of a particular piece of equipment. In an embodiment, initializing a batch specification may include reverting settings, such as batch size, included in the batch specification to an initial stage to start a production batch or operation of a particular device.

A plurality of target work items are grouped into at least one batch according to a key for the target work items of an operation S4238. In an embodiment, the number of work items grouped and included in each batch may vary depending on the key, and the plurality of multi-phase work items included in one batch may be produced as different products. For example, in a batch, work items 1 and 2 may be produced as product 1, and work item 3 may be produced as product 2.

The composition order for at least one work item in at least one batch is determined according to the predefined composition order rule based on a work item composition score for each of at least one work item included in at least one batch S4239. In an embodiment, when at least one batch is set as a virtual batch, the work item positions within the virtual batch may be arranged to determine the composition order by arranging work items corresponding to work item composition scores according to the composition order rules.

A batch composition is determined based on a predefined batch specification from at least one batch according to the composition order S4240. In an embodiment, the batch composition may be determined by filtering the batch based on the batch size of the batch based on the batch specifications or by filtering the work items within the batch.

Dispatching or queue waiting time control for at least one batch based on the batch composition is performed S4241. In an embodiment, the dispatching and queue waiting time control refer to the aforementioned description.

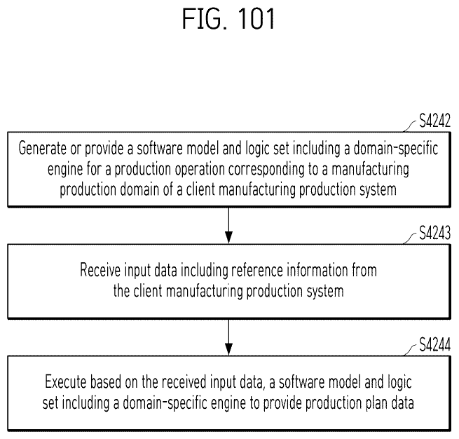

FIG. 101 discloses a flowchart illustrating an example of providing digital production plan information according to an embodiment.

A software model and logic set including a domain-specific engine for a production operation corresponding to a manufacturing production domain of a client manufacturing production system are generated or provided S4242. In an embodiment, the domain-specific engine may perform at least one of balanced production control, queue waiting time control, and batch control. In an embodiment, the domain-specific engine performs backward planning, which is a time-reversal method, on first demand information of a first operation of a first production line performed at a first production speed of the client manufacturing production system to derive first operation target information, executes forward planning, which is a time-forward method, on the first production line using the first operation target information of the first operation to derive first work item completion information and first production plan data of the first operation, performs backward planning, which is a time-reversal method, on second demand information of a second process of a second production line performed at a second production speed faster than the first production speed based on the first work item completion information to derive second operation target information, and executes forward planning, which is a time-forward method, on the second production line using the second operation target information of the second operation to derive second production plan data of the second operation. In this way, according to the present disclosure, by balancing the production speeds of parallel production lines with different production speeds through balanced production control, work items produced in the two production lines may be uniformly put into a production line (e.g., Cell) that assembles the work items.

In an embodiment, the domain-specific engine may calculate a queue waiting time of at least one of a target work item and a batch for a process of a client manufacturing system, determine whether a queue waiting time constraint of the process is satisfied based on the queue waiting time, and determine at least one of the input available work item and batch of the process based on whether the queue waiting time constraint is satisfied, thereby performing dispatching or batch control. In an embodiment, at least one of the input available work items and batches may be determined by filtering to remove work items and batches that do not satisfy queue waiting time constraints among the target work items and target batches. In this way, according to the present disclosure, by minimizing work items waiting in each operation through queue waiting time control, the overall production flow becomes smooth, production efficiency is increased, and bottlenecks are alleviated.

In an embodiment, the domain-specific engine may group a plurality of target work items into at least one batch according to keys for the plurality of target work items of the process of the client manufacturing production system, determine a composition order for at least one work item in the at least one batch according to a predefined composition order rule based on a work item composition score for each of at least one work item included in the at least one batch, determine a batch composition based on a predefined batch specification from at least one batch according to the composition order, and perform dispatching or queue waiting time control for at least one batch based on the batch composition. In this way, according to the present disclosure, efficient decision-making may be made in batch production equipment through batch control, thereby facilitating the overall production flow. Additionally, efficient decision-making may lead to reduced replacement of batch production equipment, better balance of work on production lines, and prevention of due date delays. For this, reference is made to the description in FIGS. 91 to 100.

Input data including reference information is received from the client manufacturing production system S4243. In an embodiment, the input data may include at least one of product information, production flow information, process information, equipment information, travel time information, factory internal work-item information, and production quantity information. For this, reference is made to the description in FIGS. 91 to 100.

Based on the received input data, a software model and logic set including a domain-specific engine are executed to provide production plan data S4244. In an embodiment, the software model and logic set may include a domain-specific engine with backward planning logic and forward planning logic. For this, reference is made to the description in FIGS. 91 to 100.

Referring to FIG. 8, an embodiment of a device for analyzing a production plan based on a software model and logic set and providing digital production plan information is described as follows.

An embodiment of a device providing digital production plan information may include an input unit 310, a storage unit 320, an in-memory 330, a processor 340, an output unit 350, and a user interface 360.

An embodiment of a device providing digital production plan information below may be controlled by user control and management via a user interface 360.

The input unit 310 may obtain input data of the manufacturing production system. The storage device 320 may store at least one of input data, domain-specific engine, software model, and logic set received by the input unit 310 in the storage device 320. The storage device 320 may include volatile memory or non-volatile memory. In-memory 330 may include production plan data of a manufacturing production system. For example, the in-memory 330 may store various intermediate information such as production balance, waiting constraints (virtual decision information of virtual Gantz, workload information, input values of machine learning-based predictor, etc.,), and batch composition.

The processor 340 of the embodiment may generate or provide a software model and logic set including a domain-specific engine for a production operation corresponding to a manufacturing production domain of a client manufacturing production system, receive input data including reference information from the client manufacturing production system, and execute the software model and logic set including a domain-specific engine based on the input data to provide production plan data. For further details, please refer to the explanation above.

The processor 340 may develop a software model and logic set according to a user's request of the user interface 360. Additionally, the processor 340 may obtain production plan data by testing and pre-executing the developed software model and logic set. And the processor 340 may analyze or test the software model and logic that generates production plan data according to the user's request and provide the results to the user through the user interface 360. For further details, reference is made to the description above.

The output unit 350 may provide a software model and logic set, and may provide analysis result data of the software model and the logic set and result data of an experiment performed based on the software model and the logic set to enable management of production or processes in a local environment and client system.

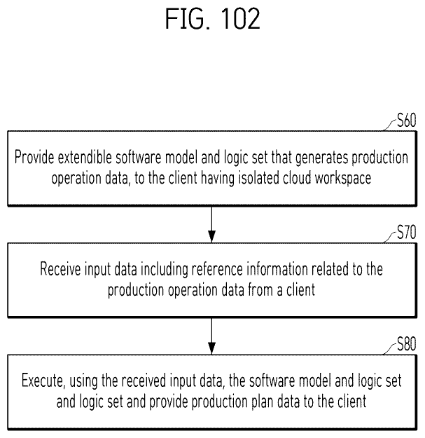

FIG. 102 is a diagram illustrating an embodiment of a method for providing a digital production plan.

According to an embodiment, production operation data may be provided to the plurality of clients having different production systems based on a cloud computing system S60. Each client may have a virtualized, isolated cloud workspace in a cloud computing system. An isolated cloud workspace is an allocated area within a cloud system. Cloud computing systems may expand resources according to customer requests. Additionally, the software packages included in the software model and logic set that generate production operation data may be extended or customized according to the client's requirements.

The cloud computing system may receive input data including reference information related to the above production operation data from a client S70.

The cloud computing system may receive input data including reference information related to production operation data and status data of the manufacturing system, and may be converted into a certain data schema and input into the cloud computing system according to the requirements of the service provided on the cloud computing system. Additionally, the cloud computing system may receive input data containing reference information for obtaining production operation data from a client.

Baseline information includes BOM, BOP information, which includes the operations that a product goes through to be made, resource specification information (how long it takes to process a certain type of work item), equipment setup/replacement times, etc. Status data includes the operating status of equipment at a specific point in time in the factory, the type/quantity/progress of work being done, and the type/quantity/waiting time of work included in the work item queue.

Using the received input data, the software model and logic set may be executed and production plan data is provided to the client S80.

The cloud computing system receives input data containing reference information, and executes stored software models and logic set based on the input data to generate production plan data related to the manufacturing system requested by the client.

Specific embodiments of the software model and logic set provided by the cloud computing system are described below. Cloud computing systems may provide customized software targeted at specific clients.

Customized software packages include logic set that may generate production operation data used by specific clients or industry sectors.

This logic set could be a number of configuration variables that affect production planning and scheduling, a number of options required to execute different software models, or a software package that is executed according to different scenarios.

Additionally, the cloud computing system may provide the generated production plan data to the client using a defined interface. A defined interface may be an API, a user interface of a specific defined type, or an interface according to some other transport protocol, such as a communications protocol.

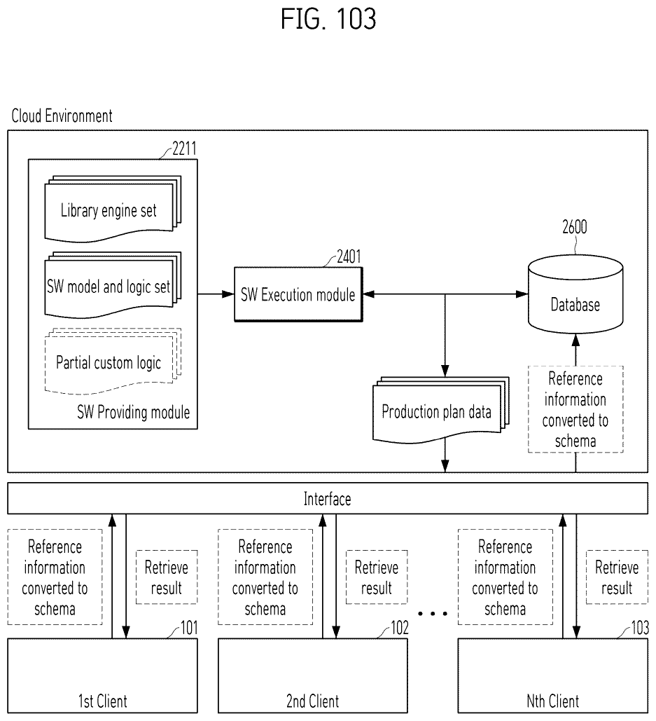

FIG. 103 discloses an embodiment of a computing system that provides digital production plan data.

An example of a disclosed cloud computing system includes a software (SW) provision module 2211, a software execution module 2401, and a database 2600.

Multiple clients 101, 102, 103 provide the cloud computing system with reference information related to the operation of the desired factory using an interface such as an API (application programming interface). Each client 101, 102, 103 may be provided with the same or different API. Additionally, each client 101, 102, 103 may be provided with the same or different user interface.

Each client 101, 102, 103 may transmit reference information converted into a standardized schema according to the service requirements of the cloud computing system to the cloud computing system. Here, the schema does not contain data, but is a structure for receiving data. After the schema is defined, it is possible to accept data from customer systems through various interfaces.

Additionally, a standardized schema refers to a predefined format/shape of information/data required for modeling, planning, and scheduling a manufacturing system. For example, a set of information for expressing a product to be produced in a manufacturing system may be predefined in a format as a set of properties such as product name (Product ID), corresponding operation flow information (BOM, BOP), customer name (Customer ID), unit price, and product priority. In this way, all information that expresses the properties and relationships between each element essential for defining all tangible and intangible objects/concepts that comprise a manufacturing system may be included in a standardized schema.

The database 2600 of the cloud computing system stores reference information transmitted by each client 101, 102, 103. Additionally, the database 2600 stores generated production plan data and production schedule data.

For example, reference information including factory status information provided by the first client 101 is stored in the database 2600. Reference information for generating production plans and schedules includes the basic formats of data required to execute the model.

A first client 101 may request the cloud computing system to generate production plan data based on reference information stored in a database 2600.

The SW provision module 2211 of the cloud computing system may include a library engine set, which are datasets for generating software models, software models and model logic for generating various types of production plan data, and a partial custom logic set for providing a customized software logic set to a client.

A partial custom logic set may include logic set that may generate software packages that are separately required by clients, depending on the industry.

Therefore, partial custom logic set may have different levels of access allowed to different clients.

The SW provision module 2211 may provide a software model and logic set required to generate production plan data based on reference information provided by the client.

The SW execution module 2401 may generate production plan data based on the software model and logic set provided by the SW provision module 2211 and the reference information of the first client 101 stored in the database 2600.

The production plan data generated by the SW execution module 2401 may be stored again in the database 2600 and provided to the first client 101 through an interface (API, UI, etc.).

Similarly, other clients may provide reference information containing related manufacturing systems or status information to the cloud computing system, and select related software model and logic to generate and receive the desired production plan data.

If the second client 102 wants to use a software package with separate functions, a software model and model logic including additional functions may be generated using the partial custom logic set of the SW provision module 2211.

By adding software packages that include these separate functions, software model and model logic may be generated to generate specialized or suitable production plan data for the factory associated with the second client.

Clients 101, 102, 103 may receive production plan data generated by the cloud computing system through various types of interfaces. Typically, clients may receive desired production plan data via API, but they may follow a client-specific UX/UI user interface or a protocol for transmitting separate data.

In this way, a cloud computing system may provide different interfaces depending on the client or the client's request.

Cloud computing systems may be of various types: public cloud, private cloud, or hybrid cloud. Public clouds are operated by third-party cloud service providers and are multi-tenant environments in which the plurality of users are allocated and use logically isolated resources. Public clouds may have multi-tenant environments that are cost-effective and scalable for allocated use. A private cloud is a cloud environment exclusively used by a specific organization. Excellent security may be maintained by managing sensitive data used only by specific organizations in a closed network. At this time, resources do not necessarily require multi-tenancy. Hybrid cloud also corresponds to a method of storing sensitive data in private while allocating and using public domain resources for non-sensitive data and operations. A multi-tenant environment may be optionally implemented in a hybrid cloud. Depending on the type of cloud computing system, the functions of the partial custom logic set, database 2600, interface, etc. disclosed above may also vary.

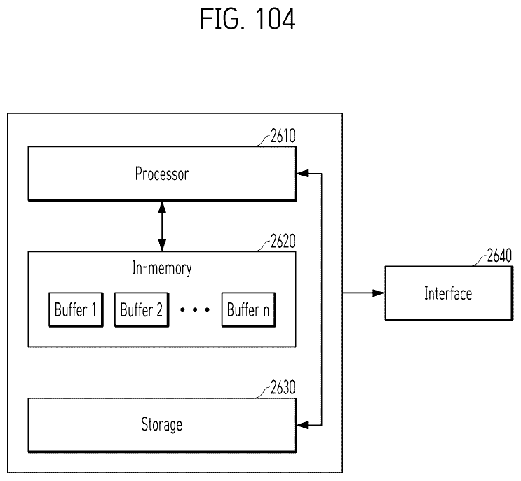

FIG. 104 discloses an example of a device providing digital production plan data.

An example of a device that provides digital production plan data to be disclosed includes a storage device 2630 that stores data, an in-memory 2620 that includes at least one buffer, a processor 2610 that processes the data, and an interface 2640.

The interface 2640 receives reference information including factory status information from the client. The reference information may have a data schema format that is processed by the processor 2610.

The storage device 2630 may store input data including the client's reference information received by the interface 2640.

In-memory 2620 may store a library engine set, which is datasets that generate software models, software models and model logic that generate various types of production plan data, and a partial custom logic set that provides a client's customized software logic set.

The in-memory 2620 includes buffers, which are structures that may provide the called software model and logic set among the stored software model and logic set to the processor 2610 when the processor 2610 operates and calls the related software model and logic set.

The processor 2610 may generate production plan data requested by the client by calling the client's reference information stored in the storage device 2630 and the software model and logic set requested by the client stored in the in-memory 2620.

The processor 2610 provides the generated production plan data to the client through the interface 2640.

A cloud computing system providing digital production plan data may be implemented by a cloud standard model, and the standardized model is a model for implementing planning/scheduling of modules including a backward module, a forward module, and backward and forward. When using a standardized model, the data schema is the same, so it may be used simultaneously by different sets of logic (models) to generate production plans and schedules. Additionally, since the form of the data may be identified, it may be easy to link the results from each logic set (model). Therefore, when using a standardized model, it is possible to drive all modules including the backward module, forward module, backward and forward modules with one data set. Below, a description of the composition of a cloud standard model for implementing a cloud computing system is provided.

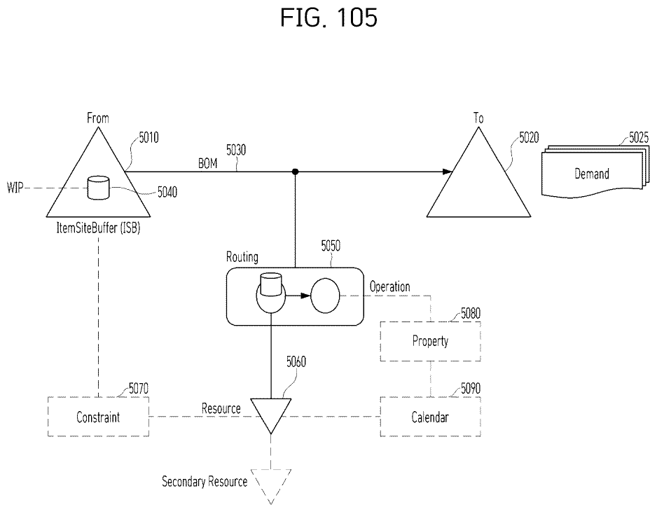

FIG. 105 discloses an embodiment of a computing system that provides digital production plan data.

This embodiment is a diagram illustrating the relationship between components of a standard model. The components of the standard model may include ISB (Item/Site/Buffer) information, BOM (Bill of Material) information, routing information, operation information, resource information, demand information, WIP information, lot information, constraint information, calendar information, property information, etc. ISB information is an object that may specify the location of work-in-process (WIP) information or work-item (Lot) information through three types of information: item, site, and buffer. It corresponds to the concept of tracking/managing products or work-items in production planning or production management. Production management information may be expressed in a triangular shape, but the shape is not limited to this. Additionally, production management information may be located on work in process (WIP) or work items (lots) when the engine is running in a backward or forward manner.

For example, LOT124 is located at mid-size car window/UIsan/buffer 3 at 5:00 on January 24th, and moves to mid-size car window/Pohang/buffer 1 at 7:00 according to backward/forward logic. At this time, the meaning of movement may include the meaning of physical movement or conceptual movement, and in this example corresponds to a change in physical location. Also, for example, let's assume that LOT124 is located at mid-size car window/UIsan/buffer 3 at 5:00 on January 24th and then moves to buffer 4. Here, if buffer 3 is before the window washing operation and buffer 4 is before the window drying operation, it corresponds to a situation where the physical locations are the same but the conceptual locations have changed.

Items are a concept to distinguish products that are subject to production management, such as raw materials, purchased goods, semi-finished products, and finished products. Site is a concept that indicates the physical location where the product is located, and buffer indicates the physical and conceptual location where the product is located. Items and sites are information to be specified, while buffers correspond to actual information. Buffers are an essential element of the standard model, and at least one buffer must be modeled to drive the standard model.

Buffer modeling may include sequence information. For example, the order of buffers 1, 2, 3, 4, 5 may be determined by the ascending numbers 1, 2, 3, 4, 5 or 100, 200, 300, 400, 600. Information on production sales inventory (PSI) may be obtained through buffers and backward/forward logic. That is, it is possible to provide production sales inventory management information by calculating the input/output product quantity at each point in time at the location.

BOM information represents process information. Routing information is information that includes the plurality of operation information, may exist 1:1 with BOM information, and includes operation order information. BOM information may include at least one operation. The operation corresponds to the step described above. Resource information corresponds to actual equipment or personnel required to perform the operation, and secondary resource information may assist this may be optional. Calendar information is an essential element corresponding to a resource, representing the time that the resource is actually available. Calendar information represents a record of modeling information within a factory that changes over time and is based on resource availability information. Additionally, calendar information represents information about scheduled events such as resource processing capacity that varies over time, equipment replacement (setup)/maintenance (PM), and weekend schedules. For example, there is a 10% drop in production per unit time in winter, and production speeds vary due to differences in the skills of workers who are brought in every other week. The characteristic information represents information that may be additionally defined for extensibility in addition to the factory and related information predefined by the standard model.

Constraint information includes constraint information on the throughput of resources as well as constraint information from the standard model.

According to the standard model, the flow of manufactured products in a manufacturing system may be represented as moving from ISB information 5010 to ISB information 5020. The pre-ISB information 5010 includes pending WIP information 5040, and the pre-ISB information 5010 and the post-ISB information 5020 are connected through BOM information 5030 representing the process. BOM information 5030 is connected to routing information 5050, and the routing information may include at least one operation. In this embodiment, there are two operations included in the routing information, and the preceding operation may include WIP. Additionally, the operation may be linked to resource 5060 information and optionally also to secondary resource information. Resource information may also be associated with constraints, calendars, and properties. Demand 5025 information represents demand information for the final finished product and corresponds to the ISB information at the end.

In this embodiment, the solid line components are elements that must be implemented, and the dotted line components are elements that may be implemented optionally. Each component illustrated in this embodiment is described in detail below.

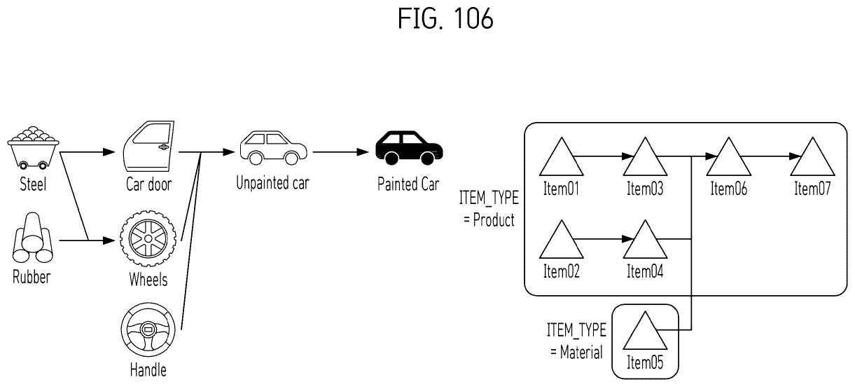

FIG. 106 is a diagram showing an item in a cloud system that provides digital production plan data.

Items are used to distinguish products subject to production management, such as raw materials, purchased products, semi-finished products, and finished products. Item types include purchased products (material type) and produced products (product type). Purchased items (material type) are products input from outside and may only be located at the earliest in the buffer sequence, may not be subject to the operation, and include raw materials, finished products, and semi-finished products. The product type is the product that will be the subject of the operation or the subject of production management, and must be connected to the front in the buffer sequence, and includes semi-finished products and finished products in the production operation.

Referring to the left side of this diagram, steel and rubber correspond to raw materials, and the car door, wheels, and handle correspond to semi-finished products. Unpainted and painted cars are considered finished products. The right side of this diagram example corresponds to the item modeling of the left side of this diagram, and is illustrated in the form of ISB information for steel, rubber, car door, wheel, handle, and car. Each ISB information is connected through BOM information, and Item 1, Item 2, Item 3, Item 4, Item 6, and Item 7 correspond to manufactured items, and Item 5 corresponds to material type.

When configuring item modeling, it is not necessary to include all material type and product type items that are actually used. For example, in the diagram on the left side, if the supply and demand of steel are smooth and an infinite supply may be assumed, the wheel production plan may be modeled by excluding steel from the modeling and modeling only rubber. Additionally, it is possible to model only the wheel production operations, for example, if one may assume an infinite supply of both steel and rubber.

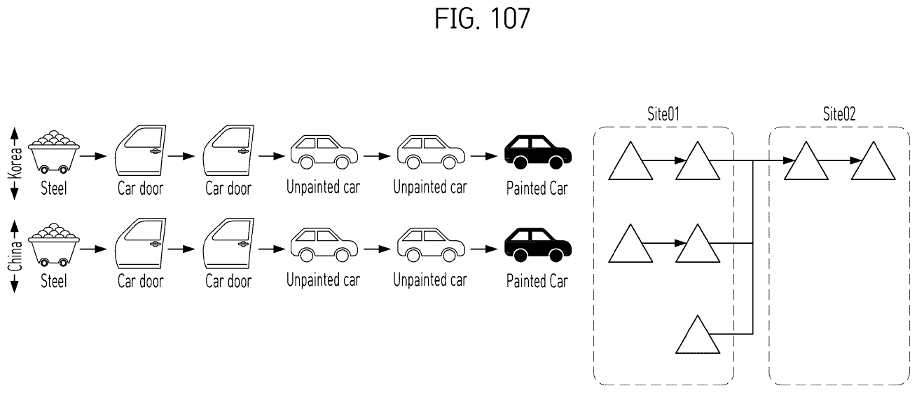

FIG. 107 is a diagram illustrating a site of a cloud system that provides digital production plan data.

A site refers to the physical location where a product is located, and may be divided into spatial units that require location distinction for product production management. For example, it may vary depending on the production plan target issue situation, such as country, region, business site, factory, line, etc. This allows modeling the plurality of sites in a single model.

Referring to the left side of this diagram, the sites are divided by country for the purpose of product production management, and the sites may be divided by Korea and China. Referring to the right side of this diagram, this corresponds to the case where the item modeling shown on the right side of FIG. 107 is divided into site 1 and site 2. Site 1 is a production site for manufacturing three types of semi-finished or finished products and supplying them to Site 2, and Site 2 is a place for assembling semi-finished or finished products supplied from Site 1.

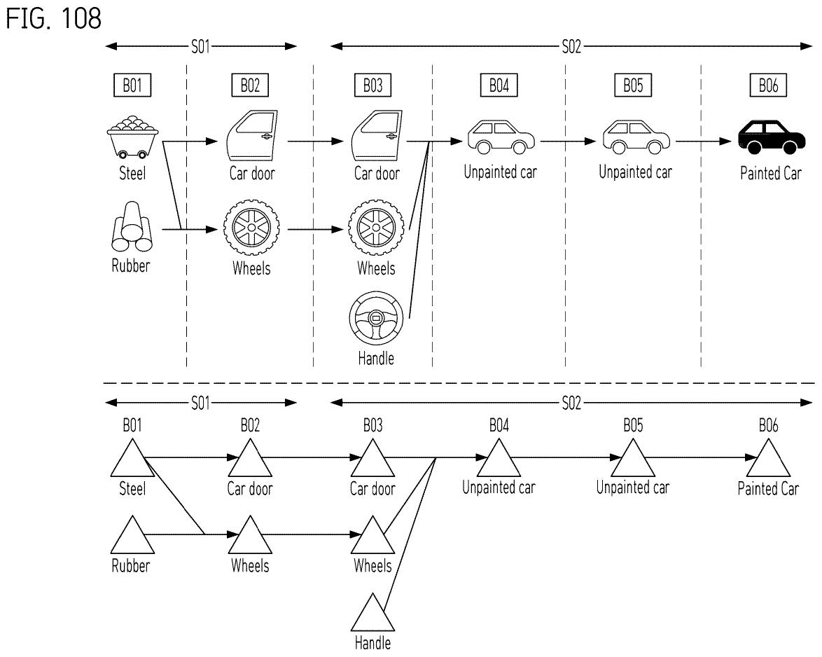

FIG. 108 is a diagram illustrating a buffer of a cloud system that provides digital production plan data.

A buffer corresponds to a physical and conceptual location where a product is located. The upper part of this diagram represents production management of an automobile manufacturing system, and the lower part of this diagram represents item modeling of an automobile manufacturing system using a standardized model.

Referring to the bottom of this diagram, the production operation may be modeled by expressing each item, such as steel, rubber, car door, wheel, handle, and car, as ISB information, and connecting each ISB information to BOM information.

At least one item may be divided into a buffer unit, which is a physical or conceptual unit of location. In this embodiment, items B01, B02, B03, B04, B05, and B06 may be distinguished as buffer units. In addition, as described above, if it is necessary to distinguish between locations for product production management, the distinction may be made by site, which is a spatial unit. In this embodiment, buffers B01 and B02 may be included in site S01, and buffers B03, B04, B05 and B06 may be included in site S02. For example, site S01 may produce semi-finished products such as car doors and wheels using steel and rubber, and the produced car doors and wheels may be delivered to site S02. Additionally, the S02 site includes assembling finished products (cars) from car doors, wheels, and handles, and shipping them after painting them.

In this embodiment, the door and wheel included in the B02 buffer within the S01 site and the door and wheel included in the B03 buffer within the S02 site correspond to cases where the physical positions have changed. In addition, within the S02 site, the B04 buffer, B05 buffer, and B06 buffer have the same physical location, but different conceptual locations (operation progress rates) due to different operations of washing, drying, and painting.

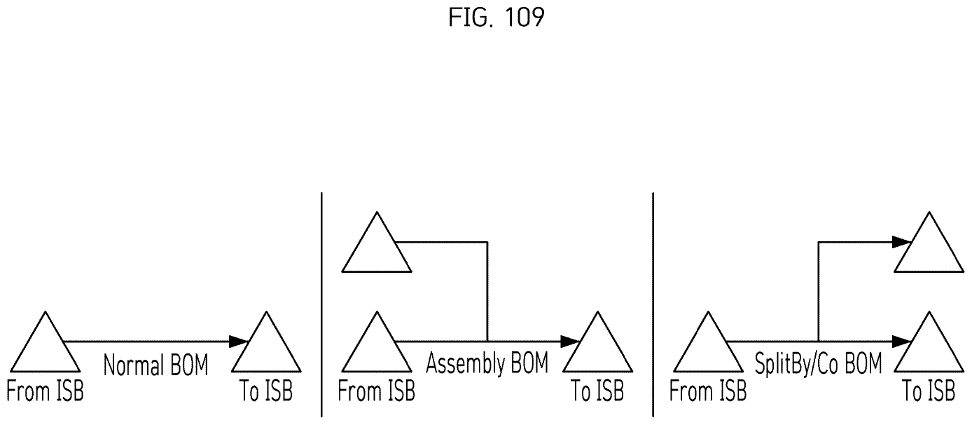

FIG. 109 is a diagram illustrating BOM information of a cloud system that provides digital production plan data.

BOM (Bill of Material) information is a concept that models (expresses) the connection between buffers and includes operation information for producing products in the intermediate operation from buffer to buffer. Additionally, BOM information is information that indicates the relationship between items within a factory. A BOM information includes at least one connection of pre-ISB information (From ISB) and post-ISB information (To ISB).

BOM information may include normal BOM information, assembly BOM information, and by-product (SplitBy/Co) BOM information. The left side of FIG. 109 embodiment shows normal BOM information, and the normal BOM information includes pre-ISB information and post-ISB information in a 1:1 ratio. The middle side of FIG. 109 embodiment shows assembly BOM information, and the assembly BOM information is a type that models the assembly operation and includes N:1 (N≥2) of pre-ISB information and post-ISB information. The right side of FIG. 109 embodiment illustrates by-product BOM information, and the by-product BOM information is a type that models an operation for producing a by-product or a joint product, and includes pre-ISB information and post-ISB information in a ratio of 1:M (M≥2). A joint product is a product that produces different outputs from the same materials, for example, crude oil produces different outputs such as diesel and gasoline.

As described above, at least one routing information may be included in one BOM information, and the routing information may include operation and order information. Additionally, the information between the pre-ISB information and the post-ISB information may be defined as a single BOM information including the plurality of BOM information or the plurality of routing information. For example, BOM information may be added in parallel between the pre-ISB information and the post-ISB information while they are set identically.

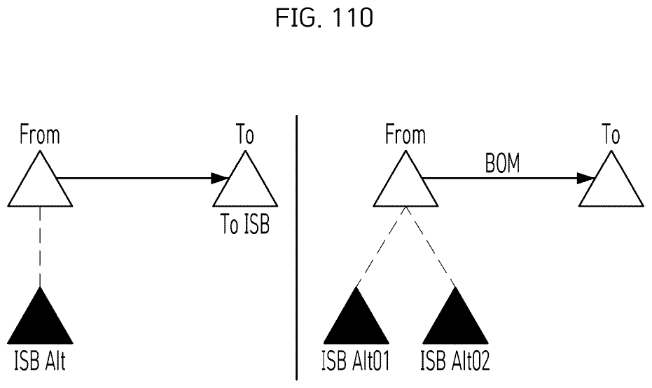

FIG. 110 is a diagram illustrating alternative BOM information of a cloud system that provides digital production plan data.

For example, if the specified quantity in the pre-ISB information is exhausted, the alternative ISB information may be moved to the post-ISB information through the BOM information.

Alternative ISB information may be set to single or multiple. The left side of the diagram illustrates a case where one piece of alternative ISB information is setup, and the right side of the diagram illustrates a case where two pieces of alternative ISB information are setup. Priority may be set between the plurality of alternative ISB information. For example, the alternative products for product A are B and C, and the priorities among A, B, and C may be set to 1, 2, and 3, respectively (the lower the number, the higher the priority). In this case, if there is a shortage of product A, the production plan may be established using the WIP of product B. Additionally, if there is a shortage of product B, production plans may be established using WIP of product C.

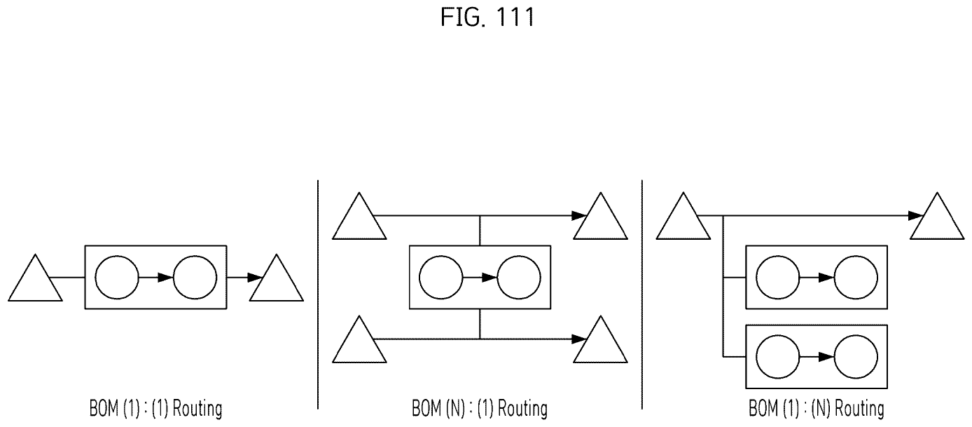

FIG. 111 is a diagram illustrating the routing of a cloud system that provides digital production plan data.

Routing information represents a set of operations that exist in the BOM information between the pre-ISB information and the post-ISB information. Additionally, routing information is information that indicates the operation order performed along the connection relationship between items. Routing information contains at least one operation. A single BOM information may contain single or the plurality of routing information. In this embodiment, routing is expressed as a square and the operation is expressed as a circle, but the shapes are not limited to this.

The left side of the diagram is a case where BOM information and routing information are configured in 1:1, and there is one BOM information and one routing information between the pre-ISB information and the post-ISB information. The middle side of the diagram is a case where BOM information and routing information are in ratio N:1, meaning that there is 1 routing information between two pieces of BOM information. The example on the right side of the diagram is a case where BOM information and routing information are in ratio 1:N, meaning that there are two pieces of routing information for one BOM information.

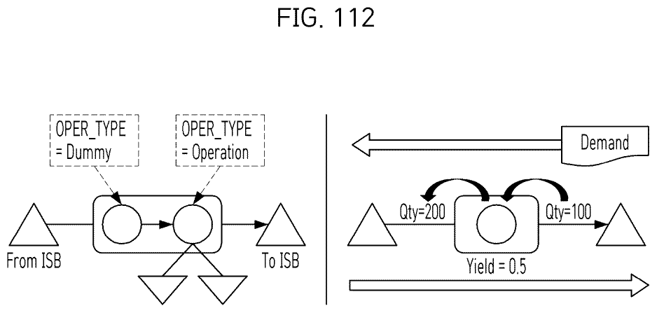

FIG. 112 is a diagram illustrating the operation of a cloud system that provides digital production plan data.

Operation information is a concept for modeling operations that require time/quantity, and includes information on resources to perform the operation. Additionally, operation information is information about the processing and resource use for a given item. The types of operations include actual operations and dummy operations. Actual operation information may be the subject of decision-making in the operation modeling method using actual production facilities, and dummy operation information corresponds to an operation modeling method that does not require facilities to carry out the operation. Dummy operation s are not important in modeling, so they need to be modeled by allowing a certain amount of time to elapse without allocating any operations, and are not subject to decision-making. For example, a dummy operation may include a leave-on operation such as drying, adsorption, or fermentation. In the left side of the diagram embodiment, routing includes both dummy operations and actual operations, with the actual operations including resource information.

Referring to the right side of the diagram embodiment, the operation may include yield information. Yield is an indicator that shows the proportion of products finally produced, taking into account the effects of losses and defective products that occur during the operation. In the case of backward logic, the yield may be considered in the process of calculating the input target (InTarget). For example, if the operation yield is 0.5, 200 units must be input to obtain 100 outputs, so the input target (InTarget) may be calculated as 200.

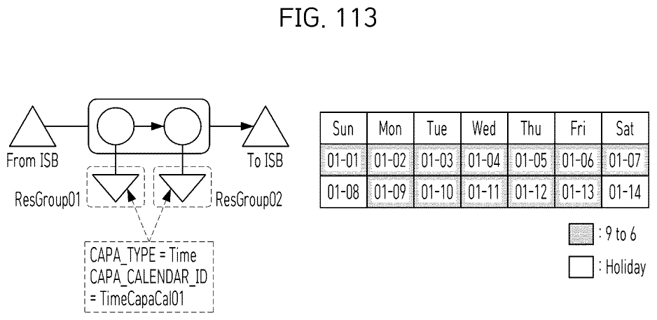

FIG. 113 is a diagram illustrating the resources of a cloud system that provides digital production plan data.

Resource information is a concept of modelling the key resources (e.g., test facilities, assembly facilities, production facilities, inspection personnel, production personnel, etc.) for carrying out the actual operation when the operation is an actual operation. Resource information includes production capacity information. Production capacity information uses either time information or quantity information.

Temporal information corresponds to a resource that uses capabilities in the form of time. Referring to the left side of the diagram example, the production capacity information of ResGroup1 and ResGroup02 resources may correspond to time information. For example, if the Res01 facility is assumed to operate for only 43,200 seconds, half of the 86,400 seconds per day, then the production capacity is 43,200. Also, for example, if 100 work items with an operation processing time of 100 seconds are processed in Res01, the remaining production capacity during the day is 33200, which is 43200 minus 100*100.

Quantitative information corresponds to resources that use capabilities in the form of quantities. For example, if the Res02 facility may produce 1,000 units of P01 type products per day, the production capacity is 1,000. If Res02 processed 500 P01 products during the day, the remaining production capacity for the day is equal to 1000 minus 500.

Additionally, resource production capacity information may be defined in the calendar. For example, as shown in the left side of the diagram embodiment, production capacity information is defined in TimeCapaCal01, and as shown in the right side of the diagram embodiment, production capacity information from 9:00 to 6:00 or holiday information may be defined as production capacity information by date in the TimeCapaCal01 calendar. Additionally, one calendar information may be used simultaneously in the plurality of resources. For example, the TimeCapaCal01 calendar may be used by all resources within the same factory or by specific operation resources.

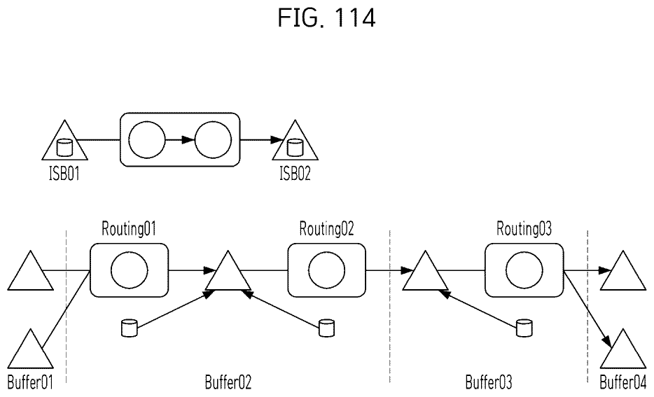

FIG. 114 is a diagram illustrating work in process (WIP) of a cloud system that provides digital production plan data.

Work in progress (WIP) information is a concept of modeling products (work items) waiting to be produced in the production process. Additionally, WIP information represents a group of items that have a specific status, such as waiting in a buffer, process, or resource within the factory, or being worked on. The WIP information provided is displayed in a cylindrical shape, but is not limited thereto.

The types of WIP are classified based on the location of the WIP and include inventory types and operation types. The inventory type is one that is not in operation and is waiting to be placed in the buffer. The WIP illustrated in the upper side of the diagram embodiment is located in the buffer and corresponds to the inventory type. The operation type corresponds to whether the operation is in progress or scheduled. The WIP illustrated in the example below side of the diagram is a case where the operation is in progress and is an operation type belonging to routing.

During production planning, logic may be included to determine which ISB information will contain WIP information of operation type. Additionally, handling of WIP in production planning logic may be determined based on the type of BOM information. As an example, in the case of assembly BOM information, the WIP is allocated to the post-ISB information.

The lower side of diagram illustrates an example of determining the ISB information to be included depending on the type of BOM information. For example, it may be decided to assign the WIP information to the ISB information with fewer arrows among the BOM information located between the pre/post ISB information, and if the number of arrows is the same, it may be decided to be located to the pre-ISB information.

In the embodiment of the lower side of the diagram, the BOM information between buffer01 and buffer02 corresponds to assembly BOM information, and in this case, the work in process (WIP) of routing01 may be allocated to buffer02. Additionally, for normal BOM information, the supply is allocated to pre-ISB information. In the example below, the BOM information between buffer02 and buffer03 is normal BOM information, and in this case, the WIP of routing02 is allocated to buffer02. Additionally, for component BOM information, the WIP is allocated to the pre-ISB information. In the example below, the BOM information between buffer03 and buffer404 is a component BOM, and in this case, the WIP in routing03 is allocated to buffer03.

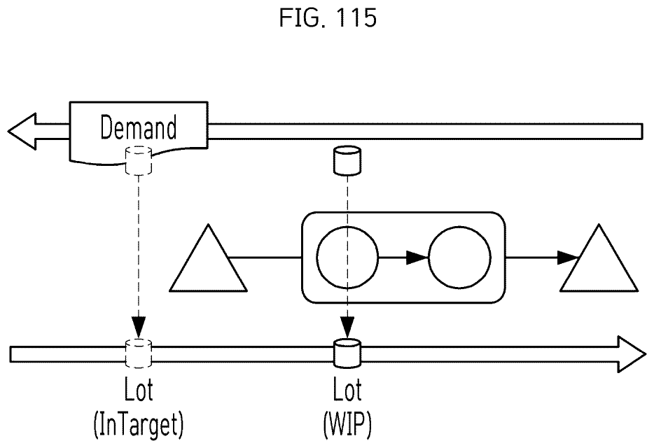

FIG. 115 is a diagram illustrating a work item (Lot) of a cloud system that provides digital production plan data.

Work item (Lot) information is a concept for modeling work items with input target (InTarget) information obtained after performing backward logic (part of PBB, PBO) through demand and WIP, and may be used in forward/backward logic. Additionally, work item information corresponds to a bundle of items that move along operations and facility within a factory. Items refers to materials and products. Additionally, products include semi-finished products and finished products.

In this embodiment, it is assumed that forward logic is performed after backward logic is performed. Once pegging is performed in backward logic, demand and BOM information may be specified and entered into the WIP. The remaining demand remaining after deducting all WIP from demand may become the input target (Intarget) information for the first operation. When forward logic is performed after backward logic is performed, the work item in the forward logic generated with the input target information of the first operation may be modeled as work item (lot) information. Additionally, the demand information and BOM information derived from backward logic may be converted into work item information based on the WIP located in the intermediate process.

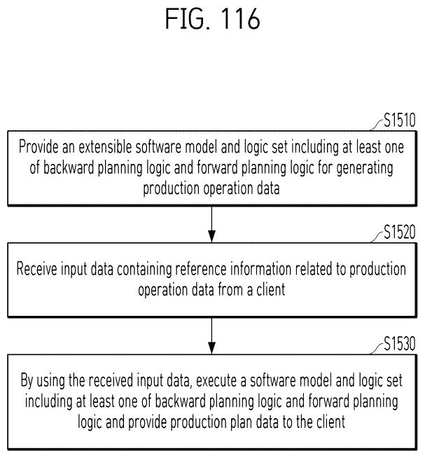

FIG. 116 discloses a flowchart illustrating an example of providing digital production plan information in a standard model of a cloud system providing digital production plan data.

An extensible software model and logic set including at least one of backward planning logic and forward planning logic are provided for generating production operation data S1510. At least one of the backward planning logic and the forward planning logic may be modeled/planned/scheduled based on the standard model described in FIGS. 105 to 115. Components of a standard model may include ISB information, BOM information, routing information, process information, resource information, demand information, WIP information, work item information, constraint information, etc. Here, modeling may refer to the process of virtually describing/representing a target system using components of a standard model. Planning can also represent a rough quantity calculation by period (e.g., calculate InTarget indicating when and how much to put in), and scheduling can represent a detailed schedule of which machines processed which jobs and when (e.g., work item A was put in machine E at minute YY at hour XX).

Input data containing reference information related to production operation data is received from a client S1520.

The cloud computing system may receive input data including reference information related to production operation (manufacturing system) data and status data of the manufacturing system, and may be converted into a certain data schema and input into the cloud computing system according to the requirements of the service provided on the cloud computing system.

Using the received input data, a software model and logic set including at least one of backward planning logic and forward planning logic are executed and production plan data is provided to the client S1530. The cloud computing system may provide production plan data by executing a software model and logic set including logic including backward planning logic, forward planning logic, backward planning logic and forward planning logic based on the above-described standard model.

Referring to FIG. 104, an embodiment of a device for analyzing a production plan based on a software model and logic set and providing digital production plan information is described as follows.

An embodiment of a device providing digital production plan information may include a processor 2610, in-memory 2620, storage 2630, and an interface 2640.

A following embodiment of a device providing digital production plan information may be controlled by user control and management via an interface 2640. The interface 2640 may obtain input data of the manufacturing production system from a client. The storage device 2630 may store at least one of input data, software models, and logic sets received by the interface 2640 in the storage device 2630. The storage device 2630 may include volatile memory or non-volatile memory. In-memory 2620 may include production plan data of a manufacturing production system.

The processor 2610 of the embodiment may provide an extensible software model and logic set including at least one of backward planning logic and forward planning logic for generating production operation data, receive input data including reference information related to production operation data from a client, and execute the software model and logic set including at least one of backward planning logic and forward planning logic using the received input data, and provide production plan data to the client. Additionally, the generated production plan data may be stored in a storage device 2630.

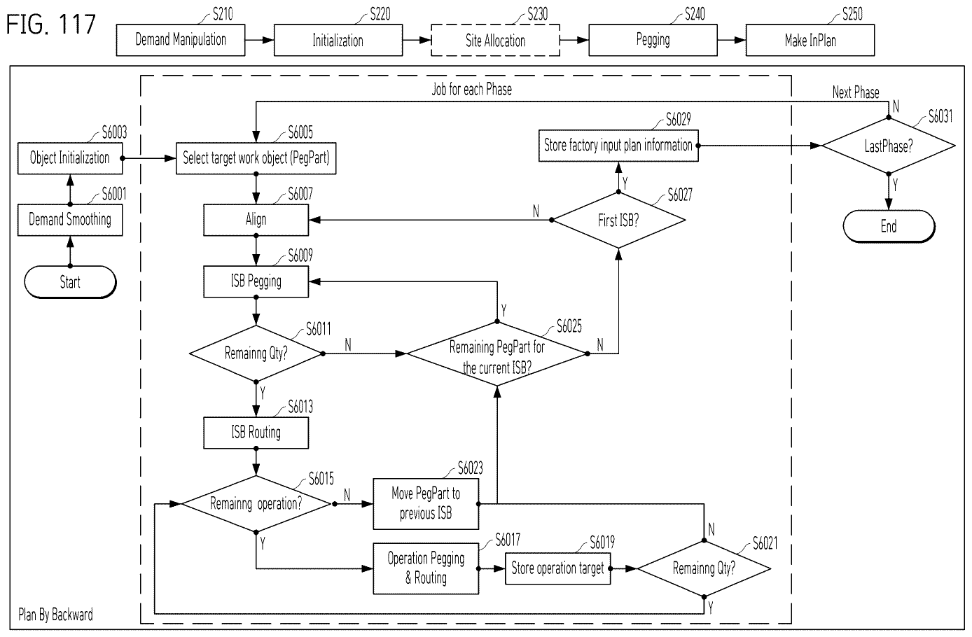

FIG. 117 discloses a diagram illustrating an example of providing digital production plan information based on backward planning logic according to an embodiment.

In an embodiment, input data including reference information about a manufacturing production system may be received from a client. In an embodiment, input data including reference information may be input into the backward planning logic. In this case, the input data may include at least one of demand information for each process, work in process (Wip) information, ISB (Item Site Buffer) information, BOM information, routing information, operation information, yield information, and time-to-attendance (TAT) information, such as wait time for input (Wait TAT) or run time for process operation (Run TAT).

Additionally, in an embodiment, it is possible to obtain rule information for each decision-making point in the backward planning logic for the client's manufacturing production system. In an embodiment, rule information per decision point may be predefined, selected by user input, or customized according to the manufacturing production system by user input. In an embodiment, backward planning logic is determined by applying input data based on a pre-stored standard model, and decision-making points of the determined backward planning logic may have rule information applied to each decision-making point. For example, backward planning logic may be modeled by applying input data based on a pre-stored standard model, or input data may be applied to backward planning logic modeled based on a pre-stored standard model. In this case, the backward planning logic to which this decision and rule information is applied may be referred to as PBB (Plan By Backward) logic or a term having an equivalent technical meaning. In an embodiment, the standard model may include the cloud standard model described above. That is, PBB logic may mean implementing decision-making points in the procedures of a backward planning engine. In this case, a standard model may be used to implement the decision-making points. In an embodiment, at least one of the various generation criteria and selection criteria included in the rule information per decision-making point may be determined based on the decision criteria per decision-making point by the compare agent for decision-making described below.

Smoothing on demand information is performed based on the standard model S6001. In an embodiment, demand information may be smoothed based on at least one of data received by the manufacturing production system, demand information, actual production record information (act) of the manufacturing production system, remaining demand quantity, and production schedule. In an embodiment, when input data is entered according to a data schema based on a standard model, smoothing of demand information included in the input data may be performed.

Initialization is performed on the work object on which smoothing has been performed S6003. In an embodiment, information such as working hours, operations, quantities, and due dates change for each operation, and work object information (PegPart) that changes according to each operation may be initialized and generated. In an embodiment, when input data is entered according to a data schema based on a standard model, initialization may be performed on a work object on which smoothing is performed based on the input data.

A number of work objects (PegParts) for which initialization has been performed are selected as target work objects S6005. In an embodiment, the target work object may represent an object for inversely estimating demand information. In an embodiment, the target work object may be derived from the demand information through a smoothing process and an initialization process.

An alignment process is performed to determine a pegging group including at least one work object among a plurality of work objects selected according to rule information S6007. In an embodiment, a plurality of work objects may be grouped and at least one pegging group may be determined from among the pegging groups. This is explained in more detail below.

An ISB pegging process is performed S6009 to perform WIP pegging on a target work object among at least one work object included in a pegging group for ISB information according to rule information. In an embodiment, a target work object may be selected from at least one work object for the ISB information, and a target WIP may be selected from at least one WIP for the ISB information. In an embodiment, the WIP pegging may include subtracting a quantity of target WIP from a quantity of target work objects. This is explained in more detail below.

It is determined whether there is a remaining quantity of target work objects for which WIP pegging has been performed S6011. In an embodiment, it is possible to determine whether there are a quantity of target work objects remaining on which additional WIP pegging may be performed. In an embodiment, if there is a remaining quantity, the process may proceed to step S6013, and if there is no remaining quantity, the process may proceed to step S6025.

An ISB Routing process is performed to determine a target BOM among at least one BOM for a target work object for which WIP pegging is performed according to rule information S6013. In an embodiment, each of the at least one BOM may include at least one operation between the current ISB information and at least one different ISB information. This is explained in more detail below.

Determine whether there is a remaining operation for the target BOM on which ISB routing has been performed S6015. In an embodiment, it may be determined whether there are operation s remaining in the target BOM that may additionally perform operation pegging and operation routing. In an embodiment, if there is a remaining operation, the process may proceed to step S6017, and if there is no remaining operation, the process may proceed to step S6023.

Perform the operation pegging process for performing WIP pegging on the target work object for the operation of the target BOM and the operation routing process for applying time information on the operation to the target work object for which WIP pegging has been performed S6017. In an embodiment, the time information for the operation may include at least one of a run time (Run TAT) for each operation and a wait time (Wait TAT) for each operation. Here, applying time information to an operation may include a process of rolling back the operation time of that operation to a previous operation by the amount of time information. This is explained in more detail below.

The operation target of the corresponding operation, which is calculated by performing operation pegging and operation routing, is stored S6019. In an embodiment, the operation target may include at least one of target production quantity information and date information of the operation.

Determine whether there is a remaining quantity of target work objects for which operation pegging and operation routing have been performed S6021. In an embodiment, it is possible to determine whether there are a quantity of target work objects remaining on which operation pegging and operation routing may be additionally performed. In an embodiment, if there is a remaining quantity, the process may proceed to step S6015, and if there is no remaining quantity, the process may proceed to step S6025.

If there is no remaining operation for the target BOM, the target work object is moved from the current ISB information to the previous ISB information S6023. That is, since operation pegging and operation routing for the target BOM have been completed and no remaining operations exist, the target work object may be moved from the current ISB information to the previous ISB information.

Determine whether there are any remaining work objects for the current ISB information S6025. In an embodiment, it is possible to determine whether there are remaining work objects in which a quantity exists among a plurality of work objects corresponding to a target work object or at least one work object included in a pegging group selected through an alignment process. In an embodiment, if there is a remaining work object, the process may proceed to step S6009, and if there is no remaining work object, the process may proceed to step S6027.

Determine whether the current ISB information is the first ISB information of the standard model-based backward planning logic S6027. In an embodiment, the current ISB information is moved backwards in time to the previous ISB information through at least one of the alignment process, the ISB pegging process, the ISB routing process, the operation pegging process, and the routing process, and it may be determined whether the current ISB information corresponds to the first ISB information of the backward planning logic according to this movement. In an embodiment, if the current ISB information is the first ISB information, the process may proceed to step S6029, and if the current ISB information is not the first ISB information, the process may proceed to step S6007.

Store factory input plan information for the first ISB information derived by moving ISB information S6029. In an embodiment, the factory input plan information may be derived from demand information of the initial operation and may include quantity and date information.

It is determined whether the number of executions of the corresponding backward planning logic corresponds to the predefined last phase S6031. Here, the phase may be predefined by the user and may represent the number of times the backward planning logic is repeated. In an embodiment, if the number of executions of the backward planning logic does not correspond to the last phase, step S6005 may be entered. If the number of executions of the backward planning logic corresponds to the last phase, the result value of the backward planning logic may be finally calculated. In an embodiment, the output value produced from the backward planning logic may include at least one of an operation target of the operation, factory input plan information, and pegging history.

In an embodiment, operation S6001 according to the present disclosure may correspond to a demand information pre-processing (Demand manipulation) step S210 of a backward planning method, steps S6003 and S6005 may correspond to a pegging initialization step S220, steps S6007 to S6027 may correspond to a pegging step S240, and step S6029 may correspond to a input plan calculation (Make Inplan) step S250.

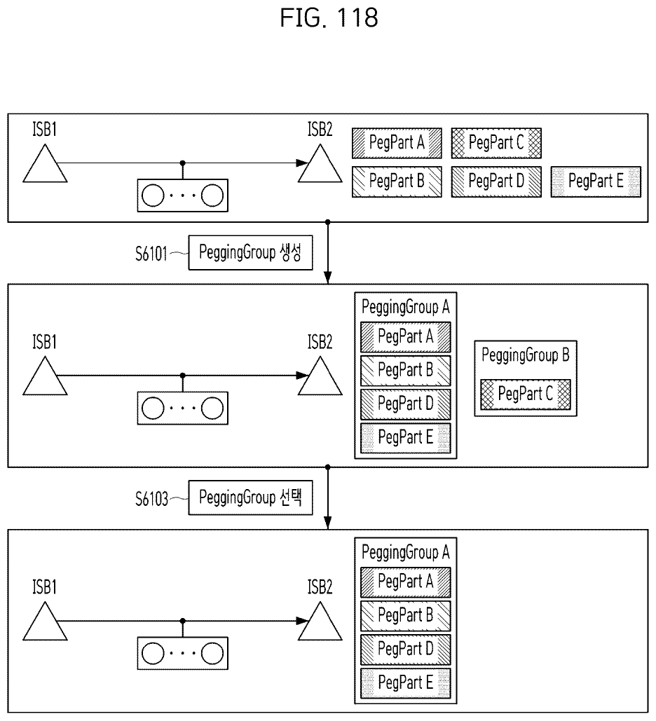

FIG. 118 is a diagram illustrating an example of an alignment process based on backward planning logic according to an embodiment.

In an embodiment, an align process may be performed to determine a pegging group including at least one work object among a plurality of work objects based on input data according to rule information.

Multiple work objects for current generation management information may be grouped according to the criteria for generating a pegging group included in the rule information to generate the plurality of pegging groups including at least one work object S6101. For example, based on the criteria for generating a pegging group, the plurality of work objects PegPart A, PegPart B, PegPart C, PegPart D, and PegPart E for the current generation management information ISB2 may be grouped to generate a pegging group A including PegPart A, PegPart B, PegPart D, and PegPart E, and a pegging group B including PegPart C.

Here, the criteria for generating a pegging group may represent the criteria for grouping work objects into a pegging group when collected in ISB information. For example, criteria for generating a pegging group may include, but are not limited to, various criteria such as criteria for setting individual work objects as pegging groups (i.e., work objects and pegging groups are matched 1:1), criteria for setting all work objects of the current ISB information as one peg group, criteria for setting work objects with the same product grade and target month as a pegging group, criteria for setting work objects with the same product grade and target week as a pegging group, etc.

One pegging group may be selected from among the plurality of pegging groups according to the pegging group selection criteria included in the rule information S6103. For example, depending on the pegging group selection criteria, you may select pegging group A among pegging group A and pegging group B.

Here, the pegging group selection criteria may indicate priorities among the plurality of generated pegging groups. For example, the criteria for selecting a pegging group may include, but are not limited to, various criteria such as a criteria for giving priority to a pegging group with an early target date for the representative target, a criteria for giving priority to a pegging group with a high grade for the representative target, a criteria for giving priority to a pegging group with an early target week for the representative target, a criteria for giving priority to a pegging group based on the priority for the demand information type, etc.

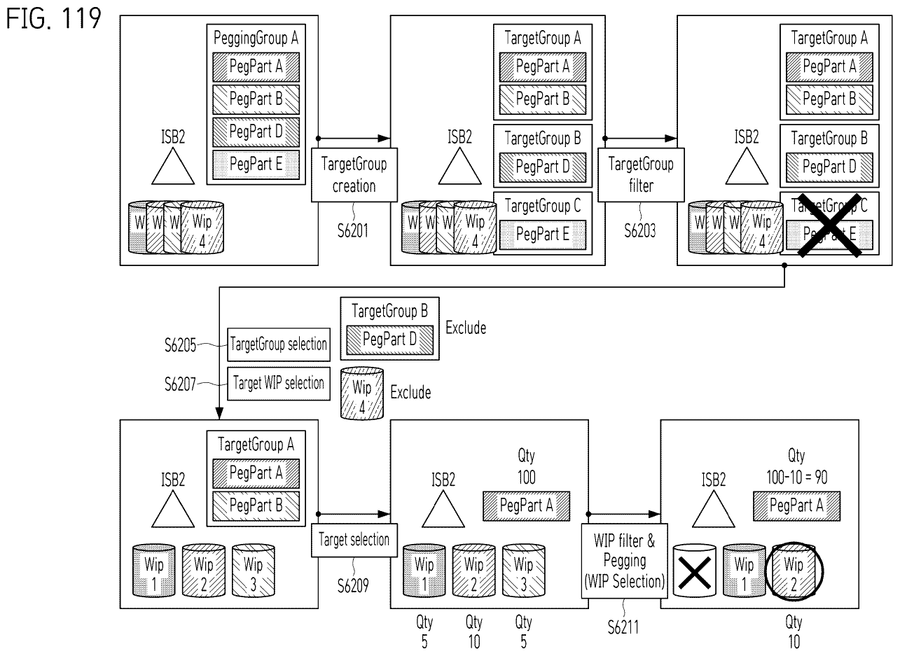

FIG. 119 is a diagram illustrating an example of an ISB pegging process based on backward planning logic according to an embodiment.

In an embodiment, an ISB Pegging process may be performed to perform WIP pegging on a target work object among at least one work object for current ISB information.

Multiple target groups may be generated by grouping at least one work object included in a selected pegging group for current ISB information according to the target group generation criteria included in the rule information S6201. For example, for the current ISB information, ISB2, the work objects PegPart A, PegPart B, PegPart D, and PegPart E included in the pegging group A may be grouped to generate a target group A including PegPart A and PegPart B, a target group B including PegPart D, and a target group C including PegPart E. In this case, the plurality of work in process (WIP) 1, 2, 3, and 4 may be determined for the current ISB information, ISB2.

Here, the target group generation criteria may represent criteria for grouping work objects for current ISB information that may perform WIP pegging under the same conditions. For example, the criteria for generating a target group may include, but are not limited to, various criteria such as grouping work objects that have at least one of the following properties: item ID, site ID, buffer ID, target week, and custom property included in the ISB information. Here, custom properties may include property values added to the standard model based on user input.

Based on the plurality of resources for current ISB information, some target groups among the plurality of target groups may be filtered S6203. In an embodiment, filtering may be performed to exclude some target groups in which there is no WIP corresponding to a work object included in each of a plurality of target groups. For example, since there are WIPs 1 and 2 corresponding to PegPart A included in target group A, WIP 3 corresponding to PegPart B, and WIP 4 corresponding to PegPart D included in target group B, but no WIP corresponding to PegPart E included in target group C, target group C may be filtered out and excluded.

One target group may be selected from among the filtered target groups according to the target group selection criteria included in the rule information S6205. For example, target group A may be selected among target group A and target group B based on the target group selection criteria. In an embodiment, the remaining target groups (e.g., target group B) may be selected based on target group selection criteria during the pegging process of the next cycle.

Here, the target group selection criteria may indicate priorities among the plurality of target groups. For example, the target group selection criteria may include, but are not limited to, various criteria such as criteria for giving priority to target groups with earlier target dates (due dates), criteria for giving priority to target groups with lower demand information priority values, criteria for giving priority to target groups with higher total target quantity (Qty) values, etc.

At least one WIP may be selected from among the plurality of resources for the current ISB information according to the target WIP selection criteria included in the rule information S6207. For example, among the plurality of WIPs, WIP 1, WIP 2, WIP 3, and WIP4 for the current ISB information, ISB2, based on the target WIP selection criteria, WIP 1, WIP 2, and WIP 3 may be selected. In an embodiment, the remaining work-in-progress (e.g., WIP4) may be selected based on the target work-in-progress selection criteria during the pegging process of the next cycle.

Here, the target WIP selection criteria may represent criteria for setting conditions for WIPs that may be peggable to a work object. For example, the target WIP selection criteria may include, but are not limited to, various criteria such as a criteria for selecting a peggable WIP if the ISB IDs of the work objects within the target group are the same, a criteria for selecting a peggable WIP if the demand information IDs of the work objects within the target group are the same, and the like.

According to the target object selection criteria included in the rule information, one target work object among at least one work object included in the target group for the current ISB information may be selected S6209. For example, among the work objects PegPart A and PegPart B included in target group A, PegPart A may be selected as the target work object based on the target object selection criteria.

Here, the target object selection criteria may indicate the priority among the work objects within the target group. For example, the target object selection criteria may include, but are not limited to, various criteria such as criteria for giving priority to work objects with an early target date (due date), criteria for giving priority to work objects with high demand information priority, etc.

At least one target WIP is selected from among the WIP filter criteria and WIP pegging criteria included in the rule information for the current ISB information, and WIP pegging for the target work object may be performed based on the target WIP S6211. For example, among WIP 1, WIP 2, and WIP3 in WIP, WIP 1 and WIP 2 may be selected as target stock. Here, the WIP filter criteria may represent criteria for excluding WIPs that are not eligible for pegging to the target work object. For example, the WIP filter criteria may include, but are not limited to, criteria that perform filtering to exclude WIPs that do not correspond to the target work object.

In addition, one target WIP may be selected from among target WIPs filtered according to WIP pegging criteria, and WIP pegging for a target work object may be performed based on the selected target WIP. For example, based on the work-in-process pegging criteria, WIP 2 may be selected among target work-in-process WIP 1 and WIP 2, and work-in-process pegging may be performed to subtract the quantity of WIP 2 (Qty) 10 from the quantity of target work objects (Qty) 100, thereby calculating the quantity of target work objects as 90. Here, the WIP pegging criteria may indicate the priority among the target WIPs that may be peggable. For example, the criteria for pegging WIP may include, but are not limited to, criteria for giving priority to WIP with a large quantity.

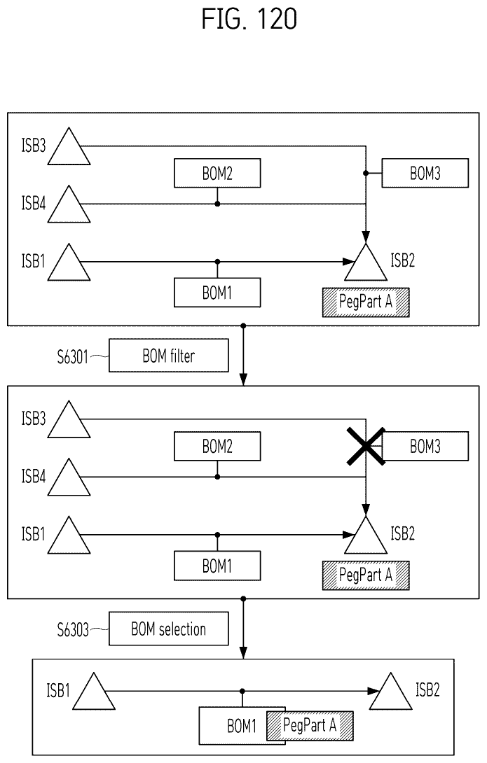

FIG. 120 discloses a diagram illustrating an example of an ISB routing process based on backward planning logic according to an embodiment.

In an embodiment, an ISB Routing process may be performed to determine a target BOM among at least one BOM for a target work object on which WIP pegging has been performed. In an embodiment, the ISB routing process may be performed when the quantity of target work objects remains after subtracting the quantity of WIP from the quantity of target work objects through the ISB pegging process. In this case, the target BOM may be selected through the ISB routing process to move the target work object from the current ISB to the previous ISB.

Some BOMs among the plurality of BOMs for the target work object of the current ISB information may be filtered according to the BOM filter criteria included in the rule information S6301. For example, filtering may be performed to exclude BOM 3 among BOM 1, BOM 2, and BOM 3 for the target work object PegPart A of the current ISB information, ISB2, based on the BOM filter criteria. Here, the BOM filter criteria may represent criteria for excluding BOMs that are not routing targets for the target work object.

A target BOM may be selected from at least one BOM filtered according to BOM selection criteria included in the rule information S6303. For example, among filtered BOM 1 and BOM 2, BOM 1 may be selected as the target BOM based on BOM selection criteria. Here, the BOM selection criteria may indicate priorities among routable BOMs. For example, BOM selection criteria may include, but are not limited to, criteria such as giving priority to selecting BOMs with shorter cumulative TAT.

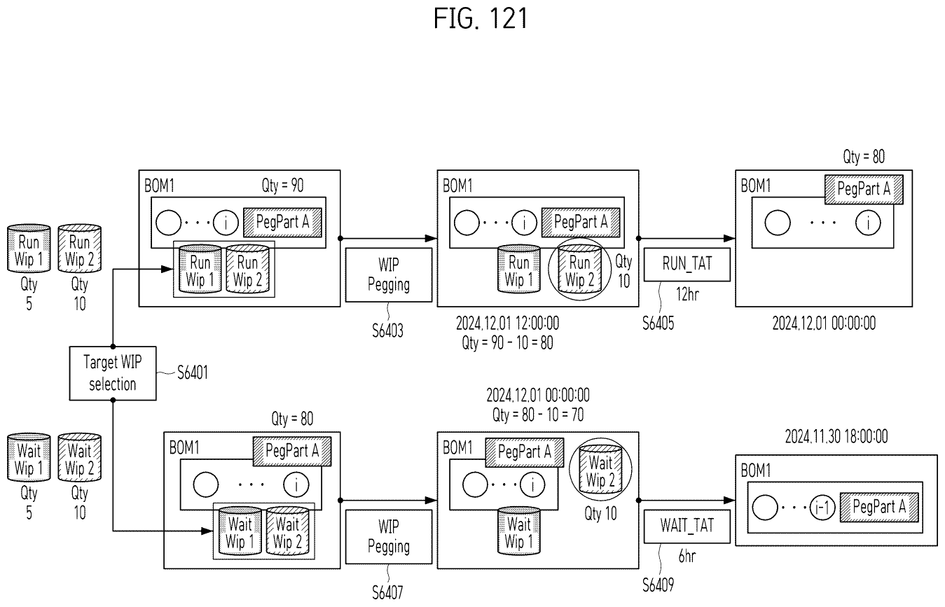

FIG. 121 is a diagram illustrating an example of an operation pegging and operation routing process based on backward planning logic according to an embodiment.

In an embodiment, an operation pegging process may be performed to perform WIP pegging on target work objects for an operation of a target BOM. In an embodiment, an operation routing process may be performed that applies time information about an operation to a target work object on which WIP pegging is performed.

According to the target WIP selection criteria, a target WIP may be selected for performing operation pegging for an operation of a target BOM among at least one running WIP (Run WIP) and at least one waiting WIP (Wait WIP) S6401. For example, among the Run WIP 1 and Run WIP 2 and the Wait WIP 1 and Wait WIP 2, the target WIP for performing operation pegging for the operation of BOM 1 which is the target BOM, may be selected. In an embodiment, based on the target WIP selection criteria, Wait WIP may be selected as the target WIP by applying at least one of the following: order of the previous process being ended for a long or not long time ago, order of the small or large quantity of WIP, order of the short or long working time, or order of more or less available equipment. In an embodiment, based on the target WIP selection criteria, a Run WIP may be selected as the target WIP by applying at least one of the following: a small or large quantity of WIP, a short or long working time, and more or less available equipment.

When Run WIP is selected as the target WIP, WIP pegging for the target work object produced in the current operation of the target BOM may be performed using Run WIP S6403. In an embodiment, when a Run WIP is selected from among the plurality of Run WIP as a target WIP, one target Run WIP may be selected to perform WIP pegging based on target WIP selection criteria. Here, the target WIP selection criteria may indicate the priority among WIPs among the plurality of Run WIPs. For example, the target WIP selection criteria may include criteria for giving priority to WIP with a large quantity among the plurality of Run WIPs.

For example, if Run WIP 1 and Run WIP 2 are selected as target WIP, WIP pegging for PegPart A may be performed using Run WIP 2 for target work object PegPart A produced in the current operation i of BOM 1. That is, the quantity of PegPart A may be calculated as 80 by subtracting the quantity 10 of Run WIP 2 from the quantity 90 of target work object PegPart A produced in the current process i.

For target work objects on which WIP pegging has been performed, the work time (Run TAT) for each operation may be applied to the operation S6405. For example, the time information 2024. 12. 01 12:00:00 of the target work object PegPart A produced in the current operation i may be returned by 12 hours (hr) of the time information of the work time for each operation (Run TAT) to produce the time information 2024. 12. 01 00:00:00 that the target work object PegPart A was calculated in the current process i.

In an embodiment, the following step S6407 may be performed for a target work object for an operation to which a work time for each operation (Run TAT) is applied.

When Wait WIP is selected as the target WIP, WIP pegging for the target work object may be performed using Wait WIP for the target work object that has been put into the current operation of the target BOM S6407. In an embodiment, when the plurality of Wait WIPs are selected as target WIPs, one target Wait WIP may be selected to perform WIP pegging based on target WIP selection criteria. Here, the target WIP selection criteria may indicate priorities among the plurality of wait WIPs. For example, the target WIP selection criteria may include criteria for preferentially selecting WIP with a large quantity among the plurality of wait WIP.

For example, if the waiting WIPs (Wait WIP 1 and Wait WIP 2) are selected as target WIPs, the waiting WIP (Wait WIP 2) may be used to perform WIP pegging for PegPart A, a target work object that has been put into the current operation i of BOM 1. That is, by subtracting the quantity of Wait WIP 2 (10) from the quantity of target work object PegPart A (80) currently putted in operation i, the quantity of PegPart A may be calculated as 70.

A input waiting time (Wait TAT) for the operation may be applied to a target work object for which WIP pegging has been performed S6409. For example, the time information 2024. 12. 01 00:00:00 of the target work object PegPart A currently putted in operation i may be rolled back by 6 hours (hr) of the time information of the input waiting time (Wait TAT) so that the target work object PegPart A may derive the time information 2024. 11. 30 18:00:00 derived from the previous operation i−1.

In an embodiment, when the operation pegging process and the operation routing process for the target BOM are completed, the operation target may be calculated, and the target work object may be moved from the current ISB information (e.g., ISB2) to the previous ISB information (e.g., ISB1). In an embodiment, if there is a quantity of target work objects remaining after performing all WIP pegging for all operations within the corresponding BOM, the target work objects may be moved to the previous ISB information. In an embodiment, an operation target based on a target work object may be derived after performing all WIP pegging on all WIP within the BOM.

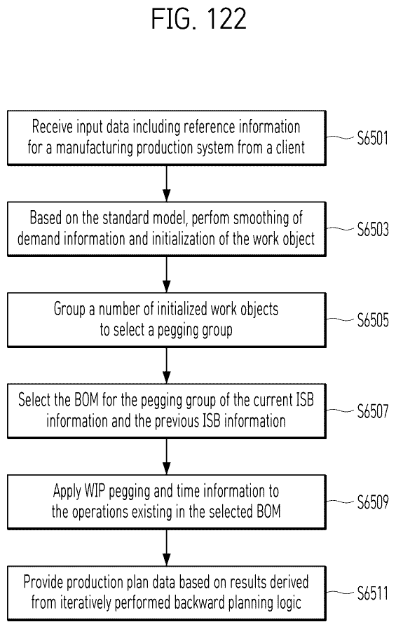

FIG. 122 discloses a flowchart illustrating an example of providing digital production plan information based on backward planning logic according to an embodiment.

Input data including reference information for a manufacturing production system is received from a client S6501. In an embodiment, reference information included in the input data may be converted into a data schema for the cloud computing system and input into the cloud computing system.

Based on the standard model, smoothing of demand information included in the input data and initialization of the work object are performed S6503. In an embodiment, the remaining demand quantity obtained by subtracting the actual production record (act) from the demand information may be divided and calculated according to the work schedule. If the demand information has a due date generated according to the weekly plan, a preprocessing task may be performed to change it into a preprocessed daily plan that distributes the remaining demand quantity and due date by each day. In an embodiment, the preprocessed demand information may be initialized with data for backward planning. Among the preprocessed and initialized demand information, the work object (PegPart) that becomes the target of backward planning may be initialized by grouping them into units such as the same product, product group, or operation.

A number of initialized work objects are grouped to select a pegging group S6505. In an embodiment, a pegging group including at least one work object among a plurality of work objects based on input data according to rule information may be determined.

The WIP pegging for the pegging group of the current ISB information is performed and the BOM for the previous ISB information are selected S6507. In an embodiment, WIP pegging may be performed on a target work object among at least one work object for ISB information. In an embodiment, a target BOM may be determined among at least one BOM for a target work object on which WIP pegging is performed.

WIP pegging and time information are applied to the operations existing in the selected BOM S6509. In an embodiment, WIP pegging may be performed on a target work object for an operation of a target BOM, and time information for the operation may be applied to the target work object for which WIP pegging has been performed.

Production plan data based on results derived from iteratively executed backward planning logic is provided S6511. In an embodiment, production plan data may be provided based on a result value produced by repeatedly performing at least one of the above-described alignment process, ISB pegging process, ISB routing process, operation pegging process, and operation routing process. In an embodiment, the output value produced from the backward planning logic may include at least one of an operation target of the operation, factory input plan information, and pegging history.

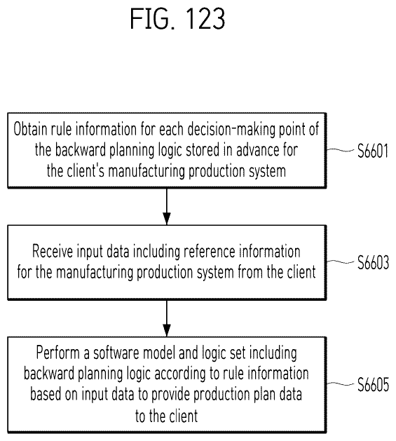

FIG. 123 discloses another flowchart illustrating an example of providing digital production plan information based on backward planning logic according to an embodiment.

Rule information for each decision-making point of the backward planning logic stored in advance for the client's manufacturing production system is obtained S46601. In an embodiment, rule information per decision-making point may be setup by user input of a client, and user input for rule information per decision-making point may be obtained from the client. For this, reference is made to the description described in FIGS. 117 to 121.

Input data including reference information for the manufacturing production system is received from the client S46603. In an embodiment, the reference information may include at least one of demand information for each process, work in process (WIP) information, ISB (Item Site Buffer) information, BOM information, routing information, operation information, yield information, and TAT information, such as wait time for input (Wait TAT) or run time for operation (Run TAT). For this, reference is made to the description above in FIG. 117.

A software model and logic set including backward planning logic according to rule information based on input data is performed to provide production plan data to the client S46605. In an embodiment, the backward planning logic may execute a step of determining the backward planning logic by applying input data based on a pre-stored standard model, and a step of applying rule information for each decision-making point to a decision point of the determined backward planning logic.

In an embodiment, the backward planning logic may execute an align step for determining a pegging group including at least one work object among a plurality of work objects based on input data according to rule information, an ISB pegging step for performing WIP pegging on a target work object among at least one work object for current ISB information according to the rule information, an ISB routing step for determining a target BOM among at least one BOM for the target work object on which WIP pegging has been performed according to the rule information, an operation pegging step for performing WIP pegging on a target work object for an operation of the target BOM according to the rule information, and an operation routing step for applying time information on an operation to the target work object on which WIP pegging has been performed according to the rule information.

In an embodiment, the backward planning logic may execute a step of calculating at least one of an operation target of the operation, factory input plan information, and pegging history based on a target work object to which time information for the operation is applied according to rule information. For this, reference is made to the description in FIGS. 117 to 122.

Referring to FIG. 104, an embodiment of a device for analyzing a production plan based on a software model and logic set and providing digital production plan information is described as follows.

An embodiment of a device providing digital production plan information may include a processor 2610, an in-memory 2620, a storage device 2630, and an interface 2640.

An embodiment of a device providing digital production plan information below may be controlled by user control and management via an interface 2640. The interface 2640 may obtain input data of the manufacturing production system from a client. In an embodiment, the interface 2640 may obtain rule information for each decision-making point in the backward planning logic from the client.

The processor 2610 of the embodiment may obtain rule information for each decision-making point in the pre-stored backward planning logic for the client's manufacturing production system, receive input data including reference information for the manufacturing production system from the client, and execute a software model and logic set including the backward planning logic according to the rule information based on the input data to provide the production plan data to the client. For further details, reference is made to the description above.

The storage device 2630 may store at least one of input data, software model, and logic set received by the interface 2640 in the storage device 2630. The storage device 2630 may include volatile memory or non-volatile memory. In-memory 2620 may include decision-making point rule information of backward planning logic and production plan data of a manufacturing production system.

In an embodiment, the interface 2640 may provide a software model and logic set, and may provide analysis result data of the software model and the logic set to enable management of production or operations in a cloud environment and client systems.

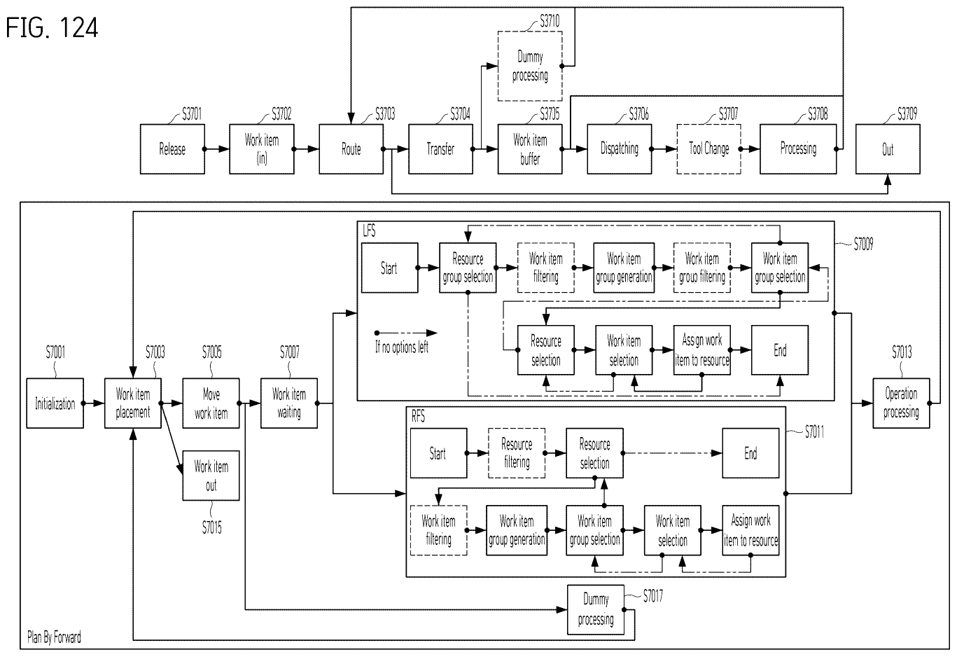

FIG. 124 is a diagram illustrating an example of providing digital production plan information based on forward planning logic according to an embodiment.

In an embodiment, input data including reference information about a manufacturing production system may be received from a client. In an embodiment, input data including reference information may be input into the forward planning logic. In an embodiment, the input data may include at least one of an operation target of the operation, factory input plan information, and pegging history. In an embodiment, the input data may include output values produced from at least one of backward planning logic and mathematical optimization logic.

Additionally, in an embodiment, it is possible to obtain rule information for each decision-making point in the forward planning logic for the client's manufacturing production system. In an embodiment, rule information per decision-making point may be predefined, selected by user input, or customized according to the manufacturing production system by user input. In an embodiment, forward planning logic is determined by applying input data based on a pre-stored standard model, and decision-making points of the determined forward planning logic may have rule information applied to each decision-making point. For example, forward planning logic may be modeled by applying input data based on a pre-stored standard model, or input data may be applied to forward planning logic modeled based on a pre-stored standard model. In this case, the forward planning logic to which this decision and rule information is applied may be referred to as Plan By Forward (PBF) logic or a term having an equivalent technical meaning. In an embodiment, the standard model may include the cloud standard model described above. That is, PBF logic may mean implementing decision-making points in the procedures of a forward planning engine. In this case, a standard model may be used to implement the decision-making points. In an embodiment, at least one of the various generation criteria and selection criteria included in the rule information per decision-making point may be determined based on the decision-making criteria for each decision-making point by the compare agent for decision-making described below. More details on this are provided later.

Initialization of the forward planning object is performed based on input data and a standard model S7001. In an embodiment, the forward planning object may include at least one of factory information, work item status information, and resource status information of the manufacturing production system. For example, factory information may include standard model data. In an embodiment, factory information may include performance information (i.e., actual production history), product information, operation information, etc. for the manufacturing production system. Additionally, the work item status information may include at least one of WIP information, information about where the work item is waiting, which facility is working on it, and how much work has been done. Additionally, resource information may include at least one of information about what work items may be produced, how long it takes to process an operation, and scheduled down time (e.g., holidays, PM, etc.).

Additionally, the work item status information may include at least one of item type, result of backward planning logic, quantity, available time, and target demand information. Here, the output of the backward planning logic may include at least one of a pegging history including routing information (i.e., information from each ISB information to the next BOM), an operation target including input quantity, target input time and target operation, and a factory input plan including work quantity at initial production, available time and generated ISB information. Additionally, the available time may represent a bucket corresponding to a specific time interval available for the operation. Additionally, the target demand information may include at least one of a target time, a target operation, a target quantity, and a priority.

Additionally, resource status information may represent status information of a bucket corresponding to a specific time interval. For example, resource status information may include at least one of available production capacity, used production capacity, and next available time.

The available production capacity may include at least one of time information corresponding to an available time window and quantity information corresponding to the number of remaining work items per time interval.

The production capacity used may include at least one of time information corresponding to the time window used for each task and quantity information corresponding to the number of work items used for each task per time interval.

Work item placement of forward planning logic based on an initialized forward planning object is performed S7003. In an embodiment, when placing work items, the production capacity deduction of resource (i.e., bucket) is recorded, and the record may vary depending on how the capacity (i.e., production capability) of the resource is defined Here, the capacity definition method may include a time-based method and a quantity-based method. The time-based method may indicate a way of storing records of the time intervals during which a work item used the bucket's capacity. Additionally, the quantity-based method may represent a method of storing records after deducting the number of buckets' production capacity as much as the work item used.

In an embodiment, when placing a work item, for a work item, the work item may be moved to the ISB information and the next operation may be selected to place the work item. In this case, the next operation may be selected based on the pegging history of the work item.

Work item is moved based on the operation target included in the input data for ISB information S7005. In an embodiment, the work item may be moved if the terminal condition, where all operations of the work item have been completed, is not satisfied.

The moved work item is allowed to wait S7007. In an embodiment, if the operation is not a dummy operation, the moved work item may be registered in a work item queue and placed in waiting. In an embodiment, a work item group for the work item may be updated.

In an embodiment, an input decision-making method for work items and resources may be determined, in which case the input decision-making method may include at least one of a first method (e.g., an LFS method) that determines a work item and then determines the most appropriate resource to process the work item, and a second method (e.g., an RFS method) that determines a resource and then determines the most appropriate work item to process on the resource.

In an embodiment, a more appropriate input decision-making method between the LFS method and the RFS method may be selected based on the predefined constraints.

For example, when considering the status of a work item when assigning facility-work item, the LFS method may be used. For example, constraints might include a condition that only a certain maximum number of facilities (e.g., two) may be used for each type of work item.

Additionally, the RFS method may be used, for example, when considering the condition of facility when assigning facility-work items. For example, a constraint might include a requirement that each facility may process a maximum of a certain type of work item (e.g., two types) per day.

The input decision-making process may prioritize the full range of work items and resources. In an embodiment, to reduce the amount of computation, work items and resources may be grouped respectively, priorities may be set between the groups, and then priorities may be set between work items and resources within the group.

For resource groups, the types of resources belonging to the resource group and the priorities among resource groups may remain constant regardless of the bucket. That is, resource grouping and prioritization between groups may be performed at initialization step. Here, buckets may be set based on at least one of resource and production capacity over time units. For example, buckets may be set up to apply production capacity to resources in time units.

In an embodiment, the work item state changes each time an input decision-making is made, so grouping may be performed each time the input decision is made.

In an embodiment, the input decision-making method should be maintained within a bucket, and may change as the bucket changes.

In an embodiment, the input decision-making may be made by repeatedly considering all work item-resource pairs within a bucket.

A particular work item-resource pair may have at most one input decision-making performed per level. In an embodiment, different rules may be used for each level. Here, a level may mean one step in a cycle of forward planning logic that includes a decision-making point. For example, after one input decision-making is performed, only one decision is made within that one input decision-making, and in the next input decision-making, the previous input decision-making may be excluded and decision-making may be performed for the remaining ones.

After determining the work item, an LFS-type input decision-making is made to determine the resources to process the work item S7009. In an embodiment, the rule information of the LFS method may include various options for the criteria for generating work item groups and the priority setting criteria for resources of work item groups, work items, and buckets. The criteria for generating work item groups may include criteria for generating work item groups with the same specified properties. The work item group priorities may include priorities among work item groups calculated using at least one of a weight sorting method and a weight sum method with respect to pre-specified rule information. In an embodiment, the weight sum method may include at least one of a linear weight sum method and a non-linear structure-based score calculation method by an artificial intelligence neural network.

The work item priorities may include priorities among the work items calculated using at least one of a weight sorting method and a weight sum method with respect to pre-specified rule information. Resource priorities may include priorities among resources calculated in at least one of a weight sorting method and a weight sum method with respect to pre-specified rule information.

After determining the resources, an RFS-type input decision is made to determine the most appropriate work item to be processed from the resources S7011. In an embodiment, the rule information in the RFS method may include various options for criteria for generating work item groups and selection, filtering, and prioritization methods for work item groups, work items, and resources. For example, the bucket selection process of this diagram involving resource selection may include selecting a production capacity interval for that time unit allocated to that resource. The criteria for generating work item groups may include criteria for generating work item groups with the same specified properties. The work item group priorities may include priorities among work item groups calculated using at least one of a weight sorting method and a weight sum method with respect to pre-specified rule information. The work item priorities may include priorities among the work items calculated using at least one of a weight sorting method and a weight sum method with respect to pre-specified rule information. The resource priorities may include priorities among resources calculated using at least one of a weight sorting method and a weight sum method with respect to pre-specified rule information.

Perform operation processing on selected work items and resources S7013. In an embodiment, an operation process may be performed that changes the properties of the work item after the operation. For example, you may change the properties (type) of the work item to match the following ISB information. For example, if the BOM type is split, the work item may be split according to the split ratio. For example, the number of work items may be changed to reflect the yield of the process.

For example, the availability time property of a work item may be updated. At this time, if the resource capacity definition method is a quantity-based method, the availability time of the work item may include the processing start time. In addition, if the capacity definition method of a resource is time-based method, the availability time of a work item may represent the sum of the processing start time, the time the work item uses the capacity of the resource, and the waiting time of the operation. Here, the processing start time may be expressed as max (resource work availability time, work item availability time).

When the terminal condition is satisfied where all operations of the work item have been completed, the work item is removed S7015. In an embodiment, the process may be completed by removing the work item.

If the operation is a dummy operation, dummy operation processing is performed on the work item S7017. In an embodiment, a dummy operation processing may be performed to change the properties of the work item after the operations. For example, the properties (type) of the work item can be changed to match the next ISB information. For example, if the BOM type is split, the work item may be split according to the split ratio. For example, the number of work items may be changed to reflect the yield of the process. For example, the availability time property of a work item may be updated. Here, the available time of the work item may represent the sum of the available time and the residence time of the operation.

In an embodiment, the work item may correspond to a WIP or a lot. In an embodiment, a resource may represent a facility or a capacity of a facility running in a bucket corresponding to a particular time interval.

In an embodiment, at least one resource may be allocated for each of at least one operation between the current ISB information and the next ISB information. In this case, resources may be allocated into buckets of specific time units.

In an embodiment, step S7001 according to the present disclosure may correspond to a work item generation (release) S3701 and work item input (in) S3702 step of the forward planning method, step S7003 may correspond to a work item routing S3703 step, step S7005 may correspond to a work item transfer S3704 step, step S7007 may correspond to a work item waiting (buffer) S3705 step, step s S7009 and S7011 may correspond to a dispatching S3706 step, step S7013 may correspond to a processing step S3708 step, step S7015 may correspond to a work item out S3709 step, and step S7017 may correspond to a dummy processing step S3710.

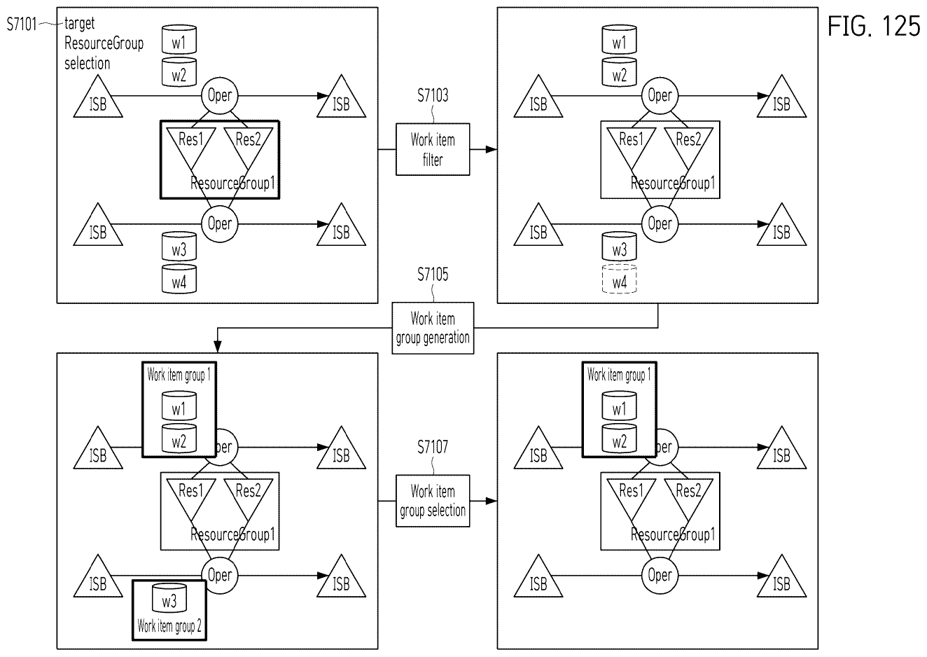

FIG. 125 is a diagram illustrating an example of a work item group selection process in the LFS method based on forward planning logic according to an embodiment.

A resource group including at least one resource for an operation of the manufacturing production system of the client is selected according to the resource group selection criteria included in the rule information S7101. For example, target resource group 1, which includes resources Res1 and Res2 for the operation, may be selected based on the resource group selection criteria. Here, the resource group may be referred to as a bucket group or a term having an equivalent technical meaning.

Here, the resource group selection criteria may represent the criteria for grouping resources into resource group for an operation. For example, resource group selection criteria may indicate priorities among the plurality of resource groups. For example, the criteria for selecting a resource group may include, but are not limited to, criteria such as selecting in the order of having more or less remaining total production capacity of all resources within the resource group, and selecting in the order of having more or fewer resource.

Some of the work items among the plurality of work items for the resource group of the operation are filtered S7103. In an embodiment, filtering may be performed to exclude some of the work items that cannot be processed in the resource group of the operation among a plurality of work items. For example, work items w1, w2, w3, and w4 for resource group 1 may be filtered by filtering out work item w4, which cannot be processed by resource group 1.

A plurality of filtered work items are grouped according to work item group generation criteria included in the rule information to generate at least one work item group S7105. For example, based on the criteria for generating work item groups, work items w1 and w2 for resource group 1 may be grouped into work item group 1, and work item w3 may be grouped into work item group 2.

Here, the criteria for generating work item groups may represent criteria for grouping work items into work item groups for resources. For example, the criteria for generating work item groups may include, but are not limited to, criteria for grouping work items (e.g., lots) with the same ISB information (e.g., current ISB information, next ISB information), criteria for grouping work items with the same target period (e.g., date, week, month), etc.

A work item group including at least one work item for a resource group is selected from at least one work item group according to work item group selection criteria included in the rule information S7107. For example, based on the priority of target demand information and the due week of the target demand information, work item groups may be selected in order of priority of target demand information followed by urgency of due week. Additionally, for example, work item group 1 may be selected for resource group 1 among work item group 1 and work item group 2 based on work item group selection criteria.

Here, the work item group selection criteria may indicate priorities among the plurality of generated work item groups. For example, the criteria for selecting work item groups may include, but are not limited to, various criteria such as criteria for giving priority to work item group that have already arrived, criteria for giving priority to work item group with an earlier target period, criteria for giving priority to work item group that arrived first, criteria for giving priority to work item group with a large quantity, etc.

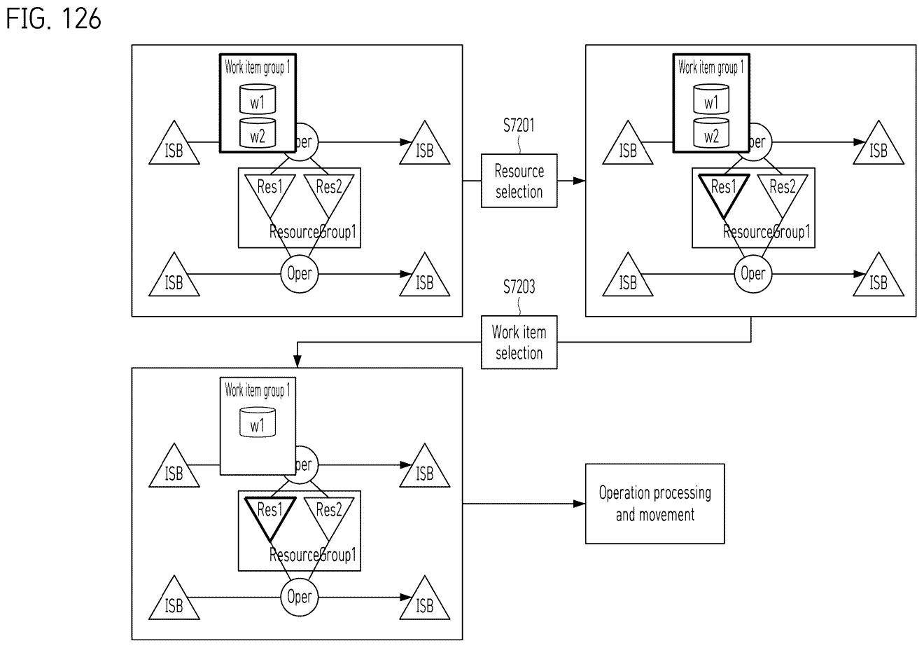

FIG. 126 is a diagram illustrating an example of a work item selection process in the LFS method based on forward planning logic according to an embodiment.

A resource for the selected work item group is selected from at least one resource included in the resource group according to the resource selection criteria included in the rule information S7201. For example, based on the resource selection criteria, resource Res 1 for resource group 1 may be selected among resources Res 1 and Res 2 included in resource group 1. For example, among resources Res 1 and Res 2, Res 1, which has a larger remaining production capacity may be selected.

Here, the resource selection criteria may indicate the priority of available resources (i.e., facilities). For example, resource selection criteria may include, but are not limited to, criteria such as giving priority to selecting facilities with a large amount of remaining production capacity, criteria such as giving priority to selecting facilities with a small amount of assignable products, etc.

A work item for a resource from among at least one work item included in a work item group may be selected according to the work item selection criteria included in the rule information S7203. For example, based on the work item selection criteria, work item w1 for resource Res 1 may be selected among work items w1 and w2 included in work item group 1. For example, the work item w1 located at the top may be selected according to the work item selection rule.

Afterwards, the status changes of the work item and the status changes of the resources may be updated. In an embodiment, selected resources and work items may undergo the operation processing and movement steps described below.

Here, the work item selection criteria may indicate the priority among the work items within the work item group. For example, the criteria for selecting work items may include, but are not limited to, criteria for setting the priority to 0 if the arrival time of the work item is in the past or equal to the current time and 1 otherwise, criteria for giving priority to work items with an earlier target time, criteria for giving priority to work items with a lower demand information priority value, and other various criteria.

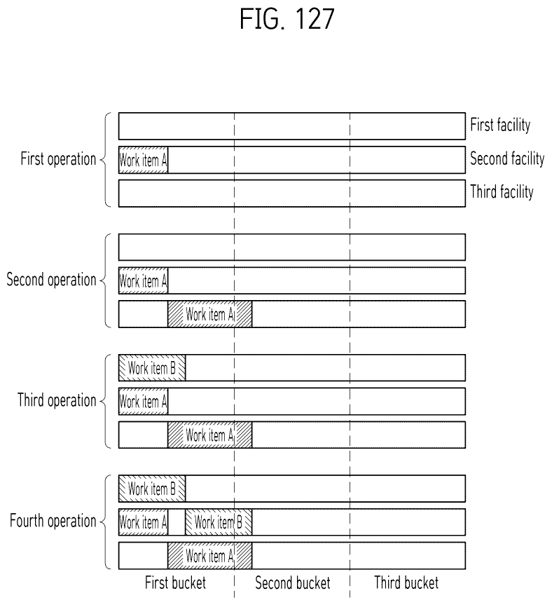

FIG. 127 is a diagram illustrating an example of an input decision-making in the LFS method based on forward planning logic according to an embodiment.

In an embodiment, the placement of work items according to the input decision-making of the LFS method may be performed in chronological order or not in chronological order.

In an embodiment, the LFS-based input decision-making method may cause work item placement within each time interval (i.e., bucket) based on work item priority. For example, in first bucket, the production capacity of second facility for first operation may be reduced by work item A. Additionally, the production capacity of the third facility for the second operation in the first bucket may be reduced by the amount of work item A. Additionally, the production capacity of the first facility for the third operation in the first bucket may be reduced by the amount of work item B. Additionally, the production capacity of the second facility for the fourth operation in the first bucket may be reduced by the amount of work item B. After all decision-makings have been made, the process may proceed to the next, second bucket. That is, placement for work item B may not be performed in chronological order after placement for work item A.

After the placement for work item A, the placement for work item B may be performed in chronological order.

That is, according to the present disclosure, a plan for important work item or important facility may be prioritized for one bucket.

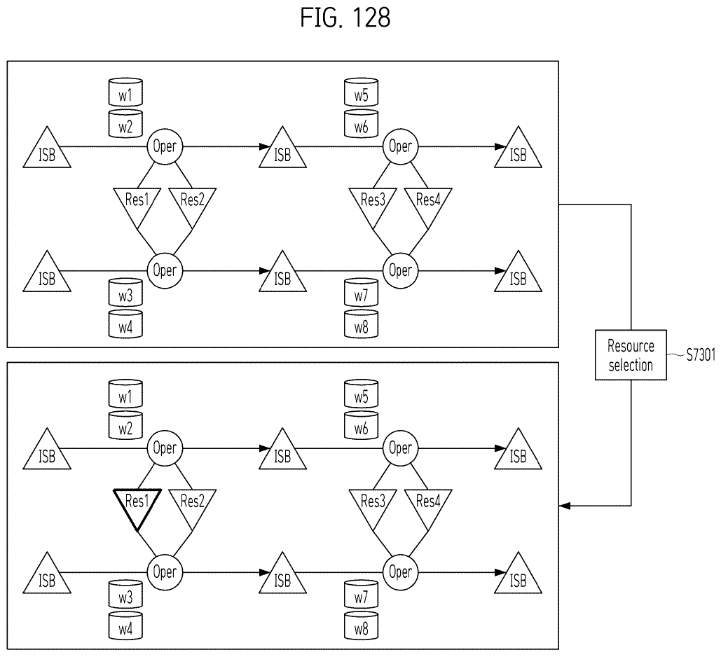

FIG. 128 discloses a diagram illustrating an example of a bucket selection process of RFS method based on forward planning logic according to an embodiment.

Resource for the operation of the client's manufacturing production system is selected based on the resource selection criteria included in the rule information S7301. For example, resource Res 1 may be selected for an operation among resources Res 1, Res 2, Res 3, and Res 4 based on resource selection criteria. That is, the resource with the highest priority may be selected based on the resource selection criteria.

Here, the resource selection criteria may indicate the priority of available resources (i.e., facilities). For example, resource selection criteria may include, but are not limited to, criteria such as giving priority to selecting facilities with a large amount of remaining production capacity, or criteria such as giving priority to selecting facilities with a small amount of assignable products, etc.

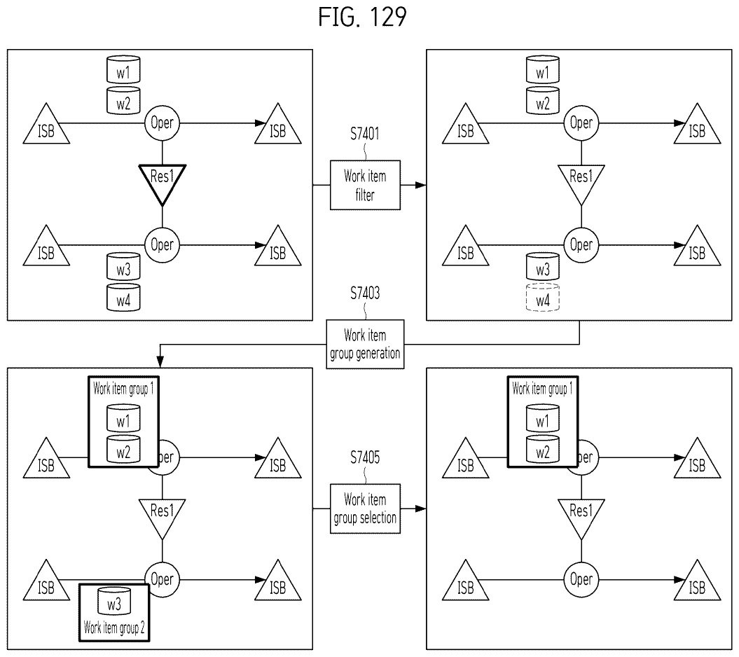

FIG. 129 is a diagram illustrating an example of a work item group selection process in the RFS method based on forward planning logic according to an embodiment.

Some of the work items among the plurality of work items for the operation corresponding to the resource are filtered out S7401. In an embodiment, filtering may be performed to exclude some of the work items that are not processed in the operation among a plurality of work items. For example, by performing work item filtering on work items w1, w2, w3, and w4 for resource Res 1, work item w4 is filtered out, which cannot be processed by resource Res 1.

A plurality of filtered work items are grouped according to work item group generation criteria included in the rule information to generate at least one work item group S7403. For example, based on the criteria for generating work item groups, work items w1 and w2 for resource 1 may be grouped into work item group 1, and work item w3 may be grouped into work item group 2.

Here, the criteria for generating work item group may represent criteria for grouping work items into work item groups for resources. For example, the criteria for generating work item group may include, but are not limited to, criteria for grouping work item (e.g., lots) with the same ISB information (e.g., current ISB information, next ISB information), criteria for grouping work items with the same target period (e.g., date, week, month), etc.

A work item group including at least one work item for a resource is selected from at least one work item group according to work item group selection criteria included in the rule information S7405. For example, based on the priority of target demand information and the due week of the target demand information, work item groups may be selected in order of priority of target demand information followed by due week urgency. Additionally, for example, work item group 1 may be selected for resource Res 1 among work item group 1 and work item group 2 based on the work item group selection criteria.

Here, the work item group selection criteria may indicate priorities among the plurality of generated work item groups. For example, the criteria for selecting work item groups may include, but are not limited to, various criteria such as criteria for giving priority to work item groups that have already arrived, criteria for giving priority to work item groups with an earlier target period, criteria for giving priority to work item groups that arrived first, criteria for giving priority to work item groups with a large quantity, etc.

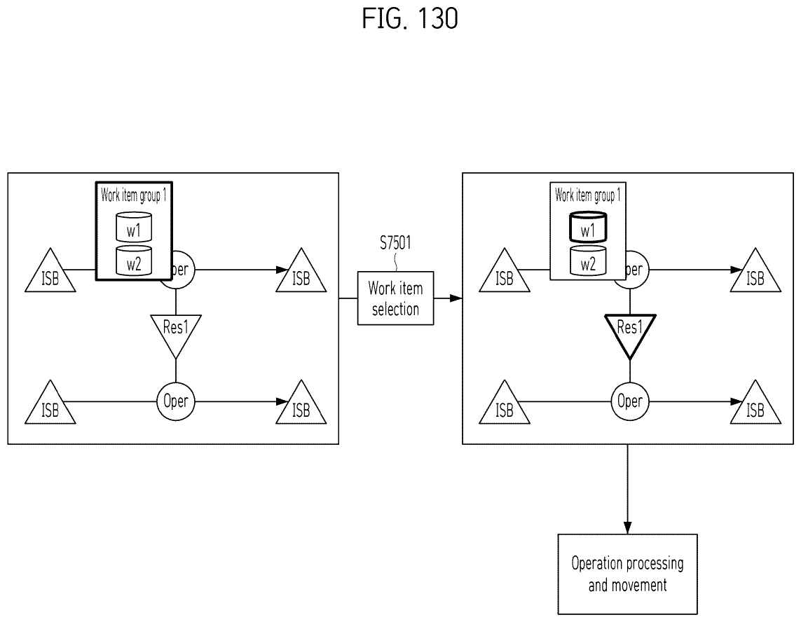

FIG. 130 is a diagram illustrating an example of a work item selection process in the RFS method based on forward planning logic according to an embodiment.

A work item for a resource from among at least one work item included in a work item group is selected according to the work item selection criteria included in the rule information S7501. For example, based on the work item selection criteria, work item w1 for resource Res 1 may be selected among work items w1 and w2 included in work item group 1. For example, the work item w1 located at the top may be selected according to the work item selection rule.

Afterwards, the status changes of the work item and the status changes of the resources may be updated. In an embodiment, selected resources and work items may undergo the operation processing and movement steps described below.

Here, the work item selection criteria may indicate the priority among the work items within the work group. For example, the criteria for selecting work items may include, but are not limited to, a criteria for setting the priority to 0 if the arrival time of the work item is in the past or equal to the current time and 1 otherwise, a criteria for giving priority to work items with an earlier target time, a criteria for giving priority to work items with a lower demand information priority value, and other various criteria.

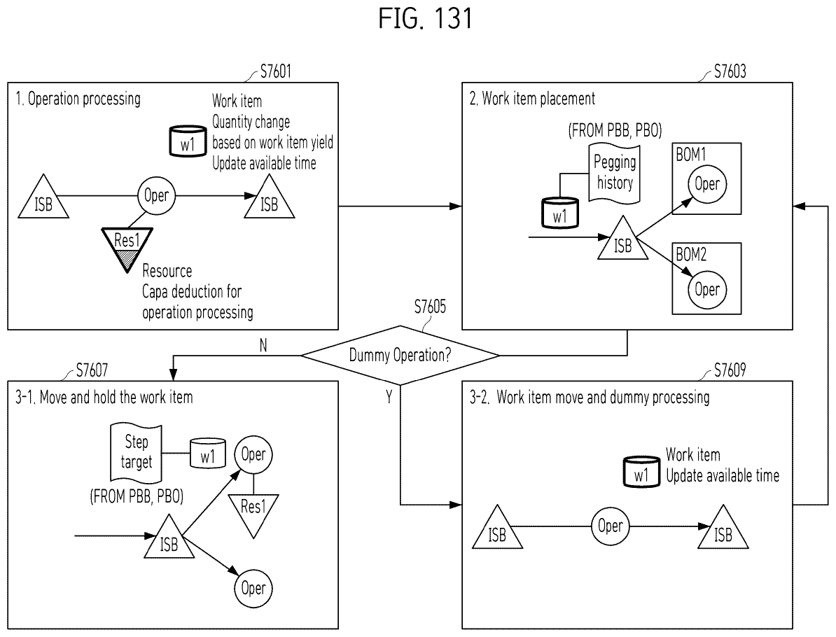

FIG. 131 is a diagram illustrating an example of a processing process based on forward planning logic according to an embodiment.

Operation processing on selected work items and resources is performed S7601. In an embodiment, the quantity of work items may be changed according to the yield of the process and the production capacity of the resource may be reduced. In an embodiment, the work item may be separated according to the split of the operation. Additionally, the next availability time of resources and work items may be updated. For example, the quantity of work item w1 may be changed according to the yield of the process and the production capacity of resource Res 1 may be reduced.

Work items based on the pegging history included in the input data are placed in the next operation of the ISB information S7603. In an embodiment, the next operation may be selected based on the pegging history for the work item. For example, the operation for BOM 1 for work item w1 may be selected based on at least one of the pegging history and the execution results of the mathematical optimization formulation.

Whether the operation is a dummy operation may be determined S7605. In an embodiment, if the operation is not a dummy operation, the process may proceed to step S7607, and if the operation is a dummy operation, the process may proceed to step S7609.

If the operation is not a dummy operation, the work item is moved based on the operation target included in the input data for the ISB information and the moved work item is placed in a waiting state S7607. For example, it is possible to determine whether a work item is assembled based on whether the assembly of the next selected operation is complete. Additionally, the work item may be registered in the queue for the next operation.

If the operation is a dummy operation, the work item is moved based on the operation target included in the input data for the ISB information, and dummy operation processing is performed on the moved work item S7609. For details regarding dummy operation processing, reference is made to the above description.

In an embodiment, after processing the currently selected work item, if there is no remaining production capacity of the currently selected resource, another resource of the same resource group may be selected and then the remaining work items of the currently selected work item group may be processed.

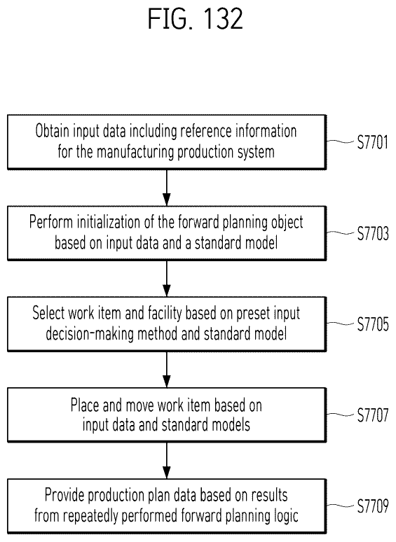

FIG. 132 discloses a flowchart illustrating an example of providing digital production plan information based on forward planning logic according to an embodiment.

Input data including reference information for the manufacturing production system is obtained S7701. In an embodiment, the input data may include output values produced from at least one of backward planning logic and mathematical optimization logic. In an embodiment, rule information for each decision-making point in forward planning logic for a manufacturing production system may be obtained.

Initialization of the forward planning object is performed based on input data and a standard model S7703. In an embodiment, the forward planning object may include at least one of factory information, work item status information, and resource status information of the manufacturing production system.

Work items and facility are selected based on the predefined input decision-making methods and standard models S7705. In an embodiment, the input decision-making method may include at least one of a first method (e.g., an LFS method) that determines a work item and then determines the most appropriate resource to process the work item, and a second method (e.g., an RFS method) that determines a resource and then determines the most appropriate work item to process on the resource.

The work item may be placed and moved based on input data and standard model S7707. In an embodiment, the work item may be placed and moved based on the pegging history and the operation target for the work item contained in the input data.

Production plan data is provided based on results from repeatedly executed forward planning logic S7709. In an embodiment, the software model and logic set including forward planning logic may be executed to generate production plan data in chronological order. In an embodiment, production plan data may be provided as a cloud-based Software-as-a-Service (SaaS).

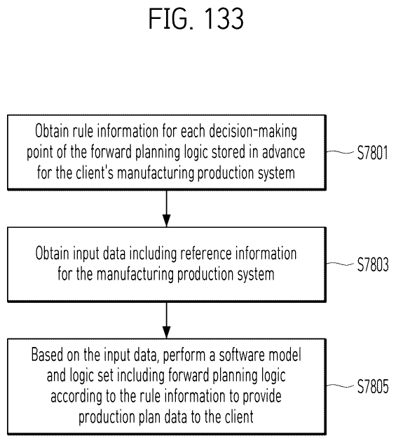

FIG. 133 discloses another flowchart illustrating an example of providing digital production plan information based on forward planning logic according to an embodiment.

The rule information for each decision-making point in the forward planning logic stored in advance for the client's manufacturing production system is obtained S7801. In an embodiment, rule information per decision-making point may be setup by user input of a client, and user input for rule information per decision-making point may be obtained from the client. For this, reference is made to the description in FIGS. 124 to 131.

The input data including reference information for the manufacturing production system is obtained S7803. In an embodiment, the input data may include at least one of an operation target of the operation, factory input plan information, and pegging history. For this, reference is made to the description in FIG. 124.

Based on the input data, a software model and logic set including forward planning logic according to the above rule information are performed to provide production plan data to the client S7805. In an embodiment, the forward planning logic may determine the forward planning logic by applying input data based on a pre-stored standard model, and may apply rule information for each decision-making point to the decision-making point in the determined forward planning logic.

In an embodiment, the forward planning logic may select a resource group including at least one resource for an operation of the manufacturing production system of the client according to rule information, select a work item group including at least one work item for the resource group, select a resource for the selected work item group from among at least one resource included in the resource group, and select a work item for the resource from among at least one work item included in the work item group.

In an embodiment, the forward planning logic may select a resource for an operation of the manufacturing production system of the client according to the rule information, select a work item group including at least one work item for the resource, and select a work item for the resource from among at least one work item included in the work item group.

In an embodiment, the forward planning logic may execute operation processing on selected work items and resources, place work items based on a pegging history included in input data into ISB information, move work items based on operation targets included in the input data to an operation for the ISB information, and if the operation is not a dummy operation, queue the moved work items, and if the operation is a dummy operation, perform dummy operation processing on the moved work items. For this, reference is made to the description in FIGS. 124 to 132.

Referring to FIG. 104, an embodiment of a device for analyzing a production plan based on a software model and logic set and providing digital production plan information is described as follows.

An embodiment of a device providing digital production plan information may include a processor 2610, in-memory 2620, storage 2630, and an interface 2640.

An following embodiment of a device providing digital production plan information may be controlled by user control and management via an interface 2640. The interface 2640 may obtain input data of the manufacturing production system from a client. In an embodiment, the interface 2640 may obtain rule information per decision-making point in the forward planning logic from the client.

The processor 2610 of the embodiment may obtain rule information for each decision-making point in the forward planning logic stored in advance for the client's manufacturing production system, receive input data including reference information for the manufacturing production system from the client, and execute a software model and logic set including forward planning logic according to the rule information based on the input data to provide production plan data to the client. For further details, reference is made to the description above.

The storage device 2630 may store at least one of input data, software models and logic sets received by the interface 2640 in the storage device 2630. The storage device 2630 may include volatile memory or non-volatile memory. In-memory 2620 may include decision point rule information of forward planning logic and production plan data of a manufacturing production system.

In an embodiment, the interface 2640 may provide a software model and logic set, and may provide analysis result data of the software model and the logic set to enable management of production or operations in a cloud environment and client systems.

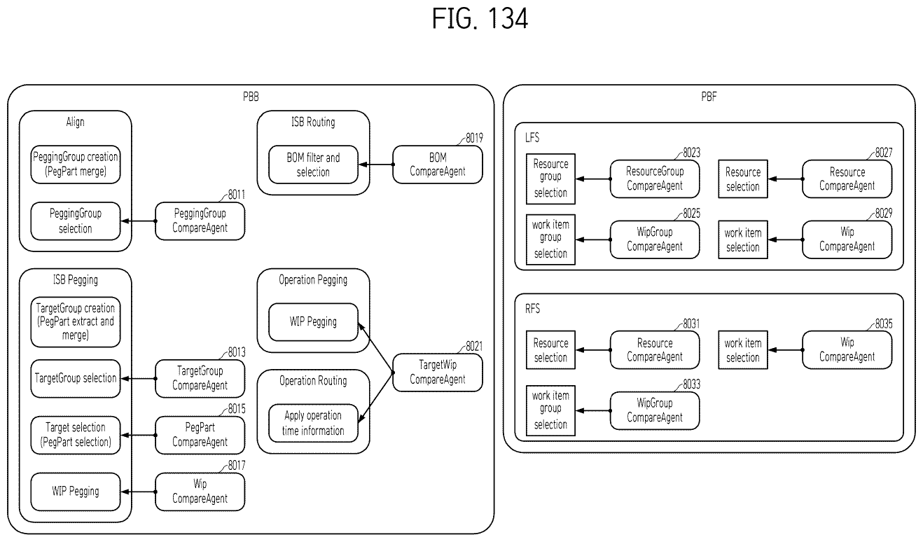

FIG. 134 is a diagram illustrating an example of providing digital production plan information based on a compare agent for decision-making according to an embodiment.

In an embodiment, to facilitate the description of at least an embodiment of backward planning logic and forward planning logic within a library engine set, an example of decision making by a compare agent for decision making, which is a type of system dynamics, is disclosed.

In an embodiment, the compare agent for decision making may perform decision-makings based on decision-making criteria based on the comparision target candidates and comparision target features included in the rule information for each decision-making point. In an embodiment, the compare agent for decision making may include an agent that calculates feature values of decision-making alternatives, i.e., candidates to be compared, at a decision point and determines the final decision-making target. For example, weight sum or weight sort methods may be performed using the feature values produced for the decision-making. Details of each decision-making method will be described in the following description.

Here, a decision-making point may mean an opened key decision-making point that allows a user to specify a decision-making rule to execute a software model and logic set including at least one of backward planning logic and forward planning logic.

In an embodiment, a decision-making point may include one or more predefined features corresponding to at least one of the backward planning logic and the forward planning logic, and feature values for the features. In an embodiment, additional features and feature values for those features may be setup by the user at decision-making points. In an embodiment, the decision-making method and policy may be changed by changing the priorities or weights of the features and feature values setup at the decision-making point.

In addition, such decision-making is managed by a compare agent for decision making, and the compare agent for decision making may correspond to a logical variable among the state variables described above. Additionally, comparative decision making may be one of the most important factors influencing performance in production planning. In an embodiment, the comparative decision-making may be performed at different point in times depending on the type of subject on which the event is executed or the decision-making point.

In an embodiment, in the case of backward planning logic, one of a plurality of pegging groups may be selected based on a pegging group selection criteria during the align process through a pegging group compare agent for decision making 8011. Here, the pegging group selection criteria may indicate priorities among the plurality of generated pegging groups.

Additionally, one target group may be selected from among the target groups filtered according to the target group selection criteria during the ISB Pegging process through the target group compare agent for decision making 8013. Here, the target group selection criteria may indicate priorities among the plurality of target groups.

In addition, through the target object compare agent for decision making 8015, one target work object among at least one work object included in the target group for the current ISB information may be selected according to the target object selection criteria during the ISB pegging process. Here, the target object selection criteria may indicate the priority among the work objects within the target group.

In addition, through the WIP pegging compare agent for decision making 8017, WIP pegging for a target work object may be performed based on target WIP for current ISB information according to the WIP pegging criteria during the ISB pegging process. Here, the WIP pegging criteria may indicate the priority among the target WIPs that may be peggable.

Additionally, a target BOM may be selected from at least one BOM filtered according to BOM selection criteria during the ISB routing process through the BOM compare agent for decision making 8019. Here, the BOM selection criteria may indicate priorities among routable BOMs.

In addition, through the target WIP compare agent for decision making 8021, WIP pegging is performed on target work objects for the operation of the target BOM according to the target WIP selection criteria in the operation pegging process, and time information on the operation may be applied to the target work objects for which WIP pegging is performed in the operation routing process. Here, the target WIP selection criteria may indicate priorities among WIPs in the plurality of WIPs or WIPs in waiting.

In an embodiment, in the case of the LFB method of the forward planning logic, a resource group including at least one resource for an operation of the client's manufacturing production system may be selected based on resource group selection criteria through a resource group compare agent for decision making 8023 for resources of a bucket. Here, the resource group selection criteria may represent the criteria for grouping resources into resource groups for an operation.

Additionally, a work item group including at least one work item for a resource group may be selected among at least one work item group according to work item group selection criteria through a work item group compare agent for decision making 8025. Here, the work item group selection criteria may indicate priorities among the plurality of generated work item groups.

Additionally, a resource for the selected work item group may be selected from among at least one resource included in the resource group based on resource selection criteria through a resource compare agent for decision making 8027. Here, the resource selection criteria may indicate the priority of available resources (i.e., facilities).

Additionally, a work item compare agent for decision making 8029 may be used to select a work item for a resource from among at least one work item included in a work item group based on work item selection criteria. Here, the work selection criteria may indicate the priority among the work items within the work group.

In an embodiment, in the RFB method of the forward planning logic, resources for the operation of the client's manufacturing production system may be selected based on resource selection criteria through a resource compare agent for decision making 8031 for resources of a bucket. Here, the resource selection criteria may indicate the priority of available resources (i.e., facilities). In an embodiment, buckets may be set up based on at least one of resource and production capacity over time units. For example, buckets may be set up to apply production capacity to resources on a time basis.

Additionally, a work item group including at least one work item for a resource may be selected among at least one work item group according to work item group selection criteria through a work item group compare agent for decision making 8033. Here, the work item group selection criteria may indicate priorities among the plurality of generated work item groups.

Additionally, a work item compare agent for decision making 8035 may be used to select a work item for a resource from among at least one work item included in a work item group based on work item selection criteria. Here, the work item selection criteria may indicate the priority among the work items within the work item group.

In an embodiment, the compare agent for decision-making may be configured to be present at each decision-making point in at least one of the backward planning logic and the forward planning logic, or may be integrated into one compare agent for decision-making to perform a function at each decision-making point. The details of the decision-making process by such a compare decision-making agent are described below.

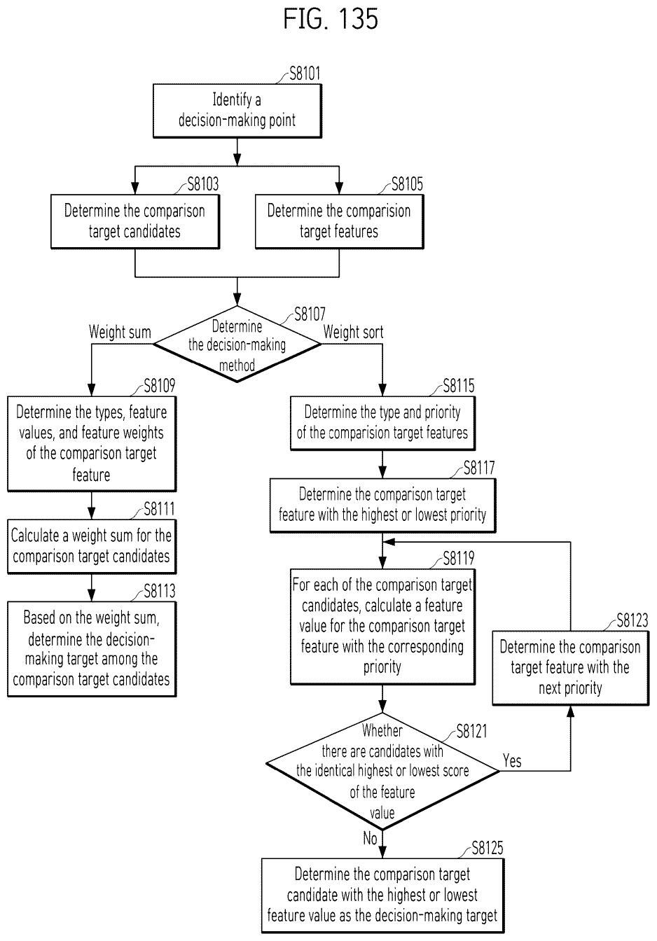

FIG. 135 discloses a flowchart illustrating an example of a decision-making execution process based on a decision-making method according to an embodiment.

At least one decision point among backward planning logic and forward planning logic is identified S8101. In an embodiment, a decision-making event may include a filtering event. That is, filtering may be performed to determine the decision-making target before deciding on the method for decision-making.

The comparison target candidates for the decision point may be determined S8103. In an embodiment, at the point in time when a decision making for a decision-making point is executed, a comparison target candidate for the decision-making point may be determined based on rule information for that decision-making point. For example, the comparison target candidate may include at least one of a pegging group, a subject WIP, a target work object, a target WIP, and a target BOM of the backward planning logic. Additionally, the comparison target candidate may include at least one of a work item group, a work item, a resource group, and a resource of the forward planning logic.

The target features to be compared to the decision point may be determined S8105. In an embodiment, at the point when a decision for a decision point is executed, a comparison target feature for the decision may be determined based on rule information for that decision-making point.

Determine the decision-making method for the decision point based on the comparison target candidate and the comparison target features S8107. In an embodiment, the decision-making method may include at least one of a weight sum method and a weight sort method. In an embodiment, the decision-making method may be determined based on at least one of the components of the cloud model for the manufacturing production system or may be determined by a user's settings. For example, components of a cloud model may include ISB (Item Site Buffer) information, BOM (Bill of Material) information, routing information, operation information, resource information, demand information, WIP information, lot information, constraint information, calendar information, property information, etc.

Here, the weight sum method is a method that calculates the sum of the products of all feature values and weights for the comparison target candidates and selects the candidate with the largest weight sum as the decision-making target.

In addition, the weight sorting method is a method of evaluating the features with high priority among the comparison target candidates and selecting one candidate as the decision-making target.

When the decision-making method is determined as a weight sum method, the types, feature values, and feature weights of the comparison target feature s for the comparison target candidates of the decision-making point are determined S8109. In an embodiment, the features of a decision-making may correspond to characteristics (or features) of candidates for comparison that may arise in the decision-making, and the feature weights may correspond to the weights of each feature. In an embodiment, the types of weights and features of the weight sum method may be predefined. Additionally, the types of features and the values of their weights may change during decision making using the weight sum method.

A weight sum is calculated for each of the comparison target candidates based on the type, feature value, and feature weight of the comparison target feature S8111. In an embodiment, a weight sum may be calculated by multiplying the features and weights for each of the plurality of comparison target candidates. Here, the weight sum evaluation may include a linear weight sum or a non-linear weight sum utilizing a non-linear structure such as a neural network.

Based on the weight sum, the decision-making target is determined among the comparison target candidates S8113. In an embodiment, a weight sum may be calculated for each of the plurality of comparison target candidates, and the final candidate with the highest weight sum may be selected as the decision-making target. That is, when improving decision-making policies through reinforcement learning during machine learning, the phenomenon of the policy being set up in a specific direction during the learning process may be prevented when decision-making is selected probabilistically.

As another example, by calculating the weight sum for each of the plurality of candidates, the final candidate with the lowest weight sum may be selected as the decision-making target. As another example, a weight sum is calculated for each of the plurality of candidates, and probabilities are assigned in order of high to low weight sums, and then the final candidate may be selected as the decision-making target according to the probability.

If the decision-making method is determined as a weight sorting method, the type and priority of the comparision target features for the comparison target candidates at the decision-making point are determined S8115. In an embodiment, the priority may correspond to the order in which feature values are compared based on features of a manufacturing production system, facility, or work item.

Among the types of comparison target features, the comparison target feature with the highest priority is determined S8117. In this embodiment, the feature value with the highest priority is determined as an example, but it may be set up to be determined as the feature value with the lowest priority.

For each of the comparison target candidates, a feature value for the comparison target feature with the highest priority is calculated S8119. In an embodiment, the feature value of the feature having the first priority may be compared for the plurality of comparison target candidates.

Determine whether there are comparison target candidates with the highest identical feature values S8121. For example, if there are the plurality of comparison target candidates, it may be determined whether at least two comparison target candidates have the same high or low score. Here, the high or low score may correspond to the highest or lowest score among the respective scores of the plurality of comparison target candidates.

If there are comparison target candidates with the highest identical feature value, the comparison target feature with the next priority is determined S8123. In an embodiment, a feature value having the next priority may be determined only for comparison target candidates having the same high or low score, excluding the remaining candidates that are not comparison target candidates having the same high or low score. For example, if there are two comparison target candidates that have the same high or low score in the feature value having the first priority among the plurality of candidates, the feature value having the second priority may be determined only for the two comparison target candidates. Afterwards, proceeding to step S8119, and the feature values for the comparison target features with the next priorities may be calculated.

If there are no comparison target candidates with the identical highest or lowest feature values, the comparison target candidate with the highest or lowest feature value is determined as the decision-making target S8125. In an embodiment, it is exemplified that a comparison target candidate with a high score is selected as the final candidate, but it may be set that a candidate with a low score is selected as the final candidate.

In other words, the weight sorting method is a decision-making method that repeats sorting the plurality of comparison target candidates based on the same feature value until only one candidate remains without the same score.

Meanwhile, although not shown in this embodiment, the weight sum method and the weight sorting method may be performed in combination in the input decision-making. For example, among the ten (10) comparison target candidates that are the subject of decision making, the five (5) with the highest weight sum may be selected, and then one candidate may be selected as the final candidate by weight sorting method among the five (5) selected candidates. In addition, for example, among ten (10) comparison target candidates to be subjected to decision-making, five (5) candidates remain after performing weight sorting first and having the same scores up to priority, a single comparison target candidate may be finally selected from the five (5) candidates using a weight sum method. At this time, in order to prevent computational waste, the features used in weight sorting may be different from the features used in the weight sum method.

In an embodiment, even when the comparison target features for all priorities have been determined according to the weight sorting method, if comparison target candidates still remain, the weight sum method may be applied to the remaining comparison target candidates.

For example, if there are candidates with the same high or low score for a feature value in step S8121, it may be determined whether there is a feature to be compared corresponding to the next priority. In this case, if there is a comparison target feature corresponding to the next priority, the process proceeds to step S8123 to determine a comparison target feature having the next priority. On the other hand, if there is no comparison target feature corresponding to the next priority, the process proceeds to step S8109 and a weight sum method may be applied to the comparison target candidates.

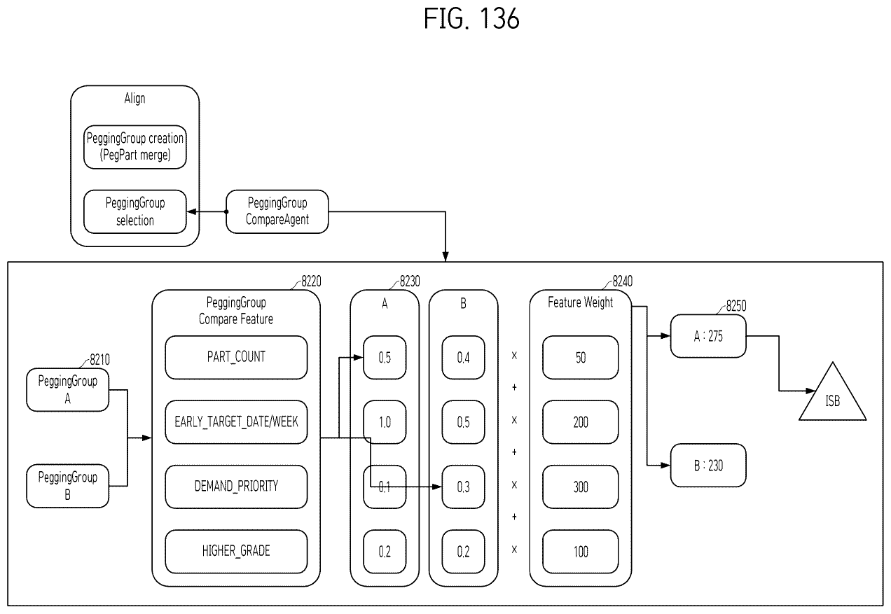

FIG. 136 discloses a flowchart illustrating an example of a decision-making process based on a weight sum method according to an embodiment.

In an embodiment, a decision-making process based on a weight sum method using a pegging group compare agent for decision making may be used to select one pegging group as a decision-making target among comparison target candidates in the alignment process.

For example, the comparison target candidate may be a pegging group 8210, which may include pegging group A and pegging group B. Next, the comparison target feature 8220, feature value 8230, and feature weight 8240 for decision-making may be determined.

For example, the types of the comparision target features 8220 may include PART_COUNT, EARLY_TARGET_DATE/WEEK, DEMAND_PRIORITY, and HIGHER_GRADE. For example, PART_COUNT may represent a feature for making decisions in order of large or small by using the sum of the quantity of work objects or materials in a pegging group as a feature value. EARLY_TARGET_DATE/WEEK may indicate a feature for making a decision with priority given to the earliest due date (e.g. day/week) among the work object or WIP within the pegging group. DEMAND_PRIORITY may represent features for decision-making priority by demand type. For example, DEMAND_PRIORITY may represent a feature to prioritize the work items of a specific customer over those of other customers. HIGHER_GRADE may represent a feature for giving priority to making the decision on the pegging group whose representative targets have a higher grade.

In this embodiment, four features are described, but the types of features are not limited thereto. In addition, the comparison target features for decision making may include various types of features that may be quantified within the client's manufacturing system.

For example, for pegging group A, the feature value of PART_COUNT may be 0.5, the feature value of EARLY_TARGET_DATE/WEEK may be 1.0, the feature value of DEMAND_PRIORITY may be 0.1, and the feature value of HIGHER_GRADE may be 0.2. Also, for pegging group B, the feature value of PART_COUNT may be 0.4, the feature value of EARLY_TARGET_DATE/WEEK may be 0.5, the feature value of DEMAND_PRIORITY may be 0.3, and the feature value of HIGHER_GRADE may be 0.2.

In an embodiment, the weight 8240 for decision making may be determined according to a weight determination criteria that serves as a basis for decision making. In an embodiment, the weight determination criteria may be predefined by a manager or an operator who establishes a production plan. Additionally, the weight determination criteria may include criteria for using weights with high performance indicators through artificial intelligence-based learning including feedback loops. For example, the weight for the PART_COUNT feature for a pegging group could be 50, the weight for the EARLY_TARGET_DATE/WEEK feature could be 200, the weight for the DEMAND_PRIORITY feature could be 300, and the weight for the HIGHER_GRADE feature could be 100.

In an embodiment, a weight sum 8250 may be calculated by multiplying the feature values and weights for each comparison target candidate and adding them together. For example, the weight sum for the pegging group A might be 275 (i.e., 0.5×50+1.0×200+0.4×300+0.2×100), and the weight sum for pegging group B might be 300 (i.e., 0.4×50+0.5×200+0.3×300+0.2×100). Therefore, the decision-making target for decision-making on the pegging group may correspond to pegging group A, which is the candidate with the highest weight sum.

In the present embodiment, it is assumed that the decision-making process for the pegging group in the alignment process is described. However, in the case of the production management information routing, production management information pegging, operation pegging, and operation routing processes of the backward planning logic described above, and the LFB method and RFB method of the forward planning logic, a decision-making may be made by performing the weight sum method in the same manner. The weight sum method has the advantage of producing high-performance production plans because the decision-making takes into account all feature values.

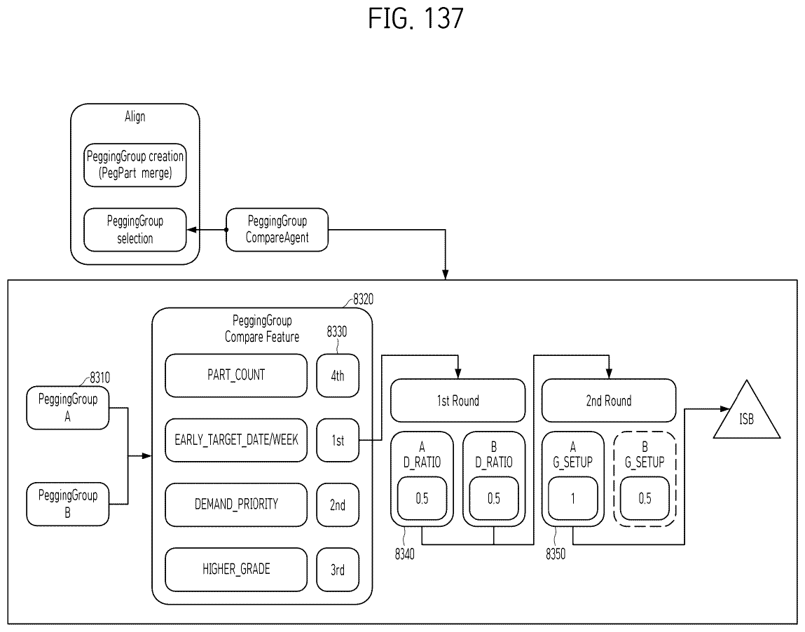

FIG. 137 discloses a flowchart illustrating an example of a decision-making process based on a weight sorting method according to an embodiment.

In an embodiment, a decision-making process based on a weight sorting method using a pegging group compare agent for decision making may be used to select one pegging group as a decision-making target among comparison target candidates in the alignment process.

For example, the comparison target candidate may be a pegging group 8310, which may include pegging group A and pegging group B. Next, the comparison target feature 8320, priority 8330, and feature value 8340, 8350 for decision-making may be determined. For example, the types of the comparision target features 8320 may include PART_COUNT, EARLY_TARGET_DATE/WEEK, DEMAND_PRIORITY, and HIGHER_GRADE.

In an embodiment, priorities 8330 may be ranked by the most important factor for each type of comparison target feature 8320. For example, EARLY_TARGET_DATE/WEEK may be 1st priority, DEMAND_PRIORITY may be 2nd priority, HIGHER_GRADE may be 3rd priority, and PART_COUNT may be 4th priority.

In an embodiment, the feature values 8340, 8350 for the comparison target feature 8320 among the comparison target candidates may be evaluated in order of highest priority. For example, the first evaluation (1st Round) is performed for EARLY_TARGET_DATE/WEEK, which has the highest priority, and the feature values 8340 of pegging group A and pegging group B may be evaluated equally as 0.5.

In this case, the second (2nd Round) is performed for DEMAND_PRIORITY, which has the second highest priority, and the feature value 8350 of pegging group A may be evaluated as 1 and the feature value 8350 of pegging group B may be evaluated as 0.5. That is, the feature value of pegging group A may be evaluated as higher than the feature value of pegging group B. Therefore, the decision-making target of the decision in the present embodiment may correspond to the pegging group A, which is the last remaining candidate in the weight sorting.

Although not shown in this embodiment, if the feature values of pegging group A and pegging group B are the same in the second evaluation, an additional evaluation may be performed on HIGHER_GRADE, which has the third highest priority.

In addition, although not shown in the present embodiment, if the feature values of EARLY_TARGET_DATE/WEEK for all comparison target candidates are different in the first evaluation, the comparison target candidate with the highest feature value among the comparison target candidates may be finally selected as the decision-making target of the decision in the first evaluation.

In this embodiment, four features are described, but the types of features are not limited thereto. In addition, the comparison target features for decision making may include various types of features that may be quantified within the client's manufacturing system.

The weight sorting method has the advantage of reducing the number of cases as decision-making progresses and reducing the amount of computation because not all feature values need to be calculated. In addition, since the amount of computation is reduced, quick decisions may be made, so in cases where simulation is difficult in a complex manufacturing production system (if it is too complex and takes too much time), decisions may be made quickly, allowing for efficient production planning.

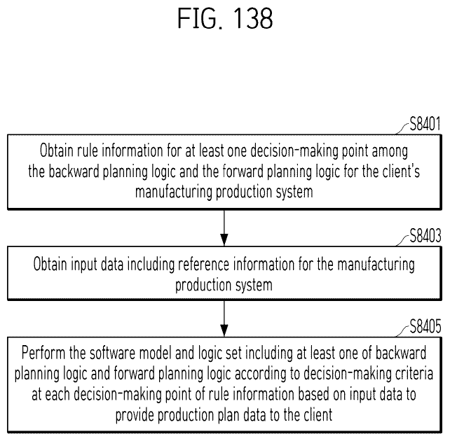

FIG. 138 discloses another flowchart illustrating an example of providing digital production plan information based on a compare decision-making agent according to an embodiment.

Rule information for at least one decision point among the backward planning logic and the forward planning logic for the client's manufacturing production system is obtained S8401. In an embodiment, the rule information for each decision-making point may include decision-making criteria for each decision-making point (e.g., criteria, conditions, rules, methods, policies, and logic for generating, selecting, filtering, and grouping) for at least one of the comparison target candidates and comparison target features for at least one of the backward planning logic and the forward planning logic. For this, reference is made to the contents described above in FIGS. 134 and 135.

Input data including reference information for the manufacturing production system is obtained S8403. In an embodiment, reference is made to the description described above in FIG. 134.

A software model and logic set including at least one of backward planning logic and forward planning logic according to decision-making criteria at each decision-making point of rule information based on input data is executed to provide production plan data to the client S8405. In an embodiment, at least one of the backward planning logic and the forward planning logic may determine a decision-making method for a decision-making point. In this case, the decision-making method may include at least one of a weight sum method and a weight sort method. In an embodiment, the priorities for the various generation and selection criteria described above of the backward planning engine and the forward planning engine may include priorities calculated by at least one of a weight sorting method and a weight sum method. For more details, reference is made to the description above.

In an embodiment, at least one of the backward planning logic and the forward planning logic, when the decision-making method is determined by the weight sum method, determines the types, feature values, and feature weights of the comparison target features for the comparison target candidates at the decision-making point, calculates a weight sum for each of the comparison target candidates based on the types, feature values, and feature weights of the comparison target features, and determines a decision-making target among the comparison target candidates based on the weight sum.

In an embodiment, at least one of the backward planning logic and the forward planning logic may determine the types and priorities of comparison target features for comparison target candidates at a decision-making point when the decision-making method is determined by a weight sorting method, determine the comparison target feature with the highest priority among the types of comparison target features, calculate a feature value for the comparison target feature with the highest priority for each of the comparison target candidates, and determine a decision-making target among the comparison target candidates based on the feature value.

In an embodiment, a process of determining a decision-making target according to at least one of a weight sum method and a weight sorting method based on rule information at each decision-making point may include a process of determining the decision-making target in order of higher or lower feature values of compared target features, and a process of determining the decision-making target according to at least one of a linear and nonlinear structure of the feature value based on the feature value. For example, after calculating the feature value, it is possible to determine the highest score, the second highest score excluding greater or less than a threshold value, or assign a probability proportional or inversely proportional to score, and determine the decision-making target based on the highest score, the second highest score, or that probability.

For this, reference is made to the description in FIGS. 134 to 137.

Referring to FIG. 104, an embodiment of a device for analyzing a production plan based on a software model and logic set and providing digital production plan information is described as follows.

An embodiment of a device providing digital production plan information may include a processor 2610, in-memory 2620, storage 2630, and an interface 2640.

An embodiment of a device providing digital production plan information below may be controlled by user control and management via an interface 2640. The interface 2640 may obtain input data of the manufacturing production system from a client. In an embodiment, the interface 2640 may obtain rule information per decision-making point in at least one of the backward planning logic and the forward planning logic from the client.

The processor 2610 of the embodiment may obtain rule information for at least one decision-making point among backward planning logic and forward planning logic for a manufacturing production system of a client, obtain input data including reference information for the manufacturing production system, and execute a software model and logic set including at least one of backward planning logic and forward planning logic according to a decision-making point criteria of the rule information based on the input data to provide production plan data to the client. For further details, reference is made to the explanation above.

The storage device 2630 may store at least one of input data, software models, and logic set received by the interface 2640 in the storage device 2630. The storage device 2630 may include volatile memory or non-volatile memory. In-memory 2620 may include rule information for at least one decision-making point among backward planning logic and forward planning logic and production plan data of the manufacturing production system.

In an embodiment, the interface 2640 may provide a software model and logic set, and may provide analysis result data of the software model and logic set to enable management of production or operations in a cloud environment and client systems.

Policies involved in decision-making in manufacturing production systems may be continuously learned and operated. The dispatching agent and compare agent described above are examples of agents that perform decision making. Making decisions that reflect policy may be necessary to drive virtual manufacturing systems and improve policies through learning. In this process, specifying the form of the policy, extracting elements, calculating the value of the alternative policy, and the selection of the alternative may be specified. By specifying and concretizing the policy, the targets for improvement through learning may be clearly identified, and such targets may be utilized through evaluation and learning processes. Learning and implementing policies is intended to automate complex decision-making and maximize the performance of manufacturing production systems. Below, a method for making decisions by reflecting policies, and for performing simulation, learning, and operation will be described in detail.

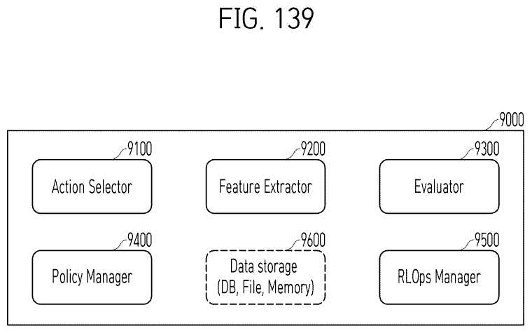

FIG. 139 is a diagram illustrating a tool of a system for a policy according to an embodiment.

Referring to FIG. 139, a system 9000 for establishing and operating a policy involved in decision making may be performed through tools such as an action selector 9100, a feature extractor 9200, an evaluator 9300, a policy manager 9400, and a reinforcement learning operation manager (RLOps manager) 9500. Optionally, a data storage 9600 may be required for policy learning and operation.

The action selector 9100 may make decision-makings at each decision-making point. The feature extractor 9200 may extract and aggregate factors relevant to decision making. The evaluator 9300 may evaluate and store values such as rewards and penalties generated by decision making. Additionally, the evaluator 9300 may store the generated performance indicators, rewards, and penalties.

The policy manager 9400 learns policies through performance indicators, reward information, decision-making factors, a list of decision-making alternatives, time points, target operations/facility/work items, etc. received through the feature extractor, and transfers the learned policies to the action selector 9100. The reinforcement learning operation manager 9500 may evaluate the learned policy, deploy the optimal policy function/optimal operation scenario, etc., and provide as an optimal policy or scenario suitable for the changing situation of the manufacturing system that delivers policy performance degradation. The data storage 9600 may correspond to a database of the client system and may include an operational model storage, a logic storage, and a policy storage.

In this embodiment, the policy manager 9400, the reinforcement learning operation manager 9500, and the data storage 9600 may be included in the system operation unit 110, and the action selector 9100, the feature extractor 920, and the evaluator 9300 may be included in the engine of the model execution unit or the experiment hub execution unit.

Meanwhile, the tools described above may be operated by user input for parameter setting or input. For example, parameters may include parameters related to policy operation, parameters for policy management, parameters for reinforcement learning operation, and parameters related to learning.

Additionally, only some of the tools included in this system may be used depending on the purpose. For a policy operation system, an action selector 9100, a feature extractor 9200, and an evaluator 9300 may be used. For a policy learning system, an action selector 9100, a feature extractor 9200, an evaluator 9300, and a policy manager 9400 may be used. For a dynamic policy operation and learning system, an action selector 9100, a feature extractor 9200, an evaluator 9300, a policy manager 9400, and a reinforcement learning operation manager 9500 may be used.

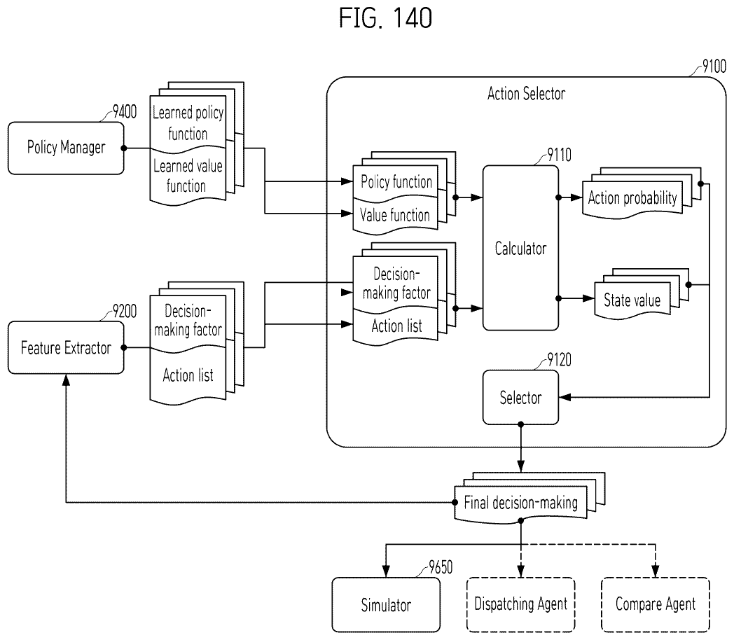

FIG. 140 is a diagram illustrating the configuration of an action selector according to an embodiment.

The action selector 9100 is responsible for making policy-related decisions and may include a calculator 9110 and a selector 9120. The calculator 9110 may calculate action probabilities or state values by inputting decision-making factors and action lists into at least one of a policy function or a value function. A policy function is a function that determines which action to choose in a given state, and a value function is a function that evaluates how good a specific state is. A policy function or value function may optionally be calculated. At this time, the policy function may correspond to a learned policy function received from the policy manager 9400, and the value function may correspond to a learned value function received from the policy manager 9400. Although not shown, policy functions may also be transferred from a data storage.

The calculator 9110 may calculate action probabilities by inputting the decision-making factor and action list into a policy function. Action probability corresponds to information indicating the probability of each action being selected.

Additionally, the calculator 9110 may calculate state value by inputting the decision-making factor and action lists into the value function. At this time, the state value corresponds to an evaluation of how good a specific state is.

The decision factor and action lists corresponds to the information received from the feature extractor 9200. The decision-making factor corresponds to the input information required for the system to determine which action to select, and the action list represents the set of actions that may be selected at a given point in time. At least one of the action probability and state value produced by the calculator 9110 is transmitted to the selector 9120.

The selector 9120 makes at least one final decision based on at least one of the action probability and the state value. The final decision-making process may be determined by a variety of algorithms. Examples include, but are not limited to, a greedy method that selects an action with the highest score or probability at the current point in time, a SoftMax method that is proportional to the score or probability, and a Monte Carlo Tree Search (MCTS) method that explores future situations based on a policy function and then makes a decision. Additionally, the final decision may be output based on a selection method determined by user input from the action list.

Once the final decision data is produced by the selector 9120, it may be transmitted to the simulator 9650 and optionally to a dispatching agent or a compare agent. The simulator 9650 may include a model execution unit and an experiment hub execution unit. Additionally, the final decision-making data produced by the selector 9120 may be transmitted to the feature extractor 9200. This may be transmitted to the feature extractor 9200 because it is necessary for the feature extractor 9200 to confirm what decision was made during policy learning.

By making rational decisions that take into account constraints on actions through the action selector 9100, flexibility may be secured in the operation of the manufacturing system. In addition, the policy/value and selection (decision) may be managed separately through the action selector 9100, and by specifying the policy, reuse is possible in similar facilities, products, lines, sites, or operations within the same system or other systems. Additionally, by changing the decision-making method, it is possible to generate a structure that may respond to any usage scenarios of evaluation or learning.

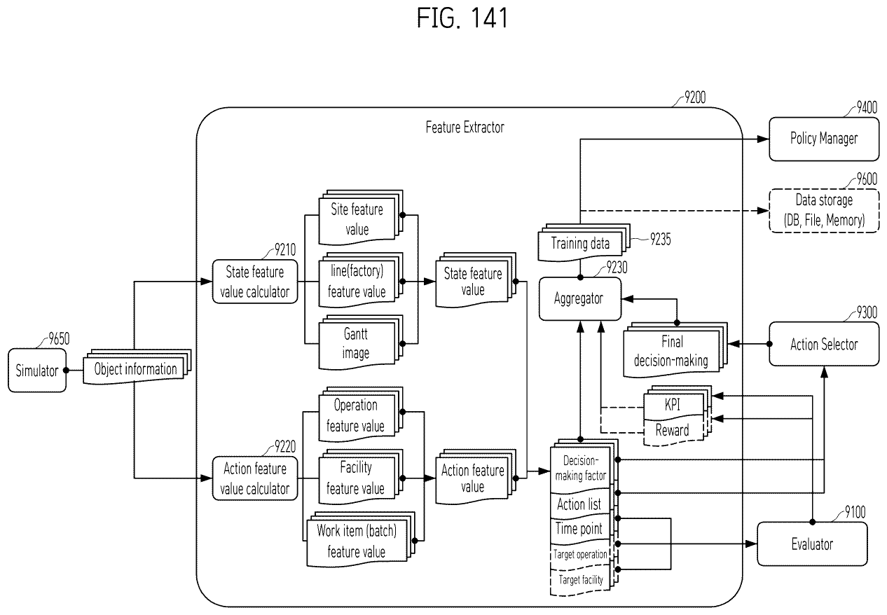

FIG. 141 is a diagram illustrating the configuration of a feature extractor according to an embodiment.

The feature extractor 9200 receives information from the simulator 9650 and performs the role of extracting and aggregating information necessary for decision making, and may include a state feature value calculator 9210, an action feature value calculator 9220, and an aggregator 9230. Here, the simulator 9650 may include a model execution unit and an experiment hub execution unit. The state feature value calculator 9210 may extract state feature values from object information received from the simulator. Additionally, the action feature value calculator 9220 may extract action feature values from object information received from the simulator.

When making decisions, it is necessary to review what situation (state) we are in and what characteristics (features) each action has. Depending on the current situation, all actions may have the same value, or each action may have different values depending on what features it has. Because the feature of the action to be focused on may vary depending on the situation, a review of both the situation and the feature of the action is necessary. Additionally, in certain cases, it may be necessary to focus on a specific situation when a certain feature becomes apparent. As the field of machine learning develops attention structures, it will be able to take into account more granular information in decision-making, using both context and features.

State features are features or properties that may be extracted from a given situation regardless of the action, and the state feature values represent the state values at a specific point in time. The status feature values calculated by the status feature value calculator 9210 may include, but are not limited to, site feature values, line (factory) feature values, and gantt images. For example, site feature values may include monthly production/purchase/sales capacity of a particular site, number of configuration lines, remaining demand, excess production, etc. For example, line feature values may include weekly production/purchase/sales capacity of a particular line, number of configuration facilities, number of active products, etc. A gantt image is image information that contains geometric information of the factory status reflecting the factory situation. Additionally, the gantt image may also include a virtual gantt image of a future point in time. For example, a gantt image may include the status of work item assignments at a facility for each time point, confirmed or virtual assignments, images after applying filters, etc.

Action features are features or characteristics about actions that may make decisions, and action feature values represent feature values for a specific action. Action feature values calculated through the action feature value calculator 9220 may include, but are not limited to, operation feature values, facility feature values, and work item (batch) feature values. For example, operation feature values may include the number of available operations associated with an action, the number of remaining operations, the operation queue delay ratio, the configuration facility availability, and the amount of work item to be flowed in in the future. For example, facility feature values may include the number of work items in queue, the number of active operations available for processing, the number of product types available for processing, the replacement time for each action, and whether the facility itself is in queue/work/replacement. For example, the work item (batch) feature value corresponds to data that may be obtained by processing information that may be obtained as data entered into the simulator, such as the appropriate number of facilities that may process the work item, arrival time score, late delivery score, product priority, number of remaining operations, number of facilities available for processing, process time, queue waiting time, and future input quantity. Non-numeric data among the above-described state features or action features may be converted into numeric vectors by embedding and included in the state feature values or action feature values. Through at least one of the state feature value calculator 9210 and the action feature value calculator 9220, the action list and time points as well as the decision-making factors are extracted. At this time, the extracted time point includes at least one of the decision-making time point and a random time point specified by the user. For example, random points in time may include regular intervals, the time of occurrence of specific events, etc. In addition, target operations and target facilities may be optionally extracted.

The aggregator 9230 may process training data 9235 for decision-making factors, action lists, and time points. In addition, considering the performance indicators (KPIs) and rewards received from the evaluator 9100 and the final decision-making received from the action selector 9300, the aggregator 9230 may process the data into training data 9235 by matching it to the point in time when the decision-making factors were calculated. In this embodiment, the aggregator 9230 of the feature extractor 9200 may aggregate which decision-making at a specific point in time resulted in which rewards or performance.

Training data 9235 is data that is the target of policy learning and may include at least one of a decision-making factor, an action list, a final decision-making, a time point, a performance indicator (KPI), a reward, a target operation, and a target facility. Although not shown, the training data 9235 may also include target queues (buffers), target products, target lines, and target sites. For example, decision-making factors, action list, final decision-making, and time point correspond to mandatory data of the training data 9235, and the rest correspond to optional data. Additionally, each element included in the training data 9235 may include one or more values. Here, the target operation represents an operation relevant to decision making, and the target facility represents a facility relevant to decision making. For example, if a decision-making occurs at facility 1 and operation 2 is being processed, the policy may be specified in more granularly.

Meanwhile, the point in time, target operation and target facility extracted through at least one of the state feature value calculator 9210 and the action feature value calculator 9220 are transmitted to the evaluator 9100 and may be used for aggregation in the evaluator 9300. Meanwhile, the state feature value may not be calculated if it is not in the calculation list based on user input, and the action feature value may be operated only if there is at least one value. Additionally, the decision-making factors and action list may be transferred to the action selector 9300 and used for decision-making of the action selector 9300.

The training data may be transmitted to a policy manager 9400 or a data storage 9600. Training data is transmitted to the policy manager 9400, so that policy learning may be performed.

Unnecessary information may be excluded and only valid information may be refined through the feature extractor 9200. Additionally, the feature extractor 9200 clarifies decision-making factors and extracts and refines them to enable policy-based scheduling, planning and learning. As the feature extractor 9200 is defined, the data collection process in the reinforcement learning operation manager may be clearly standardized and managed.

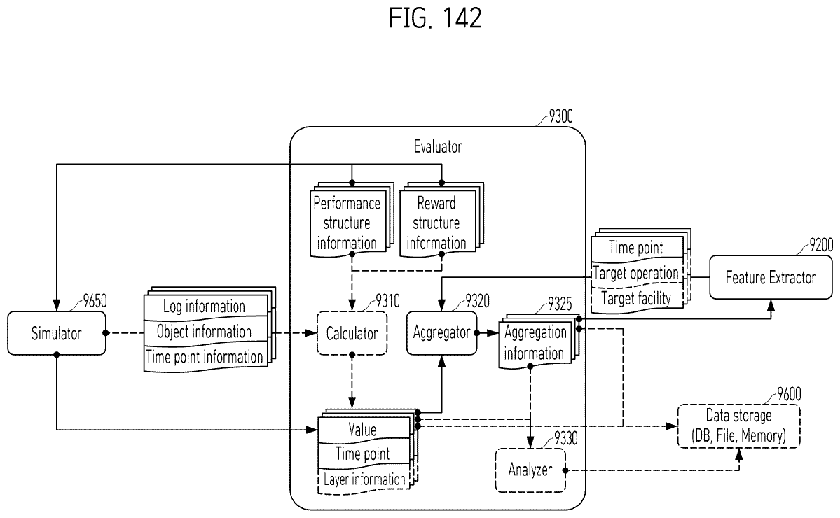

FIG. 142 is a diagram illustrating the configuration of an evaluator according to an embodiment.

The evaluator 9300 calculates and stores performance indicators (KPIs), rewards, penalties, etc., and may include a calculator 9310, an aggregator 9320, and an analyzer 9330. Here, the aggregator 9320 corresponds to a required component, and the calculator 9310 and the analyzer 9330 correspond to optional components.

The evaluator 9300 includes at least one of performance structure information and reward structure information. Performance structure information may represent information as a method or logic for aggregating performances, indicating such as parameters (logic parameters, priorities between performances, weights, etc.), the timing of calling, or conditions for occurrence, and reward structure information may represent information as a method or logic for aggregating rewards or penalties, indicating parameters (logic parameters, priorities between performances, weights, etc.), the timing of calling or conditions for occurrence, etc. Performance structure information or reward structure information may be set by the user or automatically by the system. For example, when work item A is selected, a delay in due date may result in a penalty of −10, whereas if no job replacement occurs, a reward of +15 may be granted. Such numerical values and conditions may be defined.

The evaluator 9300 may calculate a value (reward value, penalty value) based on at least one of performance structure information and reward structure information and transmit a time point. As an example, the simulator 9650 may calculate performance structure information and reward structure information received from the evaluator 9300 to derive values and time points and transmit them to the evaluator 9300. As another example, the calculator 9310 of the evaluator 9300 may calculate performance structure information and reward structure information possessed by the evaluator 9300 based on log information, object information, and time information received from the simulator 9650 to produce values and time points. For example, the aggregator 9320 may produce aggregate information by matching the type of extracted reward, penalty, performance indicator, and extracted time to the target facility, work item, operation, setting, etc. At this time, the point in time transmitted from the calculator is the point in time when the calculation is performed, which corresponds to the point in time obtained from the simulator 9650, and the point in time transmitted to the aggregator is the point in time when the decision-making was made, which corresponds to the point in time obtained from the feature extractor 9200. In this embodiment, the aggregator 9320 of the evaluator 9300 may perform the role of summing various forms of rewards and performance indicators, unlike the aggregator 9230 of the feature extractor.

The values produced by the calculator may be transmitted to an aggregator 9320, an analyzer 9330, or a data storage 9600. When the values produced by the calculator are transmitted to the aggregator 9320, the aggregator 9320 may produce aggregate information. At this time, the aggregator 9320 may produce aggregate information 9325 based on the time point, target operation, and target facility received from the feature extractor 9200. The target operation and target facility do not correspond to essential information. Although not shown, target products, target lines, target sites, etc. may be received from the feature extractor 9200.

Here, aggregate information 9325 may include performance indicators, reward penalties, and processed information that is a combination of performance indicators and reward penalties. For example, performance indicators, rewards, and penalties correspond to numerical values calculated through linear or nonlinear weight sum. Additionally, for example, when performing multi-objective policy optimization, the weight sum process may be omitted.

For example, if the processed information is given as three performance indicators A, B, and C, the comprehensive performance indicator may correspond to the processed information processed as a weighted sum of A, B, and C.

Performance indicators may be stored by matching with the target operation, target facility, and time point received from the feature extractor 9200. Additionally, performance indicators may be stored by matching target facility, target work item, target operation, target settings, etc., including the extracted performance indicator type and extracted time point as essential information. When the target facilities, work items, operations, and settings for decision making are specified, they may be stored according to the hierarchy of the specified elements. For example, if facilities 1, 2, and 3 are included in facility group 1, and the performance indicators are aggregated as 5, 6, and 4, respectively, the performance indicator of facility group 1 may be automatically aggregated as the sum of these, 15. Here, automatic aggregation methods may include, but are not limited to, sum, average, variance, frequency, maximum, minimum value, etc.

Performance indicators may be calculated after a certain section of the plan and schedule has been established. For example, it is assumed that the feature extractor 9200 extracts decision-making factors from the decision-makings at each of time points T1, T2, T2 , , , TN, and that the simulation completion time point is TM. In this case, the aggregator 9320 may calculate performance indicators K1_1, K2_1, K3_1 . . . . KL_1 of the T1(±a) to TM(±b) sections, and may calculate performance indices K1_N, K2_N, K3_N . . . KL_N of the TN(±a) to TM(±b) sections. L represents the number of types of performance to be aggregated, and T1 to TN represent the decision-making points in time. a indicates at what point from the decision-making point to start aggregating performance, and b indicates how far from the TM (end point) to aggregate performance. Here, a and b may be defined by the user or set up automatically. Additionally, it may be described that the performance of the section T1(±a) to T1(±a)+c is aggregated using the aggregation period (c) excluding b. When a performance indicator is calculated, the value may be used as is, depreciated in proportion to the length of the KPI evaluation interval, or converted to a performance indicator per unit time.

Information contained in intermediate or final outputs and reward structure information generated during the production planning and scheduling process may be used to calculate performance indicators.

Aggregated information 9325 produced by the aggregator 9320 may be transmitted to an analyzer 9330, a data storage 9600, a feature extractor 9200, or a reinforcement learning operation manager 9500. That is, aggregate information may be stored directly in the data storage 9600, or after analysis is performed through the analyzer 9330, the analysis results may be stored in the data storage 9600. The analyzer 9330 collects various performance indicators produced through simulation, analyzes the status of the factory (whether it is busy or idle), or examines the trend of changes in the factory's performance by point in time to store qualitative or quantitative records such as the level of volatility (large or small) and the presence or absence of abnormalities.

Additionally, aggregate information may be transmitted to a feature extractor 9200 and used to produce training data.

Through the evaluator 9300, reward/performance information may be extracted from intermediate products or results during simulation that are essential for policy learning and used as training data.

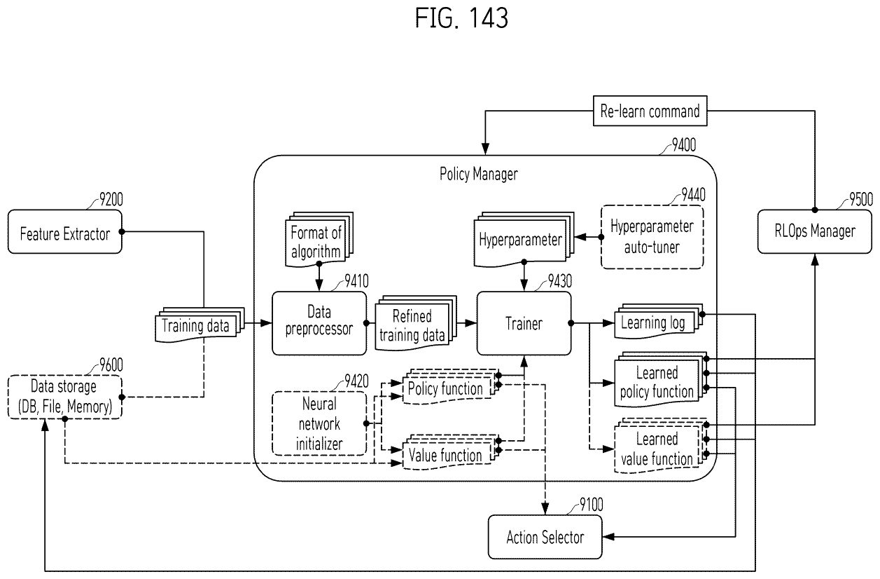

FIG. 143 is a diagram illustrating the configuration of a policy manager according to an embodiment.

The policy manager 9400 collects or refines training data to learn decision-making policies and manages (updates, stores) the learned policies, and may include a data preprocessor 9410, a neural network initializer 9420, a trainer 9430, and a hyperparameter auto-tuner 9440. The data preprocessor 9410 may receive training data from the feature extractor 9200 or data storage 9600 and perform data preprocessing. As described above, the training data is data that is the target of policy learning and may include at least one of a decision-making factor, an action list, a final decision-making, a time point, a key performance indicator (KPI), a reward, a penalty, a target operation, and a target facility.

A data preprocessor 9410 may process data to fit the form of an algorithm used for policy learning and produce or generate refined training data. For example, the data preprocessor 9410 may be configured to structure or numerically convert unstructured or non-numeric data, and may further be capable of rearranging the format thereof. As an example, when using the SARSA learning algorithm, information (time point, factor) and performance indicator information about the decision-making at the current time point and the decision-making at the next time point may be required. In this case, a job of integrating data from two time points into data from one time point may be performed through a data preprocessor 9410. For example, it is assumed that the training data contains data on decision-makings made at facilities 1, 2, 3, 4, and 5. When facilities 1, 2, and 3 are the same facility group and use/learn the same policy function, the data may be classified and refined by utilizing information such as target facility/target operation/target group during the data preprocessing process.

The policy function structure represents the policy function network model and may be defined by the user or set up automatically. For example, policy function network models include, but are not limited to, multi-layer perceptrons (MLPs), convolutional neural networks (CNNs), graph neural networks (GNNs), and transformers.

The learning machine 9430 may learn refined training data using a selected learning algorithm. At this time, the selected learning algorithm includes hyperparameters required for performing the algorithm, which may be obtained through user input or an automatic tuning device. Here, hyperparameters correspond to a set of parameters that must be acquired for the learning algorithm to operate. For example, learning algorithms may include, but are not limited to, REINFORCE (Reward Increment Nonnegative Factor Offset Reinforcement Characteristic Eligibility), SARSA (State Action Reward State Action), DQN (Deep Q-Network), A3C (Asynchronous Advantage Actor-Critic), GRPO (Group RelativePolicy Optimization), GAT (Graph Attention Network), etc.

Meanwhile, in the case of initial policy learning, in addition to refined training data, policy functions and value functions may be used for learning. For example, the policy function and the value function may correspond to the policy function and the value function initialized by the neural network initializer 9420. Additionally, for example, the policy function and value function may correspond to information received from the data storage 9600.

As an example, if the initial policy learning means the first learning during the plurality of cycles, the neural network initializer 9420 may generate the parameters of a given policy function or value function structure in an arbitrary way. An arbitrary method may involve inputting values randomly sampled from a normal distribution having a predefined mean and variance, or inputting values such that all values assume a specific constant. Alternatively, initial values may be input through various machine learning algorithms that setup initialization points that are advantageous for learning. In this case, it may operate even when there is no policy input to the action selector 9100, so that a randomly generated policy function or value function may be transferred to the action selector 9100 to drive the simulation.

As another example, if the initial policy learning means the first learning within a cycle, the neural network initializer 9240 may perform an operation of loading a previously learned policy function of the same structure from the data storage 9600. Compared to the examples described above, it is possible to continue learning from previous learning results without using any arbitrary method.

The learning device 9430 may provide at least one of a learned policy function and a learned value function and a log associated with the learning. The learning log, learned policy function, and learned value function may be stored in a data storage 9600. The learned policy function and the learned value function may be transmitted to the reinforcement learning operation manager 9500 and used for operation. Referring to this embodiment, the reinforcement learning operation manager 9500 may also command the policy manager 9400 to perform relearning. When a re-learning command is received, the policy manager 9400 may optionally initialize the neural network and then perform data preprocessing again. Additionally, the learned policy function and the learned value function are transmitted to the action selector 9100 so that training data may be extracted based on the policy that has been changed through decision-making.

The policy manager 9400 is a key function or key technology for obtaining a policy that may improve performance indicators through learning. The process of obtaining and updating the improved policies is embedded in a learning workflow (pipeline) that includes a feedback loop. Through the policy manager 9400, which is an independent tool for learning, in addition to the purpose of obtaining an improved policy, it is possible to prevent waste of resources by limiting constant operation in the process of securing a policy that is robust to situations or conditions when operating a dynamic (manufacturing) system. In addition, it may prevent resource waste by automating manually driven systems and prevent policy learning overload caused by redundant data that occurs in too short time interval or similar situations/states in dynamic systems. That is, the manufacturing system may be developed into a more automated system by learning policies through the policy manager 9400 to optimize and improve decision-making.

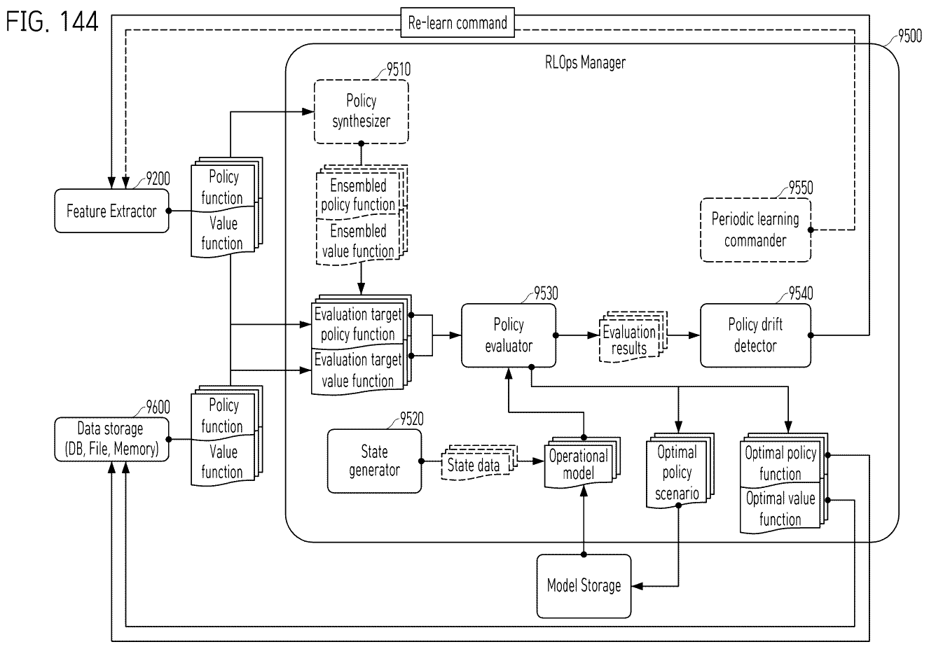

FIG. 144 is a diagram illustrating the configuration of a reinforcement learning operation manager according to an embodiment.

The reinforcement learning operation manager 9500 evaluates learned policies and presents optimal policies or optimal scenarios to the manufacturing system, and may include a policy synthesizer 9510, a state generator 9520, a policy evaluator 9530, a policy drift detector 9540, and a periodic learning commander 9550. Here, the policy evaluator 9530 and the policy drift detector 9540 are essential components.

First, prior to evaluation, the reinforcement learning operation manager 9500 prepares the evaluation target policy function and the evaluation target value function. As an example, the policy function to be evaluated and the value function to be evaluated may correspond to at least one of the policy function and the value function transmitted from the policy manager 9400 or the data storage 9600. The acquired policy function may be learned by at least one algorithm and transmitted from the policy manager 9400. For example, the algorithms include, but are not limited to, REINFORCE (Reward Increment Nonnegative Factor Offset Reinforcement Characteristic Eligibility), SARSA (State Action Reward State Action), DQN (Deep Q-Network), DQL (Deep Q-Learning), TD learning (Temporal Difference Learning), A3C (Asynchronous Advantage Actor-Critic), PPO (Proximal Policy Optimization), GRPO (Group Relative Policy Optimization), GAT (Graph Attention Network), Random Forest, AdaBoost (Adaptive Boosting), and XGBoost (Extreme Gradient Boosting).

As another example, the policy synthesizer 9510 may generate an ensembled policy function and an ensembled value function based on the policy function and value function received from the policy manager 9400. The purpose of ensembling policies using a policy synthesizer 9510 is to obtain policies that are adaptive to various situations and robust to changes in situations. For example, an ensembled policy may be obtained by using an average ensemble method that assigns setup weights to the plurality of policy functions with the same structure and features obtained at different points in time and calculates the average. Additionally, an ensembled policy may be obtained by a voting ensemble method that generates a policy that selects an alternative by voting on the results of the plurality of policy functions that have different structures but the same input features. In addition, there are stacking ensemble, bagging, and boosting methods, but are not limited thereto. The ensembled policy may be used again as an evaluation policy and may be stored and reused in a data storage 9600 according to user settings.

The policy evaluator 9530 may evaluate the policy function to be evaluated and the value function to be evaluated to produce an evaluation result. The evaluation results refer to the overall results including the optimal policy scenario, optimal policy function, and optimal value function. At this point, an operational model is needed for evaluation. As an example, the operational model may be received from a model storage within a data storage. As another example, an operation model may be provided that reflects state data generated from a state generator 9520. Here, the state generator 9520 may generate states for situations that have not been observed or collected by additionally generating states to evaluate the policy. Additionally, if a single operation model is secured, only the latest model may be retrieved for evaluation. When multiple operational models are secured, they may be used for operation and may also be utilized for reading policy drift.

Additionally, the evaluation result may refer to the execution results of all possible scenarios, which are generated using a model set generated from an evaluation operational model and a state generator 9520, and a policy set generated from a learned target policy/value function and an ensemble policy/value function. The performance results may include at least one of the following forms: models, policies, performance indicators, such as results included in a scenario and experiment summary results from an experiment hub.

When the evaluation results are transmitted to the policy drift detector 9540, the policy drift detector 9540 may determine whether the current policy is appropriate and order re-learning. The appropriateness of a current policy may mean that the policy is robust, that the policy performs well, or that the policy is located on the Pareto Front. Robustness of a policy may refer to a condition in which the policy is less affected by situations, exhibits low performance variation in response to changes in situations, or has performance variation below a predetermined threshold. Additionally, a policy with good performance indicates that the absolute value of the performance indicator is good, or that the value of the performance indicator is high or low and the performance deviation is above or below the threshold. Additionally, the fact that a policy is located on the Pareto Front indicates that it is not dominated by the performance of other policies from a multi-objective perspective.

For example, if the policy evaluation result determines that the equipment operating rate is below the threshold, the policy drift detector 9540 may issue a command to the policy manager 9400 to perform relearning. Additionally, regardless of whether the current policy included in the evaluation results is appropriate, the periodic learning commander 9550 may periodically transmit learning commands. For example, the periodic learning commander 9550 may be commanded to learn once a week. This is to continuously manage the model so that the dynamic system may automatically manage policies that may adapt to changing situations.

Meanwhile, the policy evaluator 9530 may produce an optimal policy scenario, an optimal policy function, and an optimal value function. The generated optimal policy scenario may be stored in a model storage within the data storage 9600. The produced optimal policy function and optimal value function may be stored in a data storage. Storing the optimal policy function and optimal value function in the data storage may correspond to the process of deploying the policy.

Through the reinforcement learning operation manager 9500, it may be operated robustly in a dynamic system environment, and dynamic operation may be enabled in a manufacturing system including reinforcement learning. In addition, reinforcement learning-based policies may be stably applied in real manufacturing system environments and improved in a superior direction.

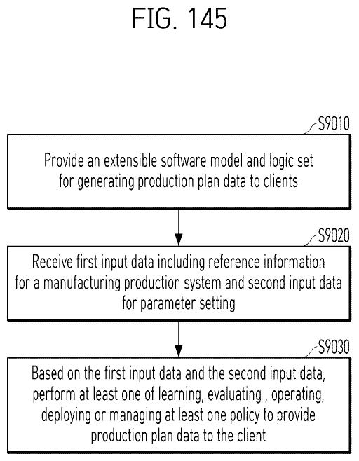

FIG. 145 is a flow chart for generating a production plan using a dynamic tool according to an embodiment.

An extensible software model and logic set for generating production plan data to clients is provided S9010. The extensible software model and logic set may be applied to both on-premise and cloud systems and may involve the backward planning engine, forward planning engine, dispatching agent, compare agent, etc. described above. In addition, the extensible software model and logic set may relate to functions for policy operation, learning, evaluation, deployment and management as described above. Detailed examples of a backward planning engine are illustrated in FIGS. 4 to 8, detailed examples of a forward planning engine are illustrated in FIGS. 9 to 13, and detailed examples of a dispatching agent are illustrated in FIGS. 14 to 18, respectively. For on-premise systems, detailed examples of the model development unit are illustrated in FIGS. 19 to 22, respectively. For the cloud system, detailed examples of the compare agent are illustrated in FIGS. 134 to 138, respectively, detailed examples of the PBB are illustrated in FIGS. 117 to 123, respectively, and detailed examples of the PBF are illustrated in FIGS. 124 to 133.

First input data including reference information for a manufacturing production system and second input data for parameter setting are received S9020. First input data including reference information related to production operation data (manufacturing system) and status data of the manufacturing system may be received, and may be converted into a certain data schema and input into the system according to the requirements of the service provided on the system. In addition, as described above, the second input data corresponds to an input for determining at least one of an action selection method, a list of decision-making factors, a logic for producing decision-making factors, information linking the policy function to each decision-making point, a list of reward and performance structures, logic for producing reward and performance structures, a method for aggregating reward and performance, conditions for generating reward and performance, a policy function structure for decision-making, and initial values and rules for storing the policy function and value function.

Based on the first input data and the second input data, at least one of learning, evaluating, operating, deploying, and managing at least one policy is performed to provide production plan data to the client S9030. As described above, tools such as an action selector, a feature extractor, an evaluator, a policy manager, and a reinforcement learning operation manager may perform at least one of learning, evaluating, operating, deploying, and managing policies. Additionally, it provides production plan data by executing the scenarios generated through it. Here, production plan data may correspond to object information of intermediate or final outputs of model execution, decision-making factors, performance indicators, policy functions, and tools for policy evaluation/learning/operation.

Referring to FIG. 29, an embodiment of a device providing digital production plan information is described as follows.

An embodiment of a device providing digital production plan information may include an input unit 410, a storage unit 420, an in-memory unit 430, a processor 440, an output unit 450, and a user interface 460. For example, a device that provides digital production plan information may correspond to a client's manufacturing production system.

An embodiment of a device providing digital production plan information below may be controlled by user control and management via a user interface 460.

The input unit 410 may receive a software model and logic set generated based on at least one of the data schema and library engine set of the client manufacturing production system from the on-premise computing system.

The storage device 420 may store pre-prepared reference information or store received software model and logic set. The storage device 420 may include volatile memory or non-volatile memory.

In-memory 430 may store the software model, input data, library engine set, and products obtained in the process of performing the library engine, model execution unit, and experiment hub unit disclosed above. A library engine set may contain a production planning engine, which is a number of encapsulated function block files that generate production plans. The in-memory 430 of the embodiment may store intermediate outputs and/or final outputs related to the operational tasks. Additionally, the storage device 420 or in-memory 430 may store services, files, data, etc. related to the function of managing dynamic policy operation. For the above-described dynamic policy operation, related functions in charge of policy operation and learning may be added, and evaluation results, data drift detection logs, situation/state generation data, ensembled policy/value functions, etc. related to functions such as re-learning judgment, state/situation generation, and policy evaluation may also be stored in the form of services, files, and data. Functions related to the above-described policy operation may include detailed functions such as feature extraction, action selection, and evaluation, and may be stored including decision-making factor values, action lists, final decision-makings, policy probabilities, state values, performance, and rewards derived from their operations. Functions related to the above-described policy learning may include functions related to the above-described policy operation and functions such as policy management, and may be stored including such as training data, refined data, initialized policy/value functions, learned policy/value functions, learning logs derived from their operations.

The processor 440 of the embodiment provides an extensible software model and logic set for generating production plan data to a client, receives first input data including reference information for a manufacturing production system and second input data for setting parameters, and performs at least one of learning, evaluating, operating, deploying and managing at least one policy based on the first input data and the second input data to provide production plan data to the client.

Referring to FIG. 104, an embodiment of a device for analyzing a production plan based on a software model and logic set and providing digital production plan information is described as follows.

An embodiment of a device providing digital production plan information may include a processor 2610, in-memory 2620, storage 2630, and an interface 2640.

An embodiment of a device providing digital production plan information below may be controlled by user control and management via an interface 2640. The interface 2640 may obtain input data of the manufacturing production system from a client. The storage device 2630 may store at least one of input data, software model, and logic set received by the interface 2640 in the storage device 2630. The storage device 2630 may include volatile memory or non-volatile memory. In-memory 2620 may include production plan data of a manufacturing production system. The in-memory 2620 or storage device 2630 of the cloud system may store the same data as the in-memory 430 or storage device 420 of the on-premise system.

The processor 2610 of the embodiment provides an extensible software model and logic set for generating production plan data to a client, receiving first input data including reference information for a manufacturing production system and second input data for setting parameters, and performing at least one of learning, evaluating, operating, deploying and managing at least one policy based on the first input data and the second input data to provide production plan data to the client.

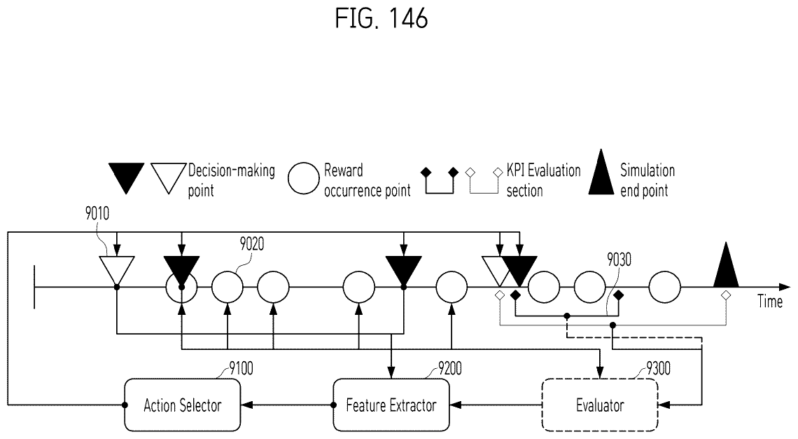

FIG. 146 is a diagram illustrating a tool of a policy operation system according to an embodiment.

An action selector 9100, a feature extractor 9200, and an evaluator 9300 may be used to provide production plan data through a policy operation system, taking into account the timing and form of decision making.

Referring to this embodiment, when a decision is made based on at least one of a policy function and a value function to generate a production plan, at least one decision-making point 9010, at least one reward occurrence point 9020, and at least one KPI evaluation section 9030 are included until the simulation end point.

A decision-making point is a specific point in time at which a decision is made by a specific entity. The reward occurrence point refers to the point corresponding to the reward occurrence condition during the simulation based on the reward occurrence condition parameter input by the user.

The decision-making point and the reward occurrence point may overlap or occur at different times. The KPI evaluation interval may be the interval starting from the decision-making point to the point of reward occurrence, the interval from the decision-making point to the end of the simulation, the interval from the decision-making point to the next decision-making point, or the interval from the decision-making point to an arbitrary amount of time later. The decision-making point, reward occurrence point, and KPI evaluation section may be directly or indirectly related to the performance of the action selector 9100, feature extractor 9200, and evaluator 9300.

Decision-making points may occur the plurality of times during the simulation until the simulation ends. Here, simulations may include running single scenarios, running engines, executing models, etc. The evaluator 9300 may produce performance indicators based on the production plan generated by the decision-making at the end of the simulation or the intermediate or final results of the simulation. Meanwhile, the plurality of policy functions may be applied simultaneously to the same decision-making event (time point). In this case, it may be applied sequentially according to the policy priority obtained through user input.

The feature extractor 9200 may extract object information from at least one decision-making point 9010 and transmit the feature value to the action selector 9100. Additionally, the feature extractor 9200 may extract the decision-making point and transmit it to the evaluator 9300. Additionally, the feature extractor 9200 may extract decision-making factors during simulation. The decision-making point that receives object information as an input value in the feature extractor 9200 and the decision-making point that transmits the final decision-making to the simulation in the action selector 9100 may be the same.

The action selector 9100 may forward the final decision-making to at least one decision-making point 9010 in the simulation. The evaluator 9300 receives object information or simulation log information from the simulator. Additionally, the evaluator 9300 may evaluate at least one reward occurrence point 9300 and KPI evaluation section 9030, and calculate, organize, and store performance indicators, rewards, and penalties. In this system, evaluation is performed selectively, and an evaluator 9300 may be optionally provided.

That is, by using an action selector 9100, a feature extractor 9200, and an evaluator 9300, a policy function or a value function may be used to make decisions and generate production plan data.

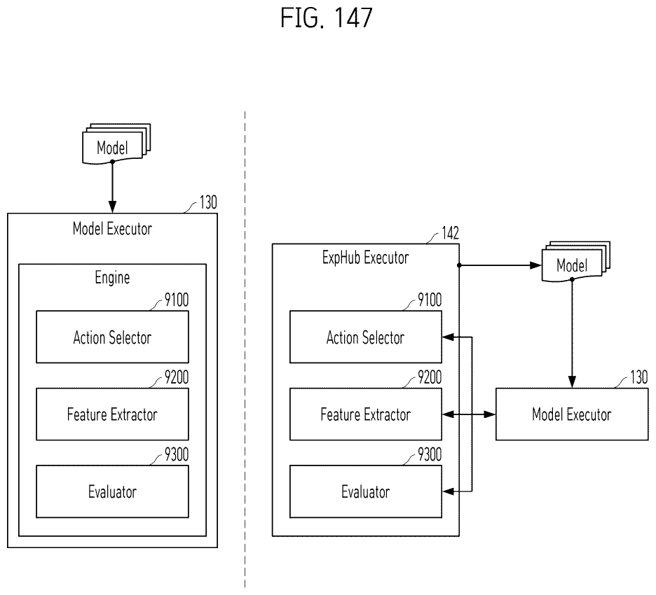

FIG. 147 is a diagram illustrating the executing entity of the policy operation system according to an embodiment.

When extracting features to produce decision-making factors and executing scenarios, each performing entity may be located within the system as follows: Referring to the left side of this embodiment, an action selector 9100, a feature extractor 9200, and an evaluator 9300 that generate a production plan through decision making are located in the engine, and the engine may be included in the model execution unit 130. That is, the model execution unit 130 may perform a simulation on the received model through the action selector 9100, feature extractor 9200, and evaluator 9300 within the engine.

Referring to the right side of this embodiment, the action selector 9100, feature extractor 9200, and evaluator 9300 that generate a production plan through decision making are located in the experiment hub execution unit 142. The model execution unit 130 may perform a simulation by an execution command from the experimental hub execution unit 142. In addition, object information may be received from the model execution unit 130 for feature value calculation, performance indicator, reward and penalty calculation, and the selected decision-making is transmitted from the experiment hub execution unit 142 to the model execution unit 130.

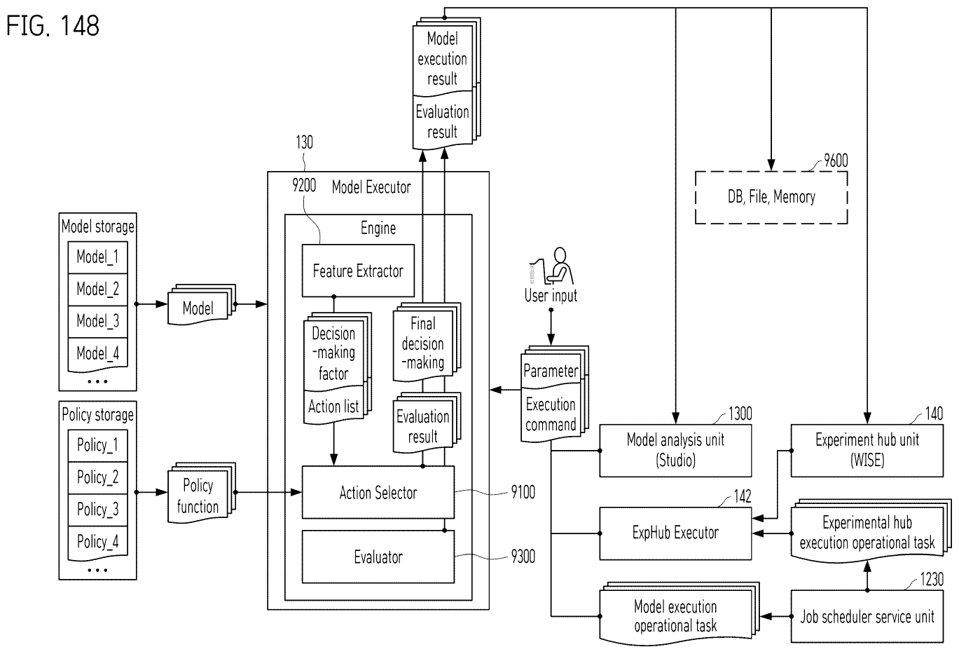

FIG. 148 is a diagram illustrating an example of generating a production plan through a policy operation system according to an embodiment.

In the present embodiment, this may apply to both cases of executing a single software model or the plurality of software models. In the case of a single model, the job scheduler service unit 1230 included in the system operation unit 110 executes the model execution operational task according to execution conditions. In addition, parameters are entered by user input, and an execution command is transmitted to the model execution unit 130, so that decision-makings may be made using the policy and a production plan may be generated. At this time, the model execution unit 130 receives one model set in the user input from the model storage and performs an action. Additionally, the model execution unit 130 may receive at least one policy function setup in the user input from the policy storage and perform an action in the action selector 9100.

In case of the plurality of models, the job scheduler service unit 1230 executes the experimental hub execution operational task according to the execution conditions. In this case, the experimental hub execution unit 142 transmits an execution command to the model execution unit 130, and parameters for executing the plurality of models are entered by user input. At this time, the model execution unit 130 receives the plurality of models set in user input from the model storage and performs actions.

Additionally, an execution command is transmitted to the model execution unit 130 through the model analysis unit 1300 or the experiment hub unit 140 that provides a user interface, so that the model execution unit 130 executes the scenario.

In this embodiment, it is assumed that the model storage already has models 1 to N, and the policy storage already has policies 1 to N. Although not shown in this embodiment, a value function storage may be provided, which corresponds to a state in which value functions from function 1 to function N are already had. Whether to use a value function may be determined by the action selector 9100, and the setting for the value function may be determined by user input. Additionally, a value function storage may be provided in the data storage 9600.

Setting parameters involves user input, and the user input may be provided through the model analysis unit 1300, the experiment hub 140, the user interface of the model execution operational task or the experiment hub execution operational task, and the editing interface of the system operation unit.

User input for parameter setting corresponds to input for determining at least one of an action selection method, a list of decision-making factors, a logic for calculating decision-making factors, information for linking policy functions at each decision-making point, a list of reward and performance structures, logic for calculating reward and performance structures, a method for aggregating reward and performance, reward and performance occurrence conditions, a policy function structure for decision making, and initial values and rules for storing policy functions and value functions. The above-described input may be provided through the user interface of the model analysis section, the experiment hub section, and the operation task editing interface of the system operation section.

In terms of user input that determines how actions are selected, a greedy approach could be taken, for example, to select the action with the highest probability/value. Additionally, a SoftMax method proportional to probability or value is input, the temperature parameter of the SoftMax method is input as alpha, and a rule is input so that alpha is proportional or inversely proportional to the number of extractions. Additionally, if the plurality of policy functions are used at a single decision-making point, a method to make a final decision by ensembling the policies may be input.

Regarding the list of decision-making factors and the user input that determines the decision-making factor output logic, for example, if the number of work items currently waiting in the first operation is to be used as a decision-making factor in making a decision, the output logic for that value can be used as a user input.

With respect to user input regarding information (or linkage) linking the policy function (or value function) to be used at each decision-making point, for example, when decision-making points 1, 2, 3, 4, and 5 are included within the model, decision-making points 1, 2, and 3 may generate decision-makings using the same first policy function, and decision-making points 4 and 5 may generate decision-makings in a different manner from decision-making points 1, 2, and 3 by using the second and third policy functions, respectively. Additionally, it is assumed that there is an event that triggers a decision-making to commit, for example, when the equipment becomes idle. In this case, if there are three A operation facilities and five B operation facilities in the factory, the entire A operation facilities may be input to use policy function 1, and the entire B operation facilities may be input to use policy function 2. Additionally, it could be input to configure a single policy function that takes action on every combination of executable facilities and work items throughout the factory at regular intervals, for example. Also, assume a situation where, for example, decisions are made before a work item has finished its task on the facility and moved into the queue for the next operation. In this case, the work item of product group C may make a final decision by policy function 3, and the work item of product group D may make a final decision by policy function 4. Here, the decision-making point represents any arbitrary point in time at which a decision is made by a specific entity.

Meanwhile, the plurality of policy functions may be applied simultaneously to the same decision-making event (time point). In this case, it may be applied sequentially according to the policy priority obtained through user input.

Regarding the list of reward and performance structures, and the user input that determines the reward and performance structure calculation logic, for example, when work item A is selected, −10 for a due date delay and +15 for no task replacement occurrence. Such numerical reward values and their corresponding conditions may be defined through user input. In addition, if the feature extractor includes pre-implemented 1st, 2nd, and 3rd reward structure calculation logic, when using the 2nd and 3rd rewards in learning, a list of 2nd and 3rd reward structures excluding the 1st reward structure may be input. Additionally, logic and n value may be input to calculate the average operating rate of all facilities included in the first operation group for n periods from the time when the decision was made. In addition, the type for distinguishing each reward and performance, and whether or not to extract target information at the point where the decision occurred, may be input. Here, target information may include target operation, target facility, target product, target work item queue, target line, target site information, etc.

Regarding user input on how to aggregate rewards or performance, for example, 0.3 for each of the 1st, 2nd and 3rd performance indicators (production volume, due date misses, facility utilization rate, etc.). A single value may be input through a weight sum or nonlinear function by inputting a weight of −0.2, 1.5. In addition, parameter values to be used when using a nonlinear structure may be entered, for example, if the production volume exceeds 50, 1 point is fixed, if the production volume is less than 50, the score is the production volume divided by 50, and if the production volume is 50, 1 point may be entered.

With respect to the user input of the policy function or value function structure and initial values for decision making, for example, among the 1st, 2nd, and 3rd policy functions included in decision-making points 1, 2, 3, 4, and 5, the 1st policy function may be input as MLP, the 2nd policy function as GNN, and the 3rd policy function as decision tree. In addition, the initial parameter values constituting each policy function may be set by randomly extracting them from a normal distribution with arbitrary mean and variance as parameters, or at least one of the information for specifying the learned policy function, such as a time point, version information, and policy function ID, may be input to load an existing learned policy function. Additionally, when loading a policy function, an input may be added to verify whether the learned policy function and the currently set policy function match or are compatible. The form of the policy function or value function is determined by user input and may include neural networks of various structures (MLP, CNN, GNN, Transformer, etc.), decision trees, or their composite structures (Ensemble, Boosting, Voting).

Which model to run in a simulation may be determined by user input, and which policy to use may be determined based on user input. Additionally, the model storage and policy storage may correspond to a data storage 9600.

The feature extractor 9200 extracts a decision-making factor and action list and transmits them to the action selector 9100. At this time, the decision-making elements extracted by the feature extractor 9200 include state feature values, which are environmental state elements unrelated to the action, and action feature values, which are directly related to the action. Additionally, the action list represents the set of actions that may be selected at a given point in time.

The action selector 9100 may make a final decision by calculating at least one of an action probability and a state value based on a policy function received from a policy storage and a decision-making factor and action list received from a feature extractor 9200. Although not shown, the action selector 9100 may calculate a state value based on a value function received from a value function storage and a decision-making factor and action list received from a feature extractor 9200 to produce a final decision-making. Additionally, the final decision-making may be output based on a selection method determined by user input from a action list. Additionally, the evaluator 9300 receives and calculates log information, object information, and time information, and thereby produces an evaluation result.

In the feature extractor 9200, object information may include all elements objectified within the simulation, such as sites, lines, facilities, products, and operations, and their detailed feature values. Additionally, in the evaluator 9300, object information may include various simulation intermediate/final results/logs generated by decision making. Evaluation results may include values, time information, hierarchy information, performance indicator type information, reward type information, aggregate information, etc. Additionally, the evaluation results may correspond to the overall results, including simulation intermediate results, simulation final results, performance indicators/reward calculation results processed from these, and used policies. The model execution unit 130 performs a simulation considering the final decision-making and generates a model execution result that is a collection of the plurality of final decision-makings. The model execution results produced from the action selector 9100 and the aggregate results produced from the evaluator 9300 may be transmitted to the model analysis unit 1300, data storage 9600, and experiment hub unit 140.

Additionally, in this embodiment, when executing the plurality of scenarios, the experiment hub execution unit 142 may execute simulations simultaneously and in parallel for one or more model execution units 130.

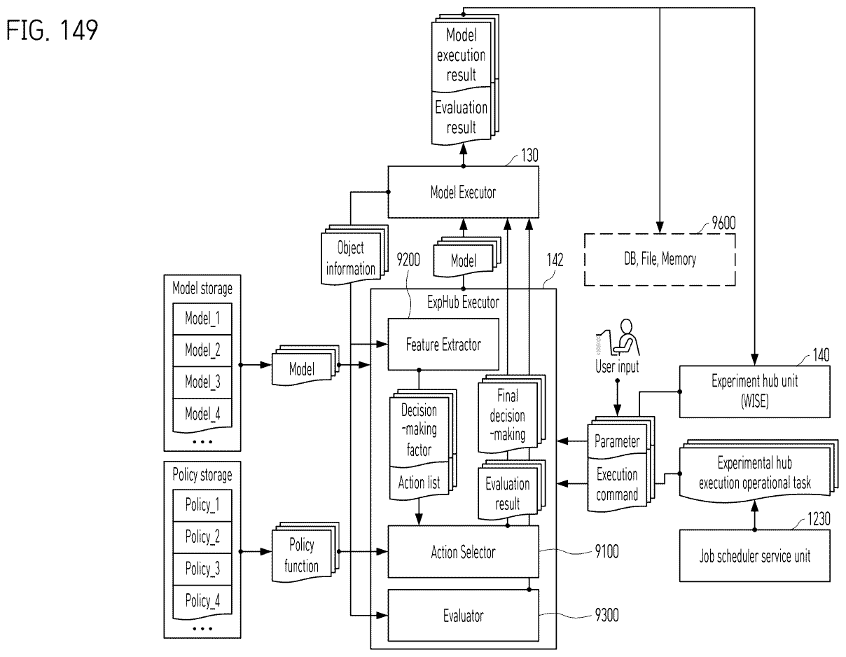

FIG. 149 is a diagram illustrating another example of generating a production plan through a policy operation system according to an embodiment.

In the present embodiment, this may apply to cases where the plurality of software models are executed. In addition, in this embodiment, the description of the same content as in FIG. 148 described above is omitted. In this embodiment, it is assumed that the model storage already has models 1 to N, and the policy storage already has policies 1 to N. Additionally, although not shown, a value function storage may be provided.

Referring to this embodiment, the job scheduler service unit 1230 included in the system operation unit 110 may be transmitted an execution command to execute an experiment hub execution operational task according to execution conditions. Additionally, an execution command may be transmitted to the experiment hub execution unit 142 through the experiment hub unit 140 that provides a user interface. At this time, the experimental hub execution unit 142 receives parameters required for execution through user input.

User input for parameter setting corresponds to input for determining at least one of an action selection method, a list of decision-making factors, a logic for calculating decision-making factors, information for linking policy functions at each decision-making point, a list of reward and performance structures, logic for calculating reward and performance structures, a method for aggregating reward and performance, conditions for generating reward and performance, a policy function structure and initial values for decision making, and rules for storing policy functions and value functions.

In this embodiment, a feature extractor 9200, an action selector 9100, and an evaluator 9300 for generating a production plan through decision making may be provided in the experiment hub execution unit 142.

The feature extractor 9200 may extract a list of decision-making factors and actions based on object information received from the model execution unit 130. The extracted decision-making factors and action list are transmitted to the action selector 9100. The action selector 9100 may make a final decision by applying decision-making factors and action list to at least one of a policy function and a value function. The final decision-making may be determined based on at least one of the action probability and state value calculated in the action selector 9100.

Additionally, the evaluator 9300 receives object information from the model execution unit 130 and calculates it, thereby producing an evaluation result. Evaluation results may include values, time information, hierarchy information, etc.

The experimental hub execution unit 142 is equipped with an action selector 9100 to make a final decision, and the experimental hub execution unit 142 may perform a simulation by considering the final decision-making and evaluation results for the model execution unit 130. The model execution unit 130 performs a simulation for a scenario based on the final decision-making received from the experiment hub execution unit 142 to generate model execution results and evaluation results, and transmits them to the data storage 9600 and the experiment hub unit 140.

In addition, in the case of this embodiment, when executing the plurality of scenarios, the experimental hub execution unit 142 may execute simulations simultaneously and in parallel for one or more model execution units 130.

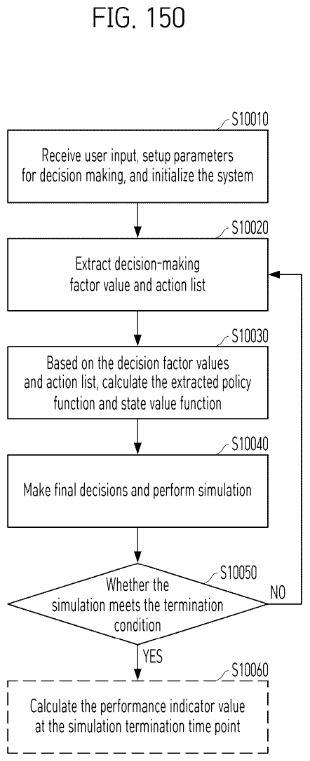

FIG. 150 is a flowchart describing an example of performing a simulation and calculating a performance index through a policy operation system according to an embodiment.

First, user input may be received, parameters for decision making may be set, and the system may be initialized S10010. System initialization may be performed in the model execution unit or the experiment hub execution unit, which includes a feature extractor 9200, an action selector 9100, and an evaluator 9300. User input for parameter setting may be received through the operational task editing interface of the model analysis unit 1300, the experiment hub unit 140, and the system operation unit. In addition, as described above, user input for parameter setting corresponds to input for determining at least one of an action selection method, a list of decision-making factors, a logic for calculating decision-making factors, information for linking policy functions at each decision-making point, a list of reward and performance structures, logic for calculating reward and performance structures, a method for aggregating reward and performance, conditions for generating reward and performance, a policy function structure and initial values for decision-making, and rules for storing policy functions and value functions.

Next, the decision-making factor values and action list may be extracted by considering the state and actions of the system at the decision-making point S10020. The decision making factor values and action lists may be extracted from the feature extractor. Meanwhile, the produced decision-making factors, feature value information, action lists, etc. may be extracted during the simulation operation.

Additionally, based on the extracted decision factor values and action list, at least one of the action probability and state value functions may be calculated S10030. When a decision-making factor matching the input form of the policy function is extracted from the feature extractor and transmitted to the action selector, at least one of the policy function value and the state value may be calculated in the action selector. This may be equivalent to a feed forward process implemented by passing the policy function through a neural network once, when the policy function is expressed as a neural network.

Final decisions may be made and simulations may be performed S10040. Additionally, performance indicator values may optionally be calculated during the simulation. Additionally, a final decision is made and a simulation is performed based on at least one of the calculated policy function and state value values. A final decision may include at least one action from the action list. Additionally, the final decision may be made in the action selector. For example, in the case of a decision-making where a facility selects a work item or a batch, at least one work item or batch may be the final decision-making depending on the selection method. Additionally, for example, if a work item selects a facility or a group of facilities, at least one facility or group of facilities may be the final decision-making. Additionally, for example, in the case of a decision-making to select between a facility-work item or batch-work item pair, at least one of the pairs may be the final decision-making.

It is possible to determine whether the simulation meets the terminal condition S10050. Scenarios are executed by a simulator, which may include an engine, a model execution unit, and an experiment hub execution unit.

If the terminal condition is satisfied, the performance indicator value may be calculated at the simulation termination time (completion time) S10060. Performance indicator values may be calculated by the evaluator. Here, the terminal conditions may include target time (computation time), planning interval (planning period), occurrence of target event, satisfaction of target demand, satisfaction of target performance value, etc. Additionally, step S10060 may be performed optionally. That is, when the simulation ends, the performance indicator values at the end point may be optionally calculated. Additionally, when the simulation is completed, production plan data may be provided.

If the terminal condition is not satisfied, the process returns to step S10020 to extract the decision-making factor values and action list again, and the next steps may be performed sequentially. That is, steps S10020 to S10040 may be repeatedly performed until a terminal condition is reached.

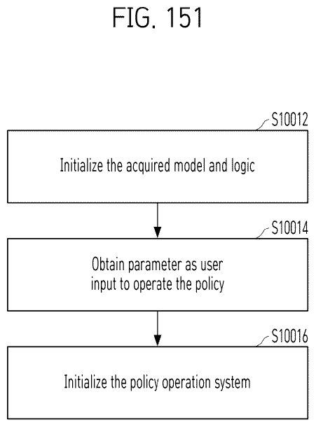

FIG. 151 is a flowchart describing steps for initializing a policy operation system according to an embodiment.

This embodiment is a flowchart explaining the S10010 initialization step described above in more detail.

First, at least one software model and logic may be received, input data may be acquired, and the acquired model and logic may be initialized S10012. Additionally, at least one software model and logic set may be provided to the client. For example, a model execution unit or an experiment hub execution unit may acquire at least one software model. Initializing the acquired model and logic corresponds to initializing a scenario or simulation for model execution.

Next, parameters may be obtained as user input to operate the policy S10014. Additionally, at least one of an action selection method, a list of decision-making factors, information linking a policy function to each decision-making point, a list of reward and performance structures, logic for calculating reward and performance structures, a reward and performance aggregation method, reward and performance occurrence conditions, a policy function structure and initial values for decision-making, and rules for storing policy functions and value functions may be set through user input.

The policy operation system may be initialized S10016. Initialization of the model and logic is performed in the model execution unit, and initialization of the feature extractor 9200, action selector 9100, and evaluator 9300 may be performed in the model execution unit or the experiment hub execution unit.

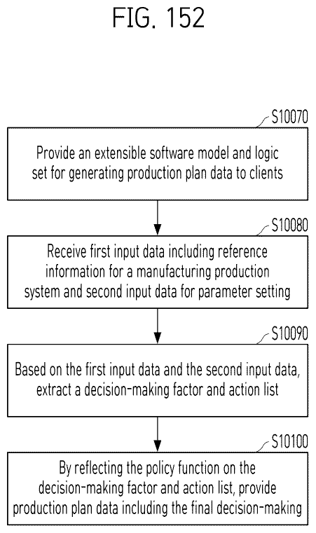

FIG. 152 is a flowchart of generating production plan data through a policy operation system according to an embodiment.

Provides an extensible software model and logic set for generating production plan data to clients S10070. The extensible software model and logic set may be applied to both on-premise and cloud systems and may involve the backward planning engine, forward planning engine, dispatching agent, compare agent, etc. described above. In addition, the extensible software model and logic set may relate to functions for policy operation, learning, evaluation, distribution, and management as described above. Detailed examples of a backward planning engine are illustrated in FIGS. 4 to 8, detailed examples of a forward planning engine are illustrated in FIGS. 9 to 13, and detailed examples of a dispatching agent are illustrated in FIGS. 14 to 18, respectively. For on-premise systems, detailed examples of the model development unit are illustrated in FIGS. 19 to 22, respectively. For the cloud system, detailed examples of the compare agent are illustrated in FIGS. 134 to 138, respectively, detailed examples of the PBB are illustrated in FIGS. 117 to 123, respectively, and detailed examples of the PBF are illustrated in FIGS. 124 to 133.

First input data including reference information for a manufacturing production system and second input data for parameter setting are received S10080. First input data including reference information related to production operation data (manufacturing system) and status data of the manufacturing system may be received, and may be converted into a certain data schema and input into the system according to the requirements of the service provided on the system. In addition, as described above, the second input data corresponds to an input for determining at least one of an action selection method, a list of decision-making factors, a logic for producing decision-making factors, information linking the policy function to each decision-making point, a list of reward and performance structures, logic for producing reward and performance structures, a method for aggregating reward and performance, conditions for generating reward and performance, a policy function structure for decision-making, and initial values and rules for storing the policy function and value function.

Based on the first input data and the second input data, a decision-making factor and action list may be extracted S10090. As described above, the decision-making factor includes at least one of a state feature value and an action feature value, and the action list represents a set or list of selectable actions.

By reflecting the policy function on the decision-making factor and action list, production plan data including the final decision may be provided S10100. As described above, a final decision may be made by applying a decision-making factor and action list to at least one of a policy function and a value function. Additionally, performance indicator values may be calculated through model execution that reflects the final decision-making, and model execution results and evaluation results may be saved. Here, production plan data may correspond to object information of intermediate or final outputs of model execution, decision-making factors, performance indicators, policy functions, and tools for policy evaluation/learning/operation.

Referring to FIG. 29, an embodiment of a device providing digital production plan information is described as follows.

An embodiment of a device providing digital production plan information may include an input unit 410, a storage unit 420, an in-memory unit 430, a processor 440, an output unit 450, and a user interface 460. For example, a device that provides digital production plan information may correspond to a client's manufacturing production system.

An embodiment of a device providing digital production plan information below may be controlled by user control and management via a user interface 460.

The input unit 410 may receive a software model and logic set generated based on at least one of the data schema and library engine set of the client manufacturing production system from the on-premise computing system.

The storage device 420 may store pre-prepared reference information or store received software model and logic set. The storage device 420 may include volatile memory or non-volatile memory.

In-memory 430 may store the software model, input data, library engine set, and products obtained in the process of performing the library engine, model execution unit, and experiment hub unit disclosed above. A library engine set may contain a production planning engine, which is a number of encapsulated function block files that generate production plans. The in-memory 430 of the embodiment may store intermediate outputs and/or final outputs related to the operational tasks. In addition, the storage device 420 or in-memory 430 may store services, files, data, etc. related to the function of managing dynamic policy operation, and related functions in charge of policy operation and learning for the above-described dynamic policy operation may be added, and evaluation results, data drift detection logs, situation/state generation data, ensemble policy/value functions, etc. related to functions such as re-learning judgment, state/situation generation, and policy evaluation may also be stored in the form of services, files, and data. Functions related to the above-described policy operation may include detailed functions such as feature extraction, action selection, and evaluation, and may be stored including decision-making factor values, action lists, final decision-makings, policy probabilities, state values, performance, and rewards derived from their operations. Functions related to the above-described policy learning may include functions related to the above-described policy operation and functions such as policy management, and may be stored including training data derived from their operations, refined data, initialized policy/value functions, learned policy/value functions, learning logs, etc.

The processor 440 of the embodiment provides an extensible software model and logic set for generating production plan data to a client, receives first input data including reference information for a manufacturing production system and second input data for setting parameters, and performs at least one of learning, evaluating, operating, deploying and managing at least one policy based on the first input data and the second input data to provide production plan data to the client.

Referring to FIG. 104, an embodiment of a device for analyzing a production plan based on a software model and logic set and providing digital production plan information is described as follows.

An embodiment of a device providing digital production plan information may include a processor 2610, in-memory 2620, storage 2630, and an interface 2640.

An embodiment of a device providing digital production plan information below may be controlled by user control and management via an interface 2640. The interface 2640 may obtain input data of the manufacturing production system from a client. The storage device 2630 may store at least one of input data, software model and logic set received by the interface 2640 in the storage device 2630. The storage device 2630 may include volatile memory or non-volatile memory. In-memory 2620 may include production plan data of a manufacturing production system. The in-memory 2620 or storage device 2630 of the cloud system may store the same data as the in-memory 430 or storage device 420 of the on-premise system.

The processor 2610 of the embodiment provides an extensible software model and logic set for generating production plan data to a client, receives first input data including reference information for a manufacturing production system and second input data for setting parameters, extracts decision-making factor and action list based on the first input data and the second input data, and reflects a policy function on the decision-making factor and action list to provide production plan data including a final decision-making.

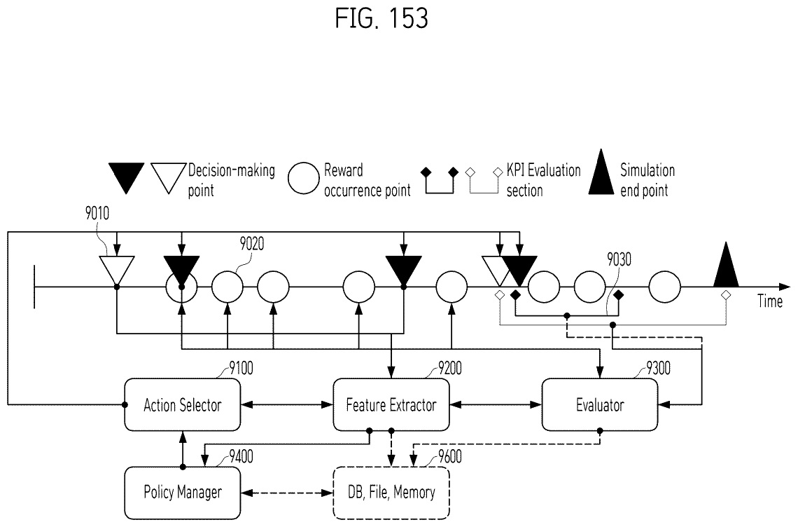

FIG. 153 is a diagram illustrating a tool of a policy learning system according to an embodiment.

To perform policy learning through data collection, an action selector 9100, a feature extractor 9200, an evaluator 9300, and a policy manager 9400 may be used.

Referring to this embodiment, when data is accumulated and learning is performed for policy learning, at least one decision-making point 9010, at least one reward occurrence point 9020, and at least one KPI evaluation section 9030 are included until the simulation end point.

A decision-making point is a specific point in time at which a decision is made by a specific entity. The reward occurrence point refers to the point corresponding to the reward occurrence condition during the simulation based on the reward occurrence condition parameter input by the user.

Decision-making points may occur the plurality of times during the simulation until the simulation ends. Here, simulations may include running single scenarios, running engines, running models, performing experiments, etc. The evaluator 9300 may produce performance indicators based on the production plan generated by the decision at the end of the simulation or the intermediate or final results of the simulation. Meanwhile, the plurality of policy functions may be applied simultaneously to the same decision-making event (time point). In this case, it may be applied sequentially according to the policy priority obtained through user input.

The feature extractor 9200 may extract a decision-making factor values and action list for at least one decision-making point 9010 and transmit them to the action selector 9100. Additionally, the feature extractor 9200 may extract the decision-making point and transmit it to the evaluator 9300. Additionally, the feature extractor 9200 may extract decision-making factors during the simulation, not just at the end of the simulation. The feature extractor 9200 may produce training data and transmit it to the policy manager 9400 or data storage 9600.

The action selector 9100 may receive decision-making factor values and an action list from the feature extractor 9200 and generate a final decision-making. The final decision-making may be transmitted to at least one decision-making point in the simulation to drive the simulation. Additionally, the final decision-making may be fed back to the feature extractor 9200 and used to refine it as training data. Additionally, the evaluator 9300 may evaluate at least one reward occurrence point 9300 and KPI evaluation section 9030, calculate performance indicators, rewards, and penalty values, and transmit them to the feature extractor 9200 or optionally store them in a data storage.

The policy manager 9400 may learn a policy through training data received from the feature extractor 9200 and produce a learning log, a learned policy function, and a learned value function to transmit to the action selector 9100 or store in a data storage.

That is, productivity and efficiency may be increased simply by improving the policy for making decisions in given resources and situations by performing policy learning using an action selector 9100, a feature extractor 9200, an evaluator 9300, and a policy manager 9400.

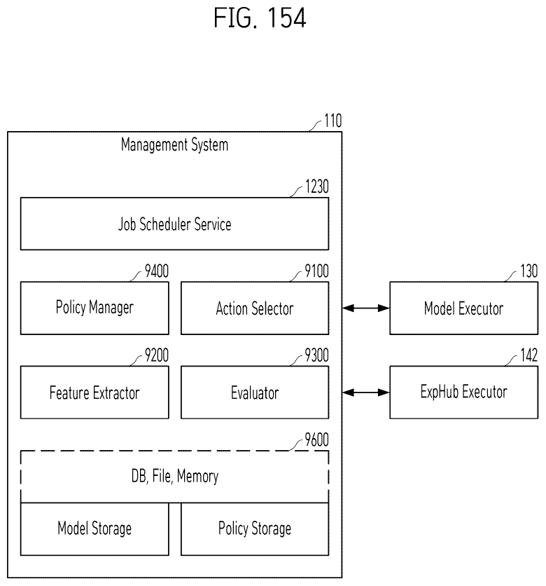

FIG. 154 is a diagram illustrating the executing entity of a policy learning system according to an embodiment.

Each entity that learns the policy function may be located within the system as follows. Referring to this embodiment, the system operation unit 110 may include an action selector 9100, a feature extractor 9200, an evaluator 9300, and a policy manager 9400 required to perform policy learning by executing a simulation. Additionally, the system operation unit 110 may include a job scheduler service unit 1230 and a data storage unit 9600. The data storage 9600 may include a model storage and a policy storage.

In addition, the model execution unit 130 and the experiment hub execution unit 142 are located separately from the system operation unit 110 and may issue execution commands. In this case, the action selector 9100, feature extractor 9200, evaluator 9300, and policy manager 9400 may be provided within the model execution unit 130 or the experiment hub execution unit 142. Although not shown in this embodiment, it is also possible for the model execution unit 130 and the experiment hub execution unit 142 to be located within the system operation unit 110.

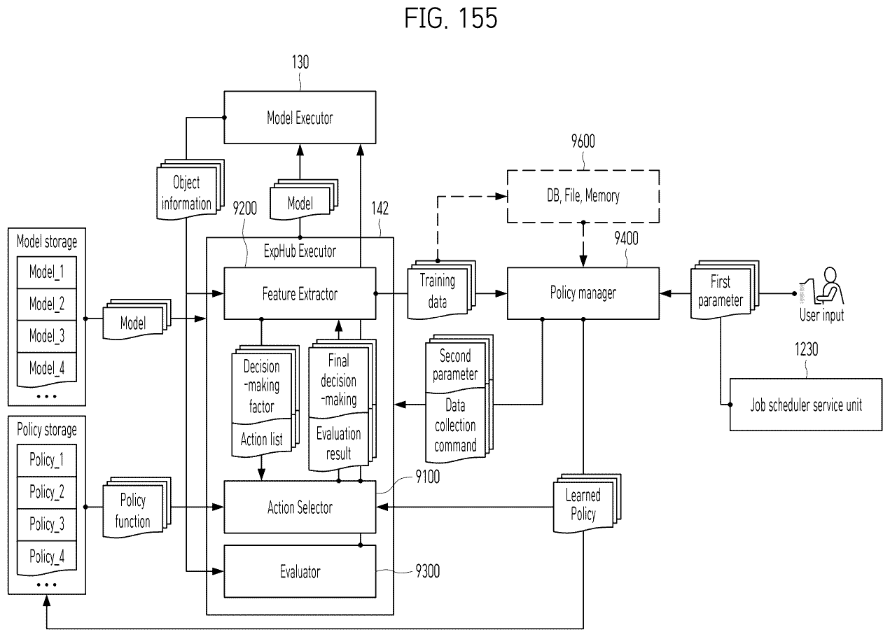

FIG. 155 is a diagram illustrating an example of performing policy learning through a policy learning system according to an embodiment.

This embodiment corresponds to an example of the operation of a policy manager when the experimental hub execution unit 142 includes a feature extractor, an action selector, an evaluator, and a policy manager.

First, the first parameter may be set or entered by user input. The first parameter includes at least one of an action selection method, a list of decision-making factors, a logic for calculating decision-making factors, information for connecting a policy function to each decision-making point, a list of reward and performance structures, logic for calculating reward and performance structures, a method for aggregating reward and performance, conditions for generating reward and performance, a policy function structure for decision making, policy initial values for decision making, rules for storing policy functions and value functions, a policy function, a type of model to be executed, and information that may specify the model. Additionally, the first parameter may include parameters related to learning. Learning-related parameters may include at least one of the following: the number of accumulated training data, the training data accumulation method, the training data management method, the learning start condition, the type of learning algorithm, the parameters of the learning algorithm, the initialization method, the initialization logic, the initialization algorithm, the hyperparameter auto-tuning method, the hyperparameter auto-tuning logic, the hyperparameter auto-tuning algorithm, and the learning termination rule.

With respect to user input for information linking (or connection relationship) the policy function (or value function) to be used at each decision-making point, for example, when the model contains decision-making points 1, 2, 3, 4, and 5, the input may be such that the decision-making points 1, 2, and 3 share training data using the same first policy function, and the decision-making points 4 and 5 collect data separately using the second and third policy functions, respectively.

With respect to the user input of the storage rule of policy function or value function, for example, it may be input as extracting at least one policy learning or value function included in one data extraction and learning process every N hours and storing it in the database, or storing it when learning for M epochs, or storing it when the change in the performance indicator is less than or equal to e. Additionally, when saving to a file or database, the input for database access rules and saving may be set.

For example, in the case of learning-related parameters such as the number of accumulated training data and the training data accumulation method, it may be set to accumulate 500,000 training data and, when this is exceeded, to overwrite the accumulated data in the order of earliest accumulated time. Additionally, for the learning start condition, for example, it may correspond to an accumulation of more than 300,000 training data. Regarding the method of managing training data, it may be set to keep the existing data at the end of learning or exclude 60% of the training data in the order of earliest accumulated time.

The learning algorithm corresponds to a reinforcement learning algorithm, and the learning algorithm used in the reinforcement learning algorithm may be set to REINFORCE, TD (SARSA), DON, A3C, PPO, GRPO, GAT, etc. Additionally, Adam, AdamW, RMSProp, Lion, etc. may be set as search algorithms used in reinforcement learning. For example, when learning a second policy function whose learning algorithm structure is GNN, Adam may be used among the optimization algorithms (search methods) based on gradient descent (SGD) method. When using Adam, the learning rate as 0. 001, the first momentum as 0. 9, the second momentum as 0. 999, and epsilon as 10-8 may be input as parameters. Additionally, for example, if a parameter auto-tuner is included, only the hyperparameters of the parameter auto-tuner may be input. In this case, the four parameters of the Adam algorithm described above may be automatically adjusted to the learning situation. Additionally, the extraction method and preprocessing method of the feature extractor may vary depending on the input learning algorithm. For example, when learning using the TD (SARSA) method, the status of two consecutive decision-making points and decision-making selection information are required, but in the case of PPO and GAT, learning is possible only with information for the time of decision making.

The learning termination rule indicates the learning termination condition, and may be set to terminate after learning for T hours, terminate after performing K epochs, terminate when the performance indicator change is less than or equal to e, or the loss function value, etc. Additionally, complex conditions may be set based on logic or rules, not just threshold values, such as when, for example, in the case of multi-objectives, the update of the Pareto Front is not made within a learning epoch.

With the first parameter set, the job scheduler service unit 1230 may transmit an execution command to the policy manager 9400 according to the execution conditions set for the operational task, or the execution command may be transmitted to the policy manager 9400 through additional user input.

The policy manager 9400 may transmit data collection commands to the experimental hub execution unit. At this time, the policy manager 9400 may transmit a data collection command while transmitting the second parameter. The second parameter corresponds to a part of the first parameter and it is for data collection.

Meanwhile, before sending the data collection command, parameters required for learning from user input may be received and various tools may be initialized. In this case, the parameters may not be suitable for the target model, so a step of checking the necessary records after running the model in advance to determine appropriate parameter values may be optionally performed. That is, prior model understanding is required to manually or automatically tune parameter settings by user input to produce superior performance through learning. This may be performed by the hyperparameter auto-tuner of the policy manager 9400 described above. Commands to pre-execute the model may also be executed by the hyperparameter auto-tuner or by transmitting execution commands to the operational tasks of the system operation unit to execute the model.

For example, it is assumed that the parameters have been defined that model training begins when 1 million data have been collected. At this time, the result of executing the target model may result in a situation where the first learning occurs after running the simulation 10,000 times, as there are only about 100 decision-making points per execution. In this case, the time point of the learning occurrence may be adjusted to the 10,000 level so that learning begins after running the simulation 100 times.

Also, for example, among facilities A, B, C, D, and E with similar roles, it is assumed that parameters are set through user input such that A, B, and C use policy 1, and facilities D and E use policy 2. At this time, a situation may arise where 100 pieces of data are collected from facilities A, B, and C, and 5 pieces are collected from facilities D and E. In this case, Policy 1 may allow learning to occur smoothly, while Policy 2 may not allow learning to occur at all. Therefore, five devices, A, B, C, D, and E, may be reconfigured to utilize the same policy and collect data.

Additionally, depending on the second parameter, the feature extractor 9200, the action selector 9100, and the evaluator 9300 may be initialized. A policy function may be required for initialization, and the policy function corresponds to a policy function stored in the policy storage. At this time, the provided policy function corresponds to the policy function set in the second parameter. Meanwhile, although not illustrated, it is also possible for a policy manager 9400 to randomly generate a policy function provided from a policy storage and transmit it as a second parameter or a learned policy through a neural network initiator or the like.

After initialization, the experimental hub execution unit 140 may execute the model. The model being executed at this time corresponds to the model stored in the model storage. For example, M models whose execution times are close to the current time may be retrieved, or all models within N hours from the current time may be retrieved. The model execution unit 130 executes the model according to the command of the experiment hub execution unit 140 and may transmit object information generated according to the model execution to the feature extractor 9200.

As described above, the feature extractor 9200 may derive decision-making factor values and an action list from object information and transmit them to the action selector 9100. The action selector 9100 may produce a final decision-making and transmit it to the feature extractor 9200. Additionally, the final decision-making and evaluation results, which are the execution results of the action selector 9100 and evaluator 9300, may be transmitted to the model execution unit 130.

As the model continues to run, training data may be produced from the feature extractor 9200 based on the final decision-making from the action selector 9100 and the evaluation results from the evaluator 9300. The produced training data may be stored in a data storage 9600 or transmitted to a policy manager 9400 to become a target of learning.

The policy manager 9400 performs learning through training data. The learned policy is updated in the policy of the action selector 9100 and used to make decisions and extract data with the new policy. Additionally, learned policies may be stored in a policy storage for recording. A learned policy may include a policy function, a value function, and a training log.

Meanwhile, when the policy manager 9400 receives an execution command while the first parameter is set, the policy manager 9400 may transfer the learned policy to the action selector 9100 or the policy storage. At this time, the transmitted learned policy may correspond to the initial policy function generated through the neural network initiator. Additionally, when an execution command is received, if it is a situation that has already been learned, learning begins again using the learned policy.

Through policy learning via the policy manager, performance may be improved simply by improving the decision-making policy in given resources and situations. In addition, it enables operation by securing policies in situations where there are no policies, and manages learned policies to enable continuous learning.

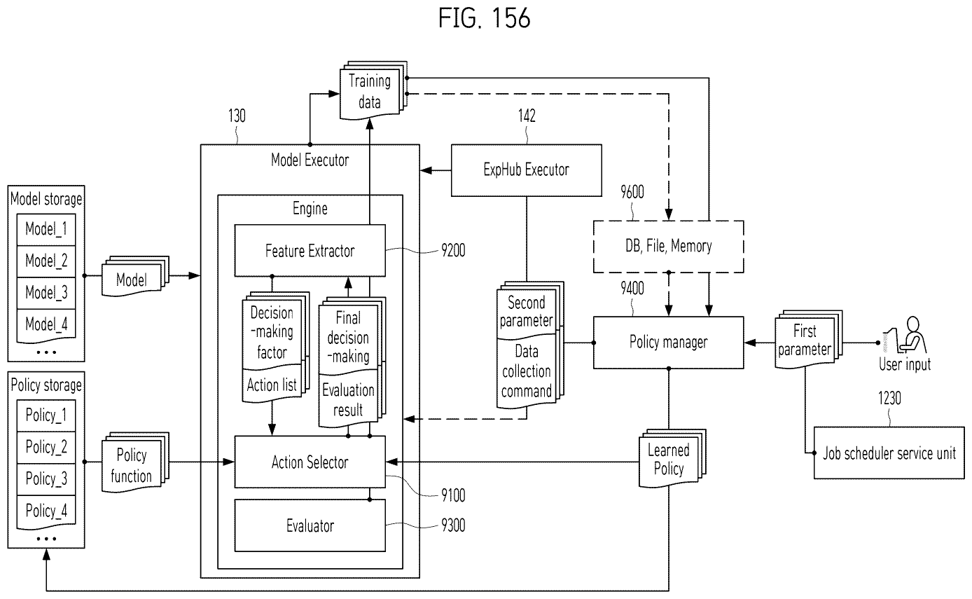

FIG. 156 is a diagram illustrating another example of performing policy learning through a policy learning system according to an embodiment.

This embodiment is an example of the operation of a policy manager when an engine included in a model execution unit includes a feature extractor, an action selector, and an evaluator. In addition, in this embodiment, the description of the same content as in FIG. 155 described above is omitted.

First, the first parameter may be set or entered by user input. With the first parameter setup, the job scheduler service unit 1230 may transmit an execution command to the policy manager 9400 according to the execution condition setup for the operational task, or the execution command may be transmitted to the policy manager 9400 through additional user input.

The policy manager 9400 may transmit data collection commands to the experimental hub execution unit. At this time, the policy manager 9400 may transmit a data collection command while transmitting the second parameter. The second parameter corresponds to a part of the first parameter and is a parameter for data extraction.

Additionally, depending on the second parameter, the feature extractor 9200, the action selector 9100, and the evaluator 9300 may be initialized. A policy function may be required for initialization, and the policy function corresponds to a policy function stored in the policy storage. At this time, the policy function provided corresponds to the policy function setup in the second parameter.

After initialization, the model is executed and the engine may execute the simulation. When the decision-making point is reached while running the simulation, the feature extractor 9200 may produce decision-making factors.

As described above, the feature extractor 9200 may derive a decision-making factor and action list from object information and transmit them to the action selector 9100. The action selector 9100 may produce a final decision-making and transmit it to the feature extractor 9200. Additionally, the final decision-making and evaluation results, which are the execution results of the action selector 9100 and evaluator 9300, may be transmitted to the model execution unit 130.

As the model continues to run, training data may be produced from the feature extractor 9200 based on the final decision-making from the action selector 9100 and the evaluation results from the evaluator 9300. More specifically, data may be refined through the aggregator of the feature extractor 9200 to produce training data. As described above, the training data may include decision-making factors, action lists, final decisions, decision-making points, performance indicators, reward information, etc. Training data may be transferred to a data storage 9600 and stored, or transferred to a policy manager 9400 and become a target of learning.

The policy manager 9400 performs learning through training data. The learned policy is updated to the policy of the action selector 9100 and used to make decisions and extract data with the new policy. This corresponds to the process of updating to obtain new training data through the learned policy. Additionally, learned policies may be stored in a policy storage for recording.

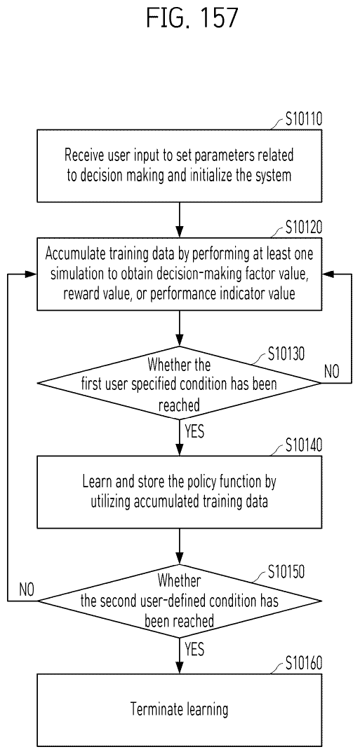

FIG. 157 is a flowchart illustrating an example of performing learning through a policy learning system according to an embodiment.

First, user input may be received to set parameters related to decision making and initialize the system S10110. As described above, when receiving user input, parameters for learning may be set as parameters related to decision making. Additionally, based on the data collection command, a system including a feature extractor, an action selector, and an evaluator may be initialized. Additionally, the policy manager may also be initialized.

Next, training data may be accumulated by performing at least one simulation to obtain decision factor values, reward values, or performance indicator values S10120. Additionally, it may be organized by matching the decision-making point and reward value. As described above, based on the object information received from the simulator, the feature extractor may transmit the decision-making factor, an action list to the action selector, and the decision-making point, etc. to the evaluator. Additionally, through data preprocessing, data is processed to fit the form of the algorithm used for policy learning, thereby generating refined training data. Additionally, refined training data may be trained with a selected learning algorithm. The selected learning algorithm will contain hyperparameters required for performing the algorithm, which may be obtained through user input or an auto-tuning device. Here, hyperparameters correspond to a set of parameters that must be acquired for the learning algorithm to operate.

It may be determined whether the first user defined condition has been reached S10130. The first user-defined condition corresponds to the condition for starting learning. For example, the first user defined condition may be that at least 300,000 data must be accumulated before learning may begin. These first user-defined conditions may be entered into the dependencies between operational tasks of the operating system. For example, if the data extraction operational task is performed once and the number of data is less than 300,000, a dependency execution condition may be executed to execute the data extraction operational task again, and if the number of data is more than 300,000, a training operational task may be executed. In addition, for example, when collecting data in an iterative experiment of the experiment hub department, after the plurality of scenario 1 iterations of extracting data in the iterative experiment design are completed, the iterative logic may check whether the data is more than or less than 300,000 to determine whether to perform the next iteration step or perform the learning algorithm.

When the first user-defined condition is reached, the policy function may be learned and stored by utilizing accumulated training data S10140. Additionally, the policy function may be updated using accumulated training data. Policies, learning logs, etc. during the learning process may be saved according to pre-entered settings. Meanwhile, while learning, updating, or storing a policy function by utilizing accumulated training data that is not urban, organizing or accumulating training data may continue. That is, the learning process may proceed separately (asynchronously) from the data collection process. For example, after 300,000 data have been collected, the learning algorithm may continuously generate policy functions regardless of data collection. During training, new data may be added, resulting in a total of 400,000, or training may proceed with only 300,000 data while training is in progress. Additionally, if the first user-defined condition is not reached, the process may be repeated from step S10120.

Next, it may be determined whether the second user-defined condition has been reached S10150. It meets the conditions for ending the second user-defined learning. For example, a second user-defined condition might be one where learning continues but there is no improvement in performance. Also, for example, this may be the case when performance is improving but not reaching the target value. The second user-defined condition may correspond to a case where at least one condition may be entered based on the plurality of user inputs.

When the second user-defined condition is reached, learning may be completed S10160. When learning is finished, the learned policy may be provided.

If the second user-defined condition is not reached, the process may be repeated from step S10120. That is, steps S10120 to S10150 may be repeatedly performed until the first user-defined condition and the second user-defined condition are reached.

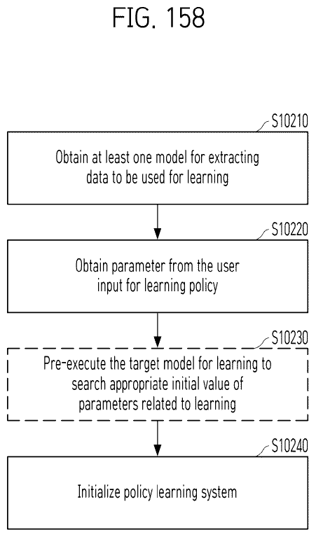

FIG. 158 is a flowchart illustrating steps for initializing a policy learning system according to an embodiment.

More specifically, it corresponds to a flowchart describing step S10110 of FIG. 157 in detail.

First, at least one model for extracting data to be used for learning may be obtained S10210. That is, when obtaining a target model for data extraction, learning may be performed by simultaneously extracting data from different manufacturing system models that share the same decision-making factors. Additionally, training may be performed using input data from different states or situations for a single model that uses the same decision-making factors. In addition, as described above, the entity that acquires the model corresponds to the model execution unit or the experiment hub execution unit, and the entity that issues commands to the model execution unit or the experiment hub execution unit corresponds to the system operation unit or the policy management unit. For example, a data extraction operational task may be added to the operating system to directly specify the extraction target model and input data version as input values. Additionally, it is possible to input a rule that specifies a model corresponding to five versions of input data, excluding, for example, the earliest version of the input data from the current point in time.

Next, the logic of the learning target decision-making factor, the structure of the policy function, the learning algorithm, and the setting values may be obtained from user input S10220. Here, the logic of the learning target decision-making factor, the structure of the policy function, the learning algorithm, and the setting values correspond to parameters set by user input.

In addition, the target model for learning may be pre-executed to search appropriate values of parameters related to learning S10230. Step S10230 is an optional step that serves to adjust the hyperparameters used for learning.

Additionally, tools for simulation and policy learning may be initialized based on the acquired model and learning-related information S10240. If hyperparameters are provided, the policy learning system may be initialized based on the searched hyperparameters. In this embodiment, tools for simulation and policy learning may include a feature extractor, an action selector, an evaluator, and a policy manager.

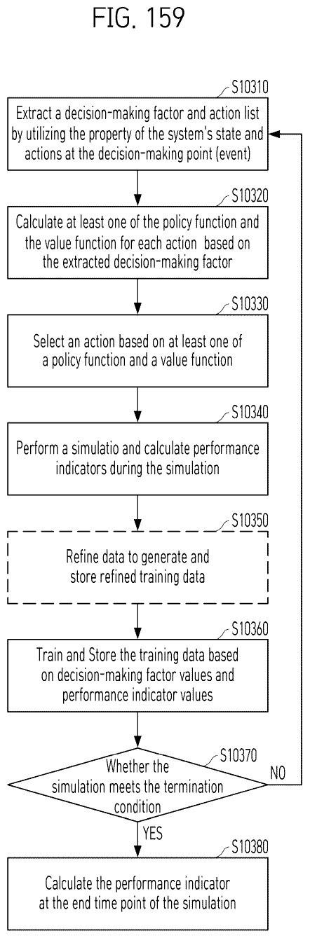

FIG. 159 is a flowchart illustrating obtaining a reward or performance indicator when performing policy learning according to an embodiment.

More specifically, it corresponds to a flowchart detailing step S10120 of FIG. 157.

First, a decision-making factor and action list may be extracted by utilizing the properties of the system's state and actions at the decision-making point (event) S10310. As described above, the feature extractor may extract state feature values and action feature values based on object information received from the simulator, and extract decision-making factors and action lists by reflecting the same.

Next, at least one of the policy function value and the value function value for each action may be calculated based on the extracted decision-making factors S10320. As described above, the action selector may calculate at least one of an action probability and a state value by reflecting the decision-making factors and the action list for at least one of a policy function and a value function.

Additionally, an action is selected based on at least one of a policy function and a value function S10330. For example, an action may be selected based on at least one of a computed policy function value and a value function. As described above, the action selector may make a final decision based on at least one of the action probability and the state value.

A simulation may be performed and performance indicators may be calculated during the simulation S10340. As described above, when executing a model by an execution command, performance indicators may be calculated during the simulation. Calculating performance indicators during the simulation may be optional.

Additionally, data may be refined to generate and store refined training data S10350. As described above, refined training data may be produced or generated by processing data to fit the form of the algorithm used for policy learning. Additionally, data refinement process may be performed optionally.

Training data may be trained and stored based on decision-making factor values and performance indicator values S10360. As described above, after training the training data, the learned policy function, the learned value function, and the log related to the training may be provided.

It is determined whether the simulation meets the terminal conditions S10380, and if the simulation meets the terminal conditions, the performance indicator at the completion time point of the simulation may be calculated S10380. At this time, the terminal conditions may include the number of decision-making times, target time, target performance value, and operating time. Here, the target time represents the schedule and planning interval of the scenario.

However, if the terminal condition is not satisfied, the decision-making factors, performance indicators, final decision, and action list may be extracted again from step S10310. That is, if the terminal condition is not satisfied, steps S10310 to S10370 may be repeatedly performed until the terminal condition is reached.

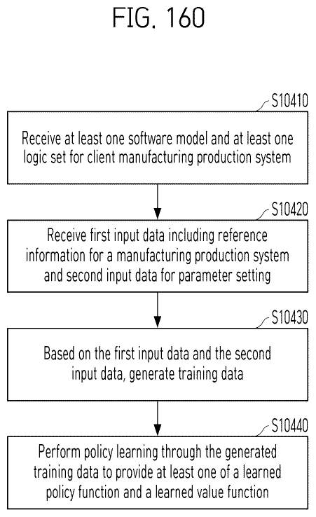

FIG. 160 is a flowchart of generating a policy through a policy learning system according to an embodiment.

Provides an extensible software model and logic set for generating production plan data to clients S10410. The extensible software model and logic set may be applied to both on-premise and cloud systems and may involve the backward planning engine, forward planning engine, dispatching agent, compare agent, etc. described above. In addition, the extensible software model and logic set may relate to functions for policy operation, learning, evaluation, distribution, etc. as described above. Detailed examples of a backward planning engine are illustrated in FIGS. 4 to 8, detailed examples of a forward planning engine are illustrated in FIGS. 9 to 13, and detailed examples of a dispatching agent are illustrated in FIGS. 14 to 18, respectively. For on-premise systems, detailed examples of the model development unit are illustrated in FIGS. 19 to 22, respectively. For the cloud system, detailed examples of the compare agent are illustrated in FIGS. 134 to 138, respectively, detailed examples of the PBB are illustrated in FIGS. 117 to 123, respectively, and detailed examples of the PBF are illustrated in FIGS. 124 to 133.

First input data including reference information for a manufacturing production system and second input data for parameter setting are received S10420. First input data including reference information related to production operation data (manufacturing system) and status data of the manufacturing system may be received, and may be converted into a certain data schema and input into the system according to the requirements of the service provided on the system. In addition, as described above, the second input data corresponds to an input for determining at least one of an action selection method, a list of decision-making factors, a logic for producing decision-making factors, information linking the policy function to each decision-making point, a list of reward and performance structures, logic for producing reward and performance structures, a method for aggregating reward and performance, conditions for generating reward and performance, a policy function structure for decision-making, and initial values and rules for storing the policy function and value function.

Based on the first input data and the second input data, training data is generated S10430. As described above, the training data includes at least one of a performance indicator, a decision-making factor, an action list, a time point, a target operation, a target facility, a reward, and a penalty. Additionally, through data preprocessing, data is processed to fit the form of the algorithm used for policy learning, thereby generating refined training data.

The generated training data can be used to policy learning to provide at least one of a learned policy function and a learned value function S10440. As described above, by learning a policy through training data, a learning log, a learned policy function, and a learned value function may be produced. Here, production plan data may correspond to object information of intermediate or final outputs of model execution, decision-making factors, performance indicators, policy functions, and tools for policy evaluation/learning/operation.

Referring to FIG. 29, an embodiment of a device providing digital production plan information is described as follows.

An embodiment of a device providing digital production plan information may include an input unit 410, a storage unit 420, an in-memory unit 430, a processor 440, an output unit 450, and a user interface 460. For example, a device that provides digital production plan information may correspond to a client's manufacturing production system.

An embodiment of a device providing digital production plan information below may be controlled by user control and management via a user interface 460.

The input unit 410 may receive a software model and logic set generated based on at least one of the data schema and library engine set of the client manufacturing production system from the on-premise computing system.

The storage device 420 may store pre-prepared reference information or store the received software model and logic set. The storage device 420 may include volatile memory or non-volatile memory.

In-memory 430 may store the software model, input data, library engine set, and products obtained in the process of performing the library engine, model execution unit, and experiment hub unit disclosed above. A library engine set may contain a production planning engine, which is a number of encapsulated function block files that generate production plans. The in-memory 430 of the embodiment may store intermediate outputs and/or final outputs related to the operational tasks. Additionally, the in-memory 430 or storage device 420 may store services, files, data, etc. related to the function of managing dynamic policy operation. For the dynamic policy operation, related functions in charge of policy operation and learning may be added, and evaluation results, data drift detection logs, situation/state generation data, ensembled policy/value functions, etc. related to functions such as re-learning judgment, state/situation generation, and policy evaluation may also be stored in the form of services, files, and data. Functions related to the policy operation may include detailed functions such as feature extraction, action selection, and evaluation, and may be stored including decision-making factor values, action lists, final decisions, policy probabilities, state values, performance, and rewards derived from their operations. Functions related to the policy learning may include functions related to the policy operation and functions such as policy management, and may be stored including training data derived from their operations, refined data, initialized policy/value functions, learned policy/value functions, learning logs, etc.

The processor 440 of the embodiment provides an extensible software model and logic set for generating production plan data to a client, receiving first input data including reference information for a manufacturing production system and second input data for setting parameters, generating training data based on the first input data and the second input data, and performing policy learning on the generated training data to provide at least one of a learned policy function and a learned value function.

Referring to FIG. 104, an embodiment of a device for analyzing a production plan based on a software model and logic set in a cloud system and providing digital production plan information is described as follows.

An embodiment of a device providing digital production plan information may include a processor 2610, in-memory 2620, storage 2630, and an interface 2640.

An embodiment of a device providing digital production plan information below may be controlled by user control and management via an interface 2640. The interface 2640 may obtain input data of the manufacturing production system from a client. The storage device 2630 may store at least one of input data, the software model and logic set received by the interface 2640 in the storage device 2630. The storage device 2630 may include volatile memory or non-volatile memory. In-memory 2620 may include production plan data of a manufacturing production system. The in-memory 2620 or storage device 2630 of the cloud system may store the same data as the in-memory 430 or storage device 420 of the on-premise system.

The processor 2610 of the embodiment provides an extensible software model and logic set for generating production plan data to a client, receiving first input data including reference information for a manufacturing production system and second input data for setting parameters, generating training data based on the first input data and the second input data, and performing policy learning on the generated training data to provide at least one of a learned policy function and a learned value function.

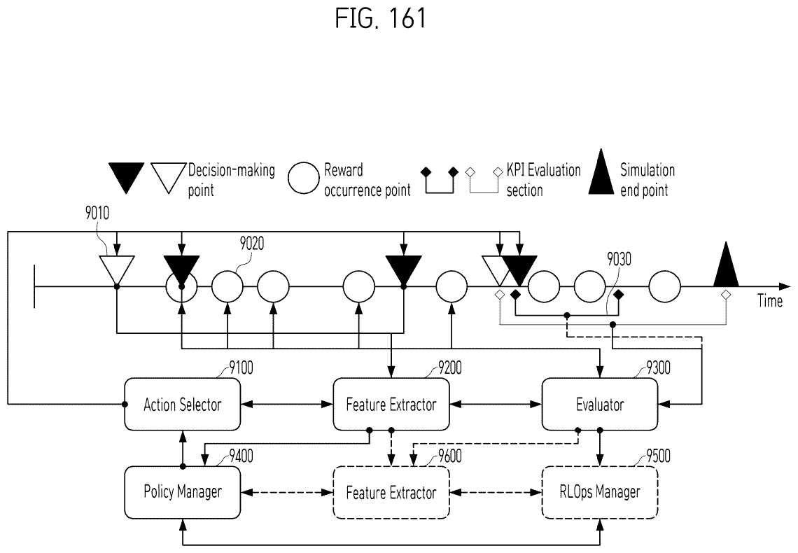

FIG. 161 is a diagram illustrating a tool of a dynamic policy operation and learning system according to an embodiment.

The present embodiment relates to a dynamic policy operation and learning system that learn a policy, evaluates the learned policy, and suggests an optimal policy or scenario suitable for the changing situation of a manufacturing system. An action selector 9100, a feature extractor 9200, an evaluator 9300, a policy manager 9400, and a reinforcement learning operation manager 9500 may be used.

Policy learning refers to a series of processes for securing policies for the operation of a manufacturing system. Policy evaluation is the process of selecting the best policy alternative in a manufacturing system and performing a virtual scenario, and mainly refers to reflecting the learned policy in the operation of the manufacturing system.

Referring to this embodiment, when performing policy learning and policy operation, at least one decision-making point 9010, at least one reward occurrence point 9020, and at least one KPI evaluation section 9030 are included until the simulation end point.

Decision-making points may occur the plurality of times during the simulation until the simulation ends. Here, simulations may include running single scenarios, running engines, running models, performing experiments, etc. The evaluator 9300 may calculate performance indicators based on the production plan or simulation intermediate results generated by decision making during and at the end of the simulation. Meanwhile, the plurality of policy functions may be applied simultaneously to the same decision-making event (time point). In this case, it may be applied sequentially according to the policy priority obtained through user input.

The feature extractor 9200 may extract a decision-making factor and action list for at least one decision-making point 9010 and transmit to the action selector 9100. The feature extractor 9200 may produce training data and transmit to the policy manager 9400.

The action selector 9100 makes a final decision using at least one of a policy function and a value function for at least one decision-making point 9010 based on decision-making factors, and transmits the final decision-making to at least one decision-making point 9010 of the simulation. Additionally, the feature extractor 9200 may extract the final decision-making delivered from at least one decision-making point 9010. Additionally, the evaluator 9300 may evaluate at least one reward occurrence point 9300 and KPI evaluation section 9030, calculate and refine the performance indicator, reward, and penalty value, and transmit to the feature extractor 9200 or optionally store them in a data storage.

The policy manager 9400 may learn a policy through training data received from the feature extractor 9200 and produce a learning log, a learned policy function, and a learned value function to store in a data storage or transfer to the reinforcement learning operation manager 9500.

The reinforcement learning operation manager 9500 receives policy functions and value functions from the policy manager 9400 or data storage 9600, and receives aggregate information including performance indicators from the evaluator 9300. The reinforcement learning operation manager 9500 may continuously evaluate the policy and transmit a re-learning command to the policy manager 9400.

That is, a system is provided that may dynamically operate a policy by learning the policy using an action selector 9100, a feature extractor 9200, an evaluator 9300, a policy manager 9400, and a reinforcement learning operation manager 9500.

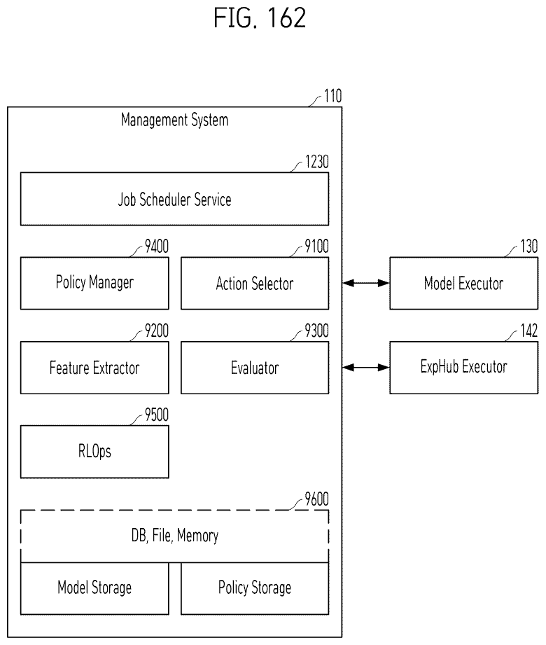

FIG. 162 is a diagram illustrating the execution entity of a dynamic policy operation and learning system according to an embodiment.

Each executing entity that learns the policy and dynamically operates the policy may be located within the system as follows. Referring to this embodiment, the system operation unit 110 may include an action selector 9100, a feature extractor 9200, an evaluator 9300, a policy manager 9400, and a reinforcement learning operation manager 9500 required to perform policy learning by executing a simulation. Additionally, the system operation unit 110 may include a job scheduler service unit 1230 and a data storage unit 9600. The data storage unit 9600 may include a model storage and a policy storage.

Although not shown, the action selector 9100, evaluator 9300, and feature extractor 9200 may be provided in the engine of the model execution unit 130 or in the experiment hub execution unit 142.

In addition, the model execution unit 130 and the experiment hub execution unit 142 are located separately from the system operation unit 110 and may issue execution commands. Although not shown in this embodiment, it is also possible for the model execution unit 130 and the experiment hub execution unit 142 to be located within the system operation unit 110.

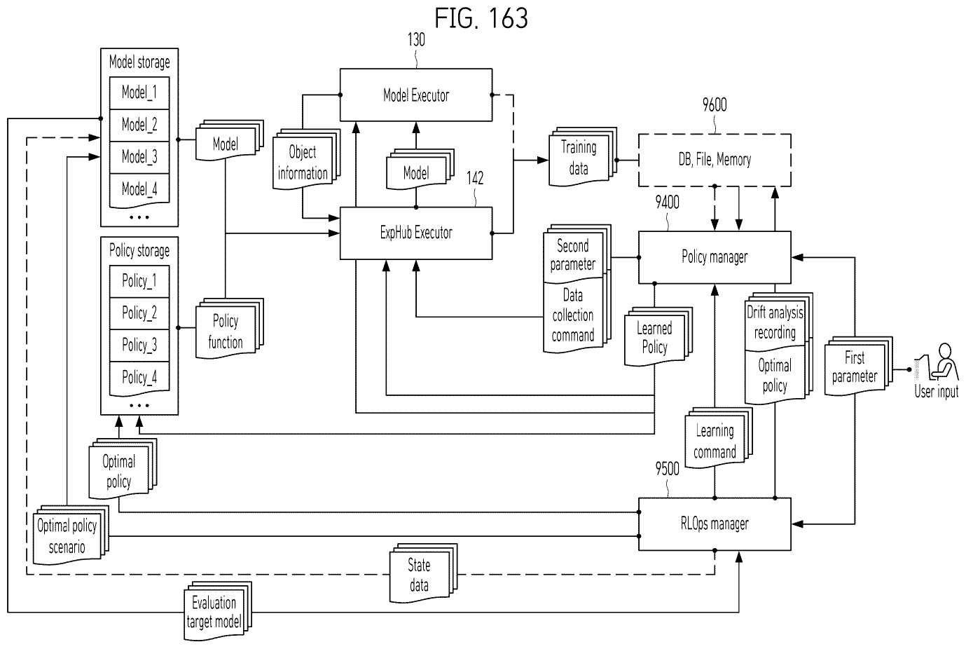

FIG. 163 is a diagram illustrating an example of executing a simulation through a dynamic policy operation and policy learning system according to an embodiment.

This example describes a method to periodically evaluate the learned policy to suggest optimal policy or scenario. The reinforcement learning operation management unit 9500 may be located in the system operation unit, or may be located outside the system operation unit and provided as a separate reinforcement learning operation management unit. In addition, in this embodiment, the feature extractor, action selector, and evaluator are not illustrated, but are assumed to be included in the system operation unit 110, model execution unit 130, or experiment hub execution unit 142, as described above in FIG. 162.

First, the first parameter may be set or entered by user input. The first parameter may include parameters related to policy operation, parameters related to learning, parameters for policy management, and parameters for reinforcement learning operation. The reinforcement learning operation manager 9500 or policy manager 9400 of this embodiment may perform the function of the job scheduler service unit of the system operation unit. Therefore, the reinforcement learning operation manager 9500 may perform operational tasks. Parameters required for the reinforcement learning operation manager 9500 to be performed may include a drift detection method, a policy function or value function ensemble logic, a policy function or value function ensemble method, an optimal operation policy selection logic, an optimal operation policy selection method, a data storage method, etc.

Additionally, the reinforcement learning operation manager 9500, policy manager 9400, feature extractor (not shown), action selector (not shown), and evaluator (not shown) may be initialized and executed.

When the reinforcement learning operation manager 9500 is executed for the first time, a policy may be received from the data storage 9600. Alternatively, if there is no policy to be evaluated, a learning command may be transmitted to the policy manager 9400. In this case, the policy manager 9400 may issue a data collection command while transmitting the second parameter to the experiment hub execution unit 142. Here, the second parameter corresponds to the data collection related parameter.

In addition, even if there is no learning command from the reinforcement learning operation manager 9500, if the first parameter is set, the policy manager 9400 may transmit a data collection command to the experiment hub execution unit 142 or the model execution unit 130.

In this case, the experimental hub execution unit 142 may execute the model. The model being executed at this time corresponds to the model stored in the model storage. The model execution unit 130 executes the model according to the command of the experiment hub execution unit 142 and may transmit object information generated according to the model execution to a feature extractor (not shown).

As described above, a feature extractor (not shown) may derive a decision-making factor and action list from object information and transmit them to an action selector (not shown). An action selector (not shown) may produce a final decision-making and transmit to a feature extractor (not shown). Additionally, the final decision-making and evaluation results, which are the execution results of the action selector (not shown) and the evaluator (not shown), may be transmitted to the model execution unit (not shown).

As the model continues to run, training data may be produced from the feature extractor (not shown) based on the final decision-making from the action selector (not shown) and the evaluation results from the evaluator (not shown). The produced training data may be stored in a data storage (not shown) or transmitted to a policy manager 9400 to become a target of learning. Although not shown, the feature extractor, action selector, and evaluator may be located in the model execution unit 130 or the experiment hub execution unit 142.

The policy manager 9400 may train the training data until the first user condition and the second user condition are satisfied. Although not illustrated, when learning is complete, the final policy may be stored in a policy storage or a data storage. Additionally, policies generated during learning may be stored in a policy storage or data storage.

The evaluation target model is transferred from the model storage to the reinforcement learning operation manager 9500, and the reinforcement learning operation manager 9500 may generate state data through the state generator and store it in the model storage. For example, state data may be produced as a new evaluation target model in a model storage. Additionally, although not shown, the reinforcement learning operation manager 9500 may retrieve policy functions from a data storage 9600, a policy storage, or a policy manager 9400.

The reinforcement learning operation manager 9500 may perform policy evaluation for at least one of policy evaluation for operation deployment and data drift reading. At this time, the acquired policies and models may be evaluated in all combinations to calculate the values of performance indicators. Performance indicators may be calculated by an evaluator included in the model execution unit or the experiment hub execution unit, or through an evaluation script in the system operation unit.

As an example, the reinforcement learning operation manager 9500 may evaluate policies to deploy an optimal operation model. The operating model being evaluated at this time may be a single model or the plurality of models. For example, if a model is evaluated over a three-day period, the plurality of models are evaluated and the optimal policy and scenario that yield the best performance are deployed. At this time, additional user input may be received or performance judgment logic may be provided to determine whether optimal performance is achieved. If an optimal policy scenario is derived, it may be passed to the model storage. Additionally, the optimal policy when the optimal scenario is derived may be transferred to the policy storage. At this time, the deployed policy and scenario may correspond to one optimal policy and scenario, or may correspond to the plurality of policies and scenarios, such as the top N.

As another example, the reinforcement learning operation manager 9500 may evaluate policies for drift detection. Various evaluation target models may be called up to determine how well policies perform in various environments or how well policy performance is maintained in a dynamic operating environment. At this time, the drift analysis record used for data storage are transferred to the data storage.

Meanwhile, the learning command issued from the reinforcement learning operation manager 9500 may include a command through a policy drift detector and a periodic learning command. If the reading result through the policy drift detector corresponds to a third user-defined condition, a learning command may be transmitted to the policy manager 9500 to proceed with learning again. Additionally, if the reading result through the policy drift detector does not correspond to a third user-defined condition, dynamic operation may be performed to continuously evaluate the policy function.

Through the above-described process, the dynamic policy operation and learning system learns and provides robust policies in various manufacturing environments and situations, thereby securing an optimal operation scenario.

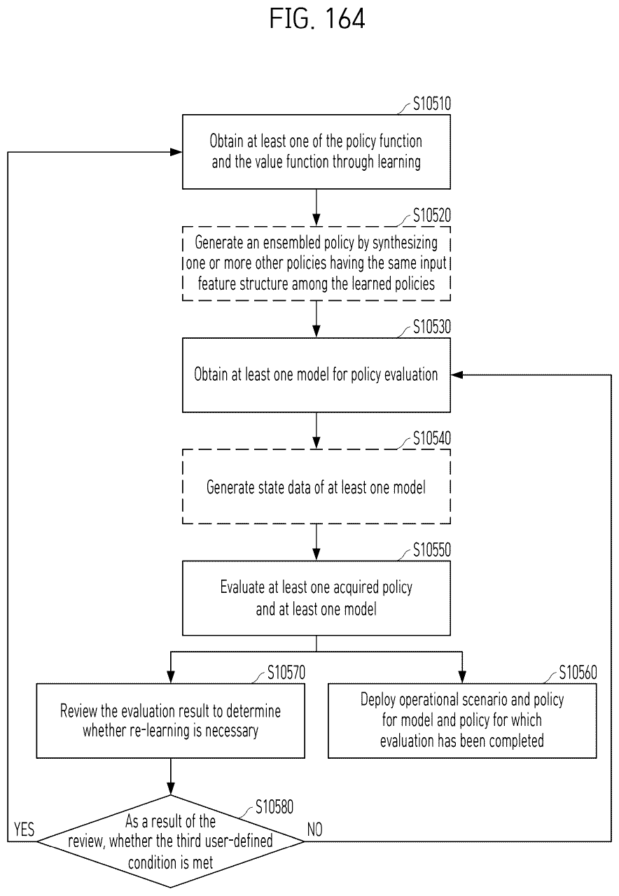

FIG. 164 is a flowchart illustrating a dynamic policy operation performed through a dynamic policy operation and learning system according to an embodiment.

First, at least one of the policy function and the value function may be obtained through learning S10510. As performed in the policy learning system, learning may be performed through a feature extractor, an action selector, an evaluator, and a policy manager until the first terminal condition and the second terminal condition are satisfied.

An ensembled policy may be generated by synthesizing one or more other policies having the same input feature structure among the learned policies S10520. In the policy synthesizer of the reinforcement learning operation manager, at least one of the policy functions and value functions received from the policy manager is performed, and at least one of the ensembled policy functions and value functions is produced as a result. This step is optional and may be performed if an ensembled policy is required.

At least one model may be obtained for policy evaluation S10530. At least one model may be obtained via a model storage, data storage, etc.

Additionally, state data of at least one acquired model may be generated S10540. This step is not required and may be performed through the state generator of the reinforcement learning operation manager. State data is the data that generates the state of the operating model prior to evaluating the operating model. It generates situations or states of the understanding model to further verify the robustness in various situations, not just the actual operating situation of the model. In addition to reference information on facility, product groups, and operation that are primarily related to the production capacity of a manufacturing system, status data is generated by transforming situations such as order quantity, queued work items, quantity, and load. The generated state data (model) may be stored in a data storage and reused. Reuse is possible not only for the reinforcement learning operation manager, but also for the policy manager when extracting data from learning.

At least one acquired policy and at least one model may be evaluated S10550. More specifically, a combination of policy and model may be evaluated, and the value of the performance indicator for the combination may be produced as evaluation results. Additionally, the values of performance indicators may be calculated by the model execution unit or the experiment hub execution unit. For example, after the model execution unit performs the plurality of scenarios, the experiment hub execution unit may calculate and collect performance indicator values for each scenario. Additionally, it may be produced through the evaluation script of the system operation unit. As described above, the reinforcement learning operation manager 9500 may perform policy evaluation for at least one of policy evaluation for operation deployment and data drift reading.

In the case of policy evaluation for operational deployment, operation scenario and policy may be deployed for model and policy for which evaluation has been completed S10560. At this time, the models and policies being evaluated may be singular or plural. Additionally, the optimal policy scenario and optimal policy may be deployed as evaluation results. Additionally, based on the evaluation results, the top N policy scenarios and top N policies may be deployed. Policy scenarios and policy functions may be deployed to system operation unit and its records may be stored in a data storage.

In the case of policy evaluation for data drift reading, the evaluation results may be reviewed to determine whether re-learning is necessary S10570. The performance indicator values may be transferred to the policy drift detector of the reinforcement learning operation manager and used to determine whether the policy functions provide appropriate performance in the model reflecting the current operation status.

As a result of the review, it may be determined whether the third user-defined condition is satisfied S10580. The third user-defined condition may be set automatically by the system or by user input. Additionally, the third user-defined condition corresponds to the condition for determining whether the policy function exhibits appropriate performance. For example, if all policies show performance with an average equipment utilization rate of less than 80% for all evaluation target models, re-learning may be performed. Additionally, if a specific policy has not been selected as the optimal operating policy for more than five times in previous policy drift detection evaluations, re-learning may be performed.

If the third user-defined condition is reached, it returns to step S10510 where learning proceeds again. Additionally, if the third user-defined condition is not reached, it returns to step S10530 for obtaining model to evaluate the operation scenario again. That is, dynamic policy operation and learning continue while the manufacturing system is in operation.

By repeatedly performing the process of re-learning after evaluating policy for data drift reading or re-evaluating the operational scenario, the dynamic policy operation and learning system may learn and provide the robust policy in various situations, thereby securing the optimal operation scenario.

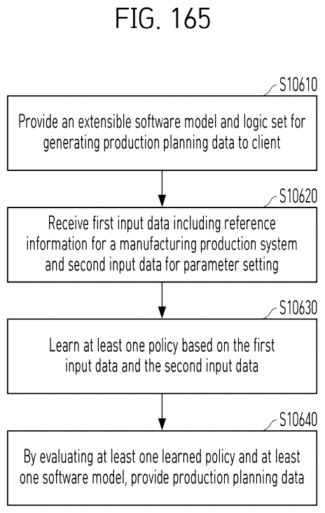

FIG. 165 is a flowchart of generating a production plan through dynamic policy operation and learning according to an embodiment.

An extensible software model and logic set for generating production plan data may provided to clients S10610. The extensible software model and logic set may be applied to both on-premise and cloud systems and may involve the backward planning engine, forward planning engine, dispatching agent, compare agent, etc. described above. In addition, the extensible software model and logic set may relate to functions for policy operation, learning, evaluation, distribution, etc. as described above. Detailed examples of a backward planning engine are illustrated in FIGS. 4 to 8, detailed examples of a forward planning engine are illustrated in FIGS. 9 to 13, and detailed examples of a dispatching agent are illustrated in FIGS. 14 to 18, respectively. For on-premise systems, detailed examples of the model development unit are illustrated in FIGS. 19 to 22, respectively. For the cloud system, detailed examples of the compare agent are illustrated in FIGS. 134 to 138, respectively, detailed examples of the PBB are illustrated in FIGS. 117 to 123, respectively, and detailed examples of the PBF are illustrated in FIGS. 124 to 133.

First input data including reference information for a manufacturing production system and second input data for parameter setting are received S10620. First input data including reference information related to production operation data (manufacturing system) and status data of the manufacturing system may be received, and may be converted into a certain data schema and input into the system according to the requirements of the service provided on the system. In addition, as described above, the second input data corresponds to an input for determining at least one of an action selection method, a list of decision-making factor, a logic for producing decision-making factor, information linking the policy function to each decision-making point, a list of reward and performance structure, logic for producing reward and performance structure, a method for aggregating reward and performance, condition for generating reward and performance, a policy function structure and initial value for decision-making, and storing rule for storing the policy function and value function.

Next, at least one policy may be learned based on the first input data and the second input data S10630. As described above, at least one of an evaluation target policy function and an evaluation target value function may be received for evaluation. At least one model may be acquired for policy evaluation, and state data that generates the state of the operating model may be generated.

By evaluating at least one learned policy and at least one software model, production plan data may be provided S10640. As described above, in the case of policy evaluation for operation deployment, operation scenario and policy may be deployed for the evaluated model and policy. Additionally, in the case of policy evaluation for data drift reading, the evaluation results may be reviewed to determine whether to perform relearning. Here, production plan data may correspond to object information of intermediate or final output of model execution, decision-making factor, performance indicator, policy function, and tool for policy evaluation/learning/operation.

Referring to FIG. 29, an embodiment of a device providing digital production plan information is described as follows.

An embodiment of a device providing digital production plan information may include an input unit 410, a storage unit 420, an in-memory unit 430, a processor 440, an output unit 450, and a user interface 460. For example, a device that provides digital production plan information may correspond to a client's manufacturing production system.

An embodiment of a device providing digital production plan information below may be controlled by user control and management via a user interface 460.

The input unit 410 may receive a software model and logic set generated based on at least one of the data schema and library engine set of the client manufacturing production system from the on-premise computing system.

The storage device 420 may store pre-prepared reference information or store received software model and logic set. The storage device 420 may include volatile memory or non-volatile memory.

In-memory 430 may store the software model, input data, library engine set, and products obtained in the process of performing the library engine, model execution unit, and experiment hub unit disclosed above. A library engine set may contain a production planning engine, which is a number of encapsulated function block files that generate production plan. The in-memory 430 of the embodiment may store intermediate output and/or final output related to the operational task. Additionally, the in-memory 430 or storage device 420 may store services, files, data, etc. related to the function of managing dynamic policy operation. For the dynamic policy operation described above, related functions in charge of policy operation and learning may be added, and related services, files, data, etc. may also be stored. Functions related to the above-described policy operation may include detailed functions such as feature extraction, action selection, and evaluation, and may be stored including decision-making factor value, action list, final decision-making, policy probability, state value, performance, and reward derived from their operations. Functions related to the policy learning may include functions related to the above-described policy operation and functions such as policy management, and may be stored including training data derived from their operations, refined data, initialized policy/value functions, learned policy/value functions, learning logs, etc.

The processor 440 of the embodiment may provide an extensible software model and logic set for generating production plan data to a client, receive first input data including reference information for a manufacturing production system and second input data for setting parameter, learn at least one policy based on the first input data and the second input data, and evaluate the at least one learned policy and the at least one software model to provide production plan data.

Referring to FIG. 104, an embodiment of a device for analyzing a production plan based on a software model and logic set in a cloud system and providing digital production plan information is described as follows.

An embodiment of a device providing digital production plan information may include a processor 2610, in-memory 2620, storage 2630, and an interface 2640.

An embodiment of a device providing digital production plan information below may be controlled by user control and management via an interface 2640. The interface 2640 may obtain input data of the manufacturing production system from a client. The storage device 2630 may store at least one of input data, software model and logic set received by the interface 2640 in the storage device 2630. The storage device 2630 may include volatile memory or non-volatile memory. In-memory 2620 may include production plan data of a manufacturing production system. The in-memory 2620 or storage device 2630 of the cloud system may store the same data as the in-memory 430 or storage device 420 of the on-premise system.

The processor 2610 of the embodiment may provide an extensible software model and logic set for generating production plan data to a client, receiving first input data including reference information for a manufacturing production system and second input data for setting parameters, learning at least one policy based on the first input data and the second input data, and evaluating the at least one learned policy and the at least one software model to provide production plan data.

What is claimed is:

1. A method of providing digital production plan information comprising:
obtaining rule information for each decision-making point of at least one of pre-stored backward planning logic or forward planning logic for a manufacturing production system of a client;
receiving input data including reference information about the manufacturing production system from the client; and
providing production plan data to the client by executing a software model and logic set including at least one of backward planning logic or forward planning logic according to the rule information based on the input data.

2. The method of claim 1, further comprising:
After the receiving step, applying the input data based on a pre-stored standard model to determine at least one of the backward planning logic or the forward planning logic; and
applying the rule information for each decision-making point to a decision-making point in at least one of the determined backward planning logic or the determined forward planning logic.

3. The method of claim 2, wherein the backward planning logic comprises:
an align step, determining a pegging group including at least one work object of a plurality of work objects based on the input data according to the rule information;
an item/site/buffer (ISB) pegging step, executing a work-in-process (WIP) pegging on a target work object of the at least one work object for current ISB information according to the rule information;
an ISB routing step, determining a target bill of material (BOM) of the at least one BOM for the target work object for which the WIP pegging is performed according to the rule information;
an operation pegging step, performing the WIP pegging on the target work object for an operation on the target BOM according to the rule information; and
an operation routing step, applying time information for the operation to the target work object for which the WIP pegging is performed according to the rule information.

4. The method of claim 3, wherein the backward planning logic comprises:
calculating at least one of an operation target, factory input plan information, or a pegging history for the operation based on a target work object having time information for the operation according to the rule information.

5. The method of claim 1, wherein the forward planning logic comprises:
selecting, based on the rule information, a resource group including at least one resource for an operation of the manufacturing production system of the client;
selecting a work item group including at least one work item for the resource group;
selecting a resource for the selected work item group from at least one resource included in the resource group; and
selecting a work item for the resource from among at least one work item included in the work item group.

6. The method of claim 1, wherein the forward planning logic comprises:
selecting, based on the rule information, a resource for an operation of the manufacturing production system of the client;
selecting a work item group including at least one work item for the resource; and
selecting a work item for the resource from the at least one work item included in the work item group.

7. The method of claim 5 or 6, wherein the forward planning logic comprises:
executing operation processing on the selected work item and resource;
placing the work item into the ISB information based on the pegging history included in the input data;
moving work item based on an operational target included in the input data to an operation for the ISB information;
if the operation is not a dummy operation, placing the moved work item into a buffer; and
if the operation is a dummy operation, executing dummy operation processing on the moved work item.

8. A device providing digital production plan information, comprising:
storage storing data;
an in-memory storing a library engine set associated with a software; and
a processor executing the software, wherein the processor is configured to:
obtain rule information for each decision-making point of at least one of pre-stored backward planning logic or forward planning logic for a manufacturing production system of a client; and
receive, from the client, input data including reference information about the manufacturing production system; and
execute perform, based on the input data, a software model and logic set including at least one of backward planning logic or forward planning logic according to the rule information to provide production plan data to the client.

9. The device of claim 8, wherein the processor is further configured to:
apply the input data based on a pre-stored standard model and determine at least one of the backward planning logic or the forward planning logic; and
apply the rule information for each decision-making point to a decision-making point of at least one of the determined backward planning logic or the determined forward planning logic

10. The device of claim 9, wherein the backward planning logic comprises:
determining a pegging group including at least one work object of a plurality of work objects based on the input data according to the rule information;
executing a work-in-process (WIP) pegging on a target work object of the at least one work object for current ISB information according to the rule information;
determining a target bill of material (BOM) of the at least one BOM for the target work object for which the WIP pegging is performed according to the rule information;
performing the WIP pegging on the target work object for an operation on the target BOM according to the rule information; and
applying time information for the operation to the target work object for which the WIP pegging is performed according to the rule information.

11. The device of claim 10, wherein the backward planning logic includes calculating at least one of an operation target, factory input plan information, or a pegging history for the operation based on a target work object having time information for the operation according to the rule information.

12. The device of claim 8, wherein the forward planning logic comprises:
selecting, based on the rule information, a resource group including at least one resource for an operation of the manufacturing production system of the client;
selecting a work item group including at least one work item for the resource group;
selecting a resource for the selected work item group from at least one resource included in the resource group; and
selecting a work item for the resource from among at least one work item included in the work item group.

13. The device of claim 8, wherein the forward planning logic comprises:
selecting, based on the rule information, a resource for an operation of the manufacturing production system of the client;
selecting a work item group including at least one work item for the resource; and
selecting a work item for the resource from the at least one work item included in the work item group.

14. The device of claim 12 or 13, wherein the forward planning logic comprises:
executing operation processing on the selected work item and resource;
placing the work item into the ISB information based on the pegging history included in the input data;
moving work item based on an operational target included in the input data to an operation for the ISB information;
if the operation is not a dummy operation, placing the moved work item into a buffer; and
if the operation is a dummy operation, executing dummy operation processing on the moved work item.

15. A non-transitory computer-readable storage medium for storing a program for providing digital production plan information executable by a computer, the program comprising instructions configured to:
obtain, rule information for each decision-making point of at least one of pre-stored backward planning logic or forward planning logic for a manufacturing production system of a client;
receive, from the client, input data including reference information about the manufacturing production system; and
execute, based on the input data, a software model and logic set including at least one of backward planning logic or forward planning logic according to the rule information to provide production plan data to the client.
